(19) United States
(12) Patent Application Publication
(10) Pub. No.: US 2013/0225248 A1
(43) Pub. Date: Aug. 29, 2013

(54) MOBILE TERMINAL

(71) Applicant: FUJITSU LIMITED, (US)

(72) Inventor: Hisamitsu Takagi, Kawasaki (JP)

(73) Assignee: FUJITSU LIMITED, Kawasaki-shi (JP)

(21) Appl. No.: 13/857,370

(22) Filed: Apr. 5, 2013

Related U.S. Application Data
(63) Continuation of application No. PCT/JP2010/067622, filed on Oct. 7, 2010.

(51) Int. Cl. H04W 88/02

(52) U.S. Cl. CPC H04W 88/02
USPC 455/575.3

(57) ABSTRACT

A mobile terminal includes a first housing having a first space wall forming a first recess-shaped space and a first wiring opening in the first space wall, a second housing having a second space wall forming a second recess-shaped space and a second wiring opening in the second space wall, a swing connecting member disposed in a space between the first recess-shaped space and the second recess-shaped space facing each other, the swing connecting member having a through hole allowing the first recess-shaped space and the second recess-shaped space to be in communication with each other and being configured to swingably move the first housing and the second housing, and a first wiring member passing through the through hole, and having a first fixing end closely connected to the first wiring opening and a second fixing end closely connected to the second wiring opening.

### CROSS-REFERENCE TO RELATED APPLICATIONS

The present application is a U.S. continuation application filed under 35 USC 111(a) claiming benefit under 35 U.S.C. 120 and 365(c) of PCT International Application No. PCT/JP2010/067622 filed on Oct. 7, 2010, the entire contents of which are incorporated herein by reference.

### FIELD

The disclosures herein relate to a mobile terminal having a waterproof structure.

### BACKGROUND

A swing type mobile phone is an example of mobile terminals. In the swing type mobile phone, a display unit performs a swing operation to pivot on a support unit attached to a movable-side case in a clockwise direction or a counterclockwise direction. When the display unit has a rectangular parallelepiped shape, the display unit performing the swing operation is configured to linearly reciprocate while pivoting on the support unit, which does not allow a corner of the display unit to hit the support unit to interfere the pivoting operation of the display unit.

Japanese Laid-open Patent Publication No. 2009-197987 (hereinafter referred to as “Patent Document 1”), for example, discloses a technology utilizing a cylindrical projection or a slot of a first hinge part so as to implement a hinge module that allows the display unit to linearly reciprocate while the display unit pivots on the support unit. In the hinge module to which the above technology is applied, a pivoting operation and a sliding operation are simultaneously conducted during the swing operation. The pivoting operation is configured to pivot the cylindrical projection inside the slot of the first hinge part, and the sliding operation is configured to slide the cylindrical projection inside the slot of the first hinge part.

Further, the hinge module includes a waterproof structure for protecting from water the display unit and the support unit mutually having an electrical connecting relationship. In this waterproof structure of the hinge module, a part of a ring gasket is pressed against a sliding surface of a second hinge part in order to prevent water from entering into the display unit and the support unit through the slot of the first hinge part.

Thus, the part of the ring gasket slides on the sliding surface of the second hinge part during the swing operation. In the hinge module, the ring gasket is inserted into a ring groove formed around the slot of the first hinge part such that the part of the ring gasket is pressed against the sliding surface of a second hinge part, and the part of the ring gasket slides on the sliding surface of the second hinge part during the swing operation. Further, in the hinge module, a part of the ring gasket inserted into the ring groove in a thickness direction is extruded from the ring groove.

That is, the extruded part of the ring gasket attached to the ring groove of the first hinge part is configured to slide on the sliding surface of the second hinge part while being pressed against the sliding surface of the second hinge part during the swing operation. The waterproof properties of the hinge module may be implemented by the above sliding operation.

Further, in the hinge module, the extruded part of the ring gasket is forcefully pressed against the sliding surface of the second hinge part in order for the waterproof properties to be durable in practical use. It is plausible that the stronger the pressing force against the extruded part of the ring gasket is, the higher the resistance against the sliding operation of the extruded part of the ring gasket is. The flexibility of the swing operation may be reduced when the resistance against the sliding operation is increased.

### RELATED ART DOCUMENTS

### Patent Document

Patent Document 1: Japanese Laid-open Patent Publication No. 2009-197987

### SUMMARY

According to an aspect of an embodiment, there is provided a mobile terminal that includes a first housing having a first space wall forming a first recess-shaped space, and a first wiring opening formed in the first space wall; a second housing having a second space wall forming a second recess-shaped space, and a second wiring opening formed in the second space wall; a swing connecting member disposed in a space formed between the first recess-shaped space and the second recess-shaped space facing each other, the swing connecting member having a through hole for allowing the first recess-shaped space and the second recess-shaped space to be in communication with each other and being configured to swingably move the first housing and the second housing; and a first wiring member passing through the through hole, the first wiring member having a first fixing end closely connected to the first wiring opening and a second fixing end closely connected to the second wiring opening.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

Other objects, features, and advantages of the present invention will become more apparent from the following detailed description when read in conjunction with the accompanying drawings.

### BRIEF DESCRIPTION OF THE DRAWINGS

FIG. 1 is an external perspective view illustrating a mobile phone serving as a mobile terminal according to a first embodiment;

FIG. 2 is a side view illustrating the mobile phone according to the first embodiment in a folded state;

FIG. 3 is a plan view illustrating the mobile phone according to the first embodiment in a folded state;

FIG. 4 is a front view illustrating a basic position of a first housing when the mobile phone according to the first embodiment is in an open state;

FIG. 5 is a front view illustrating a right-hand side swing position of the first housing when the mobile phone according to the first embodiment is in an open state;

FIG. 6 is a front view illustrating a left-hand side swing position of the first housing when the mobile phone according to the first embodiment is in an open state;

FIG. 7 is a front view illustrating an example of a right-hand side intermediate position of the first housing residing within an intermediate position between the basic position and the right-hand side swing position of the first housing when the mobile phone according to the first embodiment is in an open state;

FIG. 8 is a front view illustrating an example of a left-hand side intermediate position of the first housing residing within an intermediate position between the basic position and the left-hand side swing position of the first housing when the mobile phone according to the first embodiment is in an open state;

FIG. 9 is a perspective view illustrating a swing connecting member from a front side, in which the swing connecting member implements a swing operation of the mobile phone according to the first embodiment when the first housing of the mobile phone is in a basic position;

FIG. 10 is a front view illustrating a swing connecting member, in which the swing connecting member implements a swing operation of the mobile phone according to the first embodiment when the first housing of the mobile phone is in the basic position;

FIG. 11 is a perspective view illustrating a swing connecting member from a rear side, in which the swing connecting member implements a swing operation of the mobile phone according to the first embodiment when the first housing of the mobile phone is in the basic position;

FIG. 12 is a front view illustrating a swing connecting member, in which the swing connecting member implements a swing operation of the mobile phone according to the first embodiment when the first housing of the mobile phone is in a right-hand side swing position of the first housing;

FIG. 13 is a front view illustrating a swing connecting member, in which the swing connecting member implements a swing operation of the mobile phone according to the first embodiment when the first housing of the mobile phone is in a left-hand side swing position of the first housing;

FIG. 14 is a side view illustrating the mobile phone according to the first embodiment in a folded state;

FIG. 15 is an internal view illustrating a swing connecting side first housing of the mobile phone according to the first embodiment;

FIG. 16 is a side view illustrating the mobile phone according to the first embodiment in a folded state;

FIG. 17 is an internal view illustrating a swing connecting side second housing of the mobile phone according to the first embodiment;

FIG. 18A is a sectional view illustrating a first housing side water stop part of the mobile phone according to the first embodiment, and FIG. 18B is a sectional view illustrating a second housing side first water stop part of the mobile phone according to the first embodiment;

FIG. 19 is a sectional view illustrating a swing cladding tube attached to the first housing side water stop part and the second housing side first water stop part of the mobile phone according to the first embodiment;

FIG. 20 is a side view illustrating the mobile phone according to the first embodiment in a folded state;

FIG. 21A is a sectional view illustrating a second housing side second water stop part of the mobile phone according to the first embodiment, and FIG. 21B is a sectional view illustrating a third housing side water stop part of the mobile phone according to the first embodiment;

FIG. 22 is a sectional view illustrating a pivoting cladding tube attached to the second housing side second water stop part and the third housing side water stop part of the mobile phone according to the first embodiment;

FIG. 23 is a sectional view illustrating the mobile phone according to the first embodiment in the folded state;

FIG. 24 is a simplified sectional view illustrating the mobile phone according to the first embodiment in the folded state;

FIG. 25 is an internal view illustrating a swing connecting side first housing of the mobile phone according to the first embodiment;

FIG. 26 is an internal view illustrating a swing connecting side second housing of the mobile phone according to the first embodiment;

FIG. 27 is a front view illustrating a swing connecting member attached to the swing connecting side first housing and the swing connecting side second housing of the mobile phone according to the first embodiment when the first housing of the mobile phone according to the first embodiment is in a basic position;

FIG. 28 is a front view illustrating the swing connecting member attached to the swing connecting side first housing and the swing connecting side second housing of the mobile phone according to the first embodiment when the first housing of the mobile phone according to the first embodiment pivots by 45 degrees in a clockwise direction from the basic position;

FIG. 29 is a front view illustrating the swing connecting member attached to the swing connecting side first housing and the swing connecting side second housing of the mobile phone according to the first embodiment when the first housing of the mobile phone according to the first embodiment is in a right-hand side swing position;

FIG. 30 is a front view illustrating the swing connecting member attached to the swing connecting side first housing and the swing connecting side second housing of the mobile phone according to the first embodiment when the first housing of the mobile phone according to the first embodiment pivots by 45 degrees in a counterclockwise direction from the basic position;

FIG. 31 is a front view illustrating the swing connecting member attached to the swing connecting side first housing and the swing connecting side second housing of the mobile phone according to the first embodiment when the first housing of the mobile phone according to the first embodiment is in a left-hand side swing position;

FIG. 32 is a sectional view illustrating the mobile phone according to the first embodiment in the folded state;

FIG. 33 is a simplified sectional view illustrating the mobile phone according to the first embodiment in the folded state;

FIG. 34 is a perspective view illustrating the swing connecting member from a rear side, in which the swing connecting member implements a swing operation of the mobile phone according to the first embodiment when the first housing of the mobile phone is in a basic position;

FIG. 35 is a front view illustrating the swing connecting member attached to the swing connecting side first housing and the swing connecting side second housing of the mobile phone according to the first embodiment when the first housing of the mobile phone according to the first embodiment is in the basic position;

FIG. 36 is a front view illustrating the swing connecting member attached to the swing connecting side first housing and the swing connecting side second housing of the mobile phone according to the first embodiment when the first housing of the mobile phone according to the first embodiment pivots by 45 degrees in a clockwise direction from the basic position;

FIG. 37 is a front view illustrating the swing connecting member attached to the swing connecting side first housing and the swing connecting side second housing of the mobile phone according to the first embodiment when the first housing of the mobile phone according to the first embodiment is in a right-hand side swing position;

FIG. 38 is a front view illustrating the swing connecting member attached to the swing connecting side first housing and the swing connecting side second housing of the mobile phone according to the first embodiment when the first housing of the mobile phone according to the first embodiment pivots by 45 degrees in a counterclockwise direction from the basic position;

FIG. 39 is a front view illustrating the swing connecting member attached to the swing connecting side first housing and the swing connecting side second housing of the mobile phone according to the first embodiment when the first housing of the mobile phone according to the first embodiment is in a left-hand side swing position;

FIG. 40 is a perspective view illustrating the swing connecting member from the front side, in which the swing connecting member implements a swing operation of the mobile phone according to the first embodiment when the first housing of the mobile phone is in the basic position;

FIG. 41 is a perspective view illustrating the swing connecting member from the rear side, in which the swing connecting member implements a swing operation of the mobile phone according to the first embodiment when the first housing of the mobile phone is in the basic position;

FIG. 42 is a front view illustrating the swing connecting member attached to the swing connecting side first housing and the swing connecting side second housing of the mobile phone according to the first embodiment when the first housing of the mobile phone according to the first embodiment is in the basic position;

FIG. 43 is a front view illustrating the swing connecting member attached to the swing connecting side first housing and the swing connecting side second housing of the mobile phone according to the first embodiment when the first housing of the mobile phone according to the first embodiment pivots by 45 degrees in the clockwise direction from the basic position;

FIG. 44 is a front view illustrating the swing connecting member attached to the swing connecting side first housing and the swing connecting side second housing of the mobile phone according to the first embodiment when the first housing of the mobile phone according to the first embodiment is in a right-hand side swing position;

FIG. 45 is a front view illustrating the swing connecting member attached to the swing connecting side first housing and the swing connecting side second housing of the mobile phone according to the first embodiment when the first housing of the mobile phone according to the first embodiment pivots by 45 degrees in the clockwise direction from the basic position;

FIG. 46 is a front view illustrating the swing connecting member attached to the swing connecting side first housing and the swing connecting side second housing of the mobile phone according to the first embodiment when the first housing of the mobile phone according to the first embodiment is in a left-hand side swing position;

FIG. 47 is a front view illustrating a mobile phone serving as a mobile terminal according to a second embodiment;

FIG. 48 is a side view illustrating the mobile phone according to the second embodiment;

FIG. 49 is a front view illustrating a right-hand side swing position or a left-hand side swing position of the first housing of the mobile phone according to the second embodiment;

FIG. 50 is a front view illustrating a mobile phone serving as a mobile terminal according to a third embodiment;

FIG. 51 is a side view illustrating the mobile phone according to the third embodiment;

FIG. 52 is a front view illustrating a right-hand side swing position or a left-hand side swing position of a first housing of the mobile phone according to the third embodiment;

FIG. 53 is an external perspective view illustrating a mobile phone serving as a mobile terminal according to a fourth embodiment;

FIG. 54 is a front view illustrating a right-hand side swing position of a first housing of the mobile phone according to the fourth embodiment;

FIG. 55 is a front view illustrating a left-hand side swing position of the first housing of the mobile phone according to the fourth embodiment;

FIG. 56 is a perspective view illustrating a swing connecting member from a front side, in which the swing connecting member implements a swing operation of the mobile phone according to the fourth embodiment when the first housing of the mobile phone is in a basic position;

FIG. 57 is a perspective view illustrating the swing connecting member from a rear side, in which the swing connecting member implements the swing operation of the mobile phone according to the fourth embodiment when the first housing of the mobile phone is in the basic position;

FIG. 58 is a partial sectional view illustrating the mobile phone according to the fourth embodiment;

FIG. 59 is a view illustrating a waterproof structure having an inserting member;

FIG. 60 is a view illustrating a waterproof structure having an inserting member;

FIG. 61 is a view illustrating a waterproof structure having a cylindrical member;

FIG. 62 is a view illustrating a waterproof structure having a cylindrical member;

FIG. 63 is a view illustrating a waterproof structure having a first projection tube and a second projection tube;

FIG. 64 is a view illustrating a waterproof structure having a third projection tube and a fourth projection tube;

FIG. 65 is a view illustrating a waterproof structure having a swing cladding tube serving as a gasket integrated tube;

FIG. 66 is a view illustrating a waterproof structure having a pivoting cladding tube serving as a gasket integrated tube;

FIG. 67 is a view illustrating the mobile phone according to the first embodiment utilizing the swing cladding tube and the pivoting cladding tube serving as respective gasket integrated tubes when the mobile phone is in a folded state;

FIG. 68 is a sectional view illustrating the mobile phone according to the first embodiment utilizing the swing cladding tube and the pivoting cladding tube serving as respective gasket integrated tubes when the mobile phone is in a folded state;

FIG. 69 is a view illustrating a waterproof structure having a swing cladding tube serving as a cable integrated tube;

FIG. 70 is a view illustrating a waterproof structure having a pivoting cladding tube serving as a cable integrated tube;

FIG. 71 is a sectional view illustrating the mobile phone according to the first embodiment utilizing the swing cladding tube and the pivoting cladding tube serving as respective cable integrated tubes when the mobile phone is in a folded state;

FIG. 72 is a sectional view illustrating the mobile phone according to the first embodiment utilizing the swing cladding tube and the pivoting cladding tube serving as respective cable integrated tubes when the mobile phone is in a folded state;

FIG. 73 is a view illustrating a modification of the waterproof structure of FIG. 19;

FIG. 74 is a view illustrating a modification of the waterproof structure of FIG. 22;

FIG. 75 is a view illustrating a modification of the waterproof structure of FIG. 59;

FIG. 76 is a view illustrating a modification of the waterproof structure of FIG. 60;

FIG. 77 is a view illustrating a first modification of the waterproof structure of FIG. 61;

FIG. 78 is a view illustrating a first modification of the waterproof structure of FIG. 62;

FIG. 79 is a view illustrating a second modification of the waterproof structure of FIG. 61;

FIG. 80 is a view illustrating a second modification of the waterproof structure of FIG. 62;

FIG. 81 is a view illustrating a modification of the waterproof structure of FIG. 63;

FIG. 82 is a view illustrating a modification of the waterproof structure of FIG. 64;

FIG. 83 is a view illustrating a modification of the waterproof structure of FIG. 65;

FIG. 84 is a view illustrating a modification of the waterproof structure of FIG. 66;

FIG. 85 is a view illustrating a modification of the waterproof structure of FIG. 69;

FIG. 86 is a view illustrating a modification of the waterproof structure of FIG. 70;

FIG. 87 is a view illustrating an example of a wiring member passing through the swing cladding tube or the pivoting cladding tube;

FIG. 88 is a view illustrating an example of a wiring member passing through the swing cladding tube or the pivoting cladding tube;

FIG. 89 is a view illustrating an example of a wiring member passing through the swing cladding tube or the pivoting cladding tube;

FIG. 90 is a view illustrating a waterproof structure having a swing cladding tube serving as a gasket integrated flexible printing circuit board (FPCB);

FIG. 91 is a view illustrating a waterproof structure having a pivoting cladding tube serving as a gasket integrated flexible printing circuit board (FPCB);

FIG. 92 is a sectional view illustrating the mobile phone according to the first embodiment utilizing the swing cladding tube and the pivoting cladding tube serving as respective a gasket integrated flexible printing circuit boards (FPCBs) when the mobile phone is in a folded state;

FIG. 93 is a sectional view illustrating the mobile phone according to the first embodiment utilizing the swing cladding tube and the pivoting cladding tube serving as respective gasket integrated flexible printing circuit boards (FPCBs) when the mobile phone is in a folded state;

FIG. 94 is a view illustrating a modification of the waterproof structure of FIG. 90;

FIG. 95 is a view illustrating a modification of the waterproof structure of FIG. 91; and

FIG. 96 is an internal view illustrating a modification of the swing connecting side first housing of the mobile phone according to the first embodiment.

### DESCRIPTION OF EMBODIMENTS

The disclosed embodiments may be able to provide a mobile terminal that may implement waterproof properties while exhibiting flexibility of the swing operation.

Embodiments are described below with reference to the accompanying drawings. Note that proportion of illustrated elements may differ between the drawings for the purpose of comprehension of each of elements in the drawings.

### 1. External View of Mobile Phone According to First Embodiment

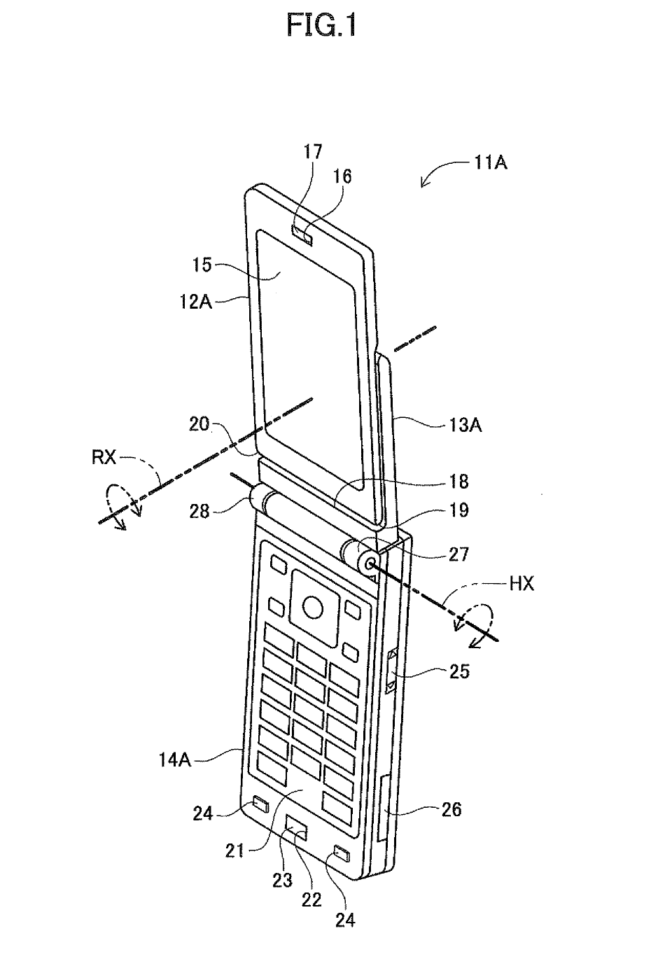

FIG. 1 is an external perspective view illustrating a mobile phone 11A serving as a mobile terminal according to a first embodiment. The mobile phone 11A is a foldable mobile phone. The mobile phone 11A includes a first housing 12A, a second housing 13A, and a third housing 14A. The first housing 12A, the second housing 13A, and the third housing 14A each have an approximately rectangular parallelepiped shapes.

The first housing 12A includes a flat display 15 such as a liquid crystal display (LCD), which is disposed on a front surface of the first housing 12A. The first housing 12A further includes an earpiece 16 above the flat display 15. The earpiece 16 includes a speaker 17 inside the earpiece 16. The first housing 12A is positioned such that a rear surface of the first housing 12A faces the second housing 13A.

The second housing 13A includes a sliding surface 18 in parallel with a width direction of the second housing 13A, the sliding surface 18 being disposed at a lower part of the second housing 13A. A first corner 19 and a second corner 20 of the first housing 12A are located at respective ends of the sliding surface 18. A swing axis RX is orthogonal to the second housing 13A.

The third housing 14A includes a fourth space wall 27 and a pivoting hinge part 28 disposed at an upper part of the third housing 14A. The fourth space wall 27 serves as a hollow shaft (or a tubular shaft) as illustrated in the later-described configuration example. Hence, the fourth space wall 27 and the pivoting hinge part 28 are configured to provide a flexible pivoting connection such that the third housing 14A and the second housing 13A are capable of pivoting flexibly. That is, there is a relationship between the third housing 14A and the second housing 13A in that the third housing 14A and the second housing 13A are capable of flexibly pivoting relative to each other on a pivoting axis HX as the center. The pivoting axis HX serves as an axis line common to the fourth space wall 27 and the pivoting hinge part 28.

The third housing 14A includes a key pad 21 on a front surface of the third housing 14A. The third housing 14A further includes a mouthpiece 22 below the key pad 21. The mouthpiece 22 includes a microphone 23 inside the mouthpiece 22. The third housing 14A further includes a pair of projections 24′ one projection on each side of the microphone 23. The third housing 14A includes a side key 25 and an earphone/microphone input plug cover 26 on a lateral surface of the third housing 14A.

### 2. Open/Close Operation Performed by Mobile Phone According to First Embodiment

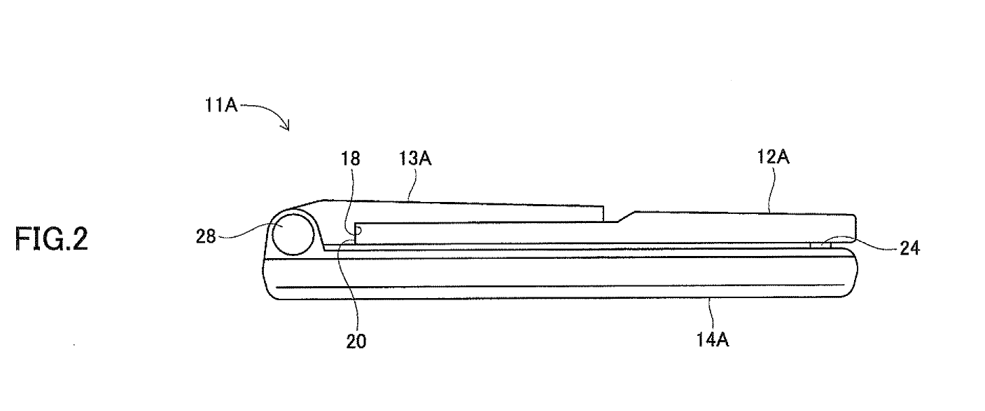

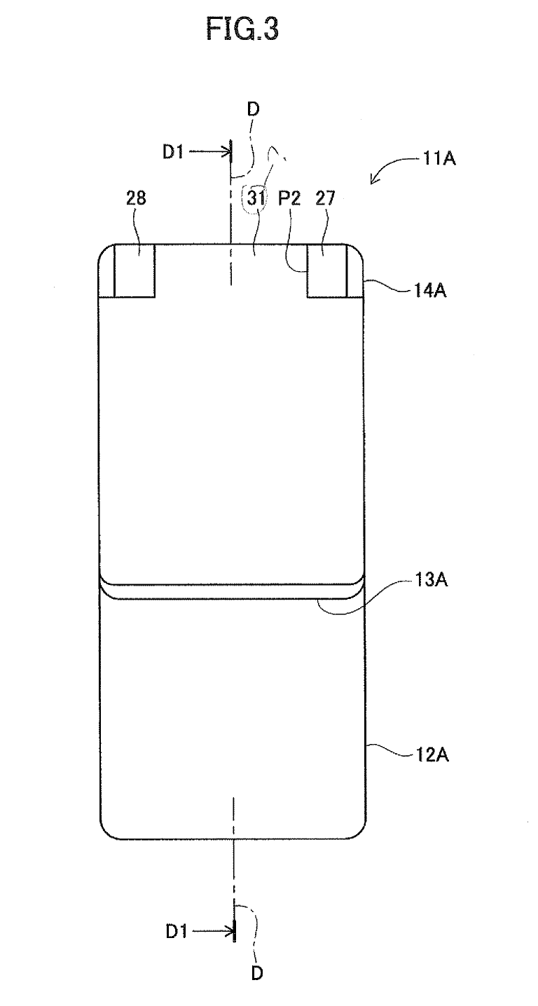

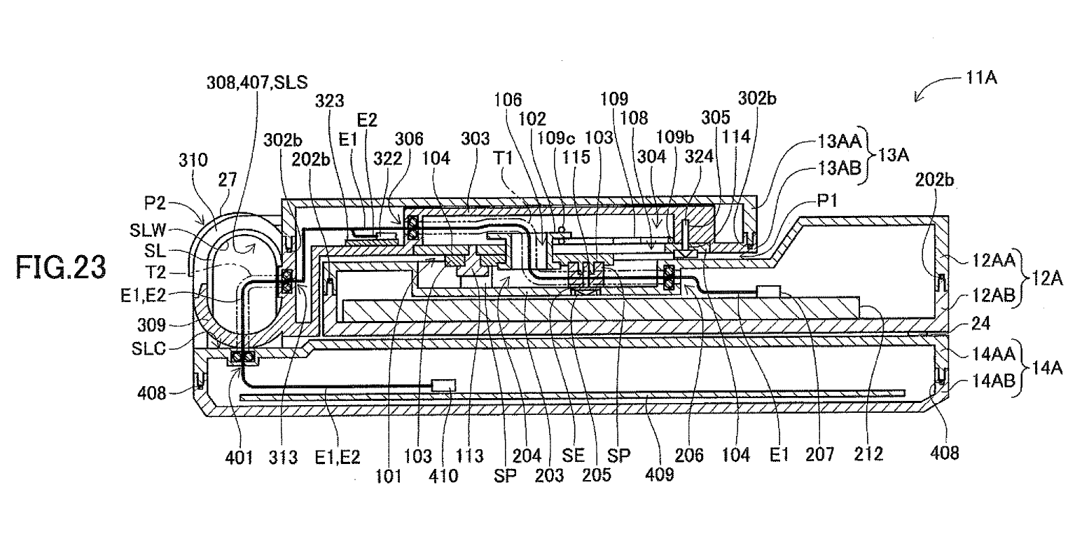

FIG. 2 is a side view illustrating the mobile phone 11A according to the first embodiment in a folded state. FIG. 3 is a plan view illustrating the mobile phone 11A according to the first embodiment in the folded state. Note that reference numerals 31, D, D1, and P2 illustrated in FIG. 3 will be illustrated later together with reference to FIG. 23.

As illustrated in FIGS. 2 and 3, when the second housing 13A and the third housing 14A are disposed in a positional relationship by a pivoting operation via the fourth space wall 27 and the pivoting hinge part 28 to allow the second housing 13A to face the third housing 14A, the first housing 12A and the third housing 14A overlap each other. That is, the mobile phone 11A is in a closed state, i.e., in a folded state. When the mobile phone 11A is in the folded state, the first housing 12A comes into contact with the projections 24 of the third housing 14A. In this state, the first housing 12A is sandwiched between the second housing 13A and the third housing 14A. Further, the first housing 12A is projected from an interval between the second housing 13A and the third housing 14A. Note that in FIG. 2, since the mobile phone 11A is illustrated from its lateral surface provided with the pivoting hinge part 28, the second corner 20 of the first housing 12A resides on the sliding surface 18 of the second housing 13A.

On the other hand, as illustrated in FIG. 1, when the second housing 13A and the third housing 14A are disposed in a positional relationship by a pivoting operation via the fourth space wall 27 and the pivoting hinge part 28 to allow the second housing 13A to be away from the third housing 14A, the mobile phone 11A is in an open state.

### 3. Swing Operation Performed by Mobile Phone According to First Embodiment

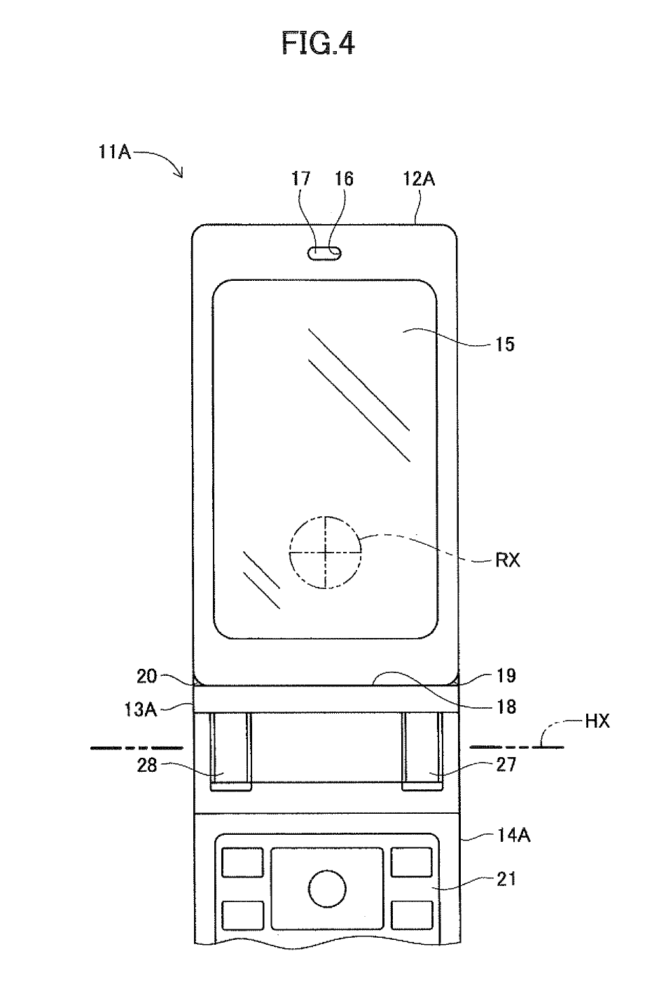

The first housing 12A may pivot on the swing axis RX in a clockwise direction or a counterclockwise direction when the mobile phone 11A is either in a folded state or in an open state. FIGS. 4 to 8 illustrate the mobile phone 11A according to the first embodiment in the folded state. There is a relationship between the swing axis RX and the pivoting axis HX in that the swing axis RX and the pivoting axis HX intersect at right angles.

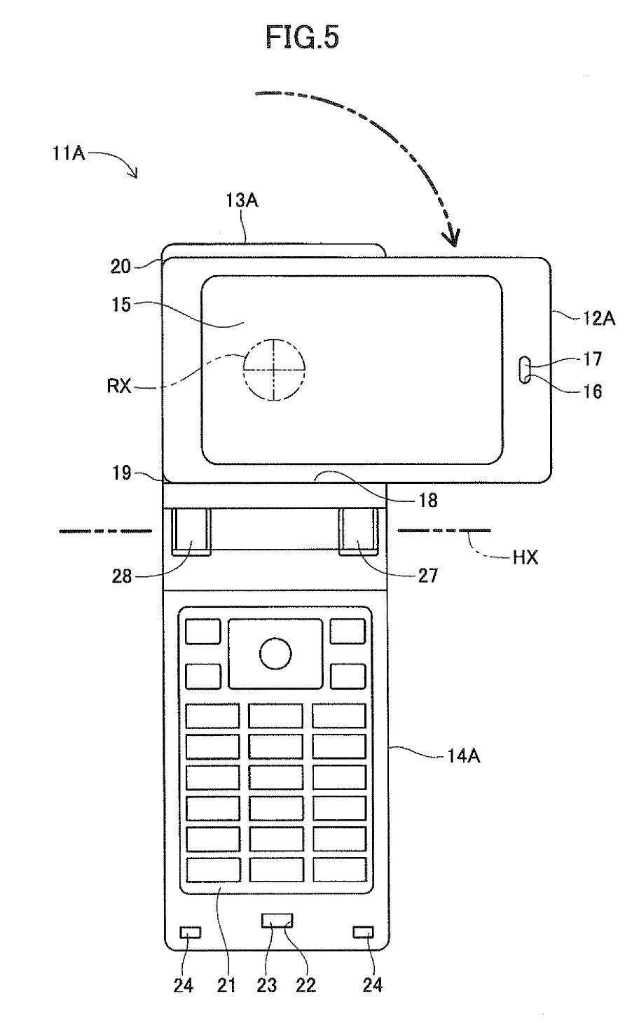

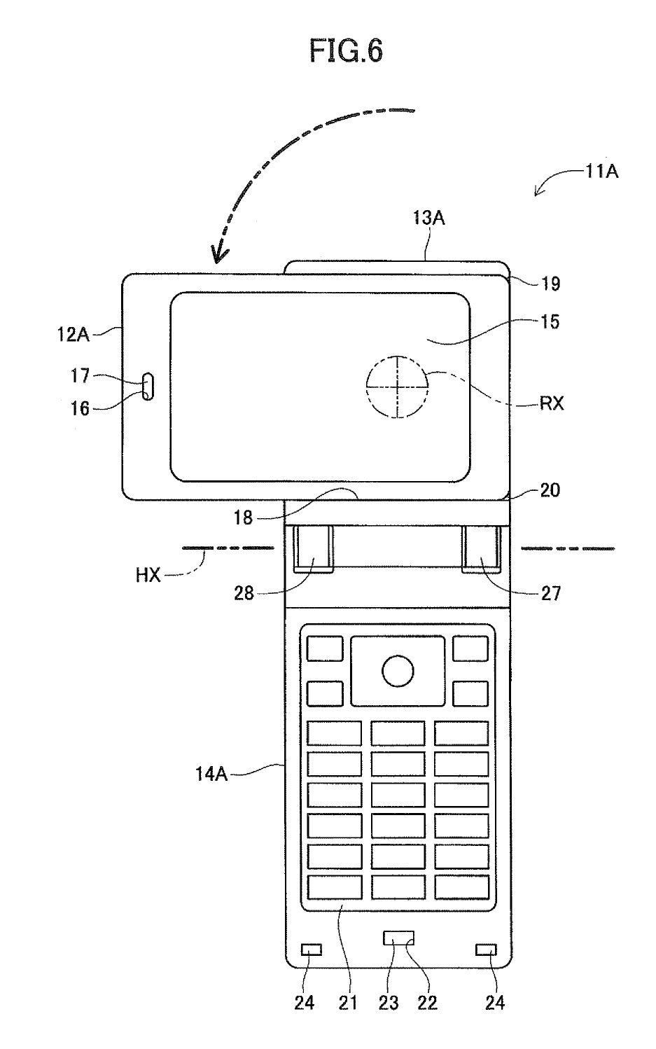

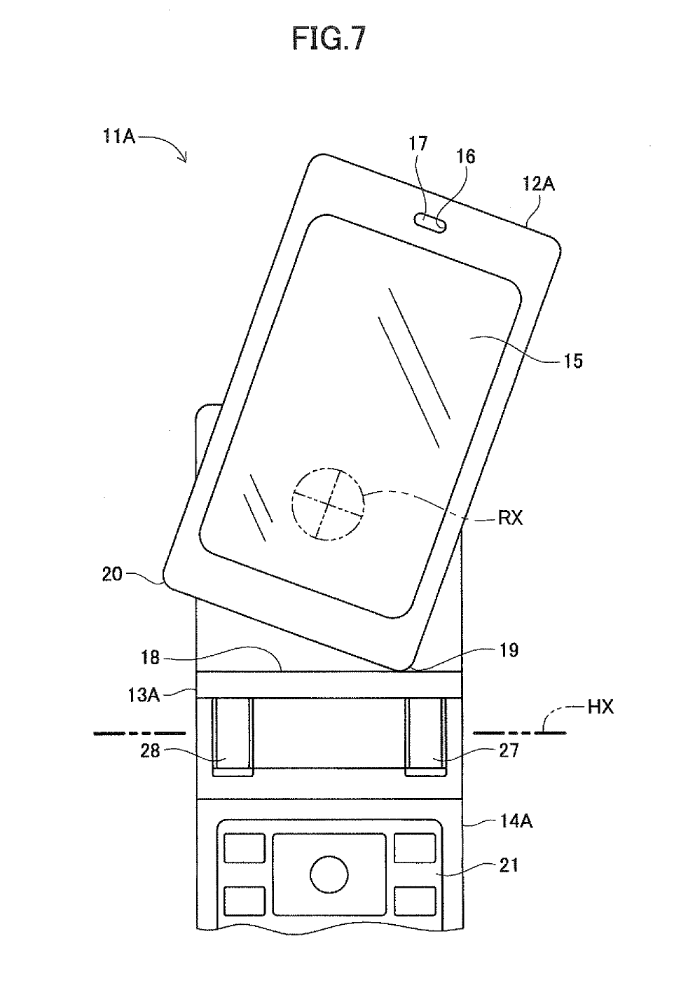

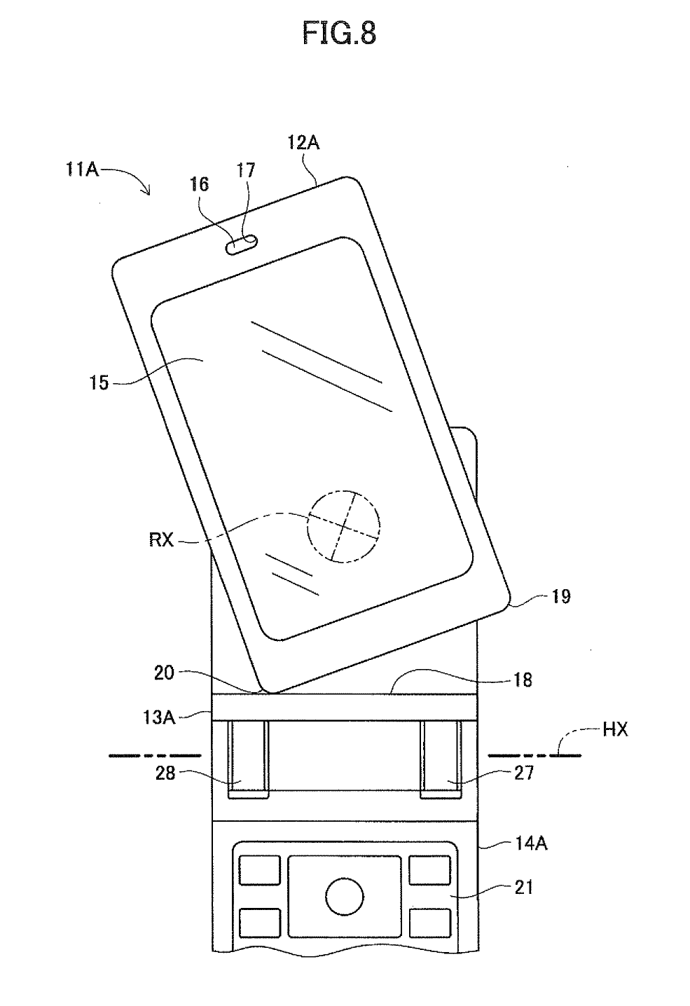

FIG. 4 is a front view illustrating a basic position of the first housing 12A. FIG. 5 is a front view illustrating a right-hand side swing position of the first housing 12A. FIG. 6 is a front view illustrating a left-hand side swing position of the first housing 12A. FIG. 7 is a front view illustrating an example of a right-hand side intermediate position of the first housing 12A residing within an intermediate position between the basic position and the right-hand side swing position of the first housing 12A. FIG. 8 is a front view illustrating an example of a left-hand side intermediate position of the first housing 12A residing within an intermediate position between the basic position and the left-hand side swing position of the first housing 12A.

As illustrated in FIGS. 4 to 8, when the mobile phone 11A is in an open state, the flat display 15, the earpiece 16, the speaker 17, the first corner 19, and the second corner 20 of the first housing 12A are exposed. Further, the sliding surface 18 of the second housing 13A is exposed in a width direction of the second housing 13A. Further, the key pad 21, the mouthpiece 22, the microphone 23, the projections 24, the fourth space wall 27, and the pivoting hinge part 28 of the third housing 14A are exposed.

As illustrated in FIG. 4, when the first housing 12A is in a basic position, the flat display 15 in a portrait form resides on the sliding surface 18 of the second housing 13A. In the first housing 12A in the basic position, the earpiece 16 and the speaker 17 are disposed at an upper side of the flat display 15. In the following description, the first housing 12A in the basic position illustrated in FIG. 4 is situated at 0 degrees.

When the first housing 12A in the basic position illustrated in FIG. 4 pivots on the swing axis RX from 0 degrees to 90 degrees in a clockwise direction, the first housing 12A is situated in a right-hand side swing position as illustrated in FIG. 5. When the first housing 12A is situated in the right-hand side swing position, the flat display 15 in a landscape form resides on the sliding surface 18 of the second housing 13A. In the first housing 12A situated in the right-hand side swing position, the earpiece 16 and the speaker 17 are disposed at a right side of the flat display 15.

When the first housing 12A in the basic position illustrated in FIG. 4 pivots on the swing axis RX from 0 degrees to 90 degrees in a counterclockwise direction, the first housing 12A is situated in a left-hand side swing position as illustrated in FIG. 6. When the first housing 12A is situated in the left-hand side swing position, the flat display 15 in the landscape form resides on the sliding surface 18 of the second housing 13A. In the first housing 12A situated in the left-hand side swing position, the earpiece 16 and the speaker 17 are disposed at a left side of the flat display 15.

That is, when the first housing 12A in the basic position illustrated in FIG. 4 pivots on the swing axis RX from 0 degrees to 90 degrees in the clockwise direction or the counterclockwise direction, the first housing 12A in the basic position is transitioned to the right-hand side swing position as illustrated in FIG. 5, or to the left-hand side swing position as illustrated in FIG. 6. By contrast, when the first housing 12A either in the right-hand side swing position as illustrated in FIG. 5 or the left-hand side swing position as illustrated in FIG. 6 pivots on the swing axis RX from 0 degrees to 90 degrees in the clockwise direction or the counterclockwise direction, the first housing 12A in the right-hand side swing position illustrated in FIG. 5 or in the left-hand side swing position illustrated in FIG. 6 is transitioned to the basic position illustrated in FIG. 4. The above-described transitioning operations indicate the swing operation of the first housing 12A.

When the first housing 12A is situated in an intermediate position between the basic position and the right-hand side swing position, the first housing 12A is situated in a right-hand side intermediate position. FIG. 7 illustrates an example of the right-hand side intermediate position of the first housing 12A. When the first housing 12A is in the right-hand side intermediate position, the first corner 19 of the first housing 12A is pressed against the sliding surface 18 of the second housing 13A as illustrated in FIG. 7.

Accordingly, the first housing 12A in the right-hand side intermediate position is upwardly moved along with the swing axis RX while the first housing 12A in the basic position pivots on the swing axis RX from 0 degrees to 45 degrees in the clockwise direction. Further, the first housing 12A in the right-hand side intermediate position is downwardly moved along with the swing axis RX while the first housing 12A in the right-hand side intermediate position pivots on the swing axis RX from 45 degrees to 90 degrees in the clockwise direction.

By contrast, the first housing 12A in the right-hand side intermediate position is upwardly moved along with the swing axis RX while the first housing 12A in the right-hand side swing position pivots on the swing axis RX from 90 degrees to 45 degrees in the counterclockwise direction. Further, the first housing 12A in the right-hand side intermediate position is downwardly moved along with the swing axis RX while the first housing 12A in the right-hand side intermediate position pivots on the swing axis RX from 45 degrees to 0 degrees in the counterclockwise direction.

On the other hand, when the first housing 12A is situated in an intermediate position between the basic position and the left-hand side swing position, the first housing 12A is in a left-hand side intermediate position. FIG. 8 illustrates an example of the left-hand side intermediate position of the first housing 12A. When the first housing 12A is in the left-hand side intermediate swing position, the second corner 20 of the first housing 12A is pressed against the sliding surface 18 of the second housing 13A as illustrated in FIG. 8.

Accordingly, the first housing 12A in the left-hand side intermediate position is upwardly moved along with the swing axis RX while the first housing 12A in the basic position pivots on the swing axis RX from 0 degrees to 45 degrees in the counterclockwise direction. Further, the first housing 12A in the left-hand side intermediate position is downwardly moved along with the swing axis RX while the first housing 12A in the left-hand side intermediate position pivots on the swing axis RX from 45 degrees to 90 degrees in the counterclockwise direction.

By contrast, the first housing 12A in the left-hand side intermediate position is upwardly moved along with the swing axis RX while the first housing 12A in the left-hand side swing position pivots on the swing axis RX from 90 degrees to 45 degrees in the clockwise direction. Further, the first housing 12A in the left-hand side intermediate position is downwardly moved along with the swing axis RX while the first housing 12A in the left-hand side intermediate position pivots on the swing axis RX from 45 degrees to 0 degrees in the clockwise direction.

That is, the swing operation performed by the mobile phone 11A indicates that the first housing 12A is upwardly or downwardly moved along with the swing axis RX while the first housing 12A pivots on the swing axis RX from 0 degrees to 90 degrees either in the clockwise direction or the counterclockwise direction.

4. Swing Connecting member of Mobile Phone According to First Embodiment

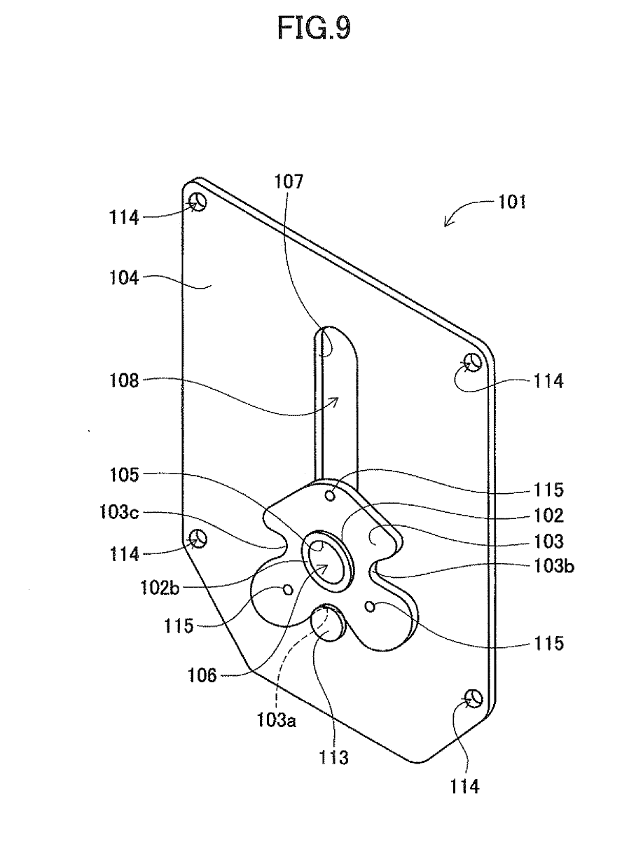

FIGS. 9 to 13 are views each illustrating a swing connecting member 101 for implementing a swing operation of the mobile phone 11A according to the first embodiment. The swing connecting member 101 serves as a waterproof swing hinge module as illustrated in the later-described configuration example.

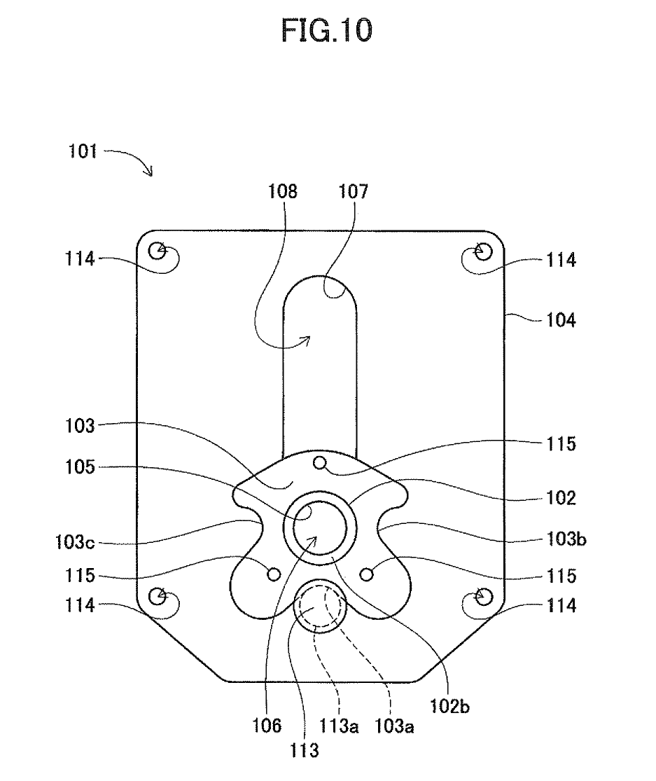

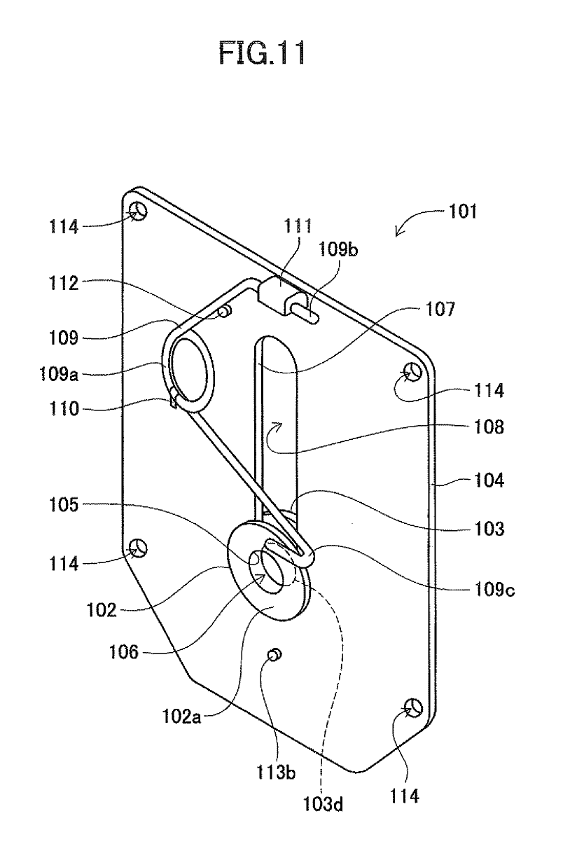

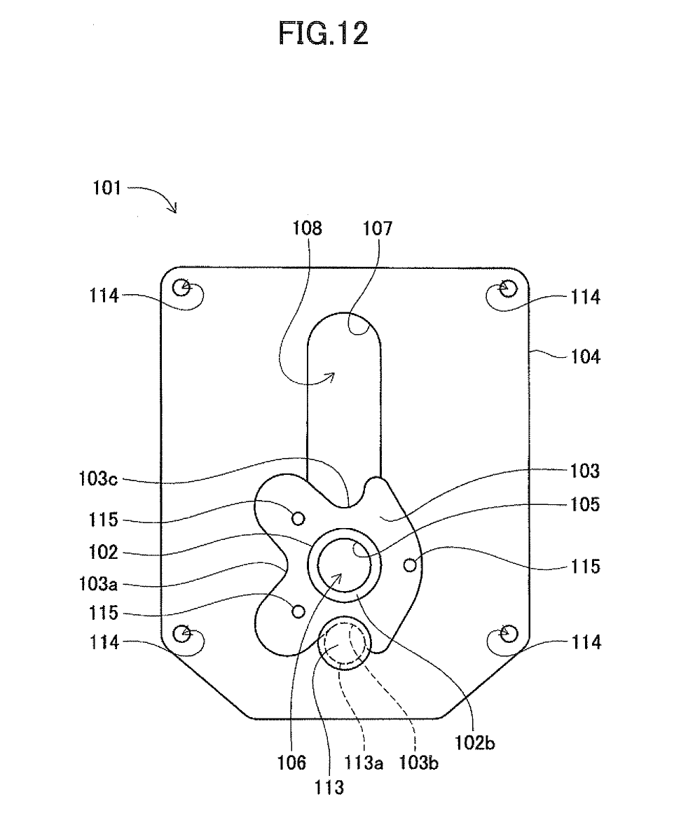

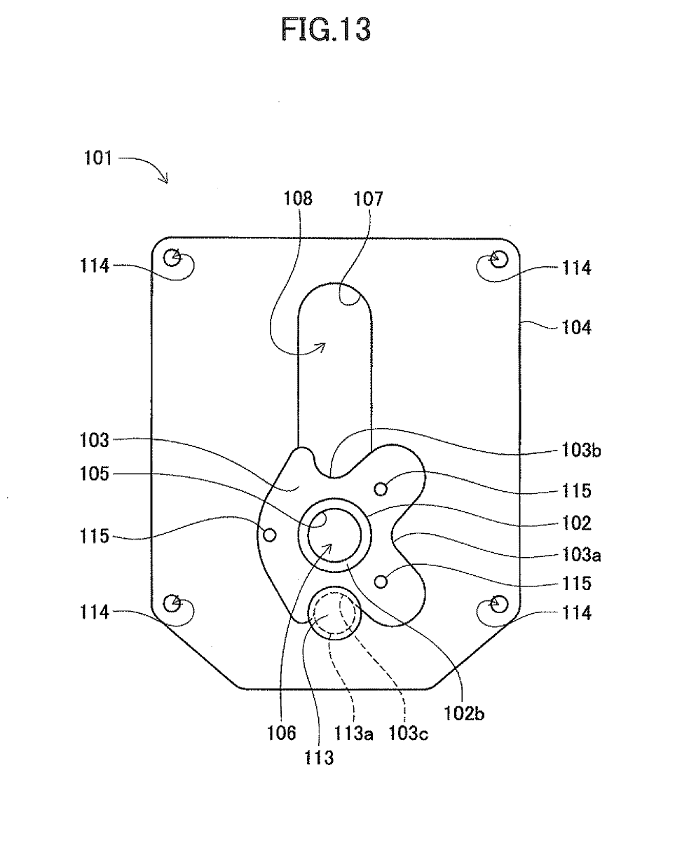

FIG. 9 is a perspective view illustrating the swing connecting member 101 from a front side when the first housing 12A of the mobile phone 11A according to the first embodiment is in a basic position. FIG. 10 is a front view illustrating the swing connecting member 101 when the first housing 12A of the mobile phone 11A according to the first embodiment is in the basic position. FIG. 11 is a perspective view illustrating the swing connecting member 101 from a rear side when the first housing 12A of the mobile phone 11A according to the first embodiment is in the basic position. FIG. 12 is a front view illustrating the swing connecting member 101 when the first housing 12A of the mobile phone 11A according to the first embodiment is in a right-hand side swing position. FIG. 13 is a front view illustrating the swing connecting member 101 when the first housing 12A of the mobile phone 11A according to the first embodiment is in a left-hand side swing position.

The swing connecting member 101 may be formed of a material resistant to corrosion. Stainless steel may be given as an example of the material resistant to corrosion. As illustrated in FIGS. 9 to 13, the swing connecting member 101 includes a first pivoting shaft 102, a plate cam 103, and a clamping plate 104. The first pivoting shaft 102 includes a first shaft hole 106 formed by causing a first shaft hole wall 105 to penetrate the first pivoting shaft 102. The plate cam 103 includes a first depression 103a, a second depression 103b, and a third depression 103c formed in a lateral surface of the plate cam 103. The plate cam 103 includes a fixing hole 103d (see FIG. 11) penetrating the plate cam 103. The clamping plate 104 includes a guide slot 108 formed by causing a guide slot wall 107 to penetrate the clamping plate 104.

The first pivoting shaft 102 is loosely attached to the guide slot 108 without allowing the first pivoting shaft 102 to come off the guide slot 108. The plate cam 103 is attached to the first pivoting shaft 102 such that the plate cam 103 is projected from a circumference of the first pivoting shaft 102. FIGS. 9 to 13 illustrate fixing examples of the first pivoting shaft 102 and the plate cam 103. That is, the first pivoting shaft 102 includes a ring part 102a (see FIG. 11) disposed at an end of a rear side of the first pivoting shaft 102. In viewing from a rear side of the swing connecting member 101, the first pivoting shaft 102 passes through the guide slot 108 of the clamping plate 104 and a fixing hole 103d of the plate cam 103 such that the ring part 102a of the first pivoting shaft 102 is locked by the clamping plate 104 (see FIG. 11). By contrast, in viewing from a front side of the swing connecting member 101, a circular bending part 102b is formed by outwardly bending an end of the front side of the first pivoting shaft 102. The first pivoting shaft 102 is connected to the plate cam 103 via the circular bending part 102b.

The first pivoting shaft 102 is loosely attached to the guide slot 108 without allowing the first pivoting shaft 102 to come off the guide slot 105 by connecting the first pivoting shaft 102 to the plate cam 103. Further, the plate cam 103 is attached to the first pivoting shaft 102 such that the plate cam 103 is projected from the circumference of the first pivoting shaft 102. Accordingly, the first pivoting shaft 102 is flexibly pivotable and flexibly slidable within the guide slot 108. Note that grease is applied as lubrication to facilitate a flexible pivoting operation or a flexible sliding operation of the first pivoting shaft 102.

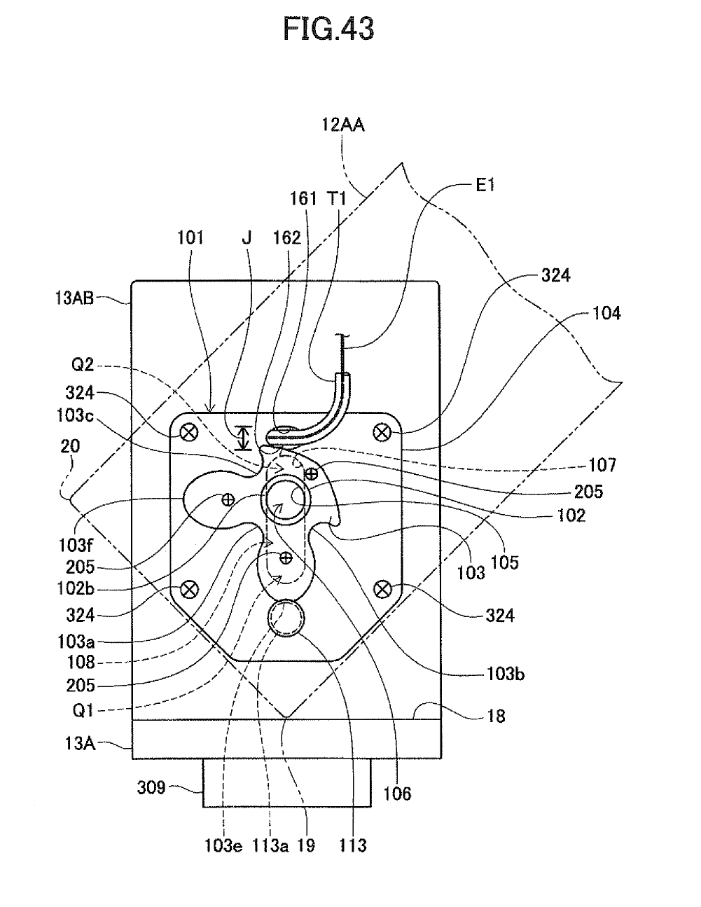

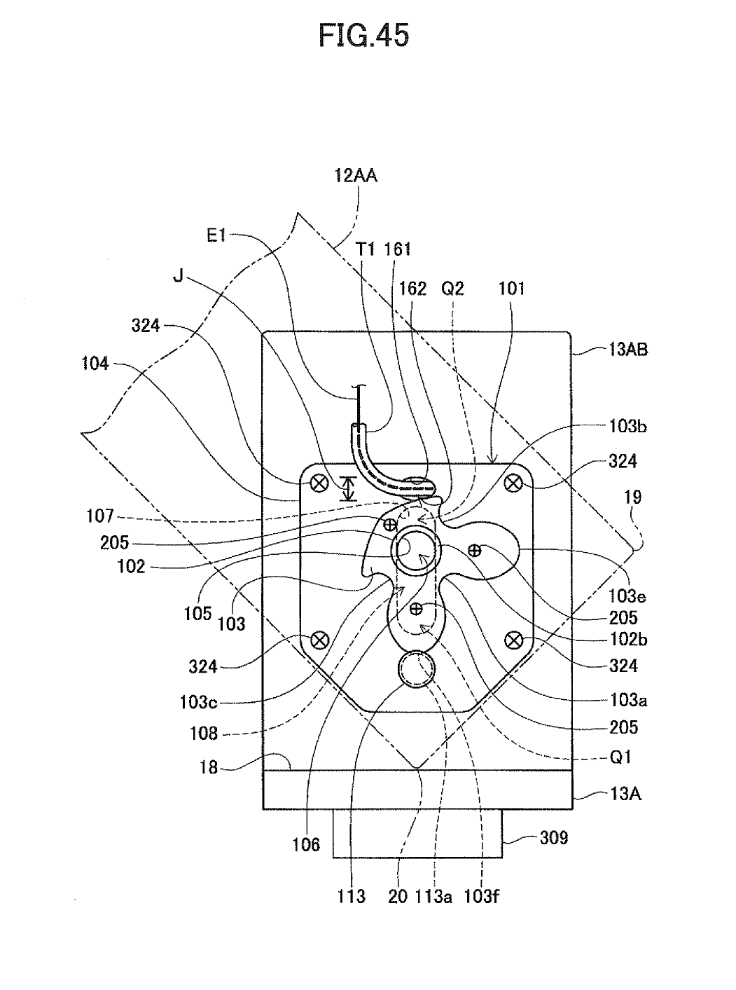

However, as illustrated in FIG. 11, the clamping plate 104 includes a resilient member 109 fixed at the rear side of the clamping plate 104. The resilient member 109 constantly applies force to the first pivoting shaft 102 in a resilient direction (i.e., a downward direction in FIG. 11) inside the guide slot 108. As illustrated later in FIG. 43 or 45, the guide slot 108 includes a first end Q1 and a second end Q2. That is, the resilient member 109 constantly applies force to the first pivoting shaft 102 in directions toward the first end Q1 and the second end Q2 of the guide slot 108 (see FIGS. 43 and 45). The resilient member 109 illustrated in FIG. 11 is a torsion spring. Note that the resilient member 109 may be a flat spring.

FIG. 11 illustrates a fixing example of the resilient member 109. Specifically, the clamping plate 104 includes a fixing piece 110, a locking piece 111, and a projection 112 on a rear side of the clamping plate 104. The resilient member 109 includes a coiled part 109a, a first end 109b, and a second end 109c. The coiled part 109a of the resilient member 109 is fixed to the clamping plate 104 by the fixing piece 110. The first end 109b of the resilient member 109 is locked to the clamping plate 104 by the locking piece 111. An intermediate part between the coiled part 109a and the first end 109b of the resilient member 109 is supported by the projection 112. The second end 109c of the resilient member 109 is hooked on the ring part 102a of the first pivoting shaft 102. Hence, the second end 109c of the resilient member 109 is bent in a U shape due to being hooked on the ring part 102a. Note that the second end 109c of the resilient member 109 may be bent in an L shape or a J shape.

When the resilient member 109 constantly applies force to the first pivoting shaft 102 in the downward direction inside the guide slot 108, force is also applied to the plate cam 103 connected to the first pivoting shaft 102 in the downward direction.

The clamping plate 104 includes a pivoting contactor 113 on the front side of the clamping plate 104. The pivoting contactor 113 is attached to the clamping plate 104 at a position below the guide slot 108. The pivoting contactor 113 includes a cylindrical contact surface 113a configured to be brought into contact with a lateral surface of the plate cam 103. The pivoting contactor 113 is pivotally attached to the clamping plate 104. FIG. 11 illustrates a fixing example of the pivoting contactor 113. Specifically, a pivoting pin 113b is inserted into the pivoting contactor 113 via the clamping plate 104 from a rear side of the swing connecting member 101.

The clamping plate 104 includes four fixing holes 114 penetrating one at each of four corners of the clamping plate 104. The four fixing holes 114 are utilized for fixing the clamping plate 104 to the second housing 13A (see FIGS. 1 to 8). The plate cam 103 includes three female screw bosses 115 on the front side of the plate cam 103. The three female screw bosses 115 are utilized for fixing the plate cam 103 to the first housing 12A (see FIGS. 1 to 8).

When the clamping plate 104 is fixed to the second housing 13A, and the plate cam 103 is fixed to the first housing 12A, the swing axis RX (see FIG. 1, and FIGS. 4 to 8) meets an axis line of the first pivoting shaft 102.

When the first housing 12A is in the basic position, a first depression 103a of the plate cam 103 is pressed against the cylindrical contact surface 113a of the pivoting contactor 113 as illustrated in FIG. 10. When the first housing 12A is in the right-hand side swing position, a second depression 103b of the plate cam 103 is pressed against the cylindrical contact surface 113a of the pivoting contactor 113 as illustrated in FIG. 12. When the first housing 12A is in the left-hand side swing position, a third depression 103c of the plate cam 103 is pressed against the cylindrical contact surface 113a of the pivoting contactor 113 as illustrated in FIG. 13.

### 5. Waterproof Structure of Mobile Phone According to First Embodiment

Below is given of a description of a waterproof structure of the mobile phone 11A according to the first embodiment.

5-1. Waterproof Structure with First Insertion Type

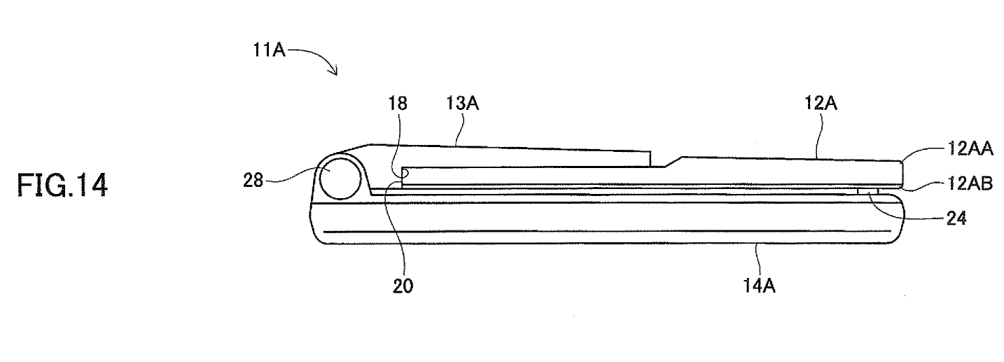

Initially, a waterproof structure with a first insertion type is illustrated. FIG. 14 is a side view illustrating the mobile phone 11A according to the first embodiment in a folded state. In FIG. 14, since the mobile phone 11A according to the first embodiment is illustrated from its lateral surface provided with the pivoting hinge part 28, the second corner 20 of the first housing 12A resides on the sliding surface 18 of the second housing 13A. When the mobile phone 11A according to the first embodiment is in the folded state, the first housing 12A comes into contact with the projections 24 of the third housing 14A as already described above. As illustrated in FIG. 14, the first housing 12A includes a swing connecting side first housing 12AA and a non-swing connecting side first housing 12AB.

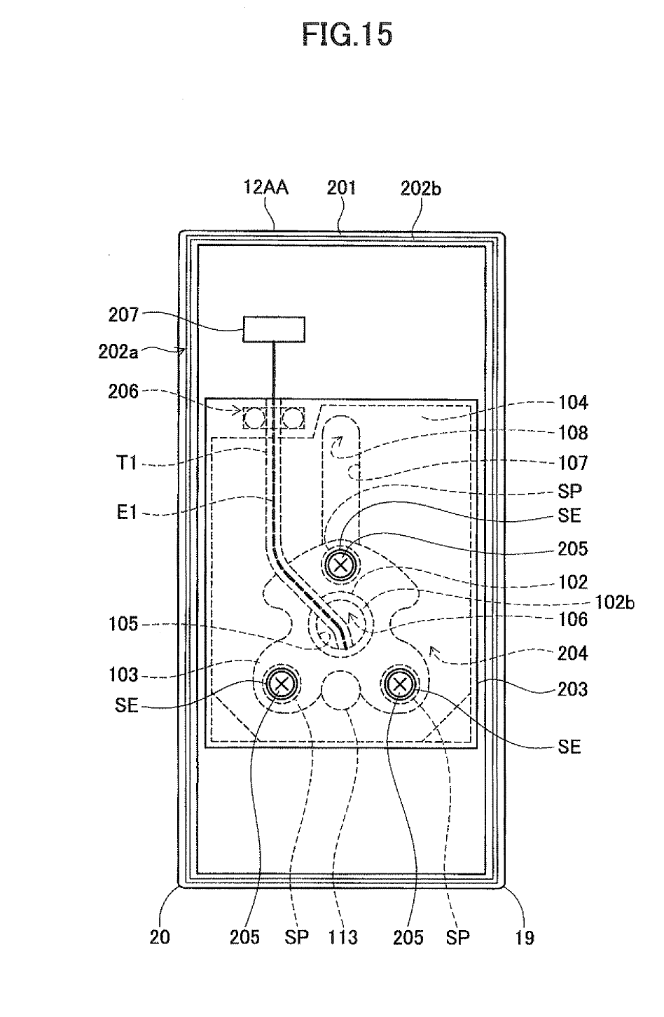

FIG. 15 is an internal view illustrating the swing connecting side first housing 12AA. Two lower corners of the swing connecting side first housing 12AA indicate a first corner 19 and a second corner 20, respectively. The swing connecting side first housing 12AA includes a flange rib 201 on an inner side of the swing connecting side first housing 12AA. The flange rib 201 is formed in the circumference of the swing connecting side first housing 12AA. The flange rib 201 includes a circumferential groove 202a. A gasket 202b is fitted into the circumferential groove 202a. The gasket 202b is compressed between mating surfaces of the swing connecting side first housing 12AA and the non-swing connecting side first housing 12AB (see FIG. 14) so as to seal the circumference of the first housing 12A.

The swing connecting side first housing 12AA includes a first space wall 203. The first space wall 203 forms a projected surface in the inner side of the swing connecting side first housing 12AA. By contrast, the first space wall 203 forms a recessed surface in an outer side of the swing connecting side first housing 12AA. Thus, a first space 204 having the recessed surface is formed in the first space wall 203. The swing connecting side first housing 12AA includes a first housing side water stop part 206 on a lateral surface of a first space wall 203.

The plate cam 103 is fixed to a bottom surface of the first space wall 203 via spacers SP intervening from an outer side of the swing connecting side first housing 12AA. The swing connecting member 101 is attached to the swing connecting side first housing 12AAby fixing the plate cam 103 to the first space wall 203 (e.g., see FIG. 9). In the fixation of the plate cam 103 to the bottom surface of the first space wall 203, three machine screws 205 are screwed into the female screw bosses 115 (e.g., see FIG. 9) of the plate cam 103 via the first space wall 203 and the spacers SP from the inner side of the swing connecting side first housing 12AA.

In the screwing of the machine screws 205 into the female screw bosses 115, a waterproof sheet SE is sandwiched between the machine screws 205 and the first space wall 203. The waterproof sheet SE has respective holes for penetrating by the machine screws 205. Examples of the waterproof sheet SE include a rubber sheet and a joint sheet, and the like. Note that a water-resistant double-faced tape or a sealing agent may be used in place of the waterproof sheet SE. The spacers SP are prepared separately from the bottom surface of the first space wall 203. Note that the spacers SP may be uniformly formed in the bottom surface of the first space wall 203.

When the plate cam 103 is fixed to the bottom surface of the first space wall 203, the circular bending part 201b of the first pivoting shaft 102 connected to the plate cam 103 is located above the first space 204 or inside the first space 204. The guide slot wall 107 and the guide slot 108 of the clamping plate 104 are located above the first space 204. Further, the pivoting contactor 113 below the plate cam 103 is located above the first space 204 or inside the first space 204.

Note that even when the first housing 12A is in any one of the positions illustrated in FIGS. 4 to 8, the guide slot wall 107 and the guide slot 108 of the clamping plate 104 are located above the first space 204.

The first shaft hole 106 is formed by causing the first shaft hole wall 105 to pass through the first pivoting shaft 102 having the circular bending part 102b. A swing cladding tube T1 passes through the first shaft hole 106 of the first pivoting shaft 102. The swing cladding tube T1 serves as a wiring tube. The swing cladding tube T1 may, for example, be formed of a silicon tube or a resin tube. Specifically, the swing cladding tube T1 may be obtained by processing a lightweight, soft, and flexible insulating raw material. Accordingly, the swing cladding tube T1 has flexibility or elasticity. The swing cladding tube T1 passes through a wiring space formed by the spacers SP intervening between the bottom surface of the first space wall 203 and the plate cam 103. Specifically, the swing cladding tube T1 passing through the first shaft hole 106 resides within the first space 204. The swing cladding tube

T1 residing within the first space 204 is attached to the first housing side water stop part 206.

A first wiring member E1 passes through the swing cladding tube T1. Accordingly, since the first wiring member E1 is enveloped by the swing cladding tube T1, the first wiring member E1 is protected with the swing cladding tube T1. The first wiring member E1 inside the swing cladding tube T1 is extended from the swing cladding tube T1 attached to the first housing side water stop part 206 so as to pass through the first housing side water stop part 206. The extended first wiring member E1 is connected to a first housing side connector 207 attached to the inner side of the swing connecting side first housing 12AA. Examples of the first wiring member E1 include an insulated wire, a single core cable, a multi-conductor cable, a flat cable, a thin line coaxial cable, a flexible flat cable (FFC), or a flexible printing circuit board (FPCB).

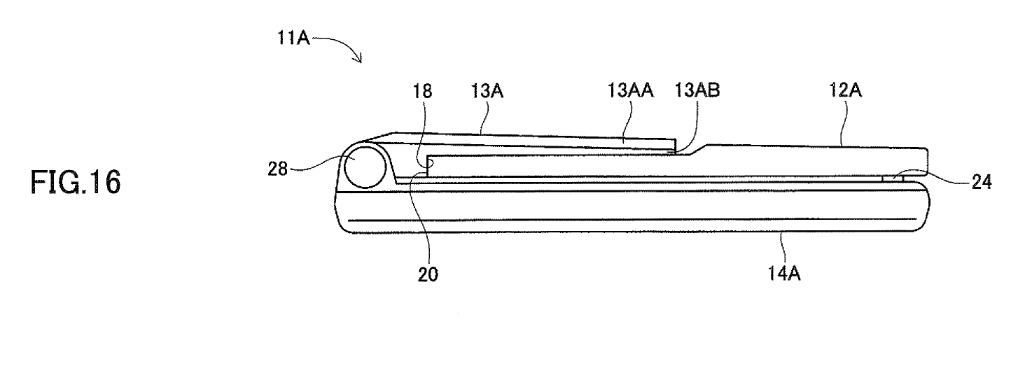

FIG. 16 is a side view illustrating the mobile phone 11A according to the first embodiment in a folded state. In FIG. 16, since the mobile phone 11A according to the first embodiment is illustrated from its lateral surface provided with the pivoting hinge part 28, the second corner 20 of the first housing 12A resides on the sliding surface 18 of the second housing 13A. When the mobile phone 11A according to the first embodiment is in the folded state, the first housing 12A comes into contact with the projections 24 of the third housing 14A as already described above. As illustrated in FIG. 16, the second housing 13A includes a non-swing connecting side second housing 13AA and a a swing connecting side second housing 13AB.

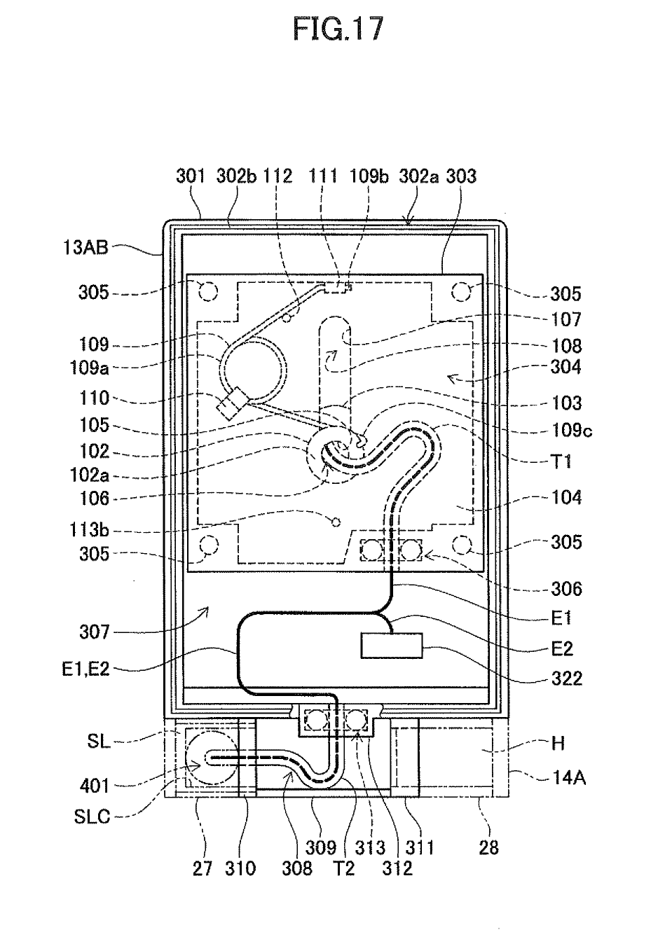

FIG. 17 is an internal view illustrating the swing connecting side second housing 13AB. The swing connecting side second housing 13AB includes a flange rib 301 on an inner side of the swing connecting side second housing 13AB. The flange rib 301 is formed in a circumference of the swing connecting side second housing 13AB. The flange rib 301 includes a circumferential groove 302a. A gasket 302b is fitted into the circumferential groove 302a. The gasket 302b is compressed between mating surfaces of the non-swing connecting side second housing 13AA and the swing connecting side second housing 13AB (see FIG. 16) so as to seal a circumference of the second housing 13A.

The swing connecting side second housing 13AB includes a second space wall 303. The second space wall 303 forms a projected surface on the inner side of the swing connecting side second housing 13AB. By contrast, the second space wall 303 forms a recessed surface on an outer side of the swing connecting side second housing 13AB. Thus, a second space 304 having the recessed surface is formed in the second space wall 303. The swing connecting side second housing 13AB includes four threaded holes 305 in an outer side of the swing connecting side second housing 13AB. The four threaded holes 305 are formed one at each of four corners of the second space wall 303. The swing connecting side second housing 13AB includes a second housing side first water stop part 306 on a lateral surface of the second space wall 303.

The clamping plate 104 is screw-fixed to the second space wall 303 from the outer side of the swing connecting side second housing 13AB. Specifically, the four screws 305 are utilized for the screw fixation by being matched with the respective fixing holes 114 of the clamping plate 104 (e.g., see FIG. 11). The swing connecting member 101 (e.g., see FIG. 11) is attached to the swing connecting side second housing 13AB by screw-fixing to the clamping plate 104 to the second space wall 303.

When the clamping plate 104 is screw-fixed to the second space wall 303, the ring part 102a, the resilient member 109, and the pivoting pin 113b reside within the second space 304. Further, the fixing piece 110 for fixing the coiled part 109a of the resilient member 109, the locking piece 111 for locking the first end 109b of the resilient member 109, and the projection 112 for supporting a part of the resilient member 109 reside within the second space 304. The guide slot wall 107 and the guide slot 108 of the clamping plate 104 are located above a center of the second space 304. A part of the plate cam 103 is exposed from the guide slot 108.

The second end 109c of the resilient member 109 is hooked on the ring part 102a. The swing cladding tube T1 passes through the first shaft hole 106 formed by causing the first shaft hole 106 to pass through the first pivoting shaft 102 having the ring part 102a as described above. Specifically, the swing cladding tube T1 passing through the first shaft hole 106 of the first pivoting shaft 102 resides within the second space 304. The swing cladding tube T1 residing within the second space 304 is attached to the second housing side first water stop part 306.

The first wiring member E1 inside the swing cladding tube T1 is extended from the swing cladding tube T1 attached to the second housing side first water stop part 306 so as to pass through the second housing side first water stop part 306. The extended first wiring member E1 resides within a second housing side cavity 307 inside the second housing 13A (e.g., see FIG. 16).

By contrast, the swing connecting side second housing 13AB includes a third space wall 309 below the second housing side cavity 307. The third space wall 309 has a shape obtained by dividing a cylinder into two. The third space wall 31 illustrated in FIG. 3 also has a shape obtained by dividing a cylinder into two in a manner similar to that of the third space wall 309. Hence, a third space 308 is formed by placing the third space wall 309 on the third space wall 31 illustrated in FIG. 3. The swing connecting side second housing 13AB includes a first tube 310 and a second tube 311 one on each side of the third space wall 309.

A fourth space wall 27 of the third housing 14A is situated adjacent to the first tube 310. A second pivoting shaft SL is inserted from the fourth space wall 27 to the first tube 310. Examples of the second pivoting shaft SL include a pivoting connecting sleeve, and the like. The pivoting hinge part 28 of the third housing 14A is situated adjacent to the second tube 311. A pivoting hinge H is inserted from the pivoting hinge part 28 to the second tube 311. The second pivoting shaft SL or the pivoting hinge H may be formed of a material resistant to corrosion. Stainless steel may be given as an example of the material resistant to corrosion. The second housing 13A and the third housing 14B are configured to mutually have a flexible pivoting connection between them (e.g., see FIG. 16) by having a second pivoting shaft SL insertion structure or a pivoting hinge H insertion structure. Note that grease is applied as lubrication to facilitate the pivoting operation of the second pivoting shaft SL or the pivoting hinge H. The pivoting hinge H includes a mechanism configured to retain an opening/closing angle formed between the second housing 13A and the third housing 14A as an ergonomically optimal angle.

The swing connecting side second housing 13AB includes a second housing side water stop projection 312 on a flange rib 301 adjacent to the third space wall 309. The second housing side water stop projection 312 is formed in a lower part of a circumference grove 302a formed on a flange rib 301. A second housing side second water stop part 313 is formed inside the second housing side water stop projection 312.

The second pivoting shaft SL forms a hollow cylinder. A cylindrical end face side of the second pivoting shaft SL to be inserted into the first tube 310 forms an opening. The second pivoting shaft SL includes a second pivoting shaft cutout part SLC by forming a cutout part in a side of the cylinder adjacent to the third housing 14A. When the second pivoting shaft SL is inserted from the fourth space wall 27 to the first tube 310, a third housing side water stop part 401 of the third housing 14a is exposed from the second pivoting shaft cutout part SLC.

A pivoting cladding tube T2 is attached to the third housing side water stop part 401. Further, the pivoting cladding tube T2 passes through the second pivoting shaft cutout part SLC and the first tube 310, and is then attached to the second housing side second water stop part 313. The pivoting cladding tube T2 serves as a wiring tube. The pivoting cladding tube T2 may, for example, be formed of a silicon tube or a resin tube. Specifically, the pivoting cladding tube T2 may be obtained by processing a lightweight, soft, and flexible insulating raw material. Accordingly, the pivoting cladding tube T2 has flexibility or elasticity.

A first wiring member E1 and a second wiring member E2 pass through the pivoting cladding tube T2. Accordingly, since the first wiring member E1 and the second wiring member E2 are enveloped by the pivoting cladding tube T2, the first wiring member E1 and the second wiring member E2 are protected with the pivoting cladding tube T2. The first wiring member E1 and the second wiring member E2 inside the pivoting cladding tube T2 are extended from the pivoting cladding tube T2 attached to the second housing side second water stop part 313 so as to pass through the second housing side second water stop part 313. The extended first wiring member E1 matches the first wiring member E1 extended from the second housing side first water stop part 306 of the swing connecting side second housing 13AB. The extended second wiring member E2 is connected to a second housing side connector 322 attached to the second housing side cavity 307 of the swing connecting side second housing 13AB. Examples of the second wiring member E2 include an insulated wire, a single core cable, a multi-conductor cable, a flat cable, a thin line coaxial cable, a flexible flat cable (FFC), or a flexible printing circuit board (FPCB).

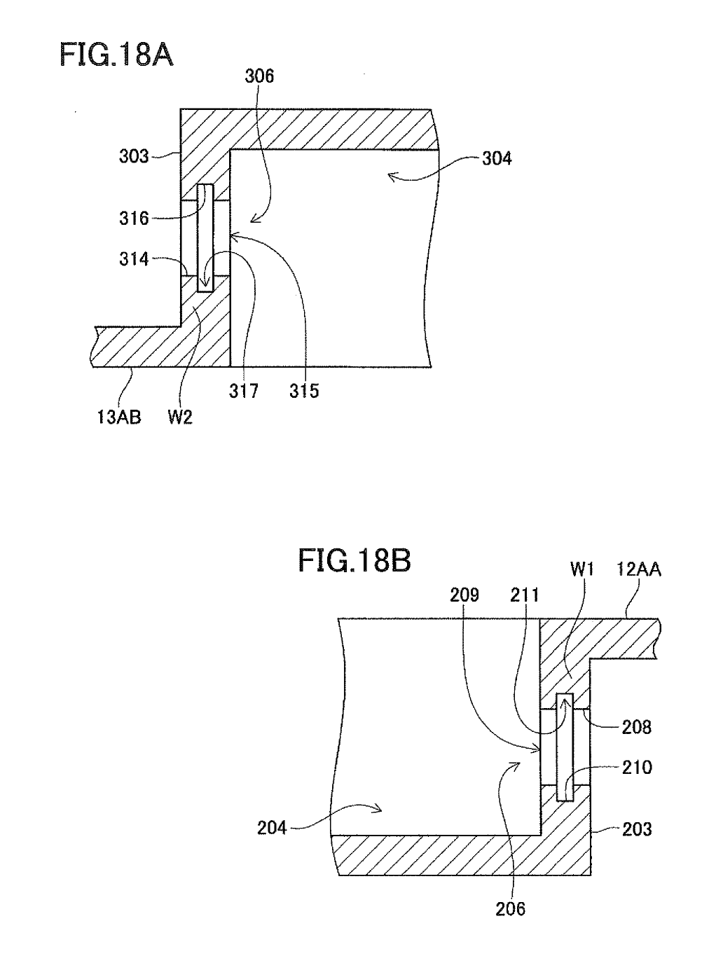

FIG. 18A is a cross-sectional view illustrating the second housing side first water stop part 306 of the swing connecting side second housing 13AB, and FIG. 18B is a cross-sectional view illustrating the first housing side water stop part 206 of the swing connecting side first housing 12AA.

As illustrated in FIG. 18B, the swing connecting side first housing 12AA includes the first housing side water stop part 206 on a lateral wall W1 of the first space wall 203 forming the first space 204. The first housing side water stop part 206 includes a first wiring opening 209 formed by causing a first wiring opening wall 208 to penetrate the lateral wall W1. Note that when no electrical wiring disruption is present in the first wiring member E1 inside the first housing 12A (e.g., see FIG. 14), the first wiring opening 209 is formed in a plane (a bottom surface) of the first space wall 203.

The first wiring opening 209 includes a first continuous groove wall 210 formed in the first wiring opening wall 208. The first wiring opening 209 further includes a first circular continuous groove 211 formed of the first continuous groove wall 210. The first wiring opening 209 has a circular cross section. Note that the cross section of the first wiring opening 209 may have an oblong shape, or a square shape formed by linking the corners of the square in an arc. The cross section of the first wiring opening 209 may have a shape matching an outer circumference of the swing cladding tube T1 (e.g., see FIG. 15).

As illustrated in FIG. 18A, the swing connecting side second housing 13AB includes the second housing side first water stop part 306 on a lateral wall W2 of the second space wall 303 forming the second space 304. The second housing side first water stop part 306 includes a second wiring opening 315 formed by causing the second wiring opening wall 314 to penetrate the lateral wall W2. Note that when no electrical wiring disruption is present in the first wiring member E1 inside the second housing 13A (e.g., see FIG. 14), the second wiring opening 315 is formed in a plane (a bottom surface) of the second space wall 303.

The first wiring opening 315 includes a second continuous groove wall 316 formed in the second wiring opening wall 314. The second wiring opening 315 further includes a second circular continuous groove 317 formed of the second continuous groove wall 316. The second wiring opening 315 has a circular cross section. Note that the cross section of the second wiring opening 315 may have an oblong shape, or a square shape formed by linking the corners of the square in an arc. The cross section of the second wiring opening 315 may have a shape matching an outer circumference of the swing cladding tube T2 (e.g., see FIG. 17).

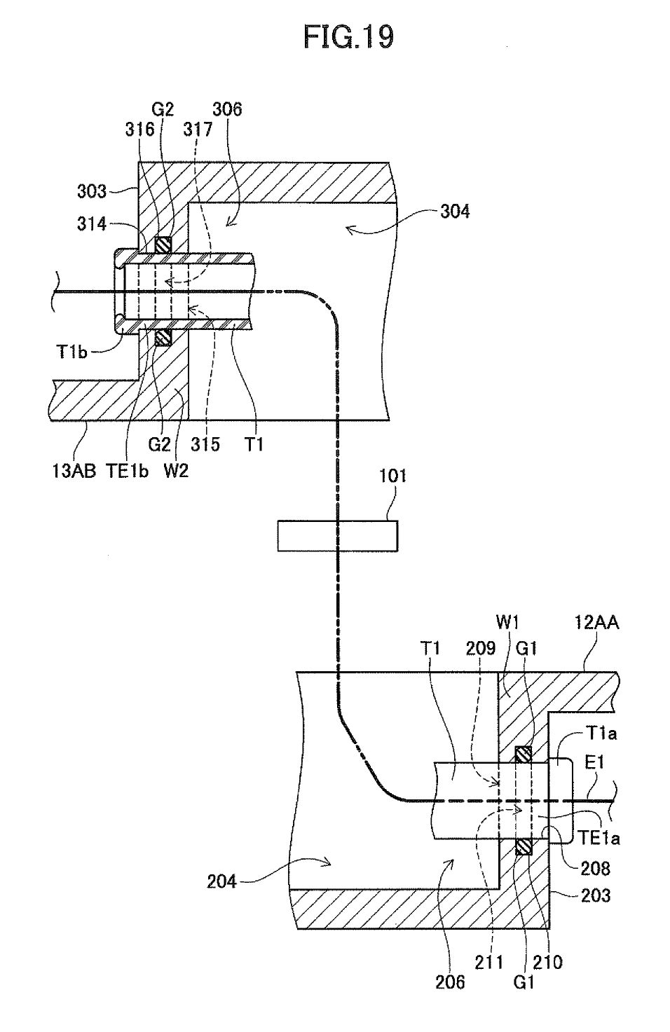

FIG. 19 depicts sectional views illustrating the first housing side water stop part 206 and the second housing side first water stop part 306 to both of which the swing cladding tube T1 is attached. FIG. 19 depicts simplified external views of the first wiring member E1 and the swing connecting member 101. The external view of the swing cladding tube T1 is illustrated in a lower part of FIG. 19. In FIG. 19, components identical to those illustrated in FIG. 18 are provided with the same reference numerals. In the following description, illustration of the components in FIG. 19 identical to those of FIG. 18 provided with the same reference numerals is therefore omitted.

In the first housing side water stop part 206, a first fixing end TE1a serving as an end part of the swing cladding tube T1 is inserted into the first wiring opening 209 in a state where a first fixing sealer G1 is attached to the first continuous groove 211 as illustrated in the lower part of FIG. 19. Examples of the first fixing sealer G1 include an O ring, and the like. When the first fixing end TE1a of the swing cladding tube T1 is inserted into the first wiring opening 209, the first fixing sealer G1 intervenes between a first continuous groove wall 210 and the first fixing end TE1a of the swing cladding tube T1. When the first fixing sealer G1 intervenes between the first continuous groove wall 210 and the first fixing end TE1a of the swing cladding tube T1, the first fixing sealer G1 is compressed by the first continuous groove wall 210 and the first fixing end TE1a of the swing cladding tube T1. When the first fixing sealer G1 is compressed, a gap between the first wiring opening wall 208 and the first fixing end TE1a of the swing cladding tube T1 is sealed with the first fixing sealer G1. Accordingly, the first fixing end TE1a of the swing cladding tube T1 is cohesively or closely connected to the first wiring opening 209 via the first fixing sealer G1. Specifically, the first wiring opening 209 into which the first fixing end TE1a of the swing cladding tube T1 is inserted acquires waterproof properties by the application of the first fixing sealer G1 to cohesively seal between the first wiring opening wall 208 and the first fixing end TE1a of the swing cladding tube T1. A compressible size of the first fixing sealer G1 may be selected according to the first continuous groove wall 210 and the first fixing end TE1a of the swing cladding tube T1.

The first space 204 serves as a wiring space of the swing cladding tube T1 through which the first wiring member E1 is passed. The swing cladding tube T1 includes a first restoration part T1a formed as an end of the swing cladding tube T1. When the swing cladding tube T1 is inserted into the first wiring opening 209, the swing cladding tube T1 is pushed into the first wiring opening 209 via the first space 204 serving as the wiring space. Since the swing cladding tube T1 has elasticity, the first restoration part T1a of the swing cladding tube T1 is compressively deformed while the swing cladding tube T1 is pushed into the first wiring opening 209. Having passed through the first wiring opening 209, the compressively deformed first restoration part T1a is restored. When the swing cladding tube T1 is pulled toward the first space 204 in a state where the first restoration part T1a of the swing cladding tube T1 is restored, the first restoration part T1a is stuck to the lateral wall W1 of the first space wall 203. That is, even though the swing cladding tube T1 is pulled toward the first space 204, the first restoration part T1a is stuck to the lateral wall W1. Hence, the swing cladding tube T1 may be prevented from coming off the first wiring opening 209 to the first space 204. Further, in a state where the first fixing end TE1a of the swing cladding tube T1 is inserted into the first wiring opening 209, the first fixing end TE1a is tightened with the first fixing sealer G1 as a reaction of the compressed first fixing sealer G1. That is, the state of the first restoration part T1a being stuck to the lateral wall W1 is stabilized owing to the first restoration part T1a being stuck to the lateral wall W1 and repulsion of the first fixing sealer G1.

Note that in a case where the only purpose is to provide waterproof properties to the first wiring opening 209, the first restoration part T1a may be omitted (removed) from the swing cladding tube T1.

On the other hand, in the second housing side first water stop part 306, a second fixing end TE1b serving as an end part of the swing cladding tube T1 is inserted into the second wiring opening 315 in a state where a second fixing sealer G2 is attached to the second continuous groove 317 as illustrated in an upper part of FIG. 19. Examples of the second fixing sealer G2 include an O ring, and the like. When the second fixing end TE1b of the swing cladding tube T1 is inserted into the second wiring opening 315, the second fixing sealer G2 intervenes between a second continuous groove wall 316 and the second fixing end TE1b of the swing cladding tube T1. When the second fixing sealer G2 intervenes between the second continuous groove wall 316 and the second fixing end TE1b of the swing cladding tube T1, the second fixing sealer G2 is compressed by the second continuous groove wall 316 and the second fixing end TE1b of the swing cladding tube T1. When the second fixing sealer G2 is compressed, a gap between the second wiring opening wall 314 and the second fixing end TE1b of the swing cladding tube T1 is sealed with the second fixing sealer G2. Accordingly, the second fixing end TE1b of the swing cladding tube T1 is cohesively or closely connected to the second wiring opening 315 via the second fixing sealer G2. Specifically, the second wiring opening 315 into which the second fixing end TE1b of the swing cladding tube T1 is inserted acquires waterproof properties by the application of the second fixing sealer G2 to cohesively seal the gap between the second wiring opening wall 314 and the second fixing end TE1b of the swing cladding tube T1. A compressible size of the second fixing sealer G2 may be selected according to the second continuous groove wall 316 and the second fixing end TE1b of the swing cladding tube T1.

The second space 304 serves as a wiring space of the swing cladding tube T1 through which the first wiring member E1 is passed. The swing cladding tube T1 includes a second restoration part T1b formed as an end of the swing cladding tube T1. When the swing cladding tube T1 is inserted into the second wiring opening 315, the swing cladding tube T1 is pushed into the second wiring opening 315 via the second space 304 serving as the wiring space. Since the swing cladding tube T1 has elasticity, the second restoration part T1b of the swing cladding tube T1 is compressively deformed while the swing cladding tube T1 is pushed into the second wiring opening 315. Having passed through the second wiring opening 315, the compressively deformed second restoration part T1b is restored. When the swing cladding tube T1 is pulled toward the second space 304 in a state where the second restoration part T1b of the swing cladding tube T1 is restored, the second restoration part T1b is stuck to the lateral wall W2 of the second space wall 303. That is, even though the swing cladding tube T1 is pulled toward the second space 304, the second restoration part T1b is stuck to the lateral wall W2. Hence, the swing cladding tube T1 may be prevented from coming off the second wiring opening 315 to the second space 304. Further, in a state where the second fixing end TE1b of the swing cladding tube T1 is inserted into the second wiring opening 315, the second fixing end TE1b is tightened with the second fixing sealer G2 as a reaction of the compressed second fixing sealer G2. That is, the state of the second restoration part T1b being stuck to the lateral wall W2 is stabilized owing to the second restoration part T1b being stuck to the lateral wall W2 and repulsion of the second fixing sealer G1.

Note that in a case where the only purpose is to provide waterproof properties to the second wiring opening 315, the second restoration part T1b may be omitted (removed) from the swing cladding tube T1.

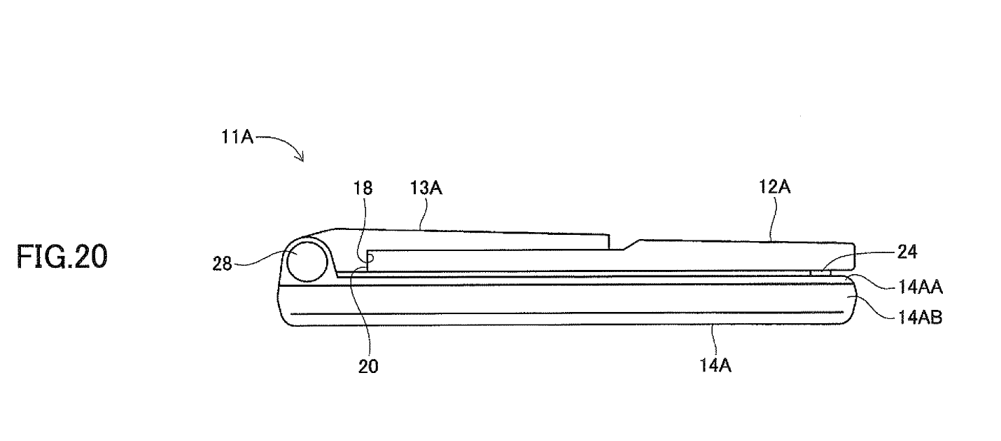

FIG. 20 is a side view illustrating the mobile phone 11A according to the first embodiment in a folded state. In FIG. 20, since the mobile phone 11A according to the first embodiment is illustrated from its lateral surface provided with the pivoting hinge part 28, the second corner 20 of the first housing 12A resides on the sliding surface 18 of the second housing 13A. When the mobile phone 11A according to the first embodiment is in the folded state, the first housing 12A comes into contact with the projections 24 of the third housing 14A as already described above. As illustrated in FIG. 20, the third housing 14A includes a pivoting connecting side third housing 14AA and a non-pivoting connecting side third housing 14AB.

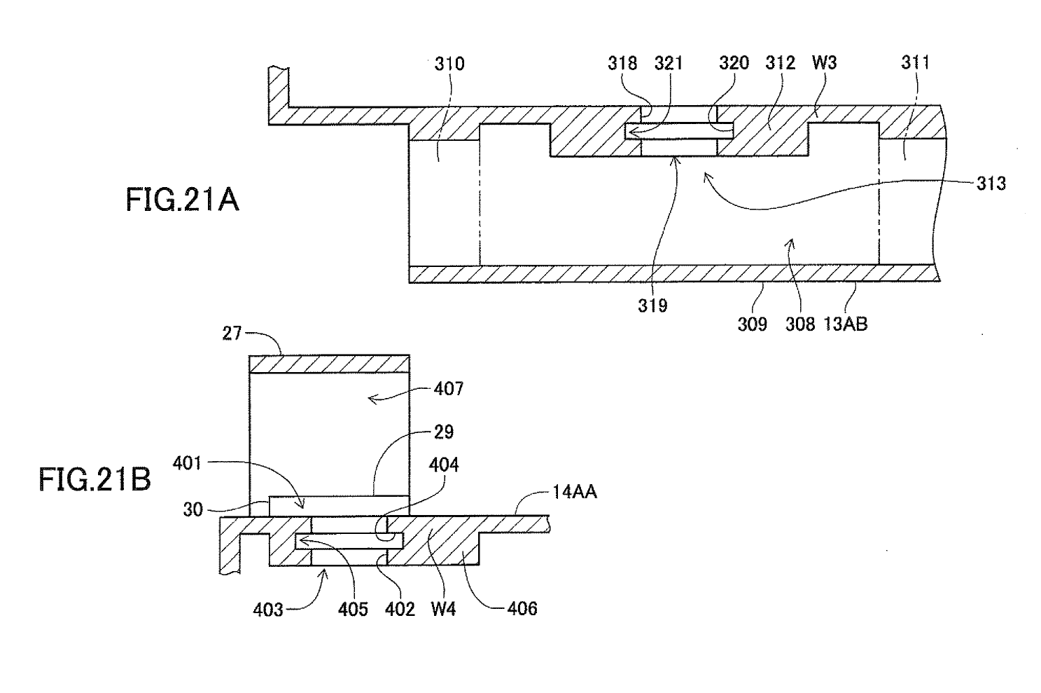

FIG. 21A is a sectional view illustrating a second housing side second water stop part 313 of the swing connecting side second housing 13AB, and FIG. 21B is a sectional view illustrating a third housing side water stop part 401 of the pivoting connecting side third housing 14AA.

As illustrated in FIG. 21A, the swing connecting side second housing 13AB includes the third space wall 309, the first tube 310, and the second tube 311 below a lateral wall W3 forming the second housing side water stop projection 312. Technically speaking, the lateral wall W3 forms respective parts of the third space wall 309, the first tube 310, and the second tube 311. The first tube 310 and the second tube 311 are in communication with the third space 308 formed within the third space wall 309. The second housing side water stop projection 312 is directed toward the third space 308. The second housing side water stop projection 312 includes a second housing side second water stop part 313 formed within the second housing side water stop projection 312. Note that when it is possible to retain the thickness of the lateral wall W3, the second housing side second water stop part 313 may be formed within the lateral wall W3.

The second housing side second water stop part 313 includes a third wiring opening 319 formed by causing a third wiring opening wall 318 to penetrate the lateral wall W3. The third wiring opening 319 includes a third continuous groove wall 320 formed in the third wiring opening wall 318. The third wiring opening 319 further includes a third circular continuous groove 321 formed of the third continuous groove wall 320. The third wiring opening 319 has a circular cross section. Note that the cross section of the third wiring opening 319 may have an oblong shape, or a square shape formed by linking the corners of the square in an arc. The cross section of the third wiring opening 319 may have a shape matching an outer circumference of the pivoting cladding tube T2 inserted into the third wiring opening 319 (e.g., see FIG. 17).

As illustrated in a lower part of FIG. 21B, the pivoting connecting side third housing 14AA includes the fourth space wall 27 above a lateral wall W4 forming a third housing side water stop projection 406. Technically speaking, the lateral wall W4 forms a part of the fourth space wall 27. The fourth space wall 27 includes a guide surface 29, a stopper 30, and a fourth space 407. The third housing side water stop projection 406 formed adjacent to the fourth space 407 includes a third housing side water stop part 401 formed within the third housing side water stop projection 406. Note that when it is possible to retain the thickness of the lateral wall W4, the third housing side water stop part 401 may be formed within the lateral wall W4.

The third housing side water stop part 401 includes a fourth wiring opening 403 formed by causing a fourth wiring opening wall 402 to penetrate the lateral wall W4. The first wiring opening 403 includes a fourth continuous groove wall 404 formed in the fourth wiring opening wall 402. The fourth wiring opening 403 further includes a fourth circular continuous groove 405 formed of the fourth continuous groove wall 404. The fourth wiring opening 403 has a circular cross section. Note that the cross section of the fourth wiring opening 403 may have an oblong shape, or a square shape formed by linking the corners of the square in an arc. The cross section of the fourth wiring opening 403 may have a shape matching an outer circumference of the pivoting cladding tube T2 inserted into the fourth wiring opening 403.

In order to distinguish the first tube 310 of the swing connecting side second housing 13AB from the fourth space wall 27 of the pivoting connecting side third housing 14AA, the first tube 310 in FIG. 21A is separately illustrated from the fourth space wall 27 illustrated in FIG. 21B. However, the first tube 310 and the fourth space wall 27 are situated adjacent to each other (see FIG. 17).

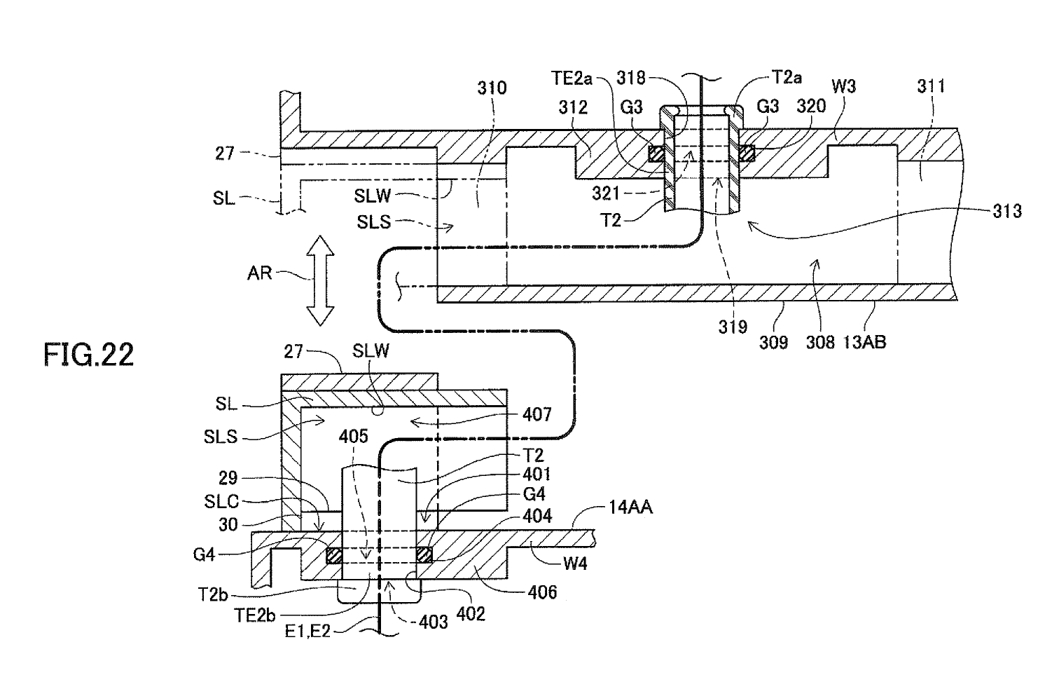

FIG. 22 depicts sectional views illustrating the second housing side second water stop part 313 and the third housing side water stop part 401 to both of which the pivoting cladding tube T2 is attached. FIG. 22 depicts simplified external views of the first wiring member E1 and the second wiring member E2. The external view of the pivoting cladding tube T2 is illustrated in a lower part of FIG. 22. In FIG. 22, components identical to those illustrated in FIG. 21 are provided with the same reference numerals. In the following description, illustration of the components in FIG. 22 identical to those of FIG. 21 provided with the same reference numerals is therefore omitted.

In FIG. 22, in order to distinguish the first tube 310 of the swing connecting side second housing 13AB from the fourth space wall 27 of the pivoting connecting side third housing 14AA, the first tube 310 is separately illustrated from the fourth space wall 27. However, when the first tube 310 or the fourth space wall 27 is moved in any one of directions indicated by an up-down double arrow AR, the first tube 310 and the fourth space wall 27 are situated adjacent to each other (see FIG. 17).

The pivoting cladding tube T2 attached to the second housing side second water stop part 313 and the third housing side water stop part 401 passes through the second pivoting shaft SL. The second pivoting shaft SL is inserted from the fourth space wall 27 to the first tube 310. Technically speaking, the second pivoting shaft SL is inserted such that the second pivoting shaft SL sliding on the guide surface 29 reaches the stopper 30. A second shaft hole SLS is formed in the fourth space wall 27 and the first tube 310 with a second shaft hole wall SLW corresponding to an inner surface of the second pivoting shaft SL.

In the third housing side water stop part 401, a fourth fixing end TE2b serving as an end part of the pivoting cladding tube T2 is inserted into the fourth wiring opening 403 in a state where a fourth fixing sealer G4 is attached to the fourth continuous groove 405 as illustrated in the lower part of FIG. 22. Examples of the fourth sealer G4 include an O ring, and the like. When the fourth fixing end TE2b of the pivoting cladding tube T2 is inserted into the fourth wiring opening 403, the fourth fixing sealer G4 intervenes between the fourth continuous groove wall 404 and the fourth fixing end TE2b of the pivoting cladding tube T2. When the fourth fixing sealer G4 intervenes between the fourth continuous groove wall 404 and the fourth fixing end TE2b of the pivoting cladding tube T2, the fourth fixing sealer G4 is compressed by the fourth continuous groove wall 404 and the fourth fixing end TE2b of the pivoting cladding tube T2. When the fourth fixing sealer G4 is compressed, a gap between the fourth wiring opening wall 402 and the fourth fixing end TE2b of the pivoting cladding tube T2 is sealed with the fourth fixing sealer G4. Accordingly, the fourth fixing end TE2b of the pivoting cladding tube T2 is cohesively or closely connected to the fourth wiring opening 403 via the fourth fixing sealer G4. Specifically, the fourth wiring opening 403 into which the fourth fixing end TE2b of the pivoting cladding tube T2 is inserted acquires waterproof properties by the application of the fourth fixing sealer G4 to cohesively seal the gap between the fourth wiring opening wall 402 and the fourth fixing end TE2b of the pivoting cladding tube T2. A compressible size of the fourth fixing sealer G4 may be selected according to the fourth continuous groove wall 404 and the fourth fixing end TE2b of the pivoting cladding tube T2.

The fourth space 407 serves as a wiring space of the pivoting cladding tube T2 through which the first wiring member E1 and the second wiring member E2 are passed. The pivoting cladding tube T2 includes a fourth restoration part T2b formed as an end of the pivoting cladding tube T2. When the pivoting cladding tube T2 is inserted into the fourth wiring opening 403, the pivoting cladding tube T2 is pushed into the fourth wiring opening 403 via the fourth space 407 serving as the wiring space. Since the pivoting cladding tube T2 has elasticity, the fourth restoration part T2b of the pivoting cladding tube T2 is compressively deformed while the pivoting cladding tube T2 is pushed into the fourth wiring opening 403. Having passed through the fourth wiring opening 403, the compressively deformed fourth restoration part T2b is restored. When the pivoting cladding tube T2 is pulled toward the fourth space 407 in a state where the fourth restoration part T2b of the pivoting cladding tube T2 is restored, the fourth restoration part T2b is stuck to the lateral wall W4 of the fourth space wall 27. That is, even though the pivoting cladding tube T2 is pulled toward the fourth space 407, the fourth restoration part T2b is stuck to the lateral wall W4. Hence, the pivoting cladding tube T2 may be prevented from coming off the fourth wiring opening 403 to the fourth space 407. Further, in a state where the fourth fixing end TE2b of the pivoting cladding tube T2 is inserted into the fourth wiring opening 403, the fourth fixing end TE2b is tightened with the fourth fixing sealer G4 as a reaction of the compressed fourth fixing sealer G4. That is, the state of the fourth restoration part T2b being stuck to the lateral wall W4 is stabilized owing to the fourth restoration part T2b being stuck to the lateral wall W4 and repulsion of the fourth fixing sealer G4.

Note that in a case where the only purpose is to provide waterproof properties to the fourth wiring opening 403, the fourth restoration part T2b may be omitted (removed) from the pivoting cladding tube T2.

The pivoting cladding tube T2 inserted into the fourth wiring opening 403 passes through the second pivoting shaft cutout part SLC and the second shaft hole SLS, and is then attached to the second housing side second water stop part 313.

On the other hand, in the second housing side second water stop part 313, a third fixing end TE2a serving as an end part of the pivoting cladding tube T2 is inserted into the third wiring opening 319 in a state where a third fixing sealer G3 is attached to the third circular continuous groove 321 as illustrated in an upper part of FIG. 22. Examples of the third fixing sealer G3 include an O ring, and the like. When the third fixing end TE2a of the pivoting cladding tube T2 is inserted into the third wiring opening 319, the third fixing sealer G3 intervenes between the third continuous groove wall 320 and the third fixing end TE2a of the pivoting cladding tube T2. When the third fixing sealer G3 intervenes between the third continuous groove wall 320 and the third fixing end TE2a of the pivoting cladding tube T2, the third fixing sealer G3 is compressed by the third continuous groove wall 320 and the third fixing end TE2a of the pivoting cladding tube T2. When the third fixing sealer G3 is compressed, a gap between the third wiring opening wall 318 and the third fixing end TE2a of the pivoting cladding tube T2 is sealed with the third fixing sealer G3. Accordingly, the third fixing end TE2a of the pivoting cladding tube T2 is cohesively or closely connected to the third wiring opening 319 via the third fixing sealer G3. Specifically, the third wiring opening 319 into which the third fixing end TE2a of the pivoting cladding tube T2 is inserted acquires waterproof properties by the application of the third fixing sealer G3 to cohesively seal the gap between the third wiring opening wall 318 and the third fixing end TE2a of the pivoting cladding tube T2. A compressible size of the third fixing sealer G3 may be selected according to the third continuous groove wall 320 and the third fixing end TE2a of the pivoting cladding tube T2.

The third space 308 serves as a wiring space of the pivoting cladding tube T2 through which the first wiring member E1 and the second wiring member E2 are passed. The pivoting cladding tube T2 includes a third restoration part T2a formed as an end of the pivoting cladding tube T2. When the pivoting cladding tube T2 is inserted into the third wiring opening 319, the pivoting cladding tube T2 is pushed into the third wiring opening 319 via the third space 308 serving as the wiring space. Since the pivoting cladding tube T2 has elasticity, the third restoration part T2a of the pivoting cladding tube T2 is compressively deformed while the pivoting cladding tube T2 is pushed into the third wiring opening 319. Having passed through the third wiring opening 319, the compressively deformed third restoration part T2a is restored. When the pivoting cladding tube T2 is pulled toward the third space 308 in a state where the third restoration part T2a of the pivoting cladding tube T2 is restored, the third restoration part T2a is stuck to the lateral wall W3 that is a part of the third space wall 309. That is, even though the pivoting cladding tube T2 is pulled toward the third space 308, the third restoration part T2a is stuck to the lateral wall W3. Hence, the pivoting cladding tube T2 may be prevented from coming off the third wiring opening 319 to the third space 308. Further, in a state where the third fixing end TE2a of the pivoting cladding tube T2 is inserted into the third wiring opening 319, the third fixing end TE2a of the pivoting cladding tube T2 is tightened with the third fixing sealer G3 as a reaction of the compressed third fixing sealer G3. That is, the state of the third restoration part T2a being stucked with the lateral wall W3 is stabilized owing to the third restoration part T2a being stuck to the lateral wall W4 and repulsion of the third fixing sealer G3.

Note that in a case where the only purpose is to provide waterproof properties to the third wiring opening 319, the third restoration part T2a may be omitted (removed) from the pivoting cladding tube T2.

The third wiring opening 319 may be shared between the non-swing connecting side second housing 13AA (see FIG. 16) and the swing connecting side second housing 13AB. Technically speaking, when the third wiring opening 319 is shared between the non-swing connecting side second housing 13AA and the swing connecting side second housing 13AB, the third wiring opening 319 is formed by placing the second non-swing connecting side second housing 13AA over the swing connecting side second housing 13AB. Note that the third continuous groove wall 321 is in communication with the circumferential groove 302a (see FIG. 17) formed in the flange rib 301 of the swing connecting side second housing 13AB (see FIG. 17). Further, the third fixing sealer G3 is integrated with the gasket 302b (see FIG. 17) fitted in the circumferential groove 302a. That is, a three-dimensional gasket obtained by integrating the third fixing sealer G3 and the gasket 302b is used. The third fixing sealer G3 and the gasket 302b may be integrated, for example, by bonding the third fixing sealer G3 and the gasket 302b with adhesion.

FIG. 23 is a sectional view illustrating the mobile phone 11A according to the first embodiment in the folded state. The sectional view illustrated in FIG. 23 depicts a cross section of the mobile phone 11A according to the first embodiment viewing from a point D1 in FIG. 3 in a case where the mobile phone 11A according to the first embodiment in the folded state illustrated in FIG. 3 is cut along a dash-dot section line D. Note that illustration of the third space wall 31 (see FIG. 3) placed over the third space wall 309 is omitted from FIG. 23.

Below is given a description of a waterproof structure with a first insertion type that is illustrated utilizing a cross section of the mobile phone 11A according to the first embodiment. As illustrated in FIG. 23, the mobile phone 11A according to the first embodiment includes the first housing 12A, the second housing 13A, and the third housing 14A. In the mobile phone 11A according to the first embodiment in the folded state, the first housing 12A comes into contact with the projections 24 of the third housing 14A.

The first housing 12A includes the swing connecting side first housing 12AA and the non-swing connecting side first housing 12AB. The repulsion of the gasket 202b gives waterproof properties between the swing connecting side first housing 12AA and the non-swing connecting side first housing 12AB. Hence, the first housing 12A includes a waterproof case structure having the waterproof properties given by the gasket 202b. The first housing 12A includes the first housing side connector 207 and the PCB (printed circuit board) 212 inside the first housing 12A. The first housing side connector 207 is mounted on the PCB 212. The swing connecting side first housing 12AA includes the first space 204 formed of the first space wall 203. The swing connecting side first housing 12AA includes the first housing side water stop part 206 on the first space wall 203.

The second housing 13A includes the non-swing connecting side second housing 13AA and the swing connecting side second housing 13AB. The repulsion of the gasket 302b gives waterproof properties between the non-swing connecting side second housing 13AA and the swing connecting side second housing 13AB. Hence, the second housing 13A includes a waterproof case structure having the waterproof properties given by the gasket 302b. The second housing 13A includes the second housing side connector 322 and the PCB (printed circuit board) 323 within the second housing 13A. The second housing side connector 322 is mounted on the PCB 323. The swing connecting side second housing 13AB includes the second space 304 formed of the second space wall 303. The swing connecting side second housing 13AB includes the threaded holes 305 and the second housing side first water stop part 306 in the second space wall 303. The swing connecting side second housing 13AB includes the second housing side second water stop part 313 and the third space wall 309. The swing connecting side second housing 13AB includes the third space 308 formed of the second space wall 309. The swing connecting side second housing 13AB includes the first tube 310 situated adjacent to the third space wall 309.

The third housing 14A includes the pivoting connecting side third housing 14AA and the non-pivoting connecting side third housing 14AB. The repulsion of a gasket 408 compressed by the pivoting connecting side third housing 14AA and the non-pivoting connecting side third housing 14AB gives waterproof properties between the pivoting connecting side third housing 14AA and the non-pivoting connecting side third housing 14AB. Hence, the third housing 14A includes a waterproof case structure having the waterproof properties given by the gasket 408. The third housing 13A includes a third housing side connector 410 and a PCB (printed circuit board) 409 within the third housing 13A. The third housing side connector 410 is mounted on the PCB 409. The pivoting connecting side third housing 14AA includes the fourth space wall 27. The pivoting connecting side third housing 14AA includes the fourth space 407 formed of the fourth space wall 27. The pivoting connecting side third housing 14AA includes the third housing side water stop part 401 at a lower part of the fourth space 407.

In this state, the swing connecting member 101 is sandwiched between the first housing 12A and the second housing 13A.

The swing connecting member 101 may be attached to the second housing 13A as follows. The threaded holes 305 of the second space wall 303 are aligned with the fixing holes 114 of the clamping plate 104 (see FIG. 17) such that the second space 304 is covered with the clamping plate 104 of the swing connecting member 101. Machine screws 324 are screwed into the threaded holes 305 aligned with the fixing holes 114. Since the clamping plate 104 of the swing connecting member 101 is fixed to the second space wall 303 by screwing the machine screws 324 into the threaded holes 305, the swing connecting member 101 is attached to the second housing 13A.

The swing connecting member 101 may be attached with respect to the first housing 12A as follows. Spacers SP are fitted to the female screw bosses 115 of the plate cam 103 of the swing connecting member 101. The spacers SP are placed on the first space wall 203 from the first space 204. The machine screws 205 are screwed into the female screw bosses 115 of the plate cam 103 via the overlaid first space wall 203 and the spacers SP. Since the plate cam 103 of the swing connecting member 101 is fixed to the first space wall 203 by screwing the machine screws 205 into the female screw bosses 115, the swing connecting member 101 is attached to the first housing 12A. In the screwing of the machine screws 205 into the female screw bosses 115, a waterproof sheet SE is sandwiched between the machine screws 205 and the first space wall 203. Hence, the sandwiched waterproof sheet SE may provide waterproof properties between the spacers SP and the first space wall 203.

As described above, when the swing connecting member 101 intervenes between the first housing 12A and the second housing 13A, the first space 204 of the first housing 12A faces the second space 304 of the second housing 13A. Specifically, the swing connecting member 101 intervenes by a connecting interval P1 formed by causing the first space 204 of the first housing 12A to face the second space 304 of the second housing 13A. The swing connecting member 101 intervening by the connecting interval P1 may facilitate a flexible swing operability connecting relationship between the first housing 12A and the second housing 13A.

Note that the swing connecting member 101 may be attached with respect to the first housing 12A or the second housing 13A as follows. Specifically, the swing connecting member 101 may be attached with respect to the first housing 12A or the second housing 13A utilizing an adhesion insofar as such adhesive bonding provides the strength to satisfy the function of the swing connecting member 101.

The second pivoting shaft SL resides within the second housing 13A and the third housing 14A.

The second pivoting shaft SL may be attached with respect to the second housing 13A and the third housing 14A as follows. The fourth space wall 27 of the third housing 14A is allowed to match the first tube 310 of the second housing 13A (see FIG. 17). Hence, the second pivoting shaft SL passes through the matched space wall 27 and the first tube 310 from the fourth space wall 27 side.

As described above, the second pivoting shaft SL resides within the second housing 13A and the third housing 14A at a connecting position P2 (see FIG. 3) at which the fourth space wall 27 of the third housing 14A is allowed to match the first tube 310 of the second housing 13A. The second pivoting shaft SL residing within the second housing 13A and the third housing 14A at a connecting position P2 may facilitate a flexible pivotal operability connecting relationship between the second housing 13A and the third housing 14A.

In the mobile phone 11A according to the first embodiment, the swing cladding tube T1 is attached to the first housing side water stop part 206 and the second housing side first water stop part 306. The swing cladding tube T1 passes through the first shaft hole 106 of the swing connecting member 101. The first end 109b and the second end 109c of the resilient member 109 are fixed to the first pivoting shaft 102 having the first shaft hole 106. Accordingly, the resilient force of the resilient member 109 is applied to the first pivoting shaft 102 attached in a manner flexibly pivotable and flexibly slidable within the guide slot 108 in a direction toward which the resilient force is applied. When the resilient force is applied to the first pivoting shaft 102 within the guide slot 108 in the direction toward which the resilient force is applied (i.e., in a resilient force direction), the plate cam 103 connected to the first pivoting shaft 102 is pressed against the pivoting contactor 113.

The pivoting cladding tube T2 is attached to the second housing side second water stop part 313 and the third housing side water stop part 401. The pivoting cladding tube T2 passes through the second shaft hole SLS and the second pivoting shaft cutout part SLC. The second shaft hole SLS is formed of the second shaft hole wall SLW corresponding to the inner surface of the second pivoting shaft SL. Hence, the second shaft hole SLS resides within the fourth space wall 27 and within the first tube 310.

The first wiring member E1 and the second wiring member E2 are connected to the third housing side connector 410. Technically speaking, the first wiring member E1 is partially connected to the first housing side connector 207 via the third housing side water stop part 401, the pivoting cladding tube T2, the second housing side second water stop part 313, the second housing side first water stop part 306, the swing cladding tube T1, and the first housing side water stop part 206. Further, the first wiring member E1 is partially connected to the second housing side connector 322 via the third housing side water stop part 401, the pivoting cladding tube T2, and the second housing side second water stop part 313. On the other hand, the second wiring member E2 is partially connected to the second housing side connector 322 via the third housing side water stop part 401, the pivoting cladding tube T2, and the second housing side second water stop part 313.

In the mobile phone 11A according to the first embodiment, since the swing connecting member 101 has no waterproof properties, some liquid such as water may enter the first space 204 of the first housing 12A and the second space 304 of the second housing 13A via the connecting interval P1 intervened by the swing connecting member 101. However, since the first housing side water stop part 206 or the second housing side first water stop part 306 to which the swing cladding tube T1 is attached has waterproof properties, such a liquid having entered the first space 204 and the second space 304 will not invade the inside of the first housing 12A or the inside of the second housing 13A. Further, the first wiring member E1 passing through the swing cladding tube T1 will not be interfered with by the liquid having entered the first space 204 or the second space 304. On the other hand, since the swing cladding tube T1 passes through the first shaft hole 106 of the swing connecting member 101, the flexible pivoting operation and flexible sliding operation of the first pivoting shaft 102 having the first shaft hole 106 within the guide slot 108 will not be interfered with by the swing cladding tube T1. Specifically, in the mobile phone 11A according to the first embodiment, despite the fact that the swing connecting member 101 for implementing the swing operation has no waterproof properties, the swing connecting member 101 may be able to simultaneously realize the flexible swing operation and the waterproof function in the place where the swing operation is performed.

In addition, the swing cladding tube T1 enveloping the first wiring member E1 passes through the first shaft hole 106 of the first pivoting shaft 102. Hence, when the first pivoting shaft 102 pivots and slides within the guide slot 108 at the swing operation, the first wiring member E1 is protected with the swing cladding tube T1. As a result, durability of the first wiring member E1 may be improved by being protected with the swing cladding tube T1. Hence, even though the first pivoting shaft 102 repeatedly pivots and slides within the guide slot 108, the first wiring member E1 exhibits prolonged durability.

As described above, the first shaft hole 106 of the first pivoting shaft 102 of the swing connecting member 101 may be given as an example of a “through hole of the swing connecting member”.

Note that the mobile phone 11A according to the first embodiment may have two or more first housing side water stop parts 206 or two or more second housing side first water stop parts 306. When the mobile phone 11A has two or more first housing side water stop parts 206 or two or more second housing side first water stop parts 306, wiring members obtained by sharing the first wiring member E1 pass through the respective first housing side water stop parts 206 or the respective second housing side first water stop parts 306 via two or more swing cladding tubes T1. Hence, each of the first housing side water stop parts 206 or each of the second housing side first water stop parts 306 may be reduced in size as well as reducing the size of each of the swing cladding tubes T1. Hence, when it is possible to reduce the dimension of the depth of the first space 204 or the second space 304 by arrangement of each of the first housing side water stop parts 206 or each of the second housing side first water stop parts 306, the mobile phone 11A according to the first embodiment may be made thinner. Further, torsion load on each of the wiring members may also be reduced.

In the mobile phone 11A according to the first embodiment, since the second pivoting shaft SL has no waterproof properties, some liquid such as water may enter into the third space 308 of the second housing 13A and the fourth space 407 of the third housing 14A via the connecting position P2 (see FIG. 3) at which the second pivoting shaft SL resides within the second housing 13A and the third housing 14A. However, since the second housing side second water stop part 313 or the third housing side water stop part 401 to which the pivoting cladding tube T2 is attached has waterproof properties, such a liquid having entered the third space 204 and the fourth space 407 will not invade the inner side of the second housing 13A or the inner side of the internal third housing 13A. Further, the first wiring member E1 or the second wiring member E2 passing through the pivoting cladding tube T2 will not be interfered with by the liquid having entered the third space 308 or the fourth space 407. On the other hand, the guide surface 29 or the stopper 30 (see FIG. 22) is applied to the second pivoting shaft SL residing within the connecting position P2 (see FIG. 3) to provide a self-pivoting prevention function. Since the pivoting cladding tube T2 passes through the second shaft hole SLS and the second pivoting shaft cutout part SLC of the second pivoting shaft SL to which the self-pivoting prevention function is applied, the pivoting operation performed via the second pivoting shaft SL will not be interfered with by the pivoting cladding tube T2. Specifically, in the mobile phone 11A according to the first embodiment, despite the fact that the second pivoting shaft SL for implementing the pivoting operation has no waterproof properties, the second pivoting shaft SL may be able to simultaneously realize the flexible pivoting operation and the waterproof function in the place where the pivoting operation is performed.

In addition, the pivoting cladding tube T2 enveloping the first wiring member E1 and the second wiring member E2 passes through the second shaft hole SLS and the second pivoting shaft cutout part SLC of the second pivoting shaft SL that is provided with the self-pivoting prevention function. Accordingly, when the pivoting operation is performed via the second pivoting shaft SL, the first wiring member E1 and the second wiring member E2 are protected with the pivoting cladding tube T2. As a result, durability of the first wiring member E1 and the second wiring member E2 may be improved by being protected with the pivoting cladding tube T2. Accordingly, even if the pivoting operation is repeatedly performed via the second pivoting shaft SL, the first wiring member E1 and the second wiring member E2 each exhibit prolonged durability.

Note that the mobile phone 11A according to the first embodiment may have two or more second housing side second water stop parts 313 or two or more third housing side water stop parts 401. When the mobile phone 11A has two or more second housing side second water stop parts 313 or two or more third housing side water stop parts 401, wiring members obtained by sharing the first wiring member E1 or the second wiring member E2 pass through the respective second housing side second water stop parts 313 or the respective third housing side water stop parts 401 via two or more corresponding operating cladding tubes T2. Hence, each of the second housing side second water stop parts 313 or each of the third housing side water stop parts 401 may be reduced in size as well as reducing the size of each of the pivoting cladding tubes T2. Hence, when the dimension of the depth of the third space 308 or the fourth space 407 is reduced by arrangement of each of the second housing side second water stop parts 313 or each of the third housing side water stop parts 401, the mobile phone 11A according to the first embodiment may be made thinner. Further, torsion load on each of the wiring members may also be reduced.

The pivoting cladding tube T2 may pass through the pivoting hinge H (see FIG. 17) inserted into the pivoting hinge part 28. In a case where the pivoting cladding tube T2 passes through the pivoting hinge H inserted into the pivoting hinge part 28, the flexible pivoting operation and the waterproof function may simultaneously be implemented in the place where the pivoting operation is performed via the pivoting hinge H.

In FIG. 23, in addition to the first wiring member E1 electrically connecting an interval between the third housing side connector 410 and the first housing side connector 207, the second wiring member E2 electrically couples an interval between the third housing side connector 410 and the second housing side connector 322. Note that while the interval between the third housing side connector 410 and the second housing side connector 322 is electrically connected to the second wiring member E2 alone, the interval between the third housing side connector 410 and the first housing side connector 207 may be electrically connected to the first wiring member E1 alone. Alternatively, a connector to which the first wiring member E1 is electrically connected and a connector to which the second wiring member E2 is electrically connected may be separately prepared in place of the second housing side connector 322 to which the first wiring member E1 and the second wiring member E2 are electrically connected.

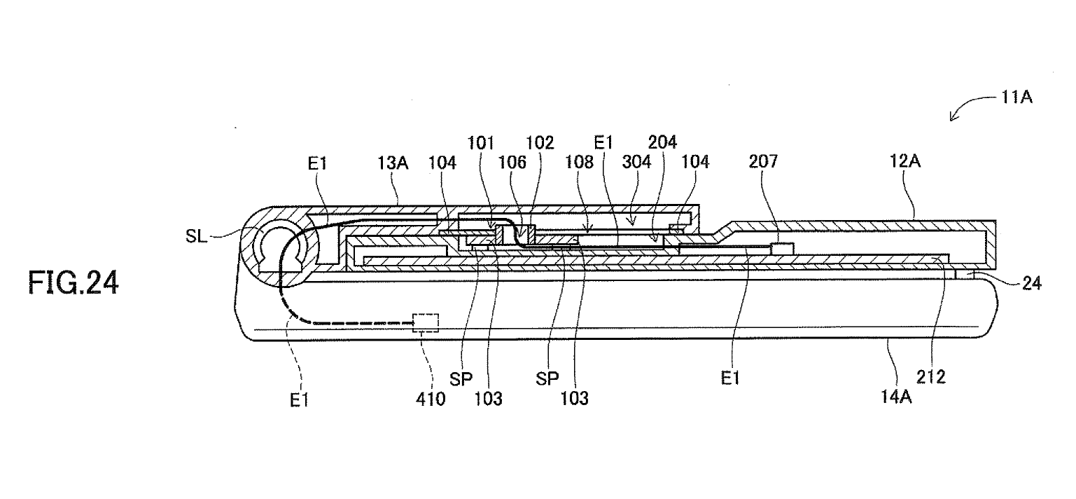

FIG. 24 is a simplified sectional view illustrating the mobile phone 11A according to the first embodiment in the folded state. The sectional view illustrated in FIG. 24 depicts across section of the mobile phone 11A according to the first embodiment viewing from a point D1 in FIG. 3 in a case where the mobile phone 11A according to the first embodiment in the folded state illustrated in FIG. 3 is cut along a dash-dot section line D. In FIG. 24, an external view of the third housing 14A is illustrated. In FIG. 24, components identical to those illustrated in FIG. 23 are provided with the same reference numerals. In the following description, illustration of the components in FIG. 24 identical to those of FIG. 23 provided with the same reference numerals is therefore omitted.

As illustrated in FIG. 24, the mobile phone 11A according to the first embodiment may include the first wiring member alone that electrically couples the third housing side connector 410 and the first housing side connector 207. In a case where the mobile phone 11A according to the first embodiment includes the first wiring member alone that electrically couples the third housing side connector 410 and the first housing side connector 207, the first wiring member E1 alone passes through the pivoting cladding tube T2 illustrated in FIG. 23.

5-2. Waterproof Structure with Second Insertion Type

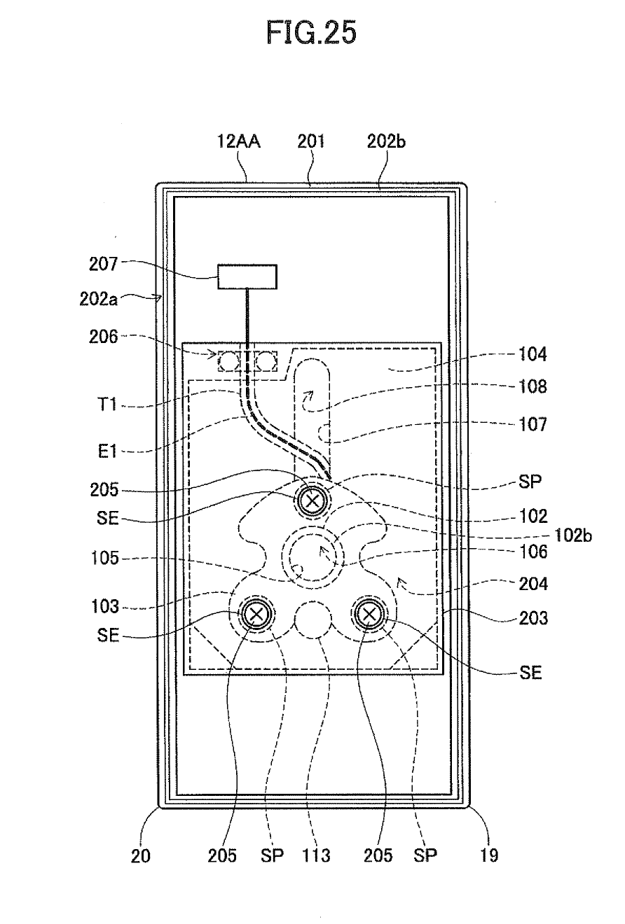

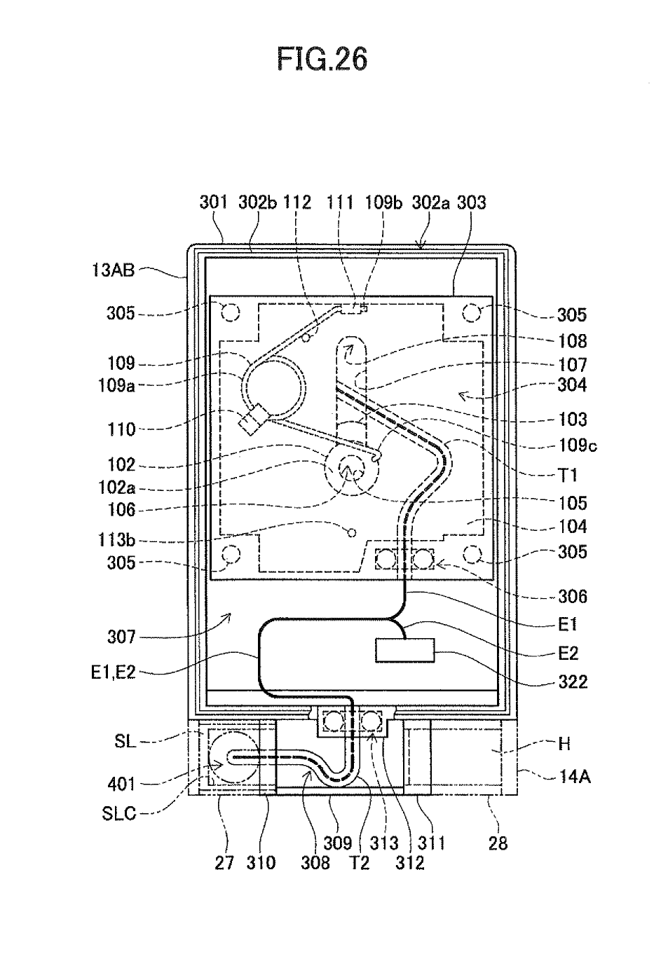

Next, a waterproof structure with a second insertion type is illustrated. FIG. 25 is an internal view illustrating the first swing connecting side housing 12AA. In FIG. 25, components identical to those illustrated in FIG. 15 are provided with the same reference numerals. In the following description, illustration of the components in FIG. 25 identical to those of FIG. 15 provided with the same reference numerals is therefore omitted. FIG. 26 is an internal view illustrating the second swing connecting side housing 13AB. In FIG. 26, components identical to those illustrated in FIG. 17 are provided with the same reference numerals. In the following description, illustration of the components in FIG. 26 identical to those of FIG. 17 provided with the same reference numerals is therefore omitted.

Specifically, since a waterproof structure with the second insertion type is similar to that with the first insertion type, the illustration of the waterproof structure with the second insertion type is omitted from the description. Further, a modification of the waterproof structure in which the pivoting cladding tube T2 passing through the pivoting hinge H (see FIG. 17) is similar to the waterproof structure with the first insertion type, illustration of such a modification of the waterproof structure is omitted from the description. In addition, a modification of the waterproof structure (see FIG. 24) associated with the electrical connection to the first wiring member E1 and the second wiring member E2 is similar to the waterproof structure with the first insertion type, illustration of such a modification of the waterproof structure associated with the electrical connection is omitted from the description.

In FIGS. 15 and 17, the swing cladding tube T1 passes through the first shaft hole 106 of the first pivoting shaft 102. However, as illustrated in FIGS. 25 and 26, in the waterproof structure with the second insertion type, the swing cladding tube T1 passes through the guide slot 108 to which the first pivoting shaft 102 is pivotally and slidably attached. A description given below is an example in which the swing cladding tube T1 passes through the guide slot 108.

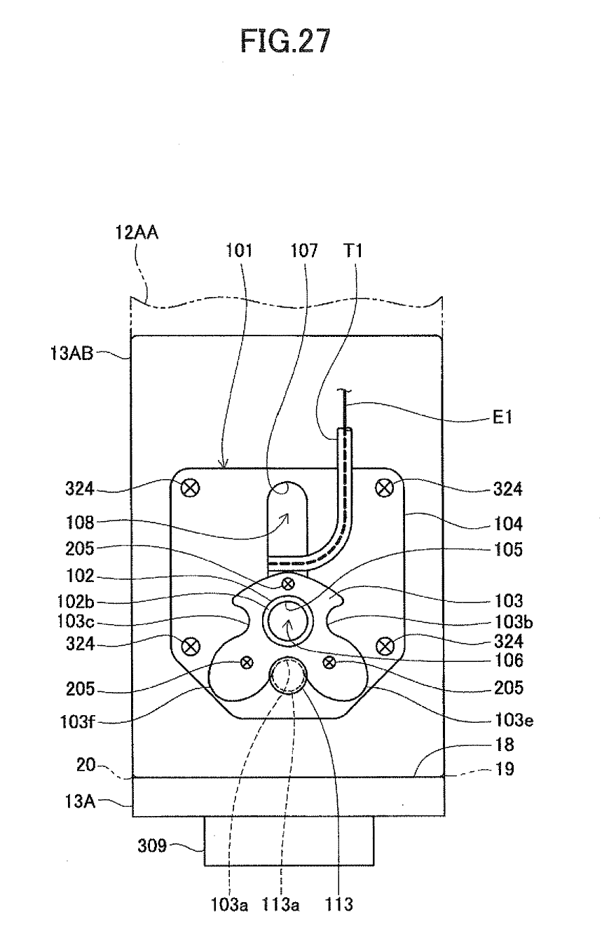

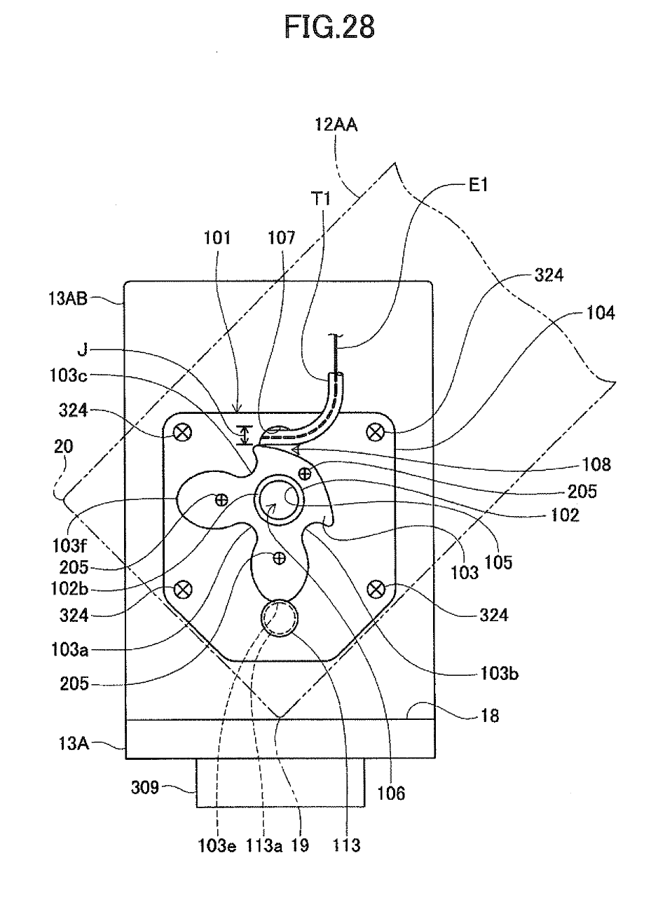

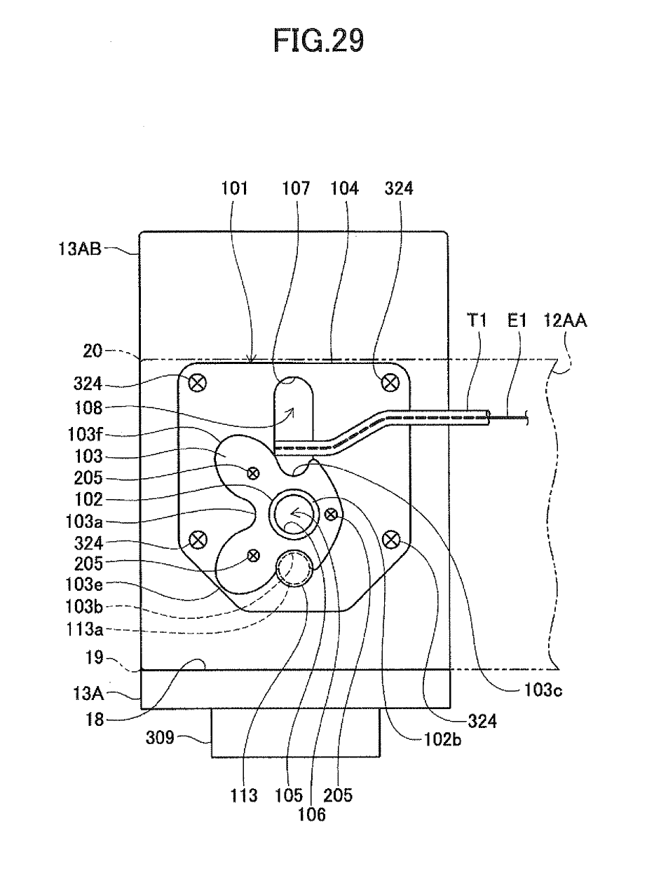

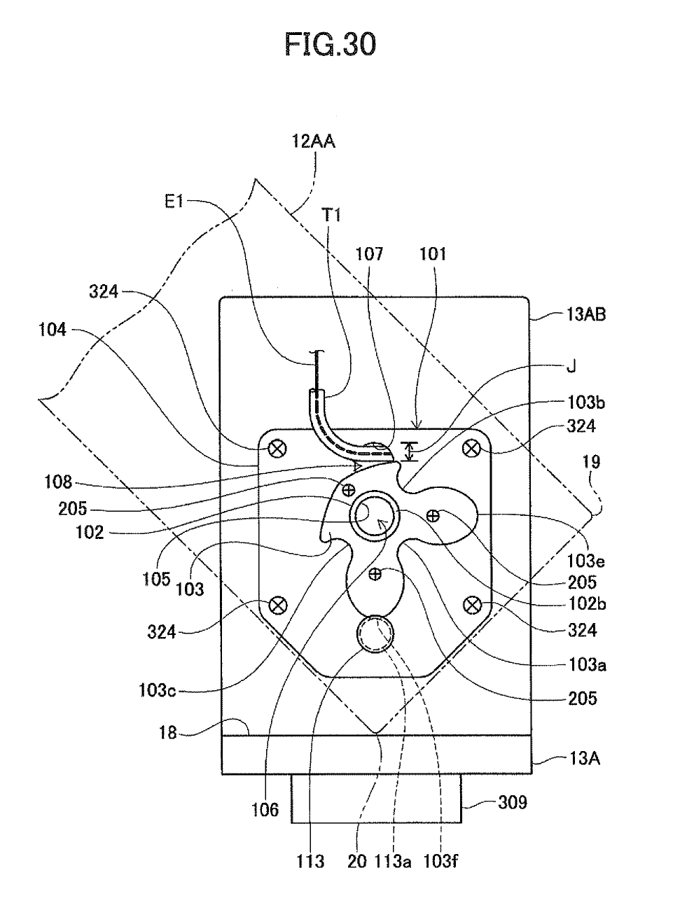

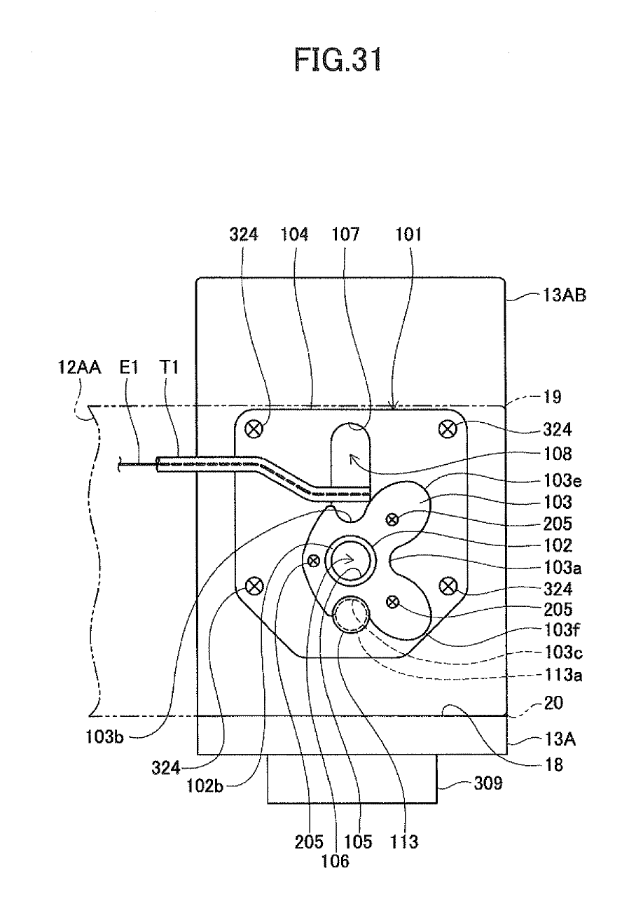

FIGS. 27 to 31 are front views each illustrating the swing connecting member 101 attached to the swing connecting side first housing 12AA and the swing connecting side second housing 13AB. FIG. 27 is a view illustrating the swing connecting member 101 when the first housing 12A of the mobile phone 11A according to the first embodiment is in the basic position (see FIG. 4). FIG. 28 is a view illustrating the swing connecting member 101 when the first housing 12A of the mobile phone 11A according to the first embodiment is in the right-hand side intermediate position (see FIG. 7). The right-hand side intermediate position of the first housing 12A illustrated in FIG. 28 indicates an intermediate position of the first housing 12A toward the right-hand side when the first housing 12A pivots by 45 degrees in a clockwise direction from its basic position. FIG. 29 is a view illustrating the swing connecting member 101 when the first housing 12A of the mobile phone 11A according to the first embodiment is in the right-hand side swing position (see FIG. 5). FIG. 30 is a view illustrating the swing connecting member 101 when the first housing 12A of the mobile phone 11A according to the first embodiment is in the left-hand side intermediate position (see FIG. 8). The left-hand side intermediate position of the first housing 12A illustrated in FIG. 30 indicates an intermediate position of the first housing 12A toward the left-hand side when the first housing 12A pivots by 45 degrees in a counterclockwise direction from its basic position. FIG. 31 is a view illustrating the swing connecting member 101 when the first housing 12A of the mobile phone 11A according to the first embodiment is in the left-hand side swing position (see FIG. 6).

In FIGS. 27 to 31, the swing connecting side first housing 12AA is represented by a phantom line. Note that illustration of the components of the swing connecting side first housing 12AA is omitted from FIGS. 27 to 31, except for the first corner 19 and the second corner 20. In FIGS. 27 to 31, components identical to those illustrated above are provided with the same reference numerals. In the following description, illustration of the components identical to those provided with the same reference numerals may therefore be omitted. As illustrated in FIGS. 27 to 31, the plate cam 103 includes a first apical end 103e and a second apical end 103f on a lateral surface of the plate cam 103.

When the first housing 12A is in the basic position (see FIG. 4), the first depression 103a of the plate cam 103 is pressed against the cylindrical contact surface 113a of the pivoting contactor 113 as illustrated in FIG. 27. In this state where the first depression 103a of the plate cam 103 is pressed against the cylindrical contact surface 113a of the pivoting contactor 113, the swing cladding tube T1 passing through the guide slot 108 is situated at a position between the guide slot wall 107 and the plate cam 103.

When the first housing 12A is in the right-hand side intermediate position where the first housing 12A pivots by 45 degrees in a clockwise direction from its basic position (see FIG. 7), the first corner 19 of the swing connecting side first housing 12AA is situated at an approximately center of the sliding surface 18 of the second housing 13A as illustrated in FIG. 28. When the first corner 19 of the swing connecting side first housing 12AA is situated at the approximately center of the sliding surface 18 of the second housing 13A, the first apical end 103e of the plate cam 103 is pressed against the cylindrical contact surface 113a of the pivoting contactor 113. In this state where the first apical end 103e of the plate cam 103 is pressed against the cylindrical contact surface 113a of the pivoting contactor 113, a largest possible area of the guide slot 108 is covered with the plate cam 103.

Note that an impenetrable region J uncovered by the plate cam 103 is exposed from the guide slot 108. That is, the impenetrable region J is a region outside a movable operating range of the plate cam 103. Hence, the impenetrable region J has a region to an extent in which the swing cladding tube T1 will not be compressed by the plate cam 103 or the guide slot wall 107. Further, the impenetrable region J includes a region outside a movable operating range of the first pivoting shaft 102 or a region outside a movable operating range of the resilient member 109 (e.g., see FIG. 26). In this state where the first apical end 103e of the plate cam 103 is pressed against the cylindrical contact surface 113a of the pivoting contactor 113, the swing cladding tube T1 is moved into the impenetrable region J due to a pushing operation of the plate cam 103. Consequently, the swing cladding tube T1 is situated at a farthermost distance from the pivoting contactor 113.

When the first housing 12A is in the right-hand side swing position (see FIG. 5), the second depression 103b of the plate cam 103 is pressed against the cylindrical contact surface 113a of the pivoting contactor 113 as illustrated in FIG. 29. In this state where the second depression 103b of the plate cam 103 is pressed against the cylindrical contact surface 113a of the pivoting contactor 113, the swing cladding tube T1 passing through the guide slot 108 is situated at a position between the guide slot wall 107 and the plate cam 103.

When the first housing 12A is in the left-hand side intermediate position where the first housing 12A pivots by 45 degrees in a counterclockwise direction from its basic position (see FIG. 8), the second corner 20 of the swing connecting side first housing 12AA is situated at an approximately center of the sliding surface 18 of the second housing 13A as illustrated in FIG. 30. When the second corner 20 of the swing connecting side first housing 12AA is situated at the approximately center of the sliding surface 18 of the second housing 13A, the second apical end 103f of the plate cam 103 is pressed against the cylindrical contact surface 113a of the pivoting contactor 113. In this state where the second apical end 103f of the plate cam 103 is pressed against the cylindrical contact surface 113a of the pivoting contactor 113, a largest possible area of the guide slot 108 is covered with the plate cam 103 in a manner similar to a case where the first housing 12A is in the right-hand side intermediate position (see FIG. 28).

Hence, the impenetrable region J is exposed from the guide slot 108. In this state where the second apical end 103f of the plate cam 103 is pressed against the cylindrical contact surface 113a of the pivoting contactor 113, the swing cladding tube T1 is moved into the impenetrable region J due to a pushing action of the plate cam 103. Consequently, the swing cladding tube T1 is situated at a farthermost distance from the pivoting contactor 113. In this state of the swing cladding tube T1 being situated at a farthermost distance from the pivoting contactor 113 is similar to a case where the first housing 12A is in the right-hand side intermediate position.

When the first housing 12A is in the left-hand side swing position (see FIG. 6), the third depression 103c of the plate cam 103 is pressed against the cylindrical contact surface 113a of the pivoting contactor 113 as illustrated in FIG. 31. In this state where the third depression 103c of the plate cam 103 is pressed against the cylindrical contact surface 113a of the pivoting contactor 113, the swing cladding tube T1 passing through the guide slot 108 is situated at a position between the guide slot wall 107 and the plate cam 103.

Specifically, when the first housing 12A is transitioned from the basic position to the right-hand side swing position, or when the first housing 12A is transitioned from the right-hand side swing position to the basic position, the plate cam 103 reciprocates over the guide slot 108. Likewise, when the first housing 12A is transitioned from the basic position to the left-hand side swing position, or when the first housing 12A is transitioned from the left-hand side swing position to the basic position, the plate cam 103 reciprocates over the guide slot 108. When the plate cam 103 reciprocates over the guide slot 108, the swing cladding tube T1 reciprocates within the guide slot 108 due to a pushing operation of the plate cam 103. When the swing cladding tube T1 moves within the guide slot 108 and a largest possible area of the guide slot 108 is covered with the plate cam 103, the plate cam 103 pushes the swing cladding tube T1 to reach the impenetrable region. Hence, the impenetrable region J has a region to an extent in which the swing cladding tube T1 will not be compressed by the plate cam 103 or the guide slot wall 107. Accordingly, the swing cladding tube T1 will not interfere with the reciprocation of the plate cam 103 when the swing cladding tube T1 moves within the guide slot 108. This may maintain flexibility of the swing operation performed by the swing connecting member 101. Further, when the swing operation is performed by the swing connecting member 101, the swing cladding tube T1 will not be damaged by the plate cam 103 or the guide slot wall 107. Hence, the first wiring member E1 enveloped by the swing cladding tube T1 will be protected.

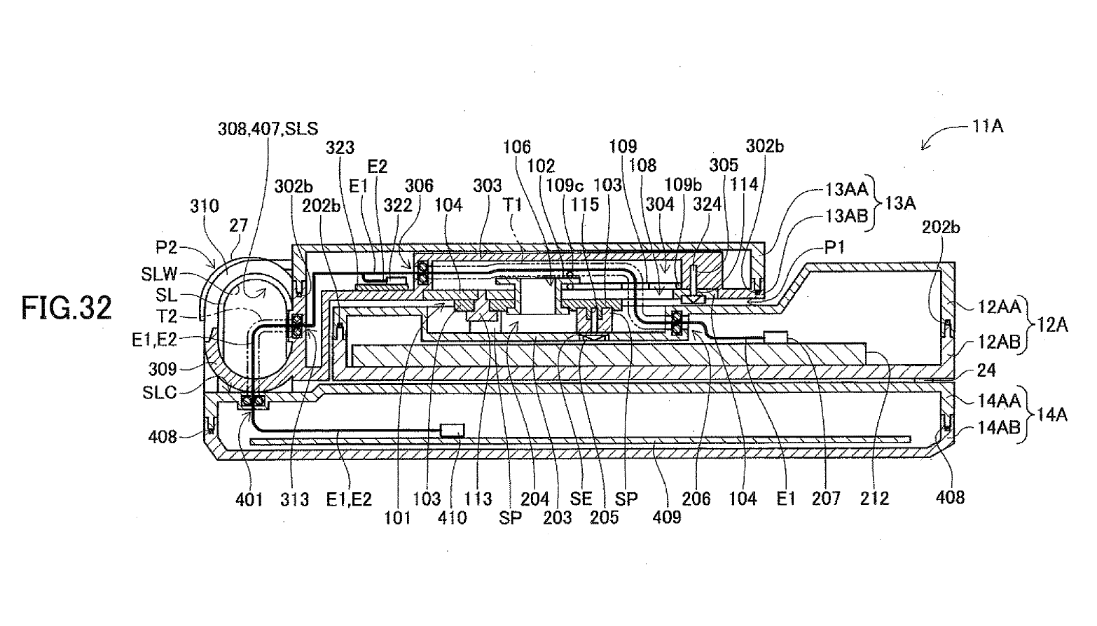

FIG. 32 is a sectional view illustrating the mobile phone 11A according to the first embodiment in the folded state. The sectional view illustrated in FIG. 32 depicts a cross section of the mobile phone 11A according to the first embodiment viewing from a point D1 in FIG. 3 in a case where the mobile phone 11A according to the first embodiment in the folded state illustrated in FIG. 3 is cut along a dash-dot section line D. Note that illustration of the third space wall 31 (see FIG. 3) placed over the third space wall 309 is omitted from FIG. 32. In FIG. 32, components identical to those illustrated in FIG. 23 are provided with the same reference numerals. Note that since

FIG. 32 illustrates a configuration identical to that of FIG. 23, except that the swing cladding tube T1 passes through the guide slot 108 of the swing connecting member 101, a description associated with the configuration in FIG. 32 is omitted.

Accordingly, in the waterproof structure with the second insertion type, despite the fact that the swing connecting member 101 for implementing the swing operation has no waterproof properties, the swing connecting member 101 may be able to simultaneously realize the flexible swing operation and the waterproof function in the place where the swing operation is performed. Further, even if the first pivoting shaft 102 repeatedly pivots and slides within the guide slot 108 by the swing operation repeatedly performed by the swing connecting member 101, the first wiring member E1 exhibits prolonged durability.

As described above, the guide slot 108 of the swing connecting member 101 may be given as an example of a “through hole of the swing connecting member”.

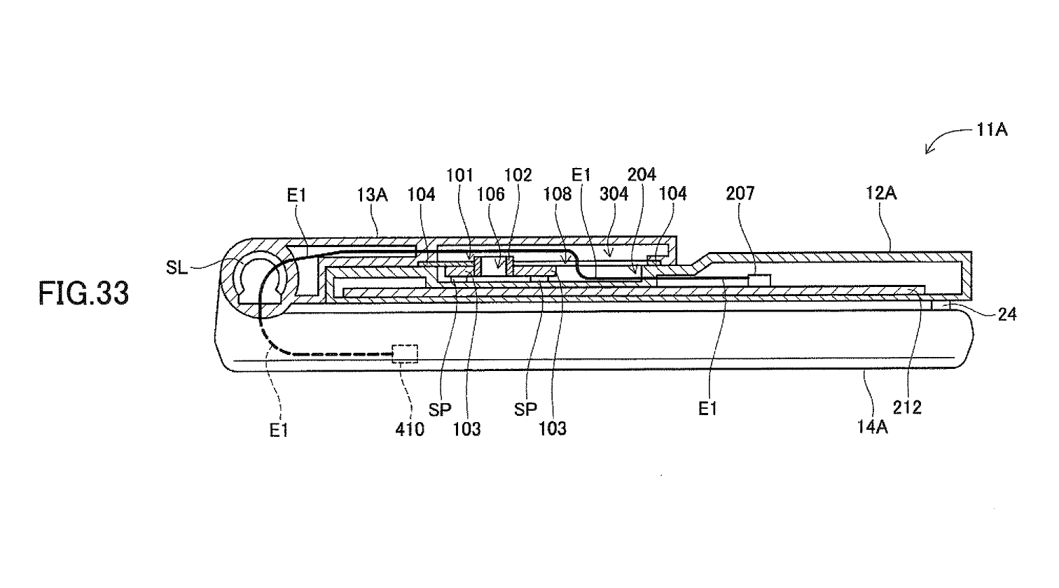

FIG. 33 is a simplified sectional view illustrating the mobile phone 11A according to the first embodiment in the folded state. The sectional view illustrated in FIG. 33 depicts a cross section of the mobile phone 11A according to the first embodiment viewing from a point D1 in FIG. 3 in a case where the mobile phone 11A according to the first embodiment in the folded state illustrated in FIG. 3 is cut along a dash-dot section line D. In FIG. 33, an external view of the third housing 14A is illustrated. In FIG. 33, components identical to those illustrated in FIG. 24 are provided with the same reference numerals. Note that since FIG. 33 illustrates a configuration identical to that of FIG. 24, except that the swing cladding tube T1 passes through the guide slot 108 of the swing connecting member 101, a description associated with the configuration in FIG. 33 is omitted.

5-3. Waterproof Structure with Third Insertion Type

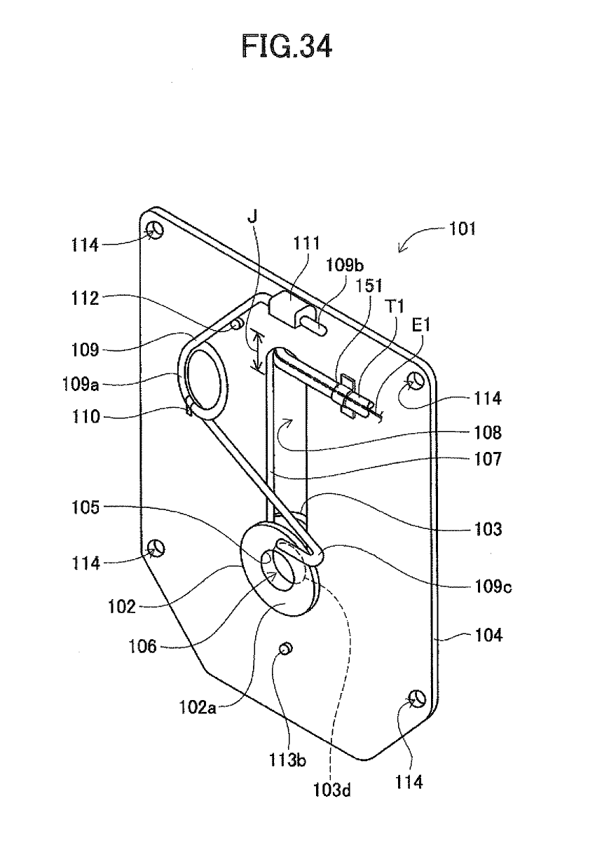

Next, a waterproof structure with a third insertion type is illustrated. FIG. 34 is a perspective view illustrating the swing connecting member 101 viewed from its rear surface. FIG. 34 is a view illustrating the swing connecting member 101 when the first housing 12A of the mobile phone 11A according to the first embodiment is in the basic position (see FIG. 4). In FIG. 34, components identical to those illustrated in FIG. 11 are provided with the same reference numerals. In the following description, illustration of the components in FIG. 34 identical to those of FIG. 11 provided with the same reference numerals is therefore omitted.

Specifically, since the waterproof structure with the third insertion type is similar to that with the first insertion type, the illustration of the waterproof structure with the third insertion type is omitted from the description. Further, a modification of the waterproof structure in which the pivoting cladding tube T2 passing through the pivoting hinge H (see FIG. 17) is similar to the waterproof structure with the first insertion type, illustration of such a modification of the waterproof structure is omitted from the description. In addition, a modification of the waterproof structure (see FIG. 24) associated with the electrical connection to the first wiring member E1 and the second wiring member E2 is similar to the waterproof structure with the first insertion type, illustration of such a modification of the waterproof structure associated with the electrical connection is omitted from the description.

As illustrated in FIG. 34, in swing connecting member 101, the swing cladding tube T1 passes through the guide slot 108 to which the first pivoting shaft 102 is pivotally and slidably attached. The swing cladding tube T1 passing through the guide slot 108 is fixed by a fixing member 151 within the impenetrable region J. A description given below is an example in which the swing cladding tube T1 passing through the guide slot 108 is fixed within the impenetrable region J.

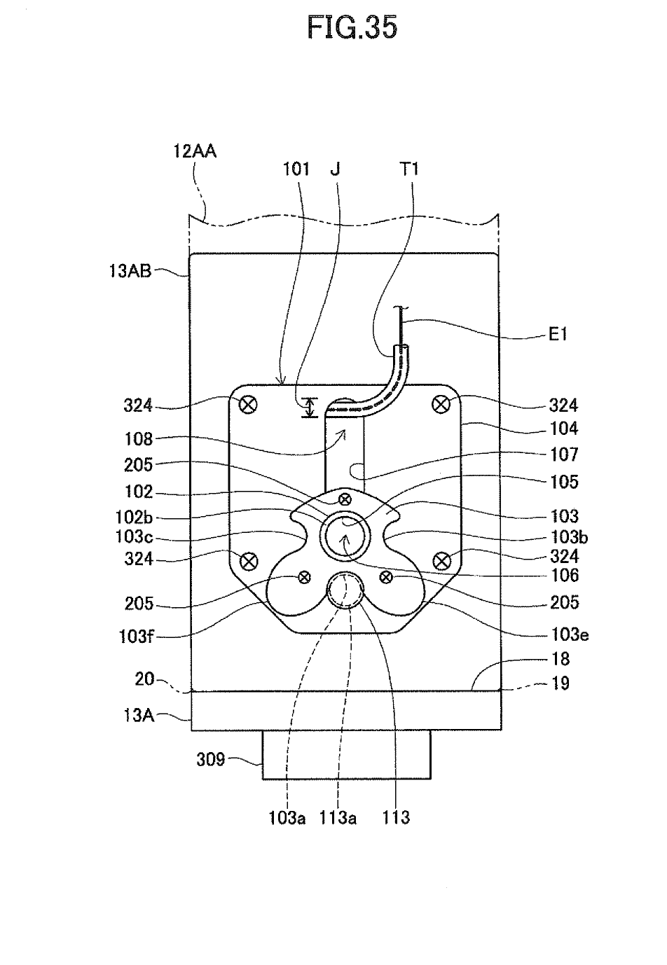

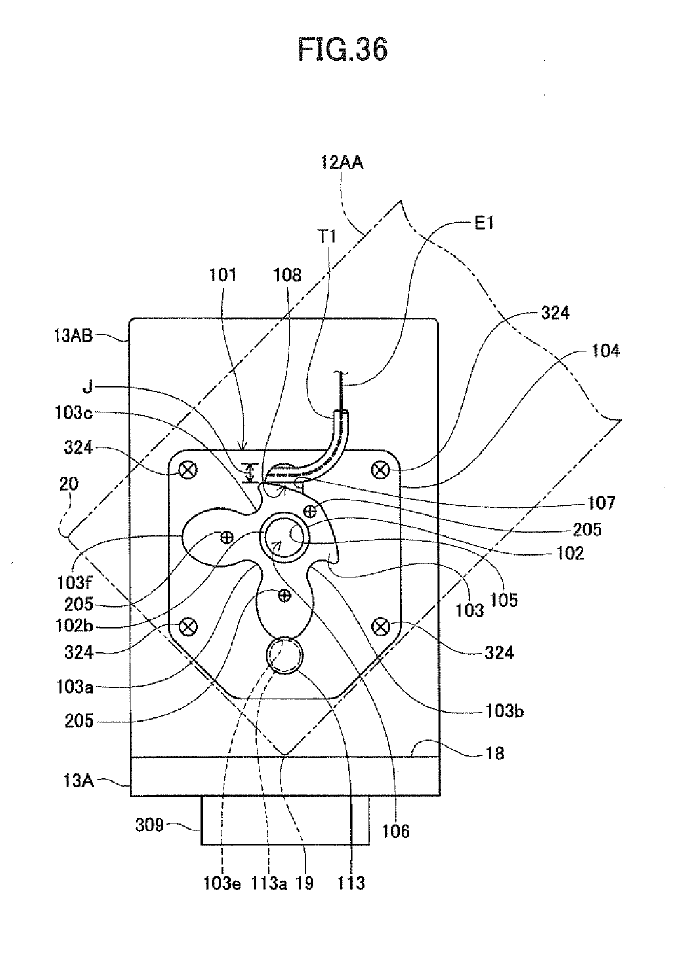

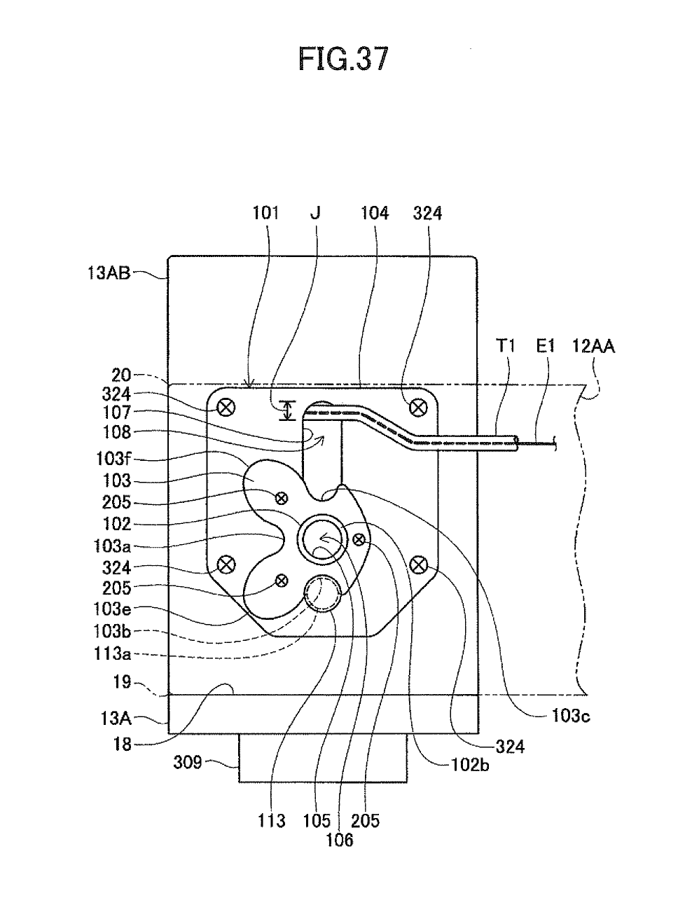

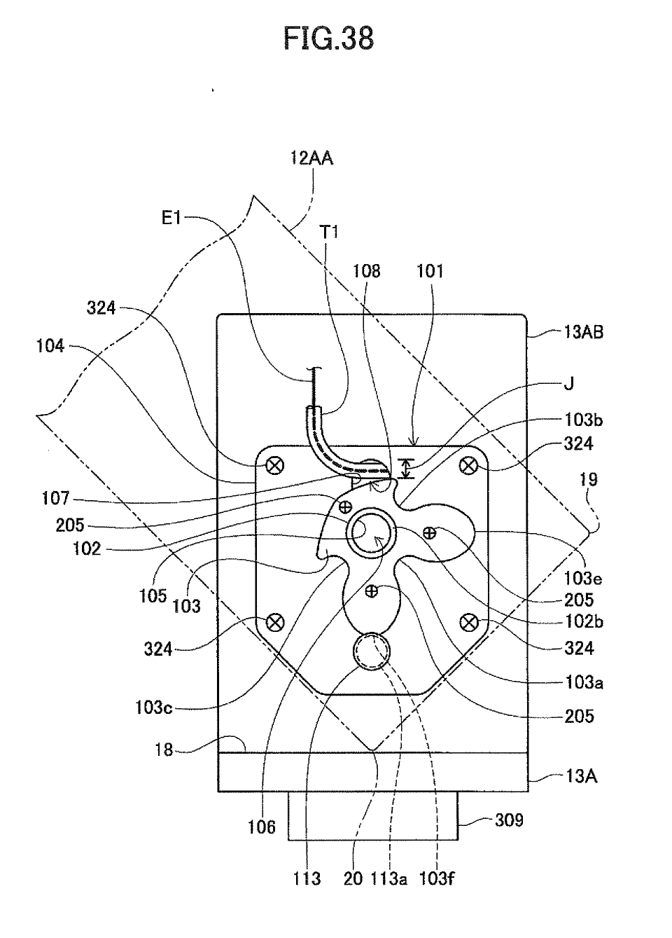

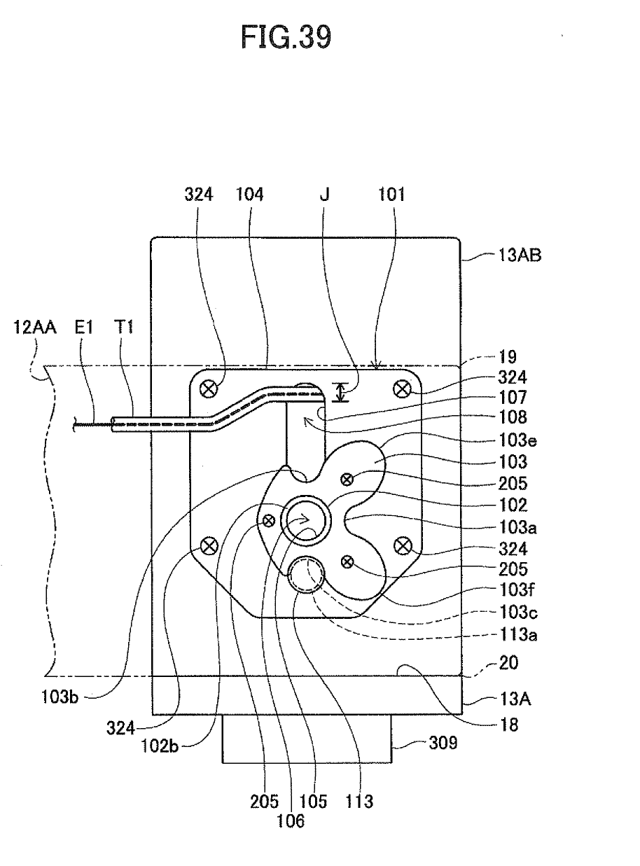

FIGS. 35 to 39 are front views each illustrating the swing connecting member 101 attached to the swing connecting side first housing 12AA and the swing connecting side second housing 13AB. FIG. 35 is a view illustrating the swing connecting member 101 when the first housing 12A of the mobile phone 11A according to the first embodiment is in the basic position (see FIG. 4). FIG. 36 is a view illustrating the swing connecting member 101 when the first housing 12A of the mobile phone 11A according to the first embodiment is in the right-hand side intermediate position (see FIG. 7). The right-hand side intermediate position of the first housing 12A illustrated in FIG. 36 indicates an intermediate position of the first housing 12A toward the right-hand side when the first housing 12A pivots by 45 degrees in a clockwise direction from its basic position. FIG. 37 is a view illustrating the swing connecting member 101 when the first housing 12A of the mobile phone 11A according to the first embodiment is in the right-hand side swing position (see FIG. 5). FIG. 38 is a view illustrating the swing connecting member 101 when the first housing 12A of the mobile phone 11A according to the first embodiment is in the left-hand side intermediate position (see FIG. 8). The left-hand side intermediate position of the first housing 12A illustrated in FIG. 38 indicates an intermediate position of the first housing 12A toward the left-hand side when the first housing 12A pivots by 45 degrees in a counterclockwise direction from its basic position. FIG. 39 is a view illustrating the swing connecting member 101 when the first housing 12A of the mobile phone 11A according to the first embodiment is in the left-hand side swing position (see FIG. 6).

In FIGS. 35 to 39, the swing connecting side first housing 12AA is represented by a phantom line. Note that illustration of the components of the swing connecting side first housing 12AA is omitted from FIGS. 35 to 39, except for the first corner 19 and the second corner 20. In FIGS. 35 to 39, components identical to those illustrated in FIGS. 27 to 31 are provided with the same reference numerals. In the following description, illustration of the components in FIGS. 35 to 39 identical to those of FIGS. 27 to 31 provided with the same reference numerals is therefore omitted.

When the first housing 12A is in the basic position (see FIG. 4), the first depression 103a of the plate cam 103 is pressed against the cylindrical contact surface 113a of the pivoting contactor 113 as illustrated in FIG. 35. As described above, the swing cladding tube T1 passing through the guide slot 108 is fixed to the impenetrable region J by the fixing member 151 (see FIG. 34). Hence, in this state where the first depression 103a of the plate cam 103 is pressed against the cylindrical contact surface 113a of the pivoting contactor 113, the plate cam 103 moves away from the swing cladding tube T1 passing through the guide slot 108.

When the first housing 12A is in the right-hand side intermediate position being pivoted by 45 degrees in a clockwise direction from its basic position (see FIG. 7), the first apical end 103e of the plate cam 103 is pressed against the cylindrical contact surface 113a of the pivoting contactor 113 as illustrated in FIG. 36. In this state where the first apical end 103e of the plate cam 103 is pressed against the cylindrical contact surface 113a of the pivoting contactor 113, a largest possible area of the guide slot 108 is covered with the plate cam 103. Note that the swing cladding tube T1 passing through the guide slot 108 is fixed to the impenetrable region J by the fixing member 151 (see FIG. 34). Hence, in this state where the first apical end 103e of the plate cam 103 is pressed against the cylindrical contact surface 113a of the pivoting contactor 113, the plate cam 103 approaches closest to the swing cladding tube T1. However, the swing cladding tube T1 will not be compressed by the plate cam 103 or the guide slot wall 107.

When the first housing 12A is in the right-hand side swing position (see FIG. 5), the second depression 103b of the plate cam 103 is pressed against the cylindrical contact surface 113a of the pivoting contactor 113 as illustrated in FIG. 37. As described above, the swing cladding tube T1 passing through the guide slot 108 is fixed to the impenetrable region J by the fixing member 151 (see FIG. 34). Hence, in this state where the second depression 103b of the plate cam 103 is pressed against the cylindrical contact surface 113a of the pivoting contactor 113, the plate cam 103 moves away from the swing cladding tube T1 passing through the guide slot 108.

When the first housing 12A is in the left-hand side intermediate position being pivoted by 45 degrees in a counterclockwise direction from its basic position (see FIG. 8), the second apical end 103f of the plate cam 103 is pressed against the cylindrical contact surface 113a of the pivoting contactor 113 as illustrated in FIG. 38. In this state where the second apical end 103f of the plate cam 103 is pressed against the cylindrical contact surface 113a of the pivoting contactor 113, a largest possible area of the guide slot 108 is covered with the plate cam 103 in a manner similar to a case where the first housing 12A is in the right-hand side intermediate position. Note that the swing cladding tube T1 passing through the guide slot 108 is fixed to the impenetrable region J of the guide slot 108 by the fixing member 151 (see FIG. 34). Hence, in this state where the second apical end 103f of the plate cam 103 is pressed against the cylindrical contact surface 113a of the pivoting contactor 113, the plate cam 103 approaches closest to the swing cladding tube T1. However, the swing cladding tube T1 will not be compressed by the plate cam 103 or the guide slot wall 107.

When the first housing 12A is in the left-hand side swing position (see FIG. 6), the third depression 103c of the plate cam 103 is pressed against the cylindrical contact surface 113a of the pivoting contactor 113 as illustrated in FIG. 39. As described above, the swing cladding tube T1 passing through the guide slot 108 is fixed to the impenetrable region J by the fixing member 151 (see FIG. 34). Hence, in this state where the third depression 103c of the plate cam 103 is pressed against the cylindrical contact surface 113a of the pivoting contactor 113, the plate cam 103 moves away from the swing cladding tube T1 passing through the guide slot 108.

Specifically, when the first housing 12A is transitioned from the basic position to the right-hand side swing position, or when the first housing 12A is transitioned from the right-hand side swing position to the basic position, the plate cam 103 reciprocates over the guide slot 108. Likewise, when the first housing 12A is transitioned from the basic position to the left-hand side swing position, or when the first housing 12A is transitioned from the left-hand side swing position to the basic position, the plate cam 103 reciprocates over the guide slot 108. Note that when the plate cam 103 reciprocates over the guide slot 108, the swing cladding tube T1 passing through the guide slot 108 is fixed to the impenetrable region J of the guide slot 108 by the fixing member 151 (see FIG. 34) regardless of a largest possible area of the guide slot 108 being covered with the plate cam 103. Hence, the impenetrable region J has a region to an extent in which the swing cladding tube T1 is not be compressed by the plate cam 103 or the guide slot wall 107. Accordingly, the swing cladding tube T1 will not interfere with the reciprocation of the plate cam 103 when the plate cam 103 reciprocates over the guide slot 108. This may maintain flexibility of the swing operation performed by the swing connecting member 101. Further, when the swing operation is performed by the swing connecting member 101, the swing cladding tube T1 will not be damaged by the plate cam 103 or the guide slot wall 107. Hence, the first wiring member E1 enveloped by the swing cladding tube T1 will be protected. In addition, the first wiring member E1 protected with the swing cladding tube T1 is fixed by the fixing member 151 via the swing cladding tube T1 (see FIG. 34). Hence, even though the swing operation is repeatedly performed by the swing connecting member 101, the first wiring member E1 will not be twisted.

Accordingly, in the waterproof structure with the third insertion type, despite the fact that the swing connecting member 101 for implementing the swing operation has no waterproof properties, the swing connecting member 101 may be able to simultaneously realize the flexible swing operation and the waterproof function in the place where the swing operation is performed. Further, even if the first pivoting shaft 102 repeatedly pivots and slides within the guide slot 108 by the swing operation repeatedly performed by the swing connecting member 101, the first wiring member E1 exhibits prolonged durability.

As described above, an internal impenetrable region J of the guide slot 108 of the swing connecting member 101 may be given as an example of a “through hole of the swing connecting member”.

5-4. Waterproof Structure with Fourth Insertion Type

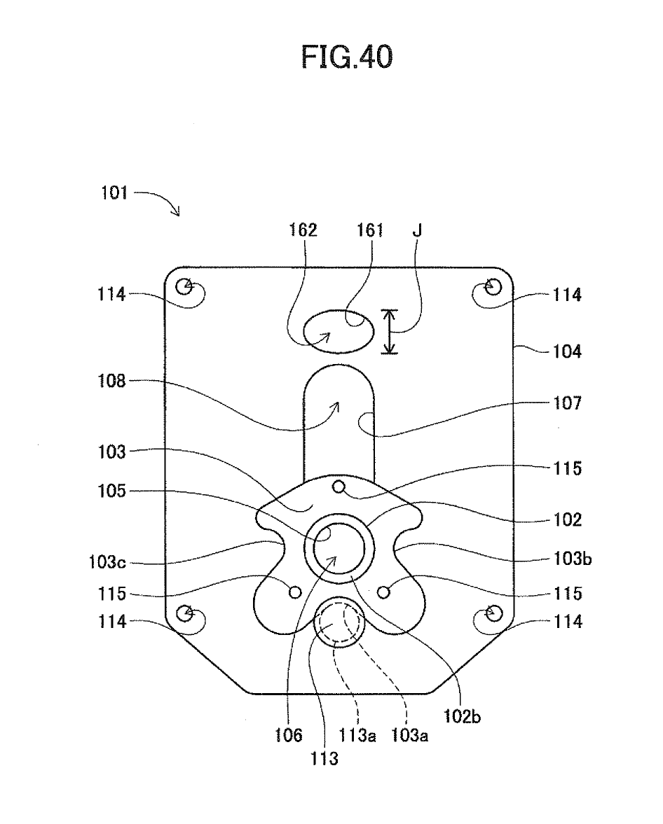

Next, a waterproof structure with a fourth insertion type is illustrated. FIG. 40 is a perspective view illustrating the swing connecting member 101 viewed from its front surface. FIG. 40 is a view illustrating the swing connecting member 101 when the first housing 12A of the mobile phone 11A according to the first embodiment is in the basic position (see FIG. 4). In FIG. 40, components identical to those illustrated in FIG. 10 are provided with the same reference numerals. In the following description, illustration of the components in FIG. 40 identical to those of FIG. 10 provided with the same reference numerals is therefore omitted.

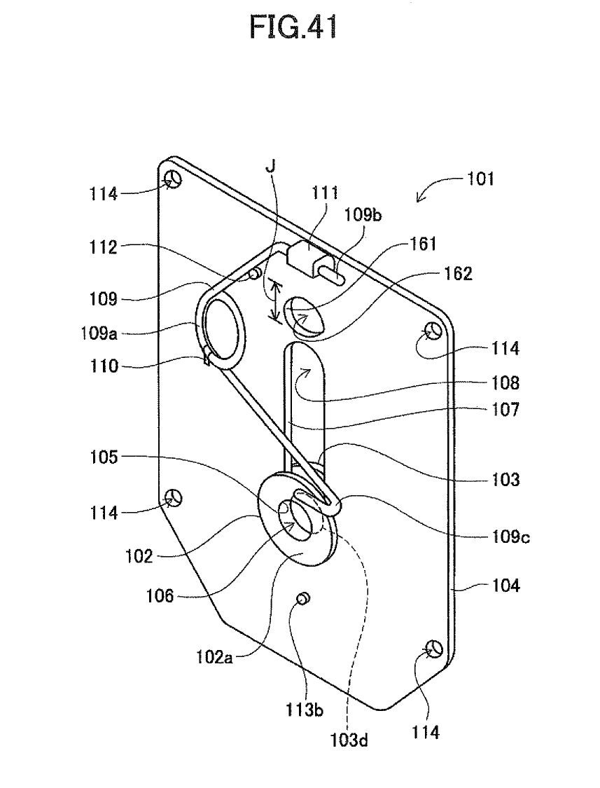

FIG. 41 is a perspective view illustrating the swing connecting member 101 viewed from its rear surface. FIG. 41 is a view illustrating the swing connecting member 101 when the first housing 12A of the mobile phone 11A according to the first embodiment is in the basic position (see FIG. 4). In FIG. 41, components identical to those illustrated in FIG. 11 are provided with the same reference numerals. In the following description, illustration of the components in FIG. 41 identical to those of FIG. 11 provided with the same reference numerals is therefore omitted.

Specifically, since the waterproof structure with the fourth insertion type is similar to that with the first insertion type, the illustration of the waterproof structure with the fourth insertion type is omitted from the description. Further, a modification of the waterproof structure in which the pivoting cladding tube T2 passing through the pivoting hinge H (see FIG. 17) is similar to the waterproof structure with the first insertion type, illustration of such a modification of the waterproof structure is omitted from the description. In addition, a modification of the waterproof structure (see FIG. 24) associated with the electrical connection to the first wiring member E1 and the second wiring member E2 is similar to the waterproof structure with the first insertion type, illustration of such a modification of the waterproof structure associated with the electrical connection is omitted from the description.

As illustrated in FIGS. 40 and 41, the swing connecting member 101 includes a dedicated hole 162 formed by causing a dedicated hole wall 161 to penetrate the clamping plate 104 in the impenetrable region J. The dedicated hole 162 resides within the impenetrable region J of the swing connecting member 101 and is formed in a region situated above the guide slot 108 illustrated in FIGS. 10 and 11. Note that the dedicated hole 162 is of course a separate hole differing from the guide slot 108. Hence, a longitudinal direction of the guide slot 108 illustrated in FIG. 40 or 41 is shorter than the longitudinal direction of the guide slot 108 illustrated in FIG. 10 or 11.

Note that even when the first housing 12A is in any one of the positions illustrated in FIGS. 4 to 8, the dedicated hole 162 of the clamping plate 104 is located above the first space 204 (e.g., see FIG. 15).

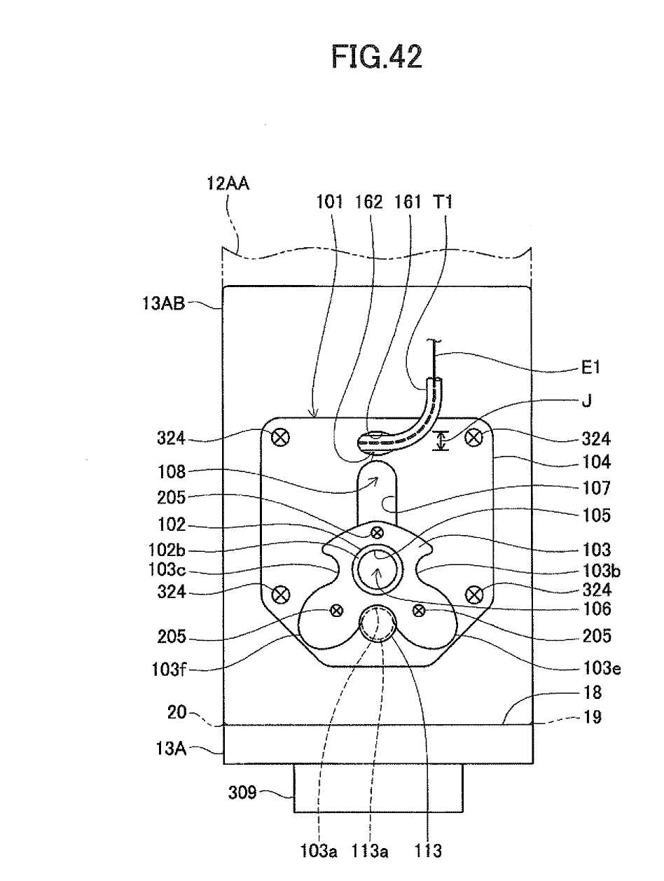

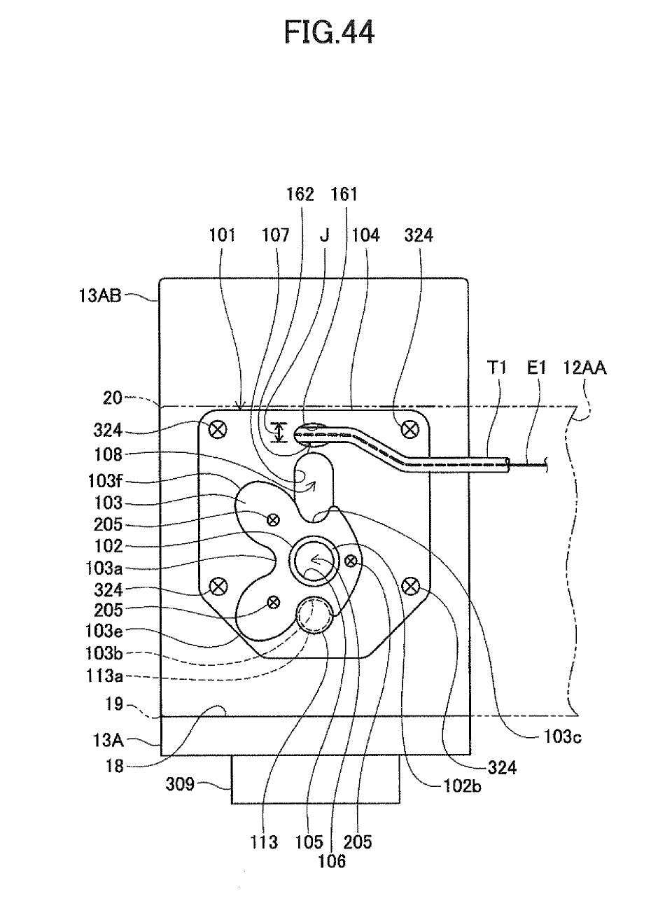

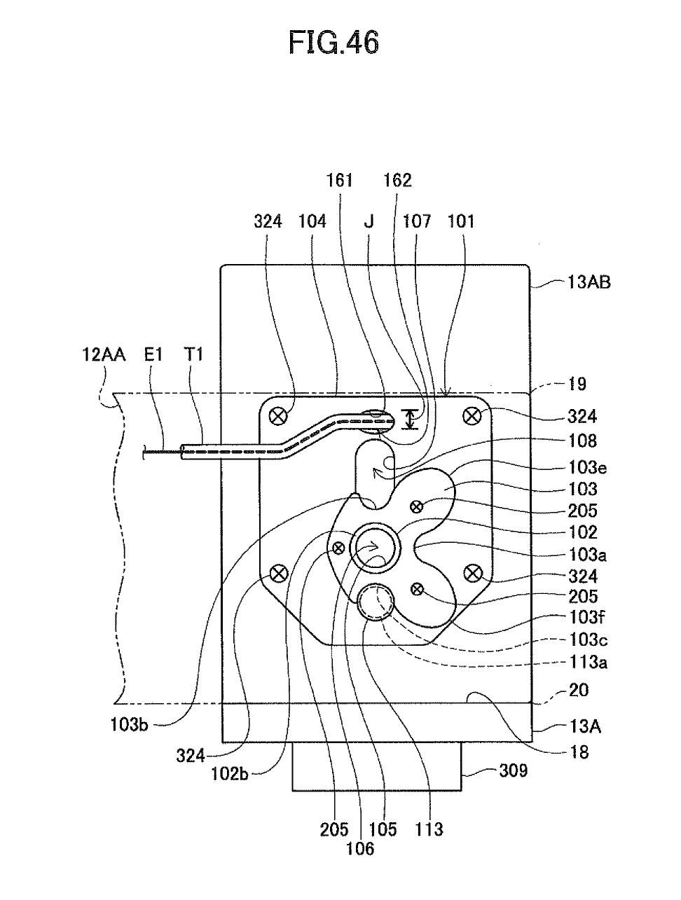

FIGS. 42 to 46 are front views each illustrating the swing connecting member 101 attached to the swing connecting side first housing 12AA and the swing connecting side second housing 13AB. FIG. 42 is a view illustrating the swing connecting member 101 when the first housing 12A of the mobile phone 11A according to the first embodiment is in the basic position (see FIG. 4). FIG. 43 is a view illustrating the swing connecting member 101 when the first housing 12A of the mobile phone 11A according to the first embodiment is in the right-hand side intermediate position (see FIG. 7). The right-hand side intermediate position of the first housing 12A illustrated in FIG. 43 indicates an intermediate position of the first housing 12A toward the right-hand side when the first housing 12A pivots by 45 degrees in a clockwise direction from its basic position. FIG. 44 is a view illustrating the swing connecting member 101 when the first housing 12A of the mobile phone 11A according to the first embodiment is in the right-hand side swing position (see FIG. 5). FIG. 45 is a view illustrating the swing connecting member 101 when the first housing 12A of the mobile phone 11A according to the first embodiment is in the left-hand side intermediate position (see FIG. 8). The left-hand side intermediate position of the first housing 12A illustrated in FIG. 45 indicates an intermediate position of the first housing 12A toward the left-hand side when the first housing 12A pivots by 45 degrees in a counterclockwise direction from its basic position. FIG. 46 is a view illustrating the swing connecting member 101 when the first housing 12A of the mobile phone 11A according to the first embodiment is in the left-hand side swing position (see FIG. 6).

In FIGS. 42 to 46, the swing connecting side first housing 12AA is represented by a phantom line. Note that illustration of the components of the swing connecting side first housing 12AA is omitted from FIGS. 42 to 46, except for the first corner 19 and the second corner 20. In FIGS. 42 to 46, components identical to those illustrated in FIGS. 27 to 31 are provided with the same reference numerals. In the following description, illustration of the components in FIGS. 42 to 46 identical to those of FIGS. 27 to 31 provided with the same reference numerals is therefore omitted.

As illustrated in FIGS. 42 to 46, in the swing connecting member 101, the swing cladding tube T passes through the dedicated hole 162 formed in the clamping plate 104. Note that the dedicated hole 162 has a size that allows the swing cladding tube T1 to move within the dedicated hole 162 when the swing cladding tube T1 passes through the dedicated hole 162. As described earlier, the dedicated hole 162 is formed in the impenetrable region J of the swing connecting member 101. The impenetrable region J is a region outside a movable operating range of the plate cam 103. Further, the impenetrable region J includes a region outside a movable operating range of the first pivoting shaft 102 or a region outside a movable operating range of the resilient member 109. A description below is an example in which the swing cladding tube T1 passes through the dedicated hole 162 formed in the impenetrable region J of the swing connecting member 101.

When the first housing 12A is in the basic position (see FIG. 4), the first depression 103a of the plate cam 103 is pressed against the cylindrical contact surface 113a of the pivoting contactor 113 as illustrated in FIG. 42. As described earlier, the impenetrable region J includes the dedicated hole 162 that is a separate hole differing from the guide slot 108. Hence, in this state where the first depression 103a of the plate cam 103 is pressed against the cylindrical contact surface 113a of the pivoting contactor 113, the plate cam 103 moves away from the swing cladding tube T1 passing through the dedicated hole 162.

When the first housing 12A is in the right-hand side intermediate position being pivoted by 45 degrees in a clockwise direction from its basic position (see FIG. 7), the first apical end 103e of the plate cam 103 is pressed against the cylindrical contact surface 113a of the pivoting contactor 113 as illustrated in FIG. 43. In the state where the first apical end 103e of the plate cam 103 is pressed against the cylindrical contact surface 113a of the pivoting contactor 113, the guide slot 108 is covered with the plate cam 103. Note that the impenetrable region J includes the dedicated hole 162 that is a separate hole differing from the guide slot 108. Hence, in this state where the first apical end 103e of the plate cam 103 is pressed against the cylindrical contact surface 113a of the pivoting contactor 113, the swing cladding tube T1 passing through the dedicated hole 162 will not be compressed by the plate cam 103.

When the first housing 12A is in the right-hand side swing position (see FIG. 5), the second depression 103b of the plate cam 103 is pressed against the cylindrical contact surface 113a of the pivoting contactor 113 as illustrated in FIG. 44. As described earlier, the impenetrable region J includes the dedicated hole 162 that is a separate hole differing from the guide slot 108. Hence, in this state where the second depression 103b of the plate cam 103 is pressed against the cylindrical contact surface 113a of the pivoting contactor 113, the plate cam 103 moves away from the swing cladding tube T1 passing through the dedicated hole 162.

When the first housing 12A is in the left-hand side intermediate position being pivoted by 45 degrees in a counterclockwise direction from its basic position (see FIG. 8), the second apical end 103f of the plate cam 103 is pressed against the cylindrical contact surface 113a of the pivoting contactor 113 as illustrated in FIG. 45. In this state where the second apical end 103f of the plate cam 103 is pressed against the cylindrical contact surface 113a of the pivoting contactor 113, a largest possible area of the guide slot 108 is covered with the plate cam 103 in a manner similar to a case where the first housing 12A is in the right-hand side intermediate position. Note that the impenetrable region J includes the dedicated hole 162 that is a separate hole differing from the guide slot 108. Hence, in this state where the second apical end 103f of the plate cam 103 is pressed against the cylindrical contact surface 113a of the pivoting contactor 113, the swing cladding tube T1 passing through the dedicated hole 162 will not be compressed by the plate cam 103.

When the first housing 12A is in the left-hand side swing position (see FIG. 6), the third depression 103c of the plate cam 103 is pressed against the cylindrical contact surface 113a of the pivoting contactor 113 as illustrated in FIG. 46. As described earlier, the impenetrable region J includes the dedicated hole 162 that is a separate hole differing from the guide slot 108. Hence, in this state where the third depression 103c of the plate cam 103 is pressed against the cylindrical contact surface 113a of the pivoting contactor 113, the plate cam 103 moves away from the swing cladding tube T1 passing through the dedicated hole 162.

Specifically, when the first housing 12A is transitioned from the basic position to the right-hand side swing position, or when the first housing 12A is transitioned from the right-hand side swing position to the basic position, the plate cam 103 reciprocates over the guide slot 108. Likewise, when the first housing 12A is transitioned from the basic position to the left-hand side swing position, or when the first housing 12A is transitioned from the left-hand side swing position to the basic position, the plate cam 103 reciprocates over the guide slot 108. Note that when the plate cam 103 reciprocates over the guide slot 108, the swing cladding tube T1 passing through the dedicated hole 162 resides in the impenetrable region J regardless of the guide slot 108 being covered with the plate cam 103. Since the impenetrable region J is a region outside a movable operating range of the plate cam 103, the swing cladding tube T1 will not interfere with the reciprocation of the plate cam 103. Accordingly, the swing cladding tube T1 will not interfere with the reciprocation of the plate cam 103 when the plate cam 103 reciprocates over the guide slot 108. This may maintain flexibility of the swing operation performed by the swing connecting member 101. Further, when the swing operation is performed by the swing connecting member 101, the swing cladding tube T1 will not be damaged by the plate cam 103. Hence, the first wiring member E1 enveloped by the swing cladding tube T1 will be protected.

Accordingly, in the waterproof structure with the fourth insertion type, despite the fact that the swing connecting member 101 for implementing the swing operation has no waterproof properties, the swing connecting member 101 may be able to simultaneously realize the flexible swing operation and the waterproof function in the place where the swing operation is performed. Further, even if the first pivoting shaft 102 repeatedly pivots and slides within the guide slot 108 by the swing operation repeatedly performed by the swing connecting member 101, the first wiring member E1 exhibits prolonged durability.

As described above, the dedicated hole 162 of the swing connecting member 101 may be given as an example of a “through hole of the swing connecting member”.

Note that the first housing 12A is the first housing 12A is transitioned from the basic position either to the right-hand side swing position or the left-hand side swing position. Accordingly, in terms of reducing the torsion load imposed on the swing cladding tube T1 or the first wiring member E1 to the greatest extent, it is preferable that the dedicated hole 162, through which the swing cladding tube T1 and the first wiring member E1 are passed, be situated at a position corresponding to a bilateral symmetric axis (i.e., a central line) of the first housing 12A. Technically speaking, if the torsion load imposed on the swing cladding tube T1 or the first wiring member E1 passing through the dedicated hole 162 is negligibly minimal, the dedicated hole 162 may be situated at a position deviated from the bilateral symmetric axis (i.e., the central line) of the first housing 12A. Note that even when the first housing 12A is in any one of the positions illustrated in FIGS. 4 to 8, the dedicated hole 162 situated at a position deviated from the bilateral symmetric axis (i.e., the central line) of the first housing 12A is located above the first space 204 (e.g., see FIG. 15).

### 6. Application to Mobile Phone According to Second Embodiment

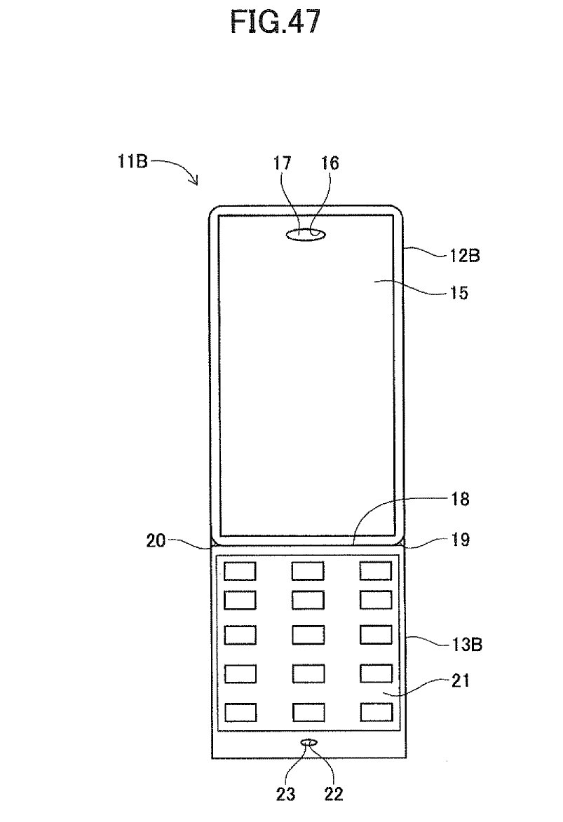

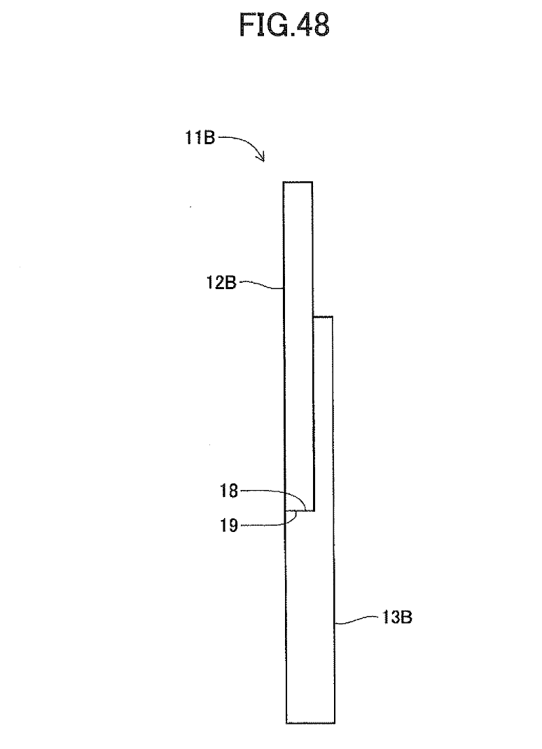

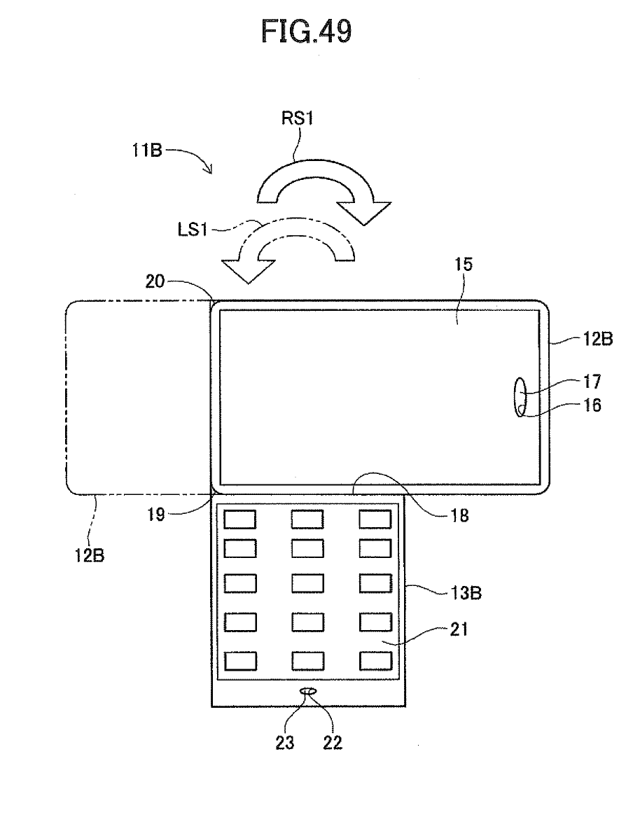

Below is given of a description of an example of a mobile phone to which the above-described waterproof structures or insertion types of the mobile phone 11A according to the first embodiment are applicable. FIG. 47 is a front view illustrating a mobile phone 11B serving as a mobile terminal according to a second embodiment. FIG. 48 is a side view illustrating the mobile phone 11B according to the second embodiment. FIG. 49 is a front view illustrating a right-hand side swing position or a left-hand side swing position of a first housing 12B of the mobile phone 11B according to the second embodiment. In FIGS. 47 to 49, components equivalent to those of the mobile phone 11A according to the first embodiment are provided with the same reference numerals. In the following description, illustration of the components identical to those provided with the same reference numerals is omitted.

Note that the mobile phone 11B according to the second embodiment includes the first housing 12B, and a second housing 13B; however, it does not include a housing equivalent to the third housing 14A of the mobile phone 11A according to the aforementioned first embodiment. Hence, the mobile phone 11B according to the second embodiment does not include a waterproof structure of the mobile phone 11A according to the above first embodiment in the place where the pivoting operation is performed via the second pivoting shaft SL (see FIGS. 21 and 22).

As illustrated in FIGS. 47 to 49, the mobile phone 11B according to the second embodiment includes a sliding surface 18 at an upper part of the second housing 13B. The second housing 13B includes a key pad 21, a mouthpiece 22, and a microphone 23.

The mobile phone 11B according to the second embodiment performs swing operations illustrated in FIG. 49. When the first housing 12B pivots in a direction indicated by an arrow RS1, the first housing 12B is directed to the right-hand side swing position. When the first housing 12B pivots in a direction indicated by an arrow LS1, the first housing 12B is directed to the left-hand side swing position. The swing operation illustrated in FIG. 49 are equivalent to the swing operation of the mobile phone 11A according to the aforementioned first embodiment. Accordingly, the respective waterproof structures or insertion types of the mobile phone 11A according to the first embodiment may be applicable to the mobile phone 11B according to the second embodiment.

### 7. Application to Mobile Phone According to Third Embodiment

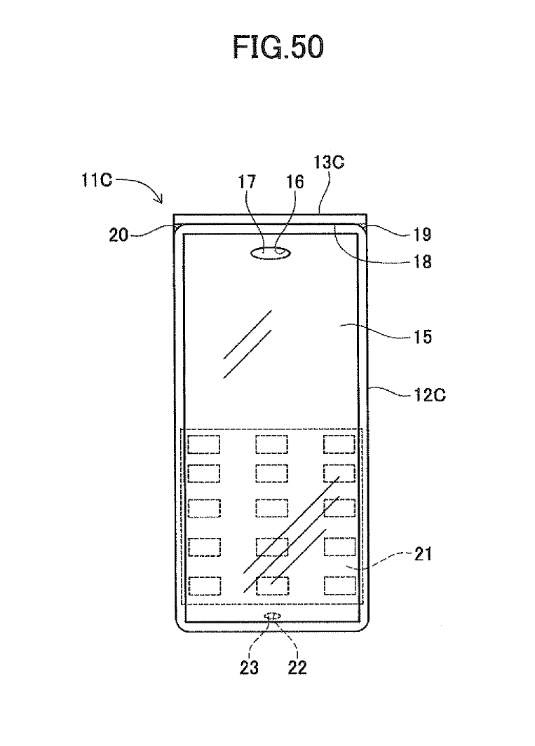

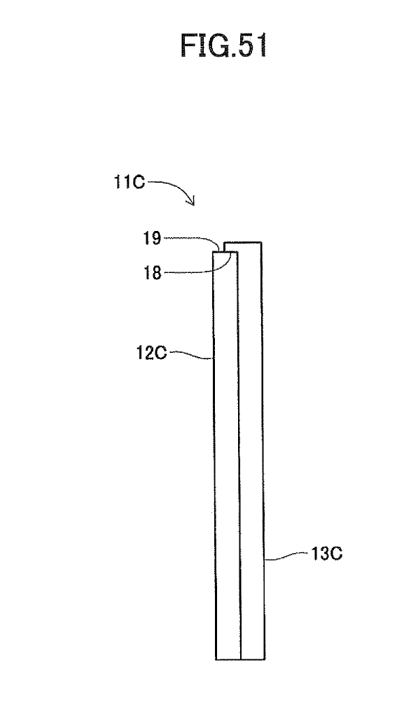

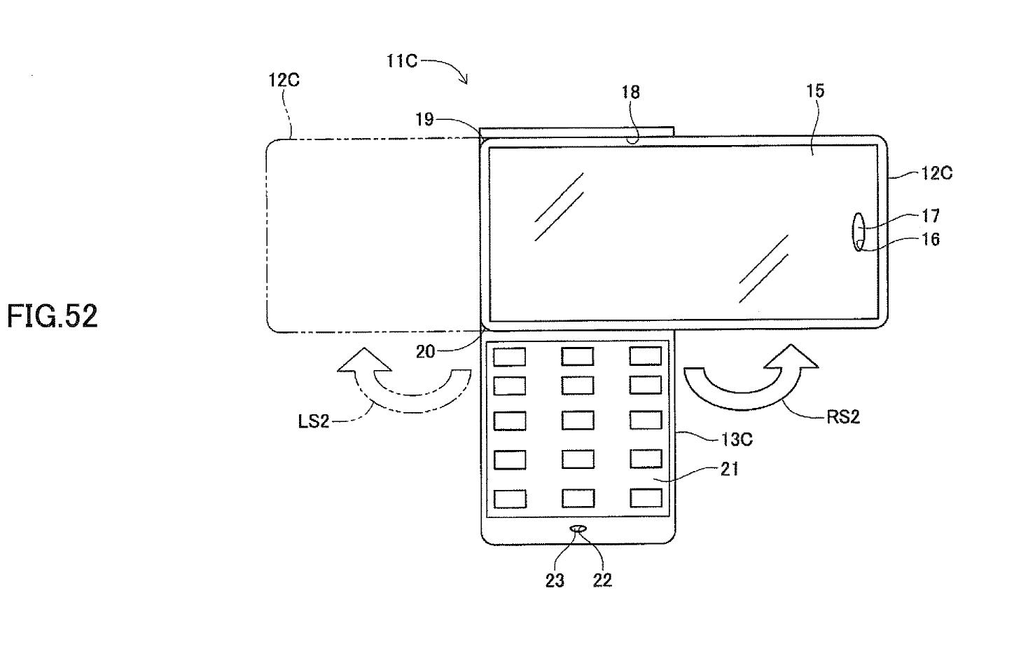

Below is given of a description of an example of a mobile phone to which the above-described waterproof structures or insertion types of the mobile phone 11A according to the first embodiment are applicable. FIG. 50 is a front view illustrating a mobile phone 11C serving as a mobile terminal according to a third embodiment. FIG. 51 is a side view illustrating the mobile phone 11C according to the third embodiment. FIG. 52 is a front view illustrating a right-hand side swing position or a left-hand side swing position of a first housing 12C of the mobile phone 11C according to the third embodiment. In FIGS. 50 to 52, components equivalent to those of the mobile phone 11A according to the first embodiment are provided with the same reference numerals. In the following description, illustration of the components identical to those provided with the same reference numerals is omitted.

Note that the mobile phone 11C according to the third embodiment includes the first housing 12C, and a second housing 13C; however, it does not include a housing equivalent to the third housing 14A of the mobile phone 11A according to the aforementioned first embodiment. Hence, the mobile phone 11C according to the third embodiment does not include a waterproof structure of the mobile phone 11A according to the above first embodiment in the place where the pivoting operation is performed via the second pivoting shaft SL (see FIGS. 21 and 22).

As illustrated in FIGS. 50 and 51, in the mobile phone 11C according to the third embodiment, the first housing 12C is covered with the second housing 13C when the first housing 12C is in the basic position. The mobile phone 11C according to the third embodiment includes the first corner 19 and the second corner 20 formed in an upper part of the first housing 12C. The mobile phone 11C according to the third embodiment includes a sliding surface 18 at an upper part of the second housing 13C. Accordingly, the first corner 19 and the second corner 20 of the first housing 12C are located at positions lower than the sliding surface 18. The second housing 13C includes a key pad 21, a mouthpiece 22, and a microphone 23.

The mobile phone 11C according to the third embodiment performs swing operation illustrated in FIG. 52. When the first housing 12C pivots in a direction indicated by an arrow RS2, the first housing 12C is directed to the right-hand side swing position. When the first housing 12C pivots in a direction indicated by an arrow LS2, the first housing 12C is directed to the left-hand side swing position. In the mobile phone 11C according to the third embodiment, the first corner 19 and the second corner 20 are situated below the sliding surface 18. Hence, the swing operations illustrated in FIG. 52 are performed in directions opposite to the directions of the swing operation of the mobile phone 11A according to the aforementioned first embodiment. The swing operations illustrated in FIG. 52 are, of course, equivalent to the swing operation of the mobile phone 11A according to the aforementioned first embodiment. Accordingly, the respective waterproof structures or insertion types of the mobile phone 11A according to the first embodiment may be applicable to the mobile phone 11C according to the third embodiment.

### 8. Application to Mobile Phone According to Fourth Embodiment

### 8-1. Swing Operation Performed by Mobile Phone According to Fourth Embodiment

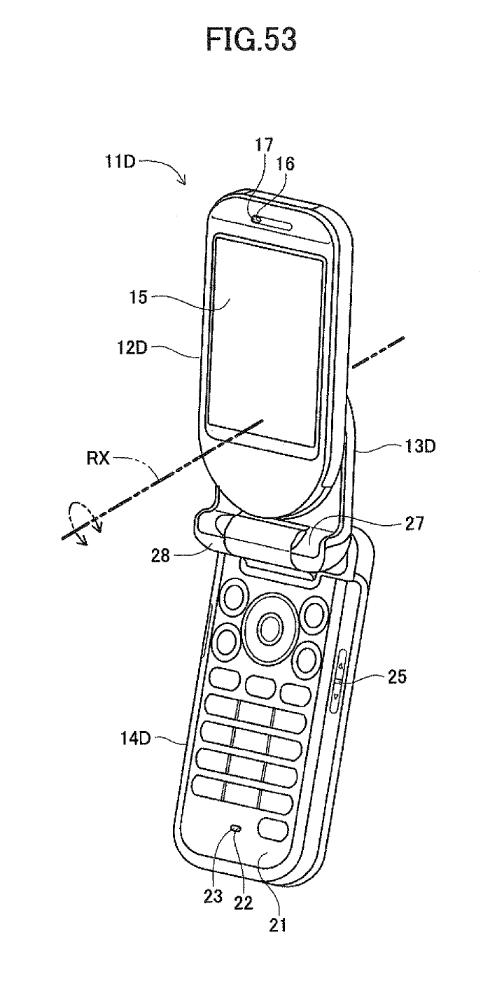

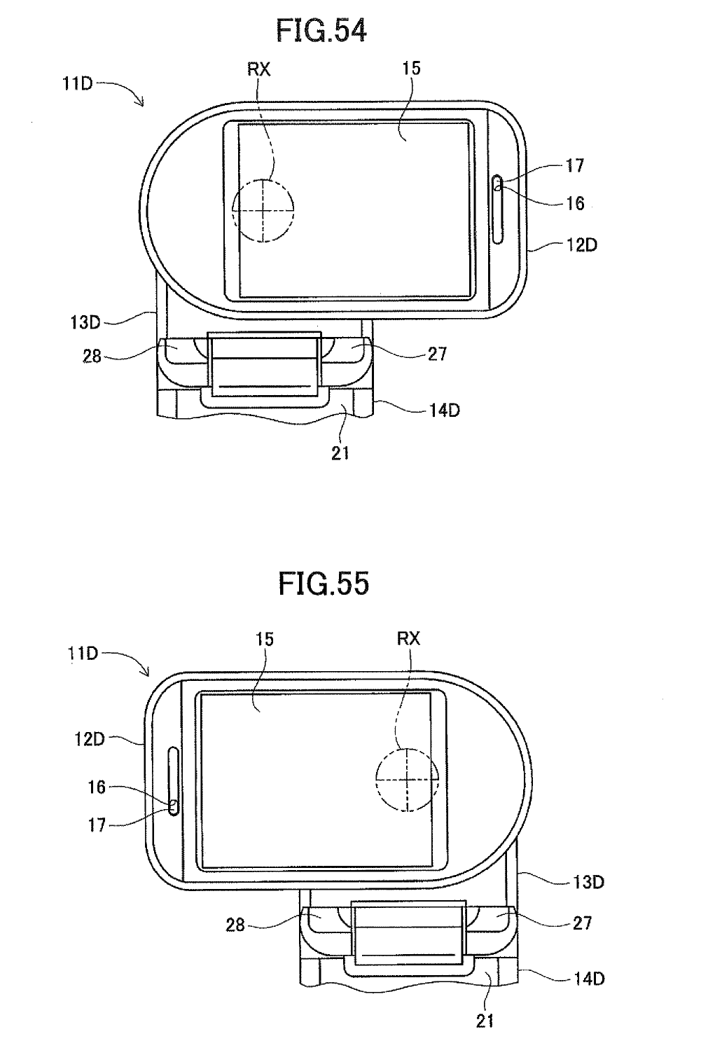

Below is given of a description of an example of a mobile phone to which the above-described waterproof structures of the mobile phone 11A according to the first embodiment are applicable. FIG. 53 is an external perspective view illustrating a mobile phone 11D serving as a mobile terminal according to a fourth embodiment. The mobile phone 11D according to the fourth embodiment includes a first housing 12D, a second housing 13D, and a third housing 14D. FIG. 53 illustrates a basic position of the first housing 12D of the mobile phone 11D according to the fourth embodiment. FIG. 54 is a front view illustrating a right-hand side swing position of the first housing 12D of the mobile phone 11D according to the fourth embodiment. FIG. 55 is a front view illustrating a left-hand side swing position of the first housing 12D of the mobile phone 11D according to the fourth embodiment. In FIGS. 53 to 55, components equivalent to those of the mobile phone 11A according to the first embodiment are provided with the same reference numerals. In the following description, illustration of the components identical to those provided with the same reference numerals is omitted.

Hence, the mobile phone 11D according to the fourth embodiment includes a waterproof structure similar to that of the mobile phone 11A according to the above first embodiment in the place where the pivoting operation is performed via the second pivoting shaft SL. Accordingly, illustration of the waterproof structure in the place where the mobile phone 11D according to the fourth embodiment has a flexible pivoting operation connecting relationship between the second housing 13D and the third housing 14D is omitted from the description. Further, a modification of the waterproof structure in which the pivoting cladding tube T2 passing through the pivoting hinge H (see FIG. 17) is similar to the waterproof structure with the first insertion type, illustration of such a modification of the waterproof structure is omitted from the description. In addition, a modification of the waterproof structure (see FIG. 24) associated with the electrical connection to the first wiring member E1 and the second wiring member E2 is similar to the waterproof structure of the mobile phone 11A according to the aforementioned first embodiment. Thus, illustration of such a modification of the waterproof structure associated with the electrical connection is omitted from the description.

As illustrated in FIGS. 53 to 55, in the swing operations of the mobile phone 11D according to the fourth embodiment, the first housing 12D pivots on the swing axis RX from 0 degrees to 90 degrees in the clockwise direction or the counterclockwise direction. Note that when the first housing 12D pivots, the swing axis RX and the first housing 12D will not be moved upward or downward.

### 8-2. Swing Connecting Member of Mobile Phone According to Fourth Embodiment

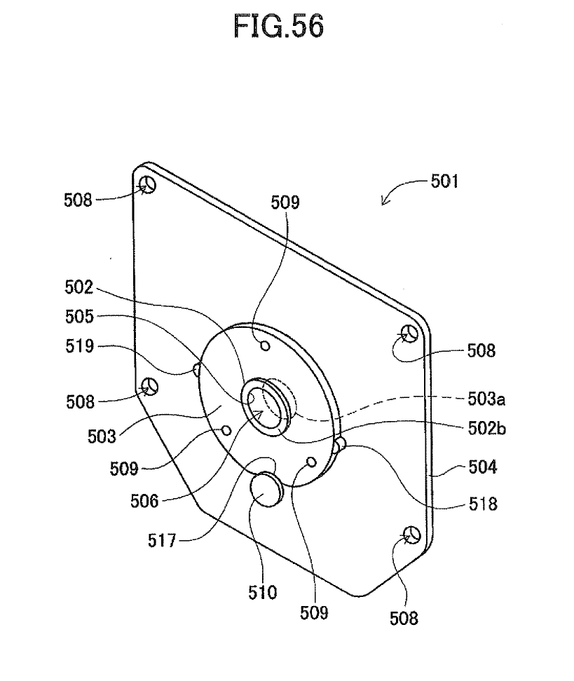

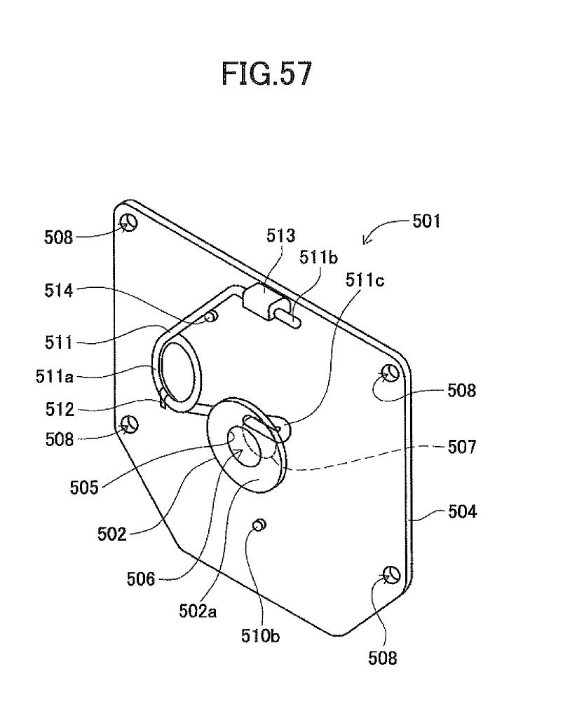

FIGS. 56 and 57 are views each illustrating a swing connecting member 501 for implementing a swing operation of the mobile phone 11D according to the fourth embodiment. As described above, the swing connecting member 501 for implementing the swing operation of the mobile phone 11D according to the fourth embodiment will not move the swing axis RX and the first housing 12D upward or downward. FIG. 56 is a perspective view illustrating the swing connecting member 501 from a front side when the first housing 12D of the mobile phone 11D according to the fourth embodiment is in a basic position. FIG. 57 is a perspective view illustrating the swing connecting member 501 from a rear side when the first housing 12D of the mobile phone 11D according to the fourth embodiment is in the basic position.

The swing connecting member 501 may be formed of a material resistant to corrosion. Stainless steel may be given as an example of the material resistant to corrosion. As illustrated in FIGS. 56 and 57, the swing connecting member 501 includes a dedicated pivoting shaft 502, a plate cam 503 (see FIG. 56), and a clamping plate 504. The dedicated pivoting shaft 502 includes a dedicated pivoting shaft hole 506 formed by causing a dedicated pivoting shaft hole wall 505 to pass through the dedicated pivoting shaft 502. The shape of the plate cam 503 is circular. The plate cam 503 includes a fixing hole 103d (see FIG. 56) penetrating the plate cam 503. The plate cam 503 includes a fixing hole 507 (see FIG. 57) penetrating the plate cam 503.

The dedicated pivoting shaft 502 is loosely attached to the fixing hole 507 of the clamping plate 504 without allowing the dedicated pivoting shaft 502 to come off the fixing hole 507. The plate cam 503 is attached to the dedicated pivoting shaft 502 such that the plate cam 503 is projected from a circumference of the dedicated pivoting shaft 502. FIGS. 56 to 57 illustrate fixing examples of the dedicated pivoting shaft 502 and the plate cam 503. That is, the dedicated pivoting shaft 502 includes a ring part 502a (see FIG. 57) disposed at an end of a rear side of the dedicated pivoting shaft 502. In viewing from a rear side of the swing connecting member 501, the dedicated pivoting shaft 502 passes through the fixing hole 507 of the clamping plate 504 and a fixing hole 503a of the plate cam 503 until the ring part 502a of the dedicated pivoting shaft 503 is locked by the clamping plate 504. By contrast, in viewing from a front side of the swing connecting member 501, a circular bending part 502b (see FIG. 56) is formed by outwardly bending an end of the front side of the dedicated pivoting shaft 502. The dedicated pivoting shaft 502 is connected to the plate cam 503 via the circular bending part 502b.

Owing to the dedicated pivoting shaft 502 being coupled to the plate cam 503, the dedicated pivoting shaft 502 is loosely attached to the fixing hole 507 without allowing the dedicated pivoting shaft 502 to come off the fixing hole 507. Further, the plate cam 503 is attached to the dedicated pivoting shaft 502 such that the plate cam 503 is projected from the circumference of the dedicated pivoting shaft 502. Accordingly, the dedicated pivoting shaft 502 is pivotable inside the fixing hole 507 of the clamping plate 504. However, the dedicated pivoting shaft 502 is not linearly slidable within the fixing hole 507 of the clamping plate 504. Note that grease is applied as lubrication to facilitate the pivoting operation of the dedicated pivoting shaft 102.

As illustrated in FIG. 57, the clamping plate 504 includes a resilient member 511 fixed at the rear side of the clamping plate 504. The resilient member 511 applies force to the dedicated pivoting shaft 502 in a resilient direction (i.e., a downward direction in FIG. 57) inside the fixing hole 507 of the clamping plate 504. The resilient member 511 illustrated in FIG. 57 is a torsion spring. Note that the resilient member 511 may be a flat spring.

FIG. 57 illustrates a fixing example of the resilient member 511. Specifically, the clamping plate 504 includes a fixing piece 512, a locking piece 513, and a projection 514. The resilient member 511 includes a coiled part 511a, a first end 511b, and a second end 511c. The coiled part 511a of the resilient member 511 is fixed to the clamping plate 504 by the fixing piece 512. The first end 511b of the resilient member 511 is locked to the clamping plate 504 by the locking piece 513. An intermediate part between the coiled part 511a and the first end 511b of the resilient member 511 is supported by the projection 514. The second end 511c of the resilient member 511 is hooked on the ring part 502a. Hence, the second end 511c of the resilient member 511 is bent in a U shape due to being hooked on the ring part 502a. Note that the second end 511c of the resilient member 511 may be bent in an L shape or a J shape.

When the resilient member 511 constantly applies force to the dedicated pivoting shaft 502 in the downward direction inside the fixing hole 507, force is also applied to the plate cam 503 connected to the dedicated pivoting shaft 502 in the downward direction.

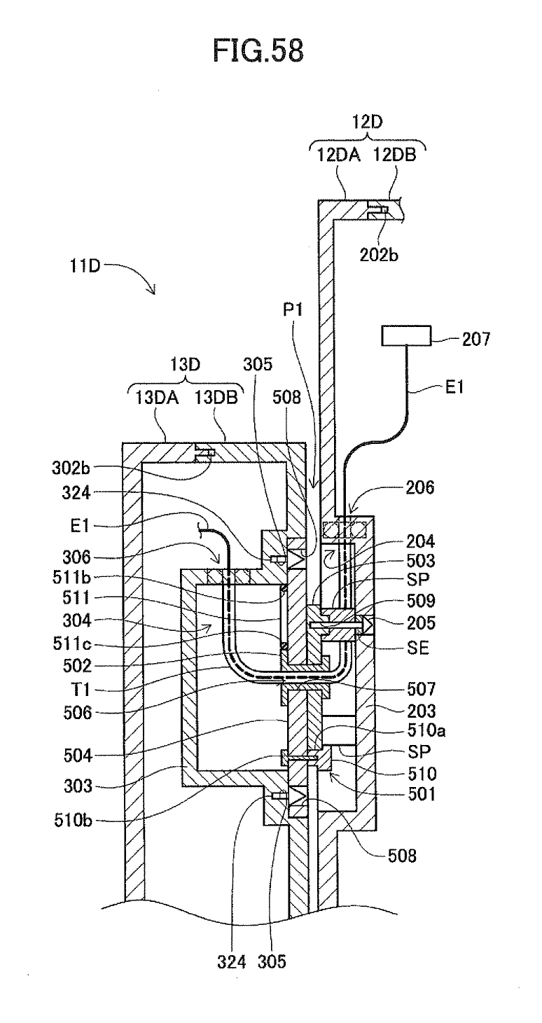

The clamping plate 504 includes a pivoting contactor 510 (see FIG. 56) on the front side of the clamping plate 504. The pivoting contactor 510 is attached to the clamping plate 504 at a position below the fixing hole 507. The pivoting contactor 510 includes a cylindrical contact surface 510a (see FIG. 58 illustrated later) configured to be brought into contact with a lateral surface of the plate cam 503. The pivoting contactor 510 is pivotally attached to the clamping plate 504. FIG. 57 illustrates a fixing example of the pivoting contactor 510. Specifically, a pivoting pin 510b is inserted into the pivoting contactor 510 via the clamping plate 504 from the rear side of the swing connecting member 501.

The clamping plate 504 includes four fixing holes 508 penetrating respective four corners of the clamping plate 504. The four fixing holes 508 are utilized for fixing the clamping plate 504 to the second housing 13D (e.g., see FIG. 53). As illustrated in FIG. 56, the plate cam 503 includes three female screw bosses 509 on the front side of the plate cam 503. The three female screw bosses 509 are utilized for fixing the plate cam 503 to the first housing 12D (e.g., see FIG. 53).

When the clamping plate 504 is fixed to the second housing 13D, and the plate cam 503 is fixed to the first housing 12D, the swing axis RX (e.g., see FIG. 53) meets an axis line of the dedicated pivoting shaft 502.

As illustrated in FIG. 56, the clamping plate 504 includes a depression 517, a first projection 518, and a second projection 519 in a circumference of the clamping plate 504. When the first housing 12D is in the basic position (see FIG. 53), the depression 517 of the plate cam 504 is pressed against the cylindrical contact surface 510a of the pivoting contactor 510 (see FIG. 58 illustrated later. As a result, the basic position of the first housing 12D may be stabilized. When the first housing 12D is in the right-hand side swing position (see FIG. 54), the first projection 518 of the plate cam 504 is locked by the cylindrical contact surface 510a of the pivoting contactor 510 (see FIG. 58 illustrated later). As a result, the right-hand side swing position of the first housing 12D may be stabilized. When the first housing 12D is in the left-hand side swing position (see FIG. 55), the second projection 519 of the plate cam 504 is locked by the cylindrical contact surface 510a of the pivoting contactor 510 (see FIG. 58 illustrated later). As a result, the left-hand side swing position of the first housing 12D may be stabilized.

### 8-3. Waterproof Structure and Insertion Type in Swing Part of Mobile Phone According to Fourth Embodiment

FIG. 58 is a partial sectional view illustrating the mobile phone 11D according to the fourth embodiment. The sectional view of FIG. 58 partially represents a cross section cut along a central line of the mobile phone 11D illustrated in FIG. 53. In FIG. 58, components equivalent to those of the mobile phone 11A according to the first embodiment are provided with the same reference numerals. In the following description, illustration of the components identical to those provided with the same reference numerals may therefore be omitted. As illustrated in FIG. 53, the mobile phone 11D according to the fourth embodiment includes a first housing 12D, a second housing 13D, and a third housing 14D. However, a pivoting relationship between the second housing 13D and the third housing 14D is equivalent to that in the configuration of the mobile phone 11A according to the aforementioned first embodiment. Thus, illustration of a part of the second housing 13D and the third housing 14D is omitted from FIG. 58.

The first housing 12D includes the swing connecting side first housing 12DA and the non-swing connecting side first housing 12DB. The repulsion of the gasket 202b gives waterproof properties between the swing connecting side first housing 12DA and the non-swing connecting side first housing 12DB. Hence, the first housing 12D includes a waterproof case structure having the waterproof properties given by the gasket 202b. The first housing 12D includes a first housing side connector 207 inside the first housing 12D. The swing connecting side first housing 12DA includes a first space 204 formed of a first space wall 203. The swing connecting side first housing 12DA includes a first housing side water stop part 206 on the first space wall 203.

The second housing 13D includes a non-swing connecting side second housing 13DA and a swing connecting side second housing 13DB. The repulsion of the gasket 302b gives waterproof properties between the non-swing connecting side second housing 13DA and the swing connecting side second housing 13DB. Hence, the second housing 13D includes a waterproof case structure having the waterproof properties given by the gasket 302b. The swing connecting side second housing 13DB includes a second space 304 formed of the second space wall 303. The swing connecting side second housing 13DB includes the threaded holes 305 and the second housing side first water stop part 306 in the second space wall 303.

In this state, the swing connecting member 501 is sandwiched between the first housing 12D and the second housing 13D.

The swing connecting member 501 may be attached to the second housing 13D as follows. The threaded holes 305 of the second space wall 303 are aligned with the fixing holes 508 of the clamping plate 504 such that the second space 304 is covered with the clamping plate 504 of the swing connecting member 501. Machine screws 324 are screwed into the threaded holes 305 aligned with the fixing holes 508 of the clamping plate 504. Since the clamping plate 504 of the swing connecting member 501 is fixed to the second space wall 303 by screwing the machine screws 324 into the threaded holes 305, the swing connecting member 501 is attached to the second housing 13D.

The swing connecting member 501 may be attached to the first housing 12D as follows. Spacers SP are fitted to the female screw bosses 509 of the plate cam 503 of the swing connecting member 501. The spacers SP are placed on the first space wall 203 from the first space 204. The machine screws are screwed into the female screw bosses 509 of the plate cam 503 via the overlaid first space wall 203 and spacers SP. Since the plate cam 503 of the swing connecting member 501 is fixed to the first space wall 203 by screwing the machine screws 205 into the female screw bosses 509, the swing connecting member 501 is attached to the first housing 12D.

In the screwing of the machine screws 205 into the female screw bosses 509, a waterproof sheet SE is sandwiched between the machine screws 205 and the first space wall 203. Hence, the sandwiched waterproof sheet SE may provide waterproof properties between the spacers SP and the first space wall 203. Examples of the waterproof sheet SE include a rubber sheet and a joint sheet, and the like. Note that a water-resistant double-faced tape or a sealing agent may be used in place of the waterproof sheet SE.

As described above, when the swing connecting member 501 intervenes between the first housing 12D and the second housing 13D, the first space 204 of the first housing 12D faces the second space 304 of the second housing 13D. Specifically, the swing connecting member 501 intervenes by a connecting interval P1 formed by causing the first space 204 of the first housing 12D to face the second space 304 of the second housing 13D. The swing connecting member 501 intervening by the connecting interval P1 may facilitate a flexible swing operation by having a flexible connecting relationship between the first housing 12D and the second housing 13D.

Note that the swing connecting member 501 may be attached with respect to the first housing 12D or the second housing 13D as follows. Specifically, the swing connecting member 501 may be attached with respect to the first housing 12D or the second housing 13D utilizing an adhesion insofar as such adhesive bonding provides the strength to satisfy the function of the swing connecting member 501.

As described above, the clamping plate 501 includes a pivoting contactor 510 on the clamping plate 504. The pivoting contactor 510 is attached to the clamping plate 504 at a position below the fixing hole 507. The pivoting contactor 510 is pivotally attached to the clamping plate 504 with the pivoting pin 510b. The pivoting contactor 510 includes a cylindrical contact surface 510a configured to be brought into contact with a lateral surface of the plate cam 503.

In the mobile phone 11D according to the fourth embodiment, the swing cladding tube T1 is attached to the first housing side water stop part 206 and the second housing side first water stop part 306. The swing cladding tube T1 passes through the dedicated shaft hole 506 of the swing connecting member 501. The first end 511b and the second end 511c of the resilient member 511 are fixed to the dedicated pivoting shaft 504 having the dedicated shaft hole 506 and the clamping plate 504. Hence, the resilient member 511 applies force to the dedicated pivoting shaft 502 being pivotable within the fixing hole 507 of the clamping plate 504 in a resilient direction. When the resilient force is attached to the dedicated pivoting shaft 502 within the fixing hole 507 of the clamping plate 504 in the direction toward which the resilient force is applied, the plate cam 503 connected to the dedicated pivoting shaft 502 is pressed against the cylindrical contact surface 510a of the pivoting contactor 510.

The first wiring member E1 is connected to the first housing side connector 207. The first wiring member E1 is extended to an inner side of the second housing 13D via the first housing side water stop part 206, the swing cladding tube T1, and the second housing side first water stop part 306.

In the mobile phone 11D according to the fourth embodiment, since the swing connecting member 501 has no waterproof properties, some liquid such as water may enter the first space 204 of the first housing 12D and the second space 304 of the second housing 13D via the connecting interval P1 intervened by the swing connecting member 501. However, as illustrated in the mobile phone 11D according to the fourth embodiment, the first housing side water stop part 206 and the second housing side first water stop part 306 to which the swing cladding tube T1 is attached have waterproof properties. Accordingly, even if the liquid enters the first space 204 of the first housing 12D or the second space 304 of the second housing 13D, such a liquid having entered the first space 204 and the second space 304 will not invade the inside of the first housing 12D or the inside of the second housing 13D via the first housing side water stop part 206 or the second housing side first water stop part 306. Further, the first wiring member E1 passing through the swing cladding tube T1 will not be interfered with by the liquid having entered the first space 204 of the first housing 12D or the second space 304 of the second housing 13D. On the other hand, since the swing cladding tube T1 passes through the dedicated shaft hole 506 of the swing connecting member 501, the dedicated pivoting shaft 502 having the dedicated shaft hole 506 being in a flexible pivoting state within the fixing hole 507 of the clamping plate 504 will not be interfered with by the swing cladding tube T1. Specifically, in the mobile phone 11D according to the fourth embodiment, despite the fact that the swing connecting member 501 for implementing the swing operation has no waterproof properties, the swing connecting member 501 may be able to simultaneously realize the flexible swing operation and the waterproof function in the place where the swing operation is performed.

In addition, the swing cladding tube T1 enveloping the first wiring member E1 passes through the dedicated shaft hole 506 of the swing connecting member 501. Hence, even though the dedicated pivoting shaft 502 pivots within the fixing hole 507 of the clamping plate 504 during the swing operation, the first wiring member E1 will be protected with the swing cladding tube T1. As a result, durability of the first wiring member E1 may be improved by being protected with the swing cladding tube T1. Hence, even though the dedicated pivoting shaft 504 repeatedly pivots within the fixing hole 507 of the clamping plate 504, the first wiring member E1 exhibits prolonged durability.

As described above, the dedicated shaft hole 506 of the dedicated pivoting shaft 502 of the swing connecting member 501 may be given as an example of a “through hole of the swing connecting member”.

Note that the mobile phone 11D according to the fourth embodiment may have two or more first housing side water stop parts 206 or two or more second housing side first water stop parts 306. When the mobile phone 11D has two or more first housing side water stop parts 206 or two or more second housing side first water stop parts 306, wiring members obtained by sharing the first wiring member E1 pass through the respective first housing side water stop parts 206 or the respective second housing side first water stop parts 306 via two or more swing cladding tubes T1. Hence, each of the first housing side water stop parts 206 or each of the second housing side first water stop parts 306 may be reduced in size as well as reducing the size of each of the swing cladding tubes T1. Hence, when it is possible to reduce the dimension of the depth of the first space 204 or the second space 304 by arrangement of each of the first housing side water stop parts 206 or each of the second housing side first water stop parts 306, the mobile phone 11D according to the fourth embodiment may be made thinner. Further, torsion load on each of the wiring members may also be reduced.

Note that alternatively, a pivoting hinge capable of allowing the swing cladding tube T1 to pass through and having durability may be employed in place of the swing connecting member 501. In a case where the pivoting hinge capable of allowing the swing cladding tube T1 to pass through and having durability is employed, the flexible pivoting operation of the pivoting operation and the waterproof function in the place where the pivoting operation is performed via the pivoting hinge H may be implemented.

### 9. Other Waterproof Structure

Below are given of illustration of other types of waterproof structure.

9-1. Waterproof Structure with Inserting Member

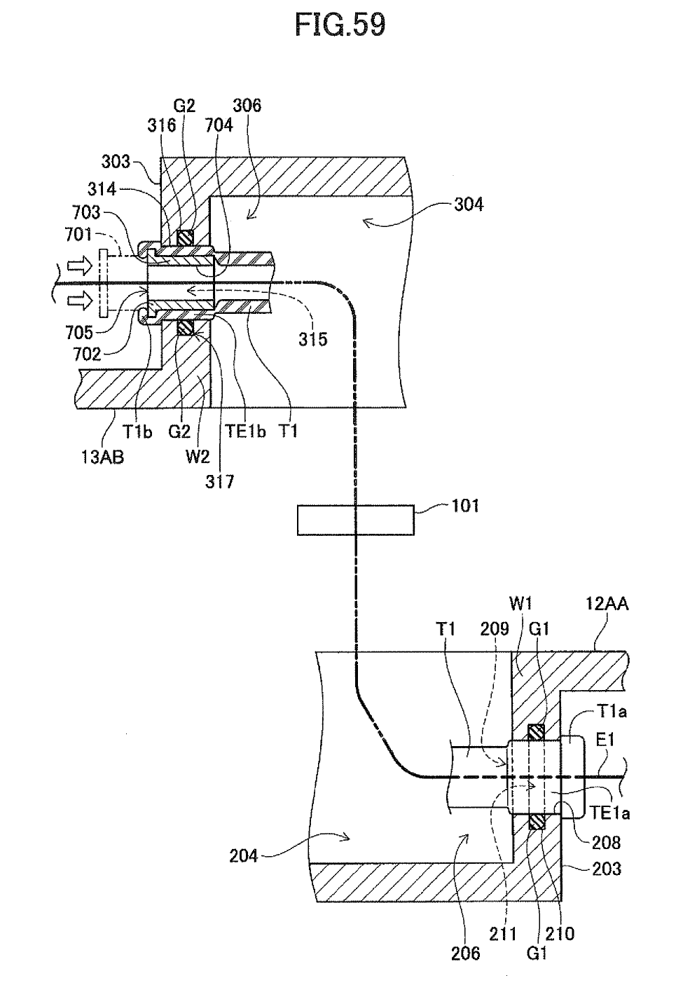

FIG. 59 is a view illustrating a waterproof structure having an inserting member 701. FIG. 59 depicts sectional views illustrating the first housing side water stop part 206 and the second housing side first water stop part 306 to both of which the swing cladding tube T1 is attached.

Note that FIG. 59 depicts simplified external views of the first wiring member E1 and the swing connecting member 101. The external view of the swing cladding tube T1 is illustrated in a lower part of FIG. 59. In FIG. 59, components identical to those illustrated in FIG. 19 are provided with the same reference numerals. In the following description, illustration of the components in FIG. 59 identical to those of FIG. 19 provided with the same reference numerals is therefore omitted. Note that FIG. 59 illustrates a waterproof structure applied to the mobile phone 11A according to the first embodiment.

As illustrated in an upper part of FIG. 59, the swing cladding tube T1 passing through the swing connecting member 101 is attached to the second housing side first water stop part 306. The inserting member 701 is inserted into a second fixing end TE1b of the swing cladding tube T1. The inserting member 701 includes an inserting main body 703. The inserting main body 703 includes an inserting hook 702 on one end of the inserting main body 703. The inserting main body 703 includes an inserting wiring opening 705 formed by allowing an inserting wiring opening wall 704 to penetrate the inserting main body 703. A first wiring member E1 residing within the swing cladding tube T1 passes through the inserting wiring opening 705.

The inserting member 701 is inserted into the second fixing end TE1b of the swing cladding tube T1 from the second restoration part T1b of the swing cladding tube T1. When the inserting member 701 is inserted into the second fixing end TE1b of the swing cladding tube T1, the second fixing end TE1b of the swing cladding tube T1 and the second fixing sealer G2 are compressed by the second continuous groove wall 316 and the inserting main body 703 of the inserting member 701. When the second fixing end TE1b of the swing cladding tube T1 and the second fixing sealer G2 are compressed, a gap between the second wiring opening wall 314 and the second fixing end TE1b of the swing cladding tube T1 is sealed with the second fixing sealer G2. An outer diameter of the inserting main body 703 is made to have a size that allows the second continuous groove wall 316 and the inserting main body 703 to compress the second fixing end TE1b of the swing cladding tube T1 and the second fixing sealer G2. Specifically, the second wiring opening 315 acquires waterproof properties when the second fixing end TE1b of the swing cladding tube T1 and the second fixing sealer G2 are compressed by the second continuous groove wall 316 and the inserting main body 703 of the inserting member 701. Hence, the inserting member 701 is effective in a case where the waterproof properties of the second wiring opening 315, into which the swing cladding tube T1 is inserted, is insufficient.

When the inserting member 701 is inserted into the second fixing end TE1b of the swing cladding tube T1, the inserting hook 702 of the inserting member 701 is inserted into the second restoration part T1b of the swing cladding tube T1. When the inserting hook 702 of the inserting member 701 is inserted into the second restoration part T1b of the swing cladding tube T1, the second restoration part T1b of the swing cladding tube T1 is pressed against the lateral wall W2 of the second space wall 303. That is, even when the swing cladding tube T1 is pulled toward the second space 304, the second restoration part T1b of the swing cladding tube T1 is pressed by the inserting hook 702 of the inserting member 701 against the lateral wall W2 of the second space wall 303. When the second restoration part T1b of the swing cladding tube T1 is pressed by the inserting hook 702 of the inserting member 701 against the lateral wall W2 of the second space wall 303, the swing cladding tube T1 may be prevented from coming off into the second space 304. Further, in a state where the second fixing end TE1b of the swing cladding tube T1 is inserted into the second wiring opening 315, the second fixing end TE1b is tightened with the second fixing sealer G2 and the inserting member 703 as a reaction of the compressed second fixing sealer G2. When the second fixing end TE1b of the swing cladding tube T1 is tightened by the inserting main body 703 and the second fixing sealer G2, it may be possible to maintain a state in which the second restoration part T1b of the swing cladding tube T1 is pressed by the inserting hook 702 of the inserting member 701 against the lateral wall W2 of the second space wall 303. That is, the state in which the second restoration part T1b of the swing cladding tube T1 is pressed by the inserting hook 702 of the inserting member 701 against the lateral wall W2 of the second space wall 303 may be stabilized owing to the hooking of the swing cladding tube T1 by the inserting hook 702 or the second restoration part T1b, and the tightening of the swing cladding tube T1 by the inserting main body 703 and the second fixing sealer G2.

In the first housing side water stop part 206 illustrated in the lower part of FIG. 59, the inserting member 701 is inserted into the first fixing end TE1a of the swing cladding tube T1. The function and effect of the inserting member 701 employed in the first housing side water stop part 206 illustrated in the lower part of FIG. 59 are similar to those of the inserting member 701 employed in the second housing side first water stop part 306 illustrated in the upper part of FIG. 59. Hence, illustration of the function and effect of the inserting member 701 employed in the first housing side water stop part 206 illustrated in the lower part of FIG. 59 is omitted from the description.

Note that the waterproof structure illustrated in FIG. 59 may also be applicable to the mobile phone 11B according to the second embodiment, the mobile phone 11C according to the third embodiment, and the mobile phone 11D according to the fourth embodiment. In a case the waterproof structure illustrated in FIG. 59 is attached to the mobile phone 11D according to the fourth embodiment, the swing cladding tube T1 is of course passed through the swing connecting member 501 (e.g., see FIG. 56) in place of the swing connecting member 101.

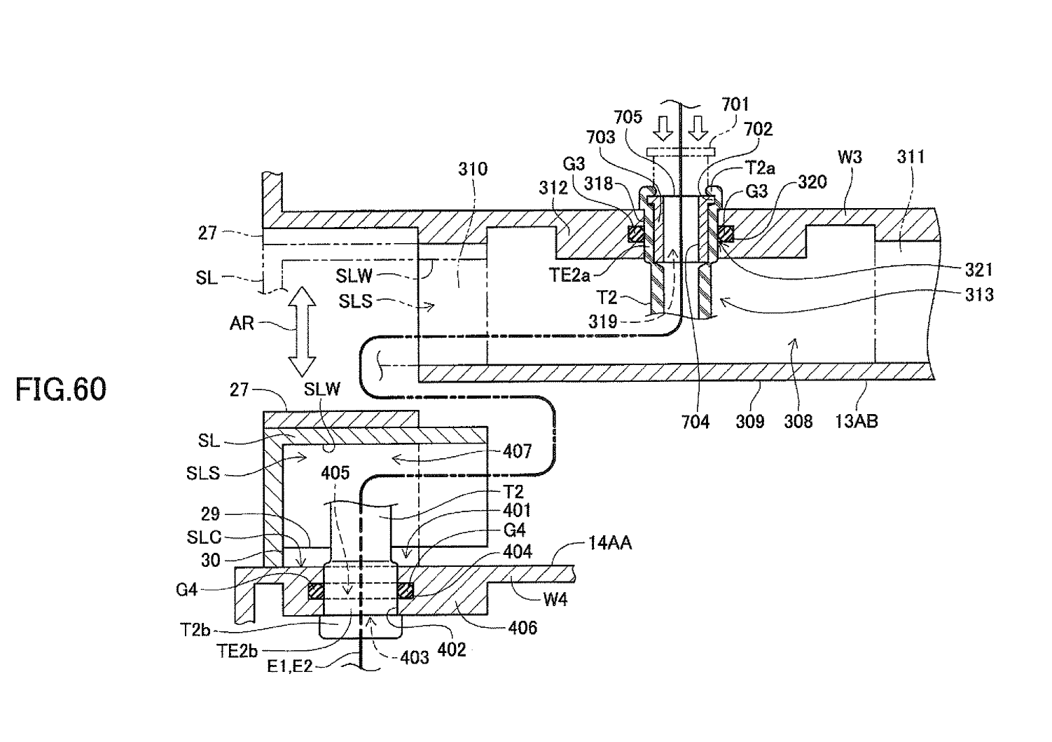

FIG. 60 is a view illustrating a waterproof structure employing the inserting member 701. FIG. 60 depicts sectional views illustrating the second housing side second water stop part 313 and the third housing side water stop part 401 to both of which the pivoting cladding tube T2 is attached.

Note that FIG. 60 depicts simplified external views of the first wiring member E1 and the second wiring member E2. The external view of the pivoting cladding tube T2 is illustrated in a lower part of FIG. 60. In FIG. 60, components identical to those illustrated in FIG. 22 are provided with the same reference numerals. In the following description, illustration of the components in FIG. 60 identical to those of FIG. 22 provided with the same reference numerals is therefore omitted. Note that FIG. 60 illustrates a waterproof structure applied to the mobile phone 11A according to the first embodiment. Note that the waterproof structure illustrated in FIG. 60 may be applicable to the mobile phone 11D according to the fourth embodiment.

As illustrated in an upper part of FIG. 60, the pivoting cladding tube T2 passing through the second pivoting shaft SL is attached to the second housing side second water stop part 313.

The inserting member 701 is inserted into a third fixing end TE2a of the pivoting cladding tube T2. A configuration of the inserting member 701 is identical to that of the inserting member 701 illustrated in FIG. 59, and illustration of the configuration of the inserting member 701 in FIG. 60 is therefore omitted from the description.

A first wiring member E1 and a second wiring member E2 residing within the pivoting cladding tube 12 are passed through the inserting wiring opening 705. The inserting member 701 is inserted into the third fixing end TE2a of the pivoting cladding tube T2 from the third restoration part T2a of the pivoting cladding tube T2. When the inserting member 701 is inserted into the third fixing end TE2a of the pivoting cladding tube T2, the third fixing end TE2a of the pivoting cladding tube T2 and the third fixing sealer G3 are compressed by the third continuous groove wall 320 and the inserting main body 703 of the inserting member 701. When the third fixing end TE2a of the pivoting cladding tube T2 and the third fixing sealer G3 are compressed, a gap between the third wiring opening wall 318 and the third fixing end TE2a of the pivoting cladding tube T2 is sealed with the third fixing sealer G3. An outer diameter of the inserting main body 703 is made to have a size that allows the third continuous groove wall 320 and the inserting main body 703 to compress the third fixing end TE2a of the pivoting cladding tube T2 and the third fixing sealer G3. Specifically, the third wiring opening 319 acquires waterproof properties when the third fixing end TE2a of the pivoting cladding tube T2 and the third fixing sealer G3 are compressed by the third continuous groove wall 320 and the inserting main body 703 of the inserting member 701. Hence, the inserting member 701 is effective in a case where the waterproof properties of the third wiring opening 319, into which the pivoting cladding tube T2 is inserted, is insufficient.

When the inserting member 701 is inserted into the third fixing end TE2a of the pivoting cladding tube T2, the inserting hook 702 of the inserting member 701 is inserted into the third restoration part T2a of the pivoting cladding tube T2. When the inserting hook 702 of the inserting member 701 is inserted into the third restoration part T2a of the pivoting cladding tube T2, the third restoration part T2a of the pivoting cladding tube T2 is pressed against the lateral wall W3 that is a part of the third space wall 309. That is, even when the pivoting cladding tube T2 is pulled toward the third space 308, the third restoration part T2a of the pivoting cladding tube T2 is pressed by the inserting hook 702 of the inserting member 701 against the lateral wall W3. When the third restoration part T2a of the pivoting cladding tube T2 is pressed by the inserting hook 702 of the inserting member 701 against the lateral wall W3, the pivoting cladding tube T2 may be prevented from coming off into the third space 308. Further, in a state where the third fixing end TE2a of the pivoting cladding tube T2 is inserted into the third wiring opening 319, the third fixing end TE2a of the pivoting cladding tube 12 is tightened with the third fixing sealer G3 and the inserting main body 703 as a reaction of the compressed third fixing sealer G3. When the third fixing end TE2a of the pivoting cladding tube T2 is tightened by the inserting main body 703 and the third fixing sealer G3, it may be possible to maintain a state in which the third restoration part T2a of the pivoting cladding tube T2 is pressed by the inserting hook 702 of the inserting member 701 against the lateral wall W3. That is, the state in which the third restoration part T2a of the pivoting cladding tube T2 is pressed by the inserting hook 702 of the inserting member 701 against the lateral wall W3 may be stabilized owing to the hooking of the pivoting cladding tube T2 by the inserting hook 702 or the third restoration part T2a, and the tightening of the pivoting cladding tube T2 by the inserting main body 703 and the third fixing sealer G3.

In the third housing side water stop part 401 illustrated in the lower part of FIG. 60, the inserting member 701 is inserted into the fourth fixing end TE2a of the pivoting cladding tube T. The function and effect of the inserting member 701 employed in the third housing side water stop part 401 illustrated in the lower part of FIG. 60 are similar to those of the inserting member 701 employed in the second housing side first water stop part 313 illustrated in the upper part of FIG. 60. Hence, illustration of the function and effect of the inserting member 701 employed in the third housing side water stop part 401 illustrated in the lower part of FIG. 60 is omitted from the description.

Note that since a modification of the waterproof structure (see FIG. 24) associated with the electrical connection to the first wiring member E1 and the second wiring member E2 is similar to the waterproof structure with the first insertion type, illustration of such a modification of the waterproof structure associated with the electrical connection is omitted from the description.

As described above, the inserting member 701 is given as an example of “a first cohesive connection unit”, “a second cohesive connection unit”, “a third cohesive connection unit”, and “a fourth cohesive connection unit”.

### 9-2. Waterproof Structure Having Cylindrical Member

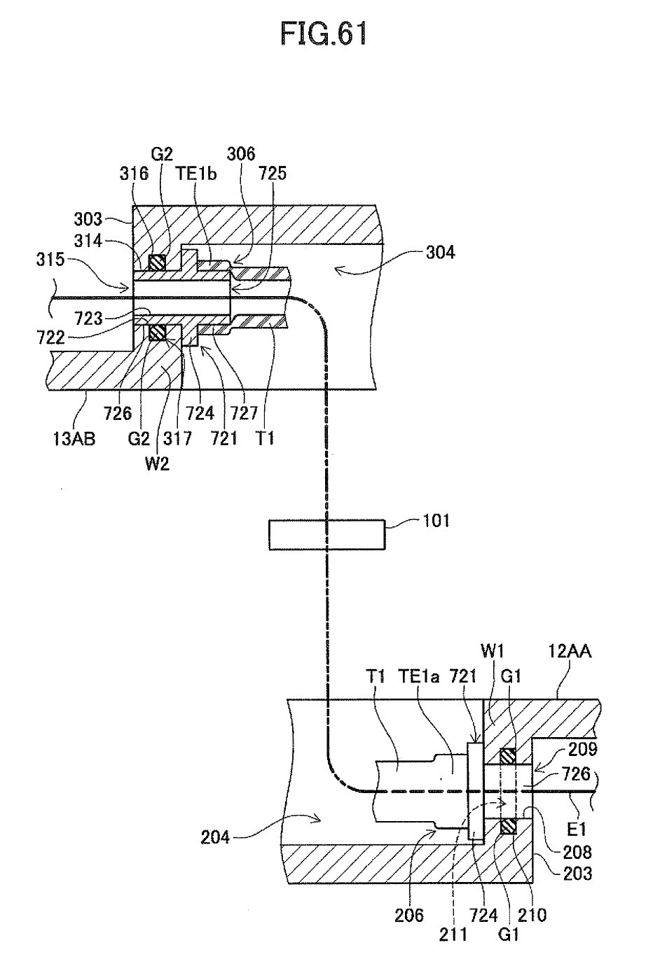

FIG. 61 is a view illustrating a waterproof structure having a cylindrical member 721. FIG. 61 depicts sectional views illustrating the first housing side water stop part 206 and the second housing side first water stop part 306 to both of which the swing cladding tube T1 is attached.

Note that FIG. 61 depicts simplified external views of the first wiring member E1 and the swing connecting member 101. The external view of the swing cladding tube T1 is illustrated in a lower part of FIG. 61. In FIG. 61, components identical to those illustrated in FIG. 19 are provided with the same reference numerals. In the following description, illustration of the components in FIG. 61 identical to those of FIG. 19 provided with the same reference numerals is therefore omitted. Note that FIG. 61 illustrates a waterproof structure applied to the mobile phone 11A according to the first embodiment.

As illustrated in an upper part of FIG. 61, the swing cladding tube T1 passing through the swing connecting member 101 is attached to the second housing side first water stop part 306 via the cylindrical member 721. The cylindrical member 721 is fitted into the second wiring opening 315 from the second space 304. The cylindrical member 721 includes a projection plate 724 projected from a cylindrical circumferential wall 722. The projected plate 724 partitions a circumferential surface of the circumferential wall 722 into a wiring opening side circumferential wall 726 and a fixing end circumferential wall 727. The cylindrical member 721 includes a hollow tube 725 formed by causing a hollow tube wall 723 to penetrate the cylindrical member 721. The first wiring member E1 residing within the swing cladding tube T passes through the hollow tube 725.

The wiring opening side circumferential wall 726 is fitted into the wiring opening 315 such that the projection plate 724 is brought into contact with the lateral wall W2 of the second space wall 303. When the wiring opening side circumferential wall 726 is fitted into the wiring opening 315, the second fixing sealer G2 is compressed by the second continuous groove wall 316 and the wiring opening side circumferential wall 726. When the second fixing sealer G2 is compressed, a gap between the wiring opening side circumferential wall 726 and the second wiring opening wall 314 is sealed with the second fixing sealer G2. An outer diameter of the wiring opening side circumferential wall 726 is made to have a size that allows the second continuous groove wall 316 and the wiring opening side circumferential wall 726 to compress the second fixing sealer G2.

The second fixing end TE1b of the swing cladding tube T1 is inserted into the fixing end circumferential wall 727. When the second fixing end TE1b of the swing cladding tube T1 is inserted into the fixing end circumferential wall 727, the first wiring member E1 residing within the swing cladding tube T1 is passed through the second wiring opening 315 via the hollow tube 725. The second fixing end TE1b of the swing cladding tube T1 inserted into the fixing end circumferential wall 727 acquires waterproof properties owing to elasticity of the second fixing end TE1b itself of the swing cladding tube T1.

Specifically, the second wiring opening 315 acquires waterproof properties by causing the second continuous groove wall 316 and the second wiring opening side circumferential wall 726 to compress the second fixing sealer G2. Further, the hollow tube 725 of the cylindrical member 721 fitted into the second wiring opening 315 acquires waterproof properties owing to elasticity of the second fixing end TE1b of the swing cladding tube T1. Accordingly, the second fixing end TE1b of the swing cladding tube T1 is cohesively or closely connected to the second wiring opening 315 via the cylindrical member 721.

In the first housing side water stop part 206 illustrated in the lower part of FIG. 61, the swing cladding tube T1 is connected to the second wiring opening 315 via the cylindrical member 721. The function and effect of the cylindrical member 721 employed in the first housing side water stop part 206 illustrated in the lower part of FIG. 61 are similar to those of the cylindrical member 721 employed in the second housing side first water stop part 306 illustrated in the upper part of FIG. 61. Hence, illustration of the function and effect of the cylindrical member 721 illustrated in the lower part of FIG. 61 employed in the first housing side water stop part 206 is omitted from the description.

Note that the waterproof structure illustrated in FIG. 61 may also be applicable to the mobile phone 11B according to the second embodiment, the mobile phone 11C according to the third embodiment, and the mobile phone 11D according to the fourth embodiment. In a case the waterproof structure illustrated in FIG. 61 is attached to the mobile phone 11D according to the fourth embodiment, the swing cladding tube T1 is of course passed through the swing connecting member 501 (e.g., see FIG. 56) in place of the swing connecting member 101.

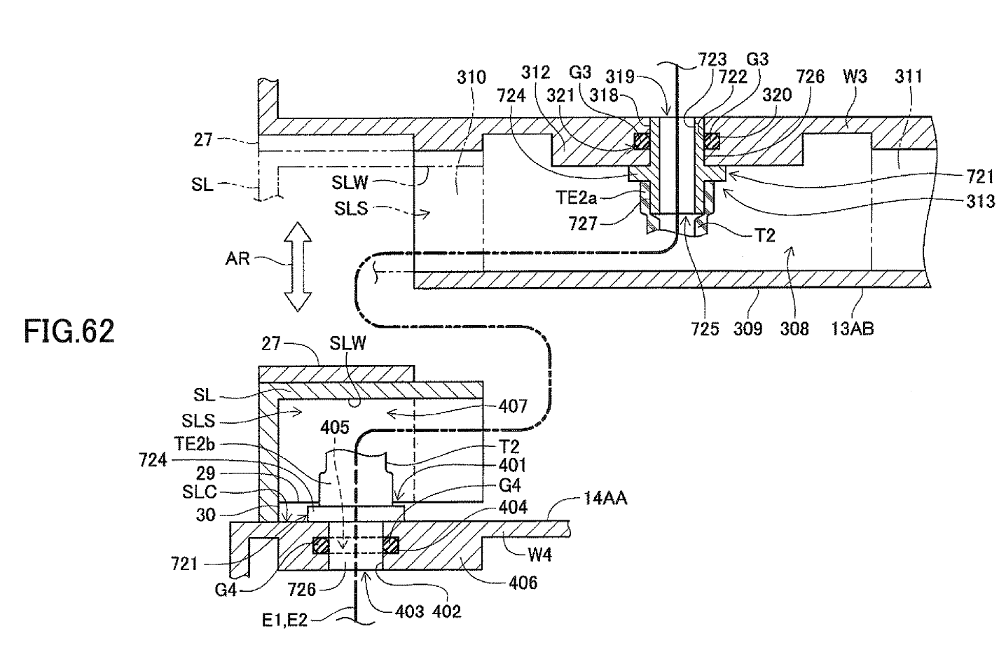

FIG. 62 is a view illustrating a waterproof structure having a cylindrical member 721. FIG. 62 depicts sectional views illustrating the second housing side second water stop part 313 and the third housing side water stop part 401 to both of which the pivoting cladding tube T2 is attached.

Note that FIG. 62 depicts simplified external views of the first wiring member E1 and the second wiring member E2. The external view of the pivoting cladding tube T2 is illustrated in a lower part of FIG. 62. In FIG. 62, components identical to those illustrated in FIG. 22 are provided with the same reference numerals. In the following description, illustration of the components in FIG. 62 identical to those of FIG. 22 provided with the same reference numerals is therefore omitted. Note that FIG. 62 illustrates a waterproof structure applied to the mobile phone 11A according to the first embodiment. Note that the waterproof structure illustrated in FIG. 62 may be applicable to the mobile phone 11D according to the fourth embodiment.

As illustrated in an upper part of FIG. 62, the pivoting cladding tube T2 passing through the second pivoting shaft SL is attached to the second housing side second water stop part 313 via the cylindrical member 721. A configuration of the cylindrical member 721 is identical to that of the cylindrical member 721 illustrated in FIG. 61, and illustration of the configuration of the cylindrical member 721 in FIG. 62 is therefore omitted from the description. A first wiring member E1 and a second wiring member E2 residing within the pivoting cladding tube T2 are passed through the hollow tube 725.

The wiring opening side circumferential wall 726 is fitted into the third wiring opening 319 such that the projection plate 724 is brought into contact with the lateral wall W3 of the swing connecting side second housing 13AB. When the wiring opening side circumferential wall 726 is fitted into the third wiring opening 319, the third sealer G3 is compressed by the third continuous groove wall 320 and the wiring opening side circumferential wall 726. When the third fixing sealer G3 is compressed, a gap between the wiring opening side circumferential wall 726 and the third wiring opening wall 318 is sealed with the third fixing sealer G3. An outer diameter of the wiring opening side circumferential wall 726 is made to have a size that allows the third continuous groove wall 320 and the wiring opening side circumferential wall 726 to compress the third fixing sealer G3.

The third fixing end TE2a of the pivoting cladding tube T2 is inserted into the fixing end circumferential wall 727. When the third fixing end TE2a of the pivoting cladding tube T2 is inserted into the fixing end circumferential wall 727, the first wiring member E1 and the second wiring member E2 residing within the pivoting cladding tube T2 pass through the third wiring opening 319 via the hollow tube 725. The third fixing end TE2a of the pivoting cladding tube T2 inserted into the fixing end circumferential wall 727 acquires waterproof properties owing to elasticity of the third fixing end TE2a itself of the pivoting cladding tube T2.

Specifically, the third wiring opening 319 acquires waterproof properties by causing the third continuous groove wall 316 and the third wiring opening side circumferential wall 726 to compress the third sealer G3. Further, the hollow tube 725 of the cylindrical member 721 fitted into the third wiring opening 319 acquires waterproof properties owing to elasticity of the third fixing end TE2a of the pivoting cladding tube T2. Accordingly, the third fixing end TE2a of the pivoting cladding tube T2 is cohesively or closely connected to the third wiring opening 319 via the cylindrical member 721.

In the third housing side water stop part 401 illustrated in the lower part of FIG. 62, the pivoting cladding tube T2 is connected to the third wiring opening 319 via the cylindrical member 721. The function and effect of the cylindrical member 721 employed in the third housing side water stop part 401 illustrated in the lower part of FIG. 62 are similar to those of the cylindrical member 721 employed in the second housing side second water stop part 313 illustrated in the upper part of FIG. 62. Hence, illustration of the function and effect of the cylindrical member 721 illustrated in the lower part of FIG. 62 employed in the third housing side water stop part 401 is omitted from the description.

Note that since a modification of the waterproof structure (see FIG. 24) associated with the electrical connection to the first wiring member E1 and the second wiring member E2 is similar to the waterproof structure with the first insertion type, illustration of such a modification of the waterproof structure associated with the electrical connection is omitted from the description.

As described above, the cylindrical member 721 is given as an example of “a first cylindrical member”, “a second cylindrical member”, “a third cylindrical member”, and “a fourth cylindrical member”. As described above, the circumferential wall 722 is given as an example of “a first circumferential wall”, “a second circumferential wall”, “a third circumferential wall”, and “a fourth circumferential wall”. As described above, the projection plate 724 is given as an example of “a first projection plate”, “a second projection plate”, “a third projection plate”, and “a fourth projection plate”. As described above, the hollow tube wall 725 is given as an example of “a first hollow tube wall”, “a second hollow tube wall”, “a third hollow tube wall”, and “a fourth hollow tube wall”. As described above, the wiring opening side circumferential wall 726 is given as an example of “a first wiring opening side circumferential wall”, “a second wiring opening side circumferential wall”, “a third wiring opening side circumferential wall”, and “a fourth wiring opening side circumferential wall”. As described above, the fixing end circumferential wall 727 is given as an example of “a first fixing end circumferential wall”, “a second fixing end circumferential wall”, “a third fixing end circumferential wall”, and “a fourth fixing end circumferential wall”.

### 9-3. Waterproof Structure Having Projection Tube

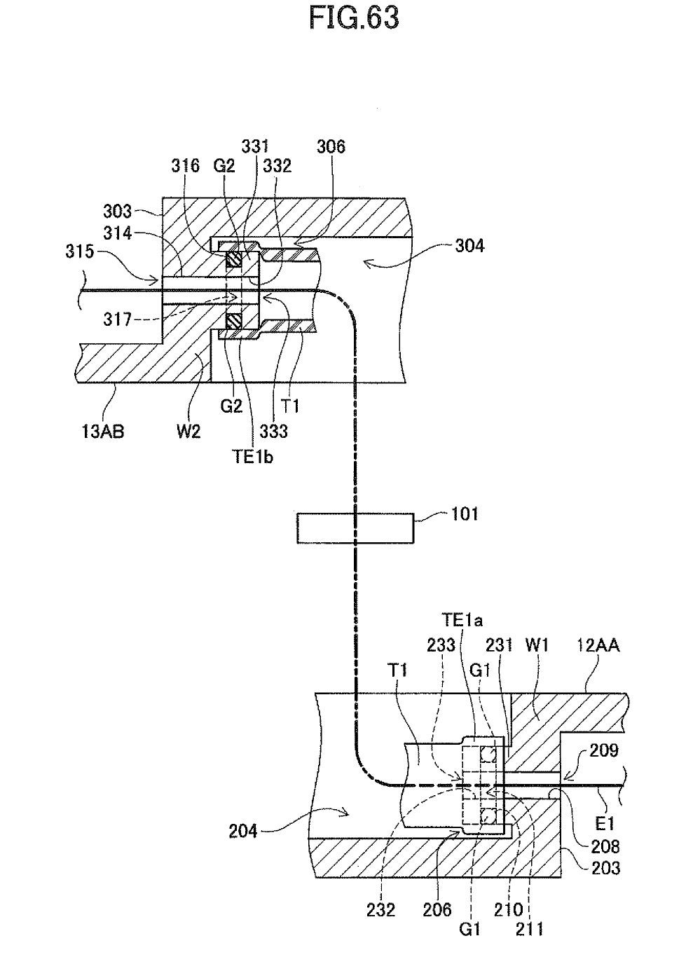

FIG. 63 is a view illustrating a waterproof structure having a first projection tube 231 and a second projection tube 331. FIG. 63 depicts sectional views illustrating the first housing side water stop part 206 and the second housing side first water stop part 306 to both of which the swing cladding tube T1 is attached.

FIG. 63 depicts simplified external views of the first wiring member E1 and the swing connecting member 101. The external view of the swing cladding tube T1 is illustrated in a lower part of FIG. 63. In FIG. 63, components identical to those illustrated above are provided with the same reference numerals. Note that FIG. 63 illustrates a waterproof structure applied to the mobile phone 11A according to the first embodiment.

As illustrated in a lower part of FIG. 63, the swing connecting side first housing 12AA includes the first housing side water stop part 206 on a lateral wall W1 of the first space wall 203 forming the first space 204. The first housing side water stop part 206 includes a first wiring opening 209 formed by causing a first wiring opening wall 208 to penetrate the lateral wall W1. The lateral wall W1 includes the first projection tube 231 projected toward the first space 204. The first projection tube 231 includes a first extended space 233 formed by causing a first extended space wall 232 to penetrate the first projection tube 231. The first extended space 233 is in communication with the first wiring opening 209. The first wiring member E1 residing within the swing cladding tube T1 passes through the first extended space 233 and the first wiring opening 209 communicating with the first extended space 233. The first projection tube 231 includes a first circular continuous groove 211 formed of the first continuous groove wall 210 in a circumference of the first projection tube 231. The first fixing sealer G1 is attached to the first continuous groove 211. Examples of the first fixing sealer G1 include an O ring, and the like. The first wiring opening 209 or the first extended space 233 has a circular cross section. Note that the cross section of the first wiring opening 209 or the first extended space 233 may have an oblong shape, or a square shape formed by linking the corners of the square in an arc. The first projection tube 231 may have a circumferential shape matching an inner circumference of the first fixing end TE1a of the swing cladding tube T1 inserted into the first projection tube 231.

The first fixing end TE1a of the swing cladding tube T1 passing through the swing connecting member 101 is inserted into the first projection tube 231. When the first fixing end TE1a of the swing cladding tube T1 is inserted into the first projection tube 231, the first extended space 233 resides within the first fixing end TE1a of the swing cladding tube T1. The first wiring member E1 residing within the swing cladding tube T1 passes through the first wiring opening 209 via the first extended space 233 of the first extended tube 231. The first space 204 serves as a wiring space of the swing cladding tube T1 through which the first wiring member E1 is passed. First, the first extended space 233 acquires waterproof properties owing to elasticity of the first fixing end TE1a of the swing cladding tube T1 inserted into the first projection tube 231.

When the first fixing end TE1a of the swing cladding tube T1 is inserted into the first projection tube 231 in a state where the first sealer G1 is attached to the first continuous groove 211, the first fixing sealer G1 intervenes between the first continuous groove wall 210 and the first fixing end TE1a of the swing cladding tube T1. When the first fixing sealer G1 intervenes between the first continuous groove wall 210 and the first fixing end TE1a of the swing cladding tube T1, the first fixing sealer G1 is compressed by the first continuous groove wall 210 and the first fixing end TE1a of the swing cladding tube T1. When the first fixing sealer G1 is compressed, a gap between the first projection tube 231 and the first fixing end TE1a of the swing cladding tube T1 is sealed with the first fixing sealer G1. That is, the first extended space 233 acquires waterproof properties by causing the first fixing sealer G1 to seal the gap between the first projection tube 231 and the first fixing end TE1a of the swing cladding tube T1. Accordingly, the first fixing end TE1a of the swing cladding tube T1 is cohesively or closely connected to the first wiring opening 209 via the first projection tube 231. Further, the swing cladding tube T1 may be prevented from coming off the first projection tube 231 into the first space 204 owing to friction and repulsion of the first fixing sealer G1 intervening between the first continuous groove wall 210 of the first projection tube 231 and the first fixing end TE1a of the swing cladding tube T1. A compressible size of the first fixing sealer G1 may be selected according to the first continuous groove wall 210 and the first fixing end TE1a of the swing cladding tube T1.

By contrast, as illustrated in an upper part of FIG. 63, the swing connecting side second housing 13AB includes the second housing side first water stop part 306 on a lateral wall W2 of the second space wall 303 forming the second space 304. The second housing side first water stop part 306 includes a second wiring opening 315 formed by causing the second wiring opening wall 314 to penetrate the lateral wall W2. The lateral wall W2 includes the second projection tube 331 projected toward the second space 304. The second projection tube 331 includes a second extended space 333 formed by causing a first extended space wall 332 to penetrate the second projection tube 331. The second extended space 333 is in communication with the second wiring opening 315. The first wiring member E1 residing within the swing cladding tube T1 passes through the second extended space 333 and the second wiring opening 315 communicating with the second extended space 333. The second projection tube 331 includes a second circular continuous groove 317 formed of the second continuous groove wall 316 in a circumference of the second projection tube 331. The second fixing sealer G1 is attached to the second continuous groove 317. Examples of the second fixing sealer G2 include an O ring, and the like. The second wiring opening 315 or the second extended space 333 has a circular cross section. Note that the cross section of the second wiring opening 315 or the second extended space 333 may have an oblong shape, or a square shape formed by linking the corners of the square in an arc. The second projection tube 331 may have a circumferential shape matching an inner circumference of the second fixing end TE1b of the swing cladding tube T1 inserted into the second projection tube 331.

The second fixing end TE1b of the swing cladding tube T1 passing through the swing connecting member 101 is inserted into the second projection tube 331. When the second fixing end TE1b of the swing cladding tube T1 is inserted into the second projection tube 331, the second extended space 333 resides within the second fixing end TE1b of the swing cladding tube T1. The first wiring member E1 residing within the swing cladding tube T1 passes through the second wiring opening 315 via the second extended space 333 of the second extended tube 331. The second space 304 serves as a wiring space of the swing cladding tube T1 through which the first wiring member E1 is passed. First, the second extended space 333 acquires waterproof properties owing to elasticity of the second fixing end TE1b of the swing cladding tube T1 inserted into the second projection tube 331.

When the second fixing end TE1b of the swing cladding tube T1 is inserted into the second projection tube 331 in a state where the second sealer G2 is attached to the second continuous groove 317, the second fixing sealer G2 intervenes between the second continuous groove wall 316 and the second fixing end TE1b of the swing cladding tube T1. When the second fixing sealer G2 intervenes between the second continuous groove wall 316 and the second fixing end TE1b of the swing cladding tube T1, the second fixing sealer G2 is compressed by the second continuous groove wall 316 and the second fixing end TE1b of the swing cladding tube T1. When the second fixing sealer G2 is compressed, a gap between the second projection tube 331 and the second fixing end TE1b of the swing cladding tube T1 is sealed with the second fixing sealer G2. That is, the second extended space 333 acquires waterproof properties by causing the second fixing sealer G2 to seal the gap between the second projection tube 331 and the second fixing end TE1b of the swing cladding tube T1. Accordingly, the second fixing end TE1b of the swing cladding tube T1 is cohesively or closely connected to the second wiring opening 315 via the second projection tube 331. Further, the swing cladding tube T1 may be prevented from coming off the second projection tube 331 into the second space 304 owing to friction and repulsion of the second fixing sealer G2 intervening between the second continuous groove wall 316 of the second projection tube 331 and the second fixing end TE1b of the swing cladding tube T1. A compressible size of the second fixing sealer G2 may be selected according to the second continuous groove wall 316 and the second fixing end TE1b of the swing cladding tube T1.

Note that the waterproof structure illustrated in FIG. 63 may also be applicable to the mobile phone 11B according to the second embodiment, the mobile phone 11C according to the third embodiment, and the mobile phone 11D according to the fourth embodiment. In a case the waterproof structure illustrated in FIG. 63 is attached to the mobile phone 11D according to the fourth embodiment, the swing cladding tube T1 is of course passed through the swing connecting member 501 (e.g., see FIG. 56) in place of the swing connecting member 101.

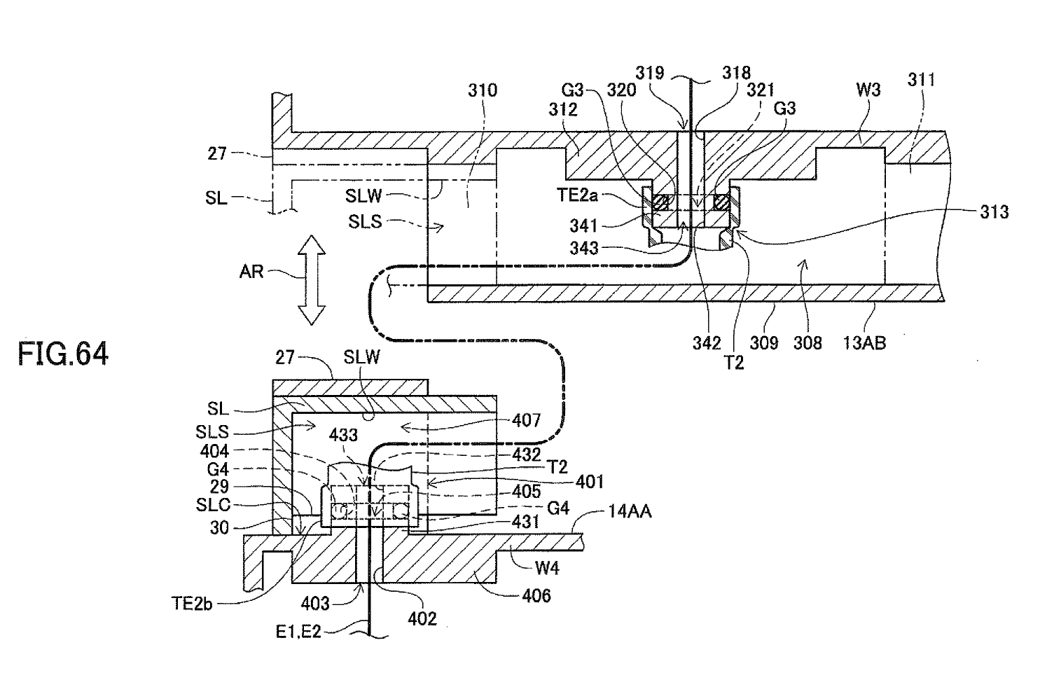

FIG. 64 is a view illustrating a waterproof structure having a third projection tube 341 and a fourth projection tube 431. FIG. 64 depicts sectional views illustrating the second housing side second water stop part 313 and the third housing side water stop part 401 to both of which the pivoting cladding tube T2 is attached.

FIG. 64 depicts simplified external views of the first wiring member E1 and the second wiring member E2. The external view of the pivoting cladding tube T2 is illustrated in a lower part of FIG. 64. In FIG. 64, components identical to those illustrated above are provided with the same reference numerals. In the following description, illustration of the components identical to those provided with the same reference numerals may therefore be omitted. Note that FIG. 64 illustrates a waterproof structure applied to the mobile phone 11A according to the first embodiment. Note that the waterproof structure illustrated in FIG. 64 may be applicable to the mobile phone 11D according to the fourth embodiment.

As illustrated in the lower part of FIG. 64, the pivoting connecting side third housing 14AA includes a third housing side water stop part 401 on a lateral wall W4 forming a third housing side water stop projection 406. The third housing side water stop part 401 includes a fourth wiring opening 403 formed by causing a fourth wiring opening wall 402 to penetrate the lateral wall W4. The lateral wall W4 includes a fourth projection tube 431 projected toward the fourth space 407. The fourth projection tube 431 includes a fourth extended space 433 formed by causing a fourth extended space wall 432 to penetrate the fourth projection tube 431. The fourth extended space 433 is in communication with the fourth wiring opening 403. The first wiring member E1 and the second wiring member E2 residing within the pivoting cladding tube T2 are passed through the fourth extended space 433 and the fourth wiring opening 403 that is in communication with the fourth extended space 433. The fourth projection tube 431 includes a fourth circular continuous groove 405 formed of the fourth continuous groove wall 404 in a circumference of the fourth projection tube 431. The fourth fixing sealer G4 is attached to the second continuous groove 405. Examples of the fourth sealer G4 include an O ring, and the like. The fourth wiring opening 403 or the fourth extended space 433 has a circular cross section. Note that the cross section of the fourth wiring opening 403 or the fourth extended space 433 may have an oblong shape, or a square shape formed by linking the corners of the square in an arc. The fourth projection tube 431 may have a circumferential shape matching an inner circumference of the fourth fixing end TE2b of the pivoting cladding tube T2 inserted into the fourth projection tube 431.

The fourth fixing end TE2b of the pivoting cladding tube T2 passing through the second pivoting shaft SL is inserted into the fourth projection tube 431. When the fourth fixing end TE2b of the pivoting cladding tube T2 is inserted into the fourth projection tube 431, the fourth extended space 433 resides within the fourth fixing end TE2b of the pivoting cladding tube T2. The first wiring member E1 and the second wiring member E2 residing within the pivoting cladding tube T2 are passed through the fourth wiring opening 403 via the fourth extended space 433 of the fourth extended tube 431. The fourth space 407 serves as a wiring space of the pivoting cladding tube T2 through which the first wiring member E1 and the second wiring member E2 are passed. First, the fourth extended space 433 acquires waterproof properties owing to elasticity of the fourth fixing end TE2b of the pivoting cladding tube T2 inserted into the fourth projection tube 431.

When the fourth fixing end TE2b of the pivoting cladding tube T2 is inserted into the fourth projection tube 431 in a state where the fourth sealer G4 is attached to the fourth continuous groove 405, the fourth fixing sealer G4 intervenes between the fourth continuous groove wall 404 and the fourth fixing end TE2b of the pivoting cladding tube T2. When the fourth fixing sealer G4 intervenes between the fourth continuous groove wall 404 and the fourth fixing end TE2b of the pivoting cladding tube T2, the fourth fixing sealer G4 is compressed by the fourth continuous groove wall 404 and the fourth fixing end TE2b of the pivoting cladding tube T2. When the fourth fixing sealer G4 is compressed, a gap between the fourth projection tube 431 and the fourth fixing end TE2b of the pivoting cladding tube T2 is sealed with the fourth fixing sealer G4. That is, the fourth extended space 433 acquires waterproof properties by causing the fourth fixing sealer G4 to seal the gap between the fourth projection tube 431 and the fourth fixing end TE2b of the pivoting cladding tube T2. Accordingly, the fourth fixing end TE2b of the pivoting cladding tube T2 is cohesively or closely connected to the fourth wiring opening 403 via the fourth projection tube 431. Further, the pivoting cladding tube T2 may be prevented from coming off the fourth projection tube 431 into the fourth space 407 owing to friction and repulsion of the fourth fixing sealer G4 intervening between the fourth continuous groove wall 404 of the fourth projection tube 431 and the fourth fixing end TE2b of the pivoting cladding tube T2. A compressible size of the fourth fixing sealer G4 may be selected according to the fourth continuous groove wall 404 and the fourth fixing end TE2b of the pivoting cladding tube T2.

By contrast, as illustrated in an upper part of FIG. 64, the swing connecting side second housing 13AB includes the second housing side second water stop part 313 on a lateral wall W3 forming the second housing side water stop projection 312. The second housing side second water stop part 313 includes a third wiring opening 319 formed by causing the third wiring opening wall 318 to penetrate the lateral wall W3. The lateral wall W3 includes the third projection tube 341 projected toward the third space 308. The third projection tube 341 includes a third extended space 343 formed by causing a third extended space wall 342 to penetrate the third projection tube 341. The third extended space 343 is in communication with the third wiring opening 319. The first wiring member E1 and the second wiring member E2 residing within the pivoting cladding tube T2 are passed through the third extended space 343 and the third wiring opening 319 that is in communication with the third extended space 343. The third projection tube 341 includes a third circular continuous groove 321 formed of the third continuous groove wall 320 in a circumference of the third projection tube 341. The third fixing sealer G3 is attached to the third continuous groove 321. Examples of the third fixing sealer G3 include an O ring, and the like. The third wiring opening 319 or the third extended space 343 has a circular cross section. Note that the cross section of the third wiring opening 319 or the third extended space 343 may have an oblong shape, or a square shape formed by linking the corners of the square in an arc. The third projection tube 341 may have a circumferential shape matching an inner circumference of the third fixing end TE2a of the pivoting cladding tube T2 inserted into the third projection tube 341.

The third fixing end TE2a of the pivoting cladding tube T2 passing through the second pivoting shaft SL is inserted into the third projection tube 341. When the third fixing end TE2a of the pivoting cladding tube T2 is inserted into the third projection tube 341, the third extended space 343 resides within the third fixing end TE2a of the pivoting cladding tube T2. The first wiring member E1 and the second wiring member E2 residing within the pivoting cladding tube T2 are passed through the third wiring opening 319 via the third extended space 343 of the third extended tube 341. The third space 308 serves as a wiring space of the pivoting cladding tube T2 through which the first wiring member E1 and the second wiring member E2 are passed. First, the third extended space 343 acquires waterproof properties owing to elasticity of the third fixing end TE2a of the pivoting cladding tube T2 inserted into the third projection tube 341.

When the third fixing end TE2a of the pivoting cladding tube T2 is inserted into the third projection tube 341 in a state where the third sealer G3 is attached to the third continuous groove 320, the third fixing sealer G3 intervenes between the third continuous groove wall 320 and the third fixing end TE2a of the pivoting cladding tube T2. When the third fixing sealer G3 intervenes between the third continuous groove wall 320 and the third fixing end TE2a of the pivoting cladding tube T2, the third fixing sealer G3 is compressed by the third continuous groove wall 320 and the third fixing end TE2a of the pivoting cladding tube T2. When the third fixing sealer G3 is compressed, a gap between the third projection tube 341 and the third fixing end TE2a of the pivoting cladding tube T2 is sealed with the third fixing sealer G3. That is, the third extended space 343 acquires waterproof properties by causing the third fixing sealer G3 to seal the gap between the third projection tube 341 and the third fixing end TE2a of the pivoting cladding tube T2. Accordingly, the third fixing end TE2a of the pivoting cladding tube T2 is cohesively or closely connected to the third wiring opening 319 via the third projection tube 341. Further, the pivoting cladding tube T2 may be prevented from coming off the third projection tube 341 into the third space 308 owing to friction and repulsion of the third fixing sealer G3 intervening between the third continuous groove wall 320 of the third projection tube 341 and the third fixing end TE2a of the pivoting cladding tube T2. A compressible size of the third fixing sealer G3 may be selected according to the third continuous groove wall 320 and the third fixing end TE2a of the pivoting cladding tube T2.

Note that since a modification of the waterproof structure (see FIG. 24) associated with the electrical connection to the first wiring member E1 and the second wiring member E2 is similar to the waterproof structure with the first insertion type, illustration of such a modification of the waterproof structure associated with the electrical connection is omitted from the description.

### 9-4. Waterproof Structure Having Gasket Integrated Tube

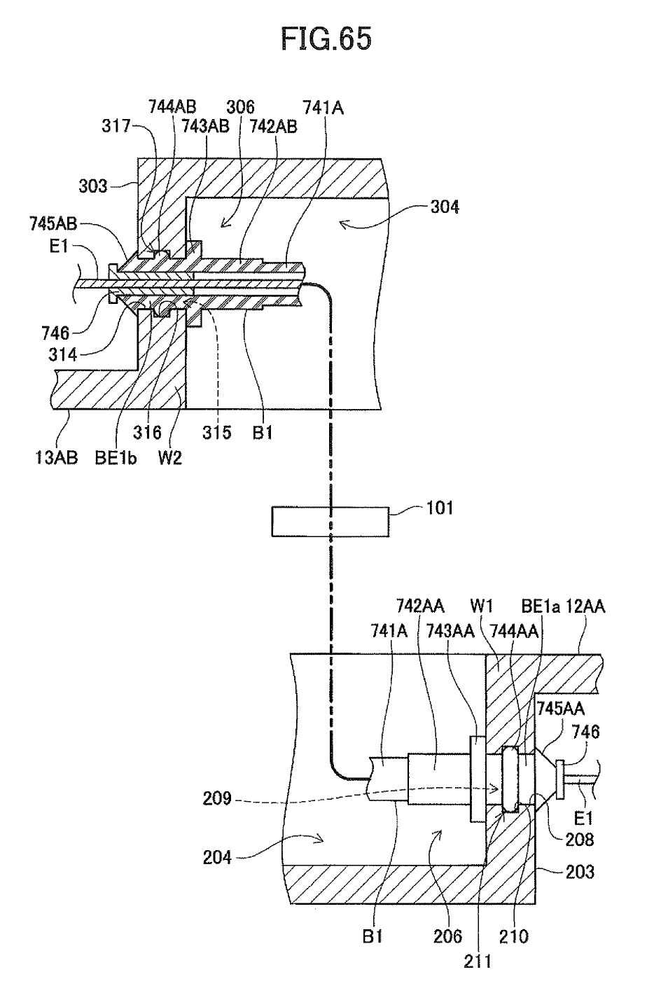

FIG. 65 is a view illustrating a waterproof structure having a swing cladding tube B1 serving as a gasket integrated tube. FIG. 65 depicts sectional views illustrating a first housing side water stop part 206 and a second housing side first water stop part 306 to both of which the swing cladding tube B1 is attached.

FIG. 65 is a simplified external view illustrating a swing connecting member 101. The external views of the first wiring member E1 and the swing cladding tube B1 are illustrated in a lower part of FIG. 65. In FIG. 65, components identical to those illustrated above are provided with the same reference numerals. In the following description, illustration of the components identical to those provided with the same reference numerals may therefore be omitted. Note that FIG. 65 illustrates a waterproof structure applied to the mobile phone 11A according to the first embodiment.

As illustrated in the lower part of FIG. 65, the swing connecting side first housing 12AA includes the first housing side water stop part 206 on a lateral wall W1 of the first space wall 203 forming the first space 204. By contrast, as illustrated in an upper part of FIG. 63, the swing connecting side second housing 13AB includes the second housing side first water stop part 306 on a lateral wall W2 of the second space wall 303 forming the second space 304. Since the first housing side water stop part 206 and the second housing side first water stop part 306 illustrated in FIG. 63 include configurations identical to those illustrated in FIG. 18, illustration of the configurations of the first housing side water stop part 206 and the second housing side first water stop part 306 is omitted from the description.

The swing cladding tube B1 passing through the swing connecting member 101 is attached to the first housing side water stop part 206 and the second housing side first water stop part 306.

The swing cladding tube B1 includes a tube main body 741A. The tube main body 741A includes a first reinforcing part 742AA, and a second reinforcing part 742AB one on each end of the tube main body 741A. The first reinforcing part 742AA includes a first stopper 743AA, a first fixing sealer 744AA, and a first restoration part 745AA as a part of the first reinforcing part 742AA. The first stopper 743AA is a ring-shaped projected part formed in a circumference of the first reinforcing part 742AA. The first fixing sealer 744AA is an O ring-shaped projected part formed in a circumference of the first reinforcing part 742AA. Specifically, the first fixing sealer 744AA serves as a substitute for the gasket. The first fixing sealer 744AA is formed between the first stopper 743AA and the first restoration part 745AA. The first restoration part 745AA is a truncated cone-shaped projected part formed on an apical end of the first reinforcing part 742AA.

The second reinforcing part 742AB includes a second stopper 743AB, a second fixing sealer 744AB, and a second restoration part 745AB that form as a part of the second reinforcing part 742AB. The second stopper 743AA is a ring-shaped projected part formed in a circumference of the second reinforcing part 742AB. The second fixing sealer 744AB is an O ring-shaped projected part formed in a circumference of the second reinforcing part 742AA. Specifically, the second fixing sealer 744AB serves as a substitute for the gasket. The second fixing sealer 744AB is formed between the second stopper 743AB and the second restoration part 745AB. The second restoration part 745AB is a truncated cone-shaped projected part formed on an apical end of the second reinforcing part 742AB.

The swing cladding tube B1 may be obtained by processing a lightweight, soft, and flexible insulating raw material. The swing cladding tube B1 may, for example, be formed of a silicon tube or a resin tube. Accordingly, the swing cladding tube B1 has flexibility or elasticity. The tube main body 741A, the first reinforcing part 742AA, and the second reinforcing part 742AB have flexibility or elasticity, accordingly. Likewise, the first stopper 743AA, the first fixing sealer 744AA, and the first restoration part 745AA have flexibility or elasticity. The second stopper 743AB, the second fixing sealer 744AB, and the second restoration part 745AB have flexibility or elasticity.

A first wiring member E1 passes through the swing cladding tube B1. As illustrated in an upper part of FIG. 65, when the swing cladding tube B1 is attached to the second housing side first water stop part 306, the swing cladding tube B1 is pushed into the second wiring opening 315 via the second space 304 serving as a wiring space. Since the swing cladding tube B1 has elasticity, the second fixing sealer 744AB of the swing cladding tube B1 and the second restoration part 745AB are compressively deformed while the swing cladding tube B1 is pushed into the second wiring opening 315. When the second stopper 743AB of the swing cladding tube B1 is brought into contact with the lateral wall W2 of the second space wall 303, the second fixing sealer 744AB of the swing cladding tube B1 resides in a second continuous groove 317. The second fixing sealer 744AB residing in the second continuous groove 317 is restored from its compressively deformed shape. The second fixing sealer 744AB is attached to the second continuous groove 317 in a state where the second fixing sealer 744AB is restored from its compressively deformed shape. When the second stopper 743AB of the swing cladding tube B1 is brought into contact with the lateral wall W2 of the second space wall 303, the second restoration part 745AB of the swing cladding tube B1 passes through the second wiring opening 315. The second restoration part 745AB passing through the second wiring opening 315 is restored from its compressively deformed shape.

When the swing cladding tube B1 is pulled toward the second space 304 in a state where the second restoration part 745AB of the swing cladding tube B1 is restored from its compressively deformed shape, the second restoration part 745AB is stuck to the lateral wall W2 of the second space wall 303. That is, even though the swing cladding tube B1 is pulled toward the second space 304, the second restoration part 745AB is stuck to the lateral wall W2. Hence, the swing cladding tube B1 may be prevented from coming off the second wiring opening 315 to the second space 304.

A second fixing end BE1b serving as an end part of the swing cladding tube B1 is inserted into the second wiring opening 315 in a state where the second fixing sealer 744AB of the swing cladding tube B1 is attached to the second continuous groove 317. When the second fixing end BE1b of the swing cladding tube B1 is inserted into the second wiring opening 315, the second fixing sealer 744AB intervenes between a second continuous groove wall 316 and the second fixing end BE1b of the swing cladding tube B1. When the second fixing sealer 744AB intervenes between the second continuous groove wall 316 and the second fixing end BE1b of the swing cladding tube B1, the second fixing sealer 744AB is compressed by the second continuous groove wall 316 and the second fixing end BE1b of the swing cladding tube B1. When the second fixing sealer 744AB is compressed, a gap between the second wiring opening wall 314 and the second fixing end BE1b of the swing cladding tube B1 is sealed with the second fixing sealer 744AB. Accordingly, the second fixing end BE1b of the swing cladding tube B1 is cohesively or closely connected to the second wiring opening 315 via the second fixing sealer 744AB. Specifically, the second wiring opening 315 into which the second fixing end BE1b of the swing cladding tube B1 is inserted acquires waterproof properties by the application of the second fixing sealer 744AB to cohesively seal the gap between the second wiring opening wall 314 and the second fixing end BE1b of the swing cladding tube B1. The second fixing sealer 744AB may be formed to have a compressible size according to the second continuous groove wall 316 and the second fixing end BE1b of the swing cladding tube B1.

Further, in a state where the second fixing end BE1b of the swing cladding tube B1 is inserted into the second wiring opening 315, the second fixing end BE1b of the swing cladding tube B1 is tightened with the second fixing sealer 744AB as a reaction of the compressed second fixing sealer 744AB. That is, the state of the second restoration part 745AB being stuck to the lateral wall W2 is stabilized by the second restoration part 745AB being stuck to the lateral wall W2 and repulsion of the second fixing sealer 744AB.

Note that when the repulsion of the second fixing sealer 744AB is insufficient, a hollow pipe 746 is pushed from the second restoration part 745AB into an interval between the swing cladding tube B1 and the first wiring member E1 as illustrated in the upper part of FIG. 65.

In the first housing side water stop part 206 illustrated in the lower part of FIG. 65, a first fixing end BE1a of the swing cladding tube B1 is inserted into the first wiring opening 209. The function and effect of the swing cladding tube B1 attached to the first housing side water stop part 206 illustrated in the lower part of FIG. 65 are similar to those of the swing cladding tube B1 attached to the second housing side first water stop part 306 illustrated in the upper part of FIG. 65. Hence, illustration of the function and effect of the swing cladding tube B1 attached to the first housing side water stop part 206 illustrated in the lower part of FIG. 65 is omitted from the description.

Note that in a case where the only purpose is to provide waterproof properties to the second wiring opening 315, the second stopper 743AB or the second restoration part 745AB may be omitted (removed) from the second reinforcing part 742AB of the swing cladding tube B1. Note that in a case where the only purpose is to provide waterproof properties to the first wiring opening 209, the first stopper 743AA or the first restoration part 745AA may be omitted (removed) from the first reinforcing part 742AA of the swing cladding tube B1.

Note that the waterproof structure illustrated in FIG. 65 may also be applicable to the mobile phone 11B according to the second embodiment, the mobile phone 11C according to the third embodiment, and the mobile phone 11D according to the fourth embodiment. In a case the waterproof structure illustrated in FIG. 65 is applied to the mobile phone 11D according to the fourth embodiment, the swing cladding tube B1 is of course passed through the swing connecting member 501 (e.g., see FIG. 56) in place of the swing connecting member 501.

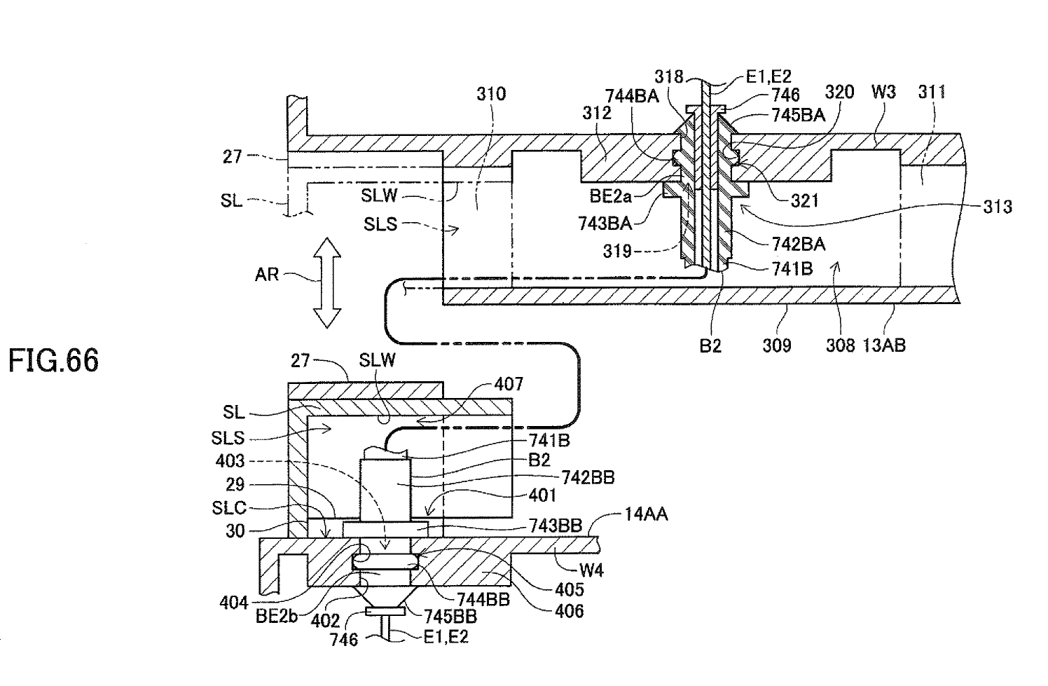

FIG. 66 is a view illustrating a waterproof structure having a pivoting cladding tube B2 serving as a gasket integrated tube. FIG. 66 depicts sectional views illustrating the second housing side second water stop part 313 and the third housing side water stop part 401 to both of which the pivoting cladding tube B2 is attached.

The external views of the first wiring member E1, the second wiring member E2, and the pivoting cladding tube B2 are illustrated in a lower part of FIG. 66. In FIG. 66, components identical to those illustrated above are provided with the same reference numerals. In the following description, illustration of the components identical to those provided with the same reference numerals may therefore be omitted. Note that FIG. 66 illustrates a waterproof structure applied to the mobile phone 11A according to the first embodiment. Note that the waterproof structure illustrated in FIG. 66 may be applicable to the mobile phone 11D according to the fourth embodiment.

As illustrated in an upper part of FIG. 66, the swing connecting side second housing 13AB includes a second housing side second water stop part 313 on a lateral wall W3 forming a second housing side water stop projection 312. On the other hand, as illustrated in the lower part of FIG. 66, the pivoting connecting side third housing 14AA includes a third housing side water stop part 401 on a lateral wall W4 forming a third housing side water stop projection 406. Since the second housing side second water stop part 313 and the third housing side water stop part 401 illustrated in FIG. 66 include configurations identical to those illustrated in FIG. 21, illustration of the configurations of the second housing side second water stop part 313 and the third housing side water stop part 401 illustrated in FIG. 66 is omitted from the description.

The pivoting cladding tube B2 passing through the second pivoting shaft SL is attached to the second housing side second water stop part 313 and the third housing side water stop part 401.

The pivoting cladding tube B2 includes a tube main body 741B. The tube main body 741B includes a third reinforcing part 742BA and a fourth reinforcing part 742BB one on each end of the tube main body 741B. The third reinforcing part 742BA includes a third stopper 743BA, a third fixing sealer 744BA, and a third restoration part 745BA as a part of the first reinforcing part 742BA. The third stopper 743BA is a ring-shaped projected part formed in a circumference of the third reinforcing part 742BA. The third fixing sealer 744BA is an O ring-shaped projected part formed in a circumference of the third reinforcing part 742BA. Specifically, the third fixing sealer 744BA serves as a substitute for the gasket. The third fixing sealer 744BA is formed between the third stopper 743BA and the third restoration part 745BA. The third restoration part 745BA is a truncated cone-shaped projected part formed on an apical end of the third reinforcing part 742BA.

The fourth reinforcing part 742BB includes a fourth stopper 743BB, a fourth fixing sealer 744BB, and a fourth restoration part 745BB as a part of the fourth reinforcing part 742BB. The fourth stopper 743BB is a ring-shaped projected part formed in a circumference of the fourth reinforcing part 742BB. The fourth fixing sealer 744BB is an O ring-shaped projected part formed in a circumference of the fourth reinforcing part 742BB. Specifically, the fourth fixing sealer 744BB serves as a substitute for the gasket. The fourth fixing sealer 744BB is formed between the fourth stopper 743BB and the fourth restoration part 745BB. The fourth restoration part 745BB is a truncated cone-shaped projected part formed on an apical end of the fourth reinforcing part 742BB.

The pivoting cladding tube B2 may be obtained by processing a lightweight, soft, and flexible insulating raw material. The pivoting cladding tube B2 may, for example, be formed of a silicon tube or a resin tube. Accordingly, the pivoting cladding tube B2 has flexibility or elasticity. The tube main body 741B, the third reinforcing part 742BA, and the fourth reinforcing part 742BB have flexibility or elasticity, accordingly. Likewise, the third stopper 743BA, the third fixing sealer 744BA, and the third restoration part 745BA have flexibility or elasticity. The fourth stopper 743BB, the fourth fixing sealer 744BB, and the fourth restoration part 745BB have flexibility or elasticity.

The first wiring member E1 and the second wiring member E2 are passed through the pivoting cladding tube B2. As illustrated in the upper part of FIG. 66, when the pivoting cladding tube B2 is attached to the second housing side first water stop part 313, the pivoting cladding tube B2 is pushed into the third wiring opening 319 via the third space 308 serving as a wiring space. Since the pivoting cladding tube B2 has elasticity, the third fixing sealer 744BA of the pivoting cladding tube B2 and the third restoration part 745BA are compressively deformed while the pivoting cladding tube B2 is pushed into the third wiring opening 319. When the third stopper 743BA of the pivoting cladding tube B2 is brought into contact with the lateral wall W3, the third fixing sealer 744BA of the pivoting cladding tube B2 resides in the third continuous groove 321. The third fixing sealer 744BA residing in the third continuous groove 321 is restored from its compressively deformed shape. The third fixing sealer 744BA is attached to the third continuous groove 321 in a state where the third fixing sealer 744BA is restored from its compressively deformed shape. When the third stopper 743BA of the pivoting cladding tube B2 is brought into contact with the lateral wall W3, the third restoration part 745BA of the pivoting cladding tube B2 passes through the third continuous groove 319. The third restoration part 745BA passing through the third wiring opening 319 is restored from its compressively deformed shape.

When the pivoting cladding tube B2 is pulled toward the third space 308 in a state where the third restoration part 745BA of the pivoting cladding tube B2 is restored from its compressively deformed shape, the third restoration part 745BA is stuck to the lateral wall W2. That is, even though the pivoting cladding tube B2 is pulled toward the third space 308, the third restoration part 745BA is stuck to the lateral wall W3. Hence, the pivoting cladding tube B2 may be prevented from coming off the third wiring opening 319 to the third space 308.

A third fixing end BE2a serving as an end part of the pivoting cladding tube B2 is inserted into the third wiring opening 319 in a state where the third fixing sealer 744BA of the pivoting cladding tube B2 is attached to the third continuous groove 321. When the third fixing end BE2a of the pivoting cladding tube B2 is inserted into the third wiring opening 319, the third fixing sealer 744BA intervenes between the third continuous groove wall 320 and the third fixing end BE2a of the pivoting cladding tube B2. When the third fixing sealer 744BA intervenes between the third continuous groove wall 320 and the third fixing end BE2a of the pivoting cladding tube B2, the third fixing sealer 744BA is compressed by the third continuous groove wall 320 and the third fixing end BE2a of the pivoting cladding tube B2. When the third fixing sealer 744BA is compressed, a gap between the third wiring opening wall 318 and the third fixing end BE2a of the pivoting cladding tube B2 is sealed with the third fixing sealer 744BA. Accordingly, the third fixing end BE2a of the pivoting cladding tube B2 is cohesively or closely connected to the third wiring opening 319 via the third fixing sealer 744BA. Specifically, the third wiring opening 319 into which the third fixing end BE2a of the pivoting cladding tube B2 is inserted acquires waterproof properties by the application of the third fixing sealer 744BA to cohesively seal the gap between the third wiring opening wall 318 and the third fixing end BE2a of the pivoting cladding tube B2. The third fixing sealer 744BA may be formed to have a compressible size according to the third continuous groove wall 320 and the third fixing end BE2a of the pivoting cladding tube B2.

Further, in a state where the third fixing end BE2a of the pivoting cladding tube B2 is inserted into the third wiring opening 319, the third fixing end BE2a of the pivoting cladding tube B2 is tightened with the third fixing sealer 744BA as a reaction of the compressed third fixing sealer 744BA. That is, the state of the third restoration part 745BA being stuck to the lateral wall W3 is stabilized by the third restoration part 745BA being stuck to the lateral wall W3 and repulsion of the third fixing sealer 744BA.

Note that when the repulsion of the second fixing sealer 744BA is insufficient, a hollow pipe 746 is pushed from the third restoration part 745BA into an interval between the pivoting cladding tube B2 and the first wiring member E1 as illustrated in the upper part of FIG. 66.

In the third housing side water stop part 401 illustrated in the lower part of FIG. 66, a fourth fixing end BE2b of the pivoting cladding tube B2 is inserted into the fourth wiring opening 403. The function and effect of the pivoting cladding tube B2 attached to the third housing side water stop part 401 illustrated in the lower part of FIG. 66 are similar to those of the pivoting cladding tube B2 attached to the second housing side second water stop part 313 illustrated in the upper part of FIG. 66. Hence, illustration of the function and effect of the pivoting cladding tube B2 attached to the third housing side water stop part 401 illustrated in the lower part of FIG. 66 is omitted from the description.

As described above, the hollow pipe 746 is given as an example of “a first cohesive connection unit”, “a second cohesive connection unit”, “a third cohesive connection unit”, and “a fourth cohesive connection unit”. Alternatively, a slitting pipe, a double-segmented pipe, or a multi-segmented pipe may be employed in place of the hollow pipe 746. Accordingly, the slitting pipe, the double-segmented pipe, or the multi-segmented pipe may also be given as examples of “a first cohesive connection unit”, “a second cohesive connection unit”, “a third cohesive connection unit”, and “a fourth cohesive connection unit”.

Note that in a case where the only purpose is to provide waterproof properties to the third wiring opening 319, the third stopper 743BA or the third restoration part 745BA may be omitted (removed) from the third reinforcing part 742BA of the pivoting cladding tube B2. Note that in a case where the only purpose is to provide waterproof properties to the fourth wiring opening 403, the fourth stopper 743BB or the fourth restoration part 745BB may be omitted (removed) from the fourth reinforcing part 742BB of the pivoting cladding tube B2.

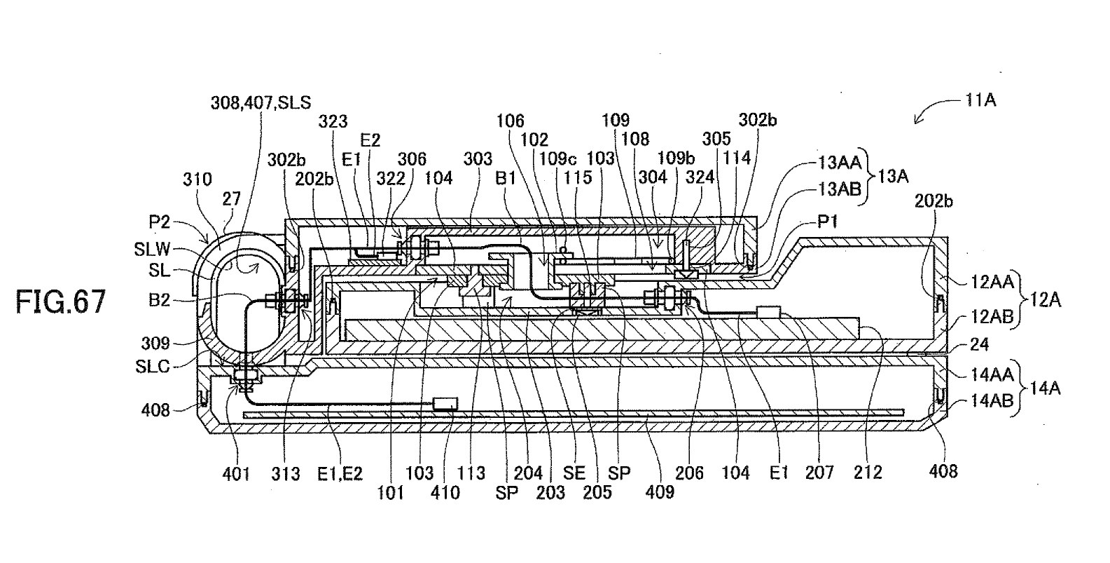

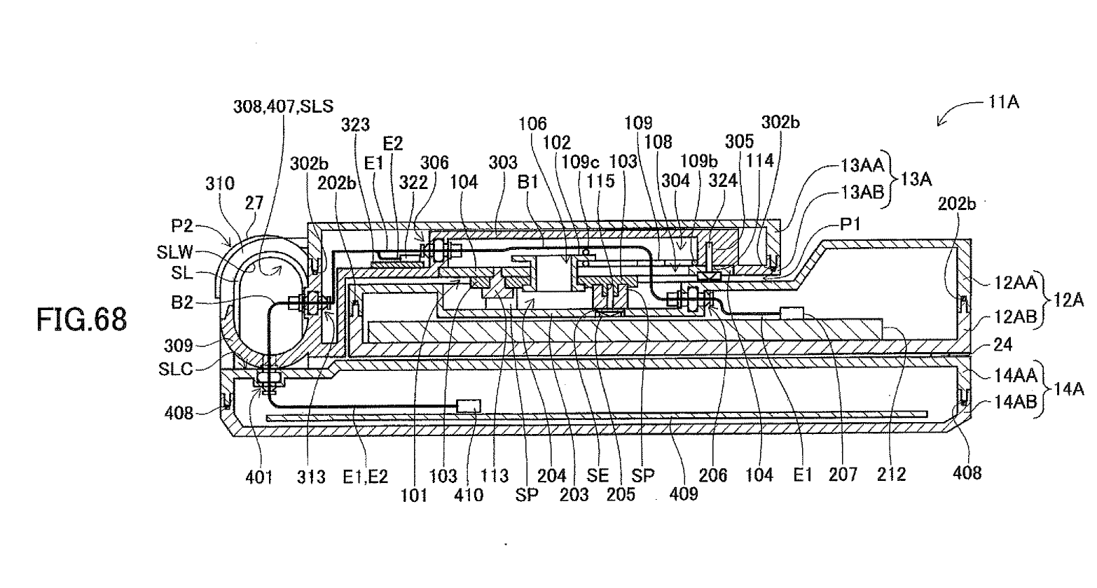

FIG. 67 or 68 is a sectional view illustrating the mobile phone 11A according to the first embodiment having a swing cladding tube B1 or a pivoting cladding tube B2 serving as a gasket integrated tube. The sectional view illustrated in FIG. 67 or 68 depicts a cross section of the mobile phone 11A according to the first embodiment viewing from a point D1 in FIG. 3 in a case where the mobile phone 11A according to the first embodiment in the folded state illustrated in FIG. 3 is cut along a dash-dot section line D. Note that illustration of the third space wall 31 (see FIG. 3) placed over the third space wall 309 is omitted from FIG. 67 or 68.

In FIGS. 67 to 68, components identical to those illustrated in FIG. 23 or 32 are provided with the same reference numerals. The mobile phone 11A according to the first embodiment illustrated in FIG. 67 or 68 employs the swing cladding tube B1 or the pivoting cladding tube B2 as a gasket integrated tube. That is, the mobile phone 11A according to the first embodiment illustrated in FIG. 67 or 68 has a configuration identical to that illustrated in FIG. 23 or 32 except that the swing cladding tube B1 or the pivoting cladding tube B2 is employed in place of the swing cladding tube T1 or the pivoting cladding tube T2. Accordingly, illustration of the components in FIG. 67 or 68 identical to those of FIG. 23 or 32 provided with the same reference numerals is therefore omitted.

In the mobile phone 11A according to the first embodiment illustrated in FIG. 67, the swing cladding tube B1 passes through the first shaft hole 106 of the swing connecting member 101. In the mobile phone 11A according to the first embodiment illustrated in FIG. 68, the swing cladding tube B1 passes through the guide slot 108 of the swing connecting member 101. When the swing cladding tube B1 passes through the guide slot 108 of the swing connecting member 101, the swing cladding tube B1 may be fixed by the fixing member 151 (see FIG. 34) as illustrated in the third insertion type above. When the swing cladding tube B1 passes through the swing connecting member 101, the swing cladding tube B1 may be passed through the dedicated hole 162 (e.g., see FIG. 40) of the swing connecting member 101 as illustrated in the fourth insertion type above. A similar insertion type of the swing cladding tube B1 inserted into the swing connecting member 101 in the mobile phone 11A according to the first embodiment may be applicable to the mobile phone 11B according to the second embodiment or the mobile phone 11C according to the third embodiment. In the mobile phone 11D according to the fourth embodiment, the swing cladding tube B1 passes through the dedicated pivoting shaft hole 506 of the swing connecting member 501 (e.g., see FIG. 56).

In the mobile phone 11A according to the first embodiment illustrated in FIG. 67, the pivoting cladding tube B2 passes through the second pivoting shaft SL. Likewise, in the mobile phone 11A according to the first embodiment illustrated in FIG. 68, the pivoting cladding tube B2 is also passed through the second pivoting shaft SL. A similar insertion type of the pivoting cladding tube B2 inserted into the second pivoting shaft SL in the mobile phone 11A according to the first embodiment may be applicable to the mobile phone 11D according to the fourth embodiment.

Note that since a modification of the waterproof structure (see FIG. 24) associated with the electrical connection to the first wiring member E1 and the second wiring member E2 is similar to the waterproof structure with the first insertion type, illustration of such a modification of the waterproof structure associated with the electrical connection is omitted from the description.

### 9-5. Waterproof Structure Having Cable Integrated Tube

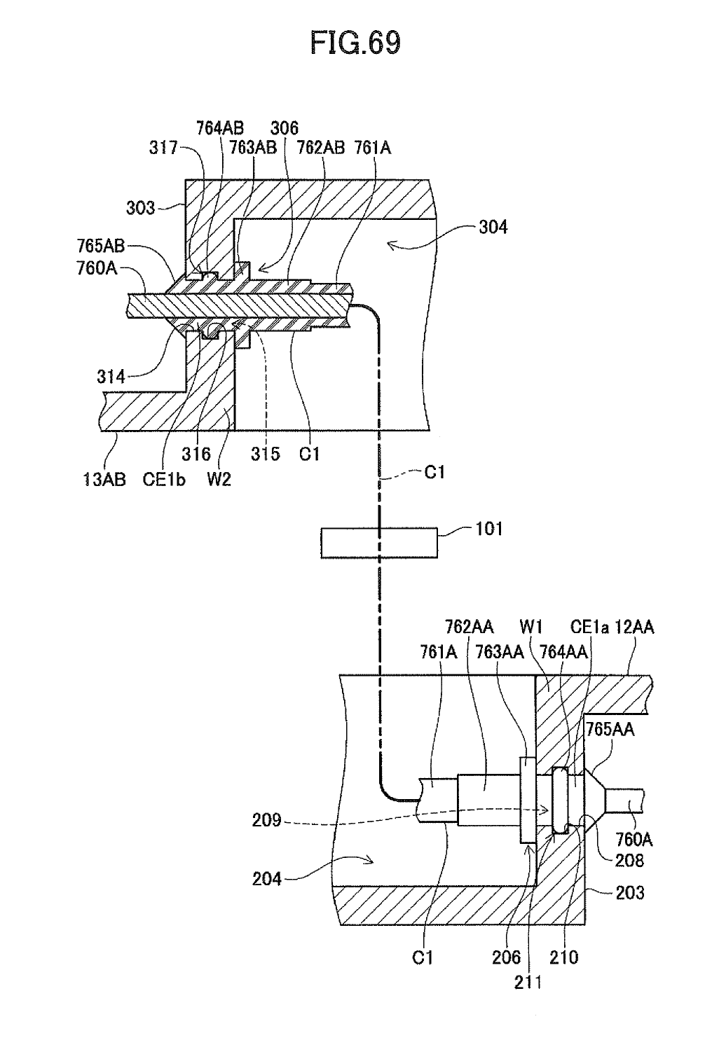

FIG. 69 is a view illustrating a waterproof structure having a swing cladding tube C1 serving as a cable integrated tube. FIG. 69 depicts sectional views illustrating the first housing side water stop part 206 and the second housing side first water stop part 306 to both of which the swing cladding tube C1 is attached.

FIG. 69 is a simplified external view illustrating a swing connecting member 101. The external views of a first wiring member 760A and the swing cladding tube C1 are illustrated in a lower part of FIG. 69. In FIG. 69, components identical to those illustrated above are provided with the same reference numerals. In the following description, illustration of the components identical to those provided with the same reference numerals may therefore be omitted. Note that FIG. 69 illustrates a waterproof structure applied to the mobile phone 11A according to the first embodiment.

As illustrated in the lower part of FIG. 69, the swing connecting side first housing 12AA includes the first housing side water stop part 206 on a lateral wall W1 of the first space wall 203 forming the first space 204. By contrast, as illustrated in an upper part of FIG. 69, the swing connecting side second housing 13AB includes the second housing side first water stop part 306 on a lateral wall W2 of the second space wall 303 forming the second space 304. Since the first housing side water stop part 206 and the second housing side first water stop part 306 illustrated in FIG. 69 include configurations identical to those illustrated in FIG. 18, illustration of the configurations of the first housing side water stop part 206 and the second housing side first water stop part 306 is omitted from the description.

The swing cladding tube C1 passing through the swing connecting member 101 is attached to the first housing side water stop part 206 or the second housing side first water stop part 306.

The swing cladding tube C1 includes a first wiring member 760A, and a tube main body 761A. A core wire of a single-core cable, each of core wires of a multi-core cable, each of core wires of a flat cable, or each of core wires of a thin coaxial cable may be given as an example of the first wiring member 760A.

The tube main body 761A includes a first reinforcing part 762AA, and a second reinforcing part 762AB one on each end of the tube main body 761A. The first reinforcing part 762AA includes a first stopper 763AA, a first fixing sealer 764AA, and a first restoration part 765AA as a part of the first reinforcing part 762AA. The first stopper 763AA is a ring-shaped projected part formed in a circumference of the first reinforcing part 762AA. The first fixing sealer 764AA is an O ring-shaped projected part formed in a circumference of the first reinforcing part 762AA. The first fixing sealer 764AA serves as a substitute for the gasket. The first fixing sealer 764AA is formed between the first stopper 763AA and the first restoration part 765AA. The first restoration part 765AA is a truncated cone-shaped projected part formed on an apical end of the first reinforcing part 762AA.

The second reinforcing part 762AB includes a second stopper 763AB, a second fixing sealer 764AB, and a second restoration part 765AB that form as a part of the second reinforcing part 762AB. The second stopper 763AA is a ring-shaped projected part formed in a circumference of the second reinforcing part 762AB. The second fixing sealer 764AB is an O ring-shaped projected part formed in a circumference of the second reinforcing part 762AA. The second fixing sealer 764AB serves as a substitute for the gasket. The second fixing sealer 764AB is formed between the second stopper 763AB and the second restoration part 765AB. The second restoration part 765AB is a truncated cone-shaped projected part formed on an apical end of the second reinforcing part 762AB.

A protection outer sheath (or simply called a “sheath”) of a cable may be given as an example of the tube main body 761A. Hence, the tube main body 761A may exhibit flexibility or elasticity in a case where the protection outer sheath (or simply called a “sheath”) of the cable is employed as the tube main body 761A. The first reinforcing part 762AA, and the second reinforcing part 762AB may exhibit flexibility or elasticity, accordingly. Likewise, the first stopper 763AA, the first fixing sealer 764AA, and the first restoration part 765AA may exhibit flexibility or elasticity. The second stopper 763AB, the second fixing sealer 764AB, and the second restoration part 765AB may also exhibit flexibility or elasticity. That is, the swing cladding tube C1 may exhibit flexibility or elasticity.

As illustrated in an upper part of FIG. 69, when the swing cladding tube C1 is attached to the second housing side first water stop part 306, the swing cladding tube C1 is pushed into the second wiring opening 315 via the second space 304 serving as a wiring space. Since the swing cladding tube C1 has elasticity, the second fixing sealer 764AB of the swing cladding tube C1 and the second restoration part 765AB are compressively deformed while the swing cladding tube C1 is pushed into the second wiring opening 315. When the second stopper 763AB of the swing cladding tube C1 is brought into contact with the lateral wall W2, the second fixing sealer 764AB of the swing cladding tube C1 resides in the second continuous groove 317. The second fixing sealer 764AB residing in the second continuous groove 317 is restored from its compressively deformed shape. The second fixing sealer 764AB is attached to the second continuous groove 317 in a state where the second fixing sealer 764AB is restored from the compressively deformed shape. When the second stopper 763AB of the swing cladding tube C1 is brought into contact with the lateral wall W2, the second restoration part 765AB of the swing cladding tube C1 passes through the second wiring opening 315. The second restoration part 765 AB passing through the second wiring opening 315 is restored from its compressively deformed shape.

When the swing cladding tube C1 is pulled toward the second space 304 in a state where the second restoration part 765AB of the swing cladding tube C1 is restored from its compressively deformed shape, the second restoration part 765AB is stuck to the lateral wall W2. That is, even though the swing cladding tube C1 is pulled toward the second space 304, the second restoration part 765AB is stuck to the lateral wall W2. Hence, the swing cladding tube C1 may be prevented from coming off the second wiring opening 315 to the second space 304.

A second fixing end CE1b serving as an end part of the swing cladding tube C1 is inserted into the second wiring opening 315 in a state where the second fixing sealer 764AB of the swing cladding tube C1 is attached to the second continuous groove 317. When the second fixing end CE1b of the swing cladding tube C1 is inserted into the second wiring opening 315, the second fixing sealer 764AB intervenes between a second continuous groove wall 316 and the second fixing end CE1b of the swing cladding tube C1. When the second fixing sealer 764AB intervenes between the second continuous groove wall 316 and the second fixing end CE1b of the swing cladding tube C1, the second fixing sealer 764AB is compressed by the second continuous groove wall 316 and the second fixing end CE1b of the swing cladding tube C1. When the second fixing sealer 764AB is compressed, a gap between the second wiring opening wall 314 and the second fixing end CE1b of the swing cladding tube C1 is sealed with the second fixing sealer 764AB. Accordingly, the second fixing end CE1b of the swing cladding tube C1 is cohesively or closely connected to the second wiring opening 315 via the second fixing sealer 764AB. Specifically, the second wiring opening 315 into which the second fixing end CE1b of the swing cladding tube C1 is inserted acquires waterproof properties by the application of the second fixing sealer 764AB to cohesively seal the gap between the second wiring opening wall 314 and the second fixing end CE1b of the swing cladding tube C1. The second fixing sealer 764AB may be formed to have a compressible size according to the second continuous groove wall 316 and the second fixing end CE1b of the swing cladding tube C1.

Further, in a state where the second fixing end CE1b of the swing cladding tube C1 is inserted into the second wiring opening 315, the second fixing end CE1b of the swing cladding tube C1 is tightened with the second fixing sealer 764AB as a reaction of the compressed second fixing sealer 764AB. That is, the state of the second restoration part 765AB being stuck to the lateral wall W2 is stabilized by the second restoration part 765AB being stuck to the lateral wall W2 and repulsion of the second fixing sealer 764AB.

In the first housing side water stop part 206 illustrated in the lower part of FIG. 69, a first fixing end CE1a of the swing cladding tube C1 is inserted into the first wiring opening 209. The function and effect of the swing cladding tube C1 attached to the first housing side water stop part 206 illustrated in the lower part of FIG. 69 are similar to those of the swing cladding tube C1 attached to the second housing side first water stop part 306 illustrated in the upper part of FIG. 69. Hence, illustration of the function and effect of the swing cladding tube C1 attached to the first housing side water stop part 206 illustrated in the lower part of FIG. 69 is omitted from the description.

Note that in a case where the only purpose is to provide waterproof properties to the second wiring opening 315, the second stopper 763AB or the second restoration part 765AB may be omitted (removed) from the second reinforcing part 762AB of the swing cladding tube C1. Note that in a case where the only purpose is to provide waterproof properties to the first wiring opening 209, the first stopper 763AA or the first restoration part 765AA may be omitted (removed) from the first reinforcing part 762AA of the swing cladding tube C1.

Note that the waterproof structure illustrated in FIG. 69 may also be applicable to the mobile phone 11B according to the second embodiment, the mobile phone 11C according to the third embodiment, and the mobile phone 11D according to the fourth embodiment. In a case the waterproof structure illustrated in FIG. 69 is applied to the mobile phone 11D according to the fourth embodiment, the swing cladding tube C1 is of course passed through the swing connecting member 501 (e.g., see FIG. 56) in place of the swing connecting member 501.

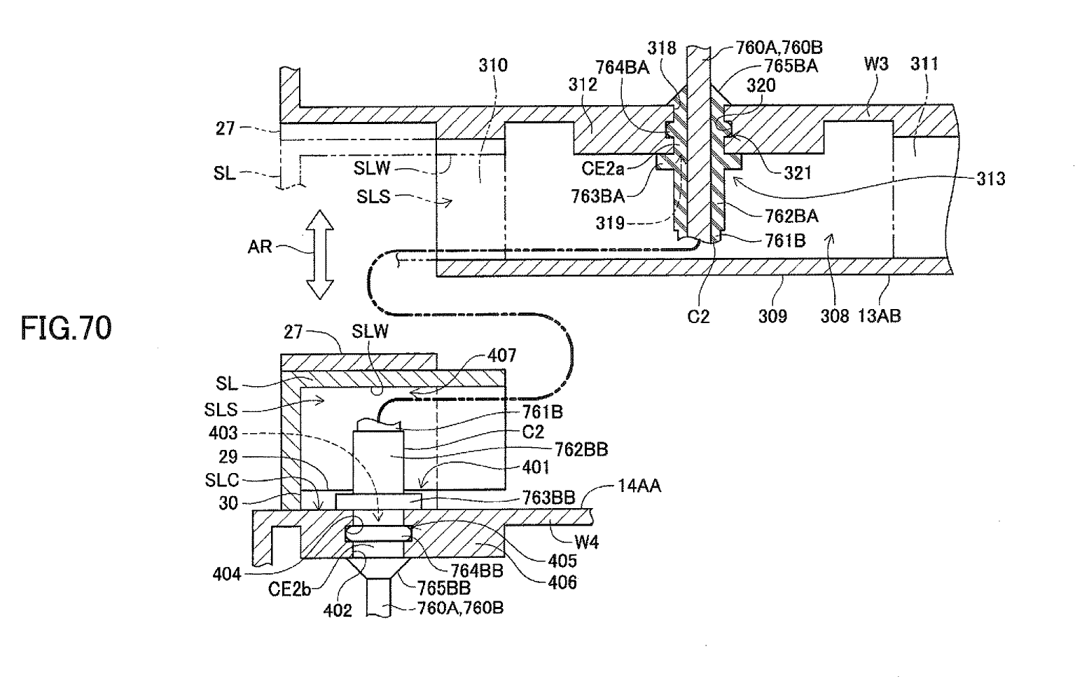

FIG. 70 is a view illustrating a waterproof structure utilizing a pivoting cladding tube serving as a cable integrated tube C2. FIG. 70 depicts sectional views illustrating the second housing side second water stop part 313 and the third housing side water stop part 401 to both of which the pivoting cladding tube C2 is attached.

The external views of the first wiring member 760A, the second wiring member 760b, and the pivoting cladding tube C2 are illustrated in a lower part of FIG. 70. In FIG. 70, components identical to those illustrated above are provided with the same reference numerals. In the following description, illustration of the components identical to those provided with the same reference numerals may therefore be omitted. Note that FIG. 70 illustrates a waterproof structure applied to the mobile phone 11A according to the first embodiment. Note that the waterproof structure illustrated in FIG. 70 may be applicable to the mobile phone 11D according to the fourth embodiment.

As illustrated in an upper part of FIG. 70, the swing connecting side second housing 13AB includes the second housing side second water stop part 313 on a lateral wall W3 forming the second housing side water stop projection 312. On the other hand, as illustrated in the lower part of FIG. 70, the pivoting connecting side third housing 14AA includes a third housing side water stop part 401 on a lateral wall W4 forming a third housing side water stop projection 406. Since the second housing side second water stop part 313 and the third housing side water stop part 401 illustrated in FIG. 70 include configurations identical to those illustrated in FIG. 21, illustration of the configurations of the second housing side second water stop part 313 and the third housing side water stop part 401 illustrated in FIG. 70 is omitted from the description.

The pivoting cladding tube C2 passing through the second pivoting shaft SL is attached to the second housing side second water stop part 313 and the third housing side water stop part 401.

The pivoting cladding tube C2 includes a first wiring member 760A, a second wiring member 760B, and a tube main body 761B. A core wire of a single-core cable, each of core wires of a multi-core cable, each of core wires of a flat cable, or each of core wires of a thin coaxial cable may be given as an example of the second wiring member 760B.

The tube main body 761B includes a third reinforcing part 762BA and a fourth reinforcing part 762BB one on each end of the tube main body 761B. The third reinforcing part 762BA includes a third stopper 763BA, a third fixing sealer 764BA, and a third restoration part 765BA as a part of the first reinforcing part 762BA. The third stopper 763BA is a ring-shaped projected part formed in a circumference of the third reinforcing part 762BA. The third fixing sealer 764BA is an O ring-shaped projected part formed in a circumference of the third reinforcing part 762BA. The third fixing sealer 764BA serves as a substitute for the gasket. The third fixing sealer 764BA is provided between the third stopper 763BA and the third restoration part 765BA. The third restoration part 765BA is a truncated cone-shaped projected part formed on an apical end of the third reinforcing part 762BA.

The fourth reinforcing part 762BB includes a fourth stopper 763BB, a fourth fixing sealer 764BB, and a fourth restoration part 765BB as a part of the fourth reinforcing part 762BB. The fourth stopper 763BB is a ring-shaped projected part formed in a circumference of the fourth reinforcing part 762BB. The fourth fixing sealer 764BB is an O ring-shaped projected part formed in a circumference of the fourth reinforcing part 762BB. The fourth fixing sealer 764BB serves as a substitute for the gasket. The fourth fixing sealer 764BB is provided between the fourth stopper 763BB and the fourth restoration part 765BB. The fourth restoration part 765BB is a truncated cone-shaped projected part formed on an apical end of the fourth reinforcing part 762BB.

A protection outer sheath (or simply called a “sheath”) of a cable may be given as an example of the tube main body 761B. Hence, the tube main body 761B may exhibit flexibility or elasticity in a case where the protection outer sheath (or simply called a “sheath”) of the cable is employed as the tube main body 761B. The third reinforcing part 762BA, and the fourth reinforcing part 762BB may exhibit flexibility or elasticity, accordingly. Likewise, the third stopper 763BA, the third fixing sealer 764BA, and the third restoration part 765BA may exhibit flexibility or elasticity. The fourth stopper 763BB, the fourth fixing sealer 764BB, and the fourth restoration part 765BB may also exhibit flexibility or elasticity. That is, the pivoting cladding tube C2 may exhibit flexibility or elasticity.

As illustrated in the upper part of FIG. 70, when the pivoting cladding tube C2 is attached to the second housing side first water stop part 313, the pivoting cladding tube C2 is pushed into the third wiring opening 319 via the third space 308 serving as a wiring space. Since the pivoting cladding tube C2 has elasticity, the third fixing sealer 764BA of the pivoting cladding tube C2 and the third restoration part 765BA are compressively deformed while the pivoting cladding tube C2 is pushed into the third wiring opening 319. When the third stopper 763BA of the pivoting cladding tube C2 is brought into contact with the lateral wall W3, the third fixing sealer 764BA of the pivoting cladding tube C2 resides in the third continuous groove 321. The third fixing sealer 764BA residing in the third continuous groove 321 is restored from its compressively deformed shape. The third fixing sealer 764BA is attached to the third continuous groove 321 in a state where the third fixing sealer 764BA is restored from its compressively deformed shape. When the third stopper 763BA of the pivoting cladding tube C2 is brought into contact with the lateral wall W3, the third restoration part 765BA of the pivoting cladding tube C2 passes through the third continuous groove 319. The third restoration part 765BA passing through the third wiring opening 319 is restored from its compressively deformed shape.

When the pivoting cladding tube C2 is pulled toward the third space 308 in a state where the third restoration part 765BA of the pivoting cladding tube C2 is restored from its compressively deformed shape, the third restoration part 765BA is stuck to the lateral wall W3. That is, even though the pivoting cladding tube C2 is pulled toward the third space 308, the third restoration part 765BA is stuck to the lateral wall W3. Hence, the pivoting cladding tube C2 may be prevented from coming off the third wiring opening 319 to the third space 308.

A third fixing end CE2a serving as an end part of the pivoting cladding tube C2 is inserted into the third wiring opening 319 in a state where the third fixing sealer 764BA of the pivoting cladding tube C2 is attached to the third continuous groove 321. When the third fixing end CE2a of the pivoting cladding tube C2 is inserted into the third wiring opening 319, the third fixing sealer 764BA intervenes between the third continuous groove wall 320 and the third fixing end CE2a of the pivoting cladding tube C2. When the third fixing sealer 764BA intervenes between the third continuous groove wall 320 and the third fixing end CE2a of the pivoting cladding tube C2, the third fixing sealer 764BA is compressed by the third continuous groove wall 320 and the third fixing end CE2a of the pivoting cladding tube C2. When the third fixing sealer 764BA is compressed, a gap between the third wiring opening wall 318 and the third fixing end CE2a of the pivoting cladding tube C2 is sealed with the third fixing sealer 764BA. Accordingly, the third fixing end CE2a of the pivoting cladding tube C2 is cohesively or closely connected to the third wiring opening 319 via the third fixing sealer 764BA. Specifically, the third wiring opening 319 into which the third fixing end CE2a of the pivoting cladding tube C2 is inserted acquires waterproof properties by the application of the third fixing sealer 764BA to cohesively seal the gap between the third wiring opening wall 318 and the third fixing end CE2a of the pivoting cladding tube C2. The third fixing sealer 764BA may be formed to have a compressible size according to the third continuous groove wall 320 and the third fixing end CE2a of the pivoting cladding tube C2.

Further, in a state where the third fixing end CE2a of the pivoting cladding tube C2 is inserted into the third wiring opening 319, the third fixing end CE2a of the pivoting cladding tube C2 is tightened with the third fixing sealer 764BA as a reaction of the compressed third fixing sealer 764BA. That is, the state of the third restoration part 765BA being stuck to the lateral wall W3 is stabilized by the third restoration part 765BA being stuck to the lateral wall W3 and repulsion of the third fixing sealer 764BA.

In the third housing side water stop part 401 illustrated in the lower part of FIG. 70, a fourth fixing end CE2b of the pivoting cladding tube C2 is inserted into the fourth wiring opening 403. The function and effect of the pivoting cladding tube C2 attached to the third housing side water stop part 401 illustrated in the lower part of FIG. 70 are similar to those of the pivoting cladding tube C2 attached to the second housing side second water stop part 313 illustrated in the upper part of FIG. 70. Hence, illustration of the function and effect of the pivoting cladding tube C2 attached to the third housing side water stop part 401 illustrated in the lower part of FIG. 70 is omitted from the description.

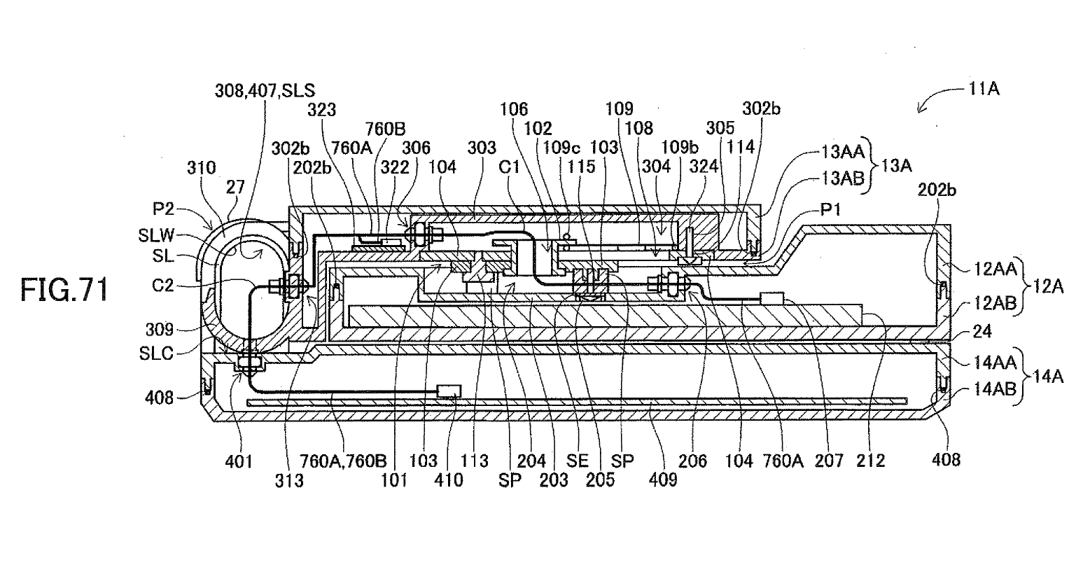

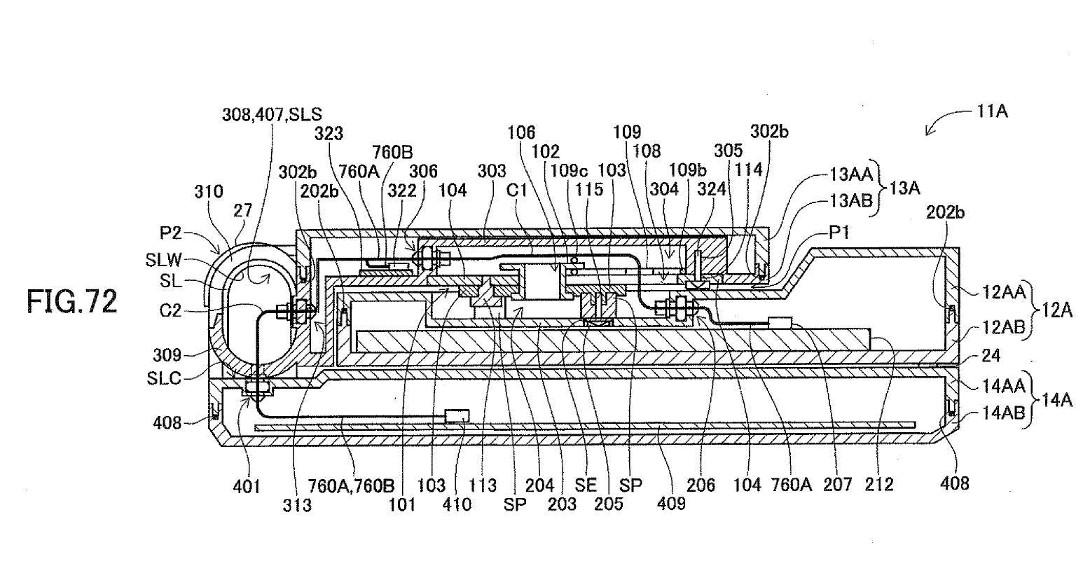

FIG. 71 or 72 is a sectional view illustrating the mobile phone 11A according to the first embodiment having a swing cladding tube C1 or a pivoting cladding tube C2 serving as a cable integrated tube. The sectional view illustrated in FIG. 71 or 72 depicts a cross section of the mobile phone 11A according to the first embodiment viewing from a point D1 in FIG. 3 in a case where the mobile phone 11A according to the first embodiment in the folded state illustrated in FIG. 3 is cut along a dash-dot section line D. Note that illustration of the third space wall 31 (see FIG. 3) placed over the third space wall 309 is omitted from FIG. 71 or 72.

In FIGS. 71 to 72, components identical to those illustrated in FIG. 23 or 32 are provided with the same reference numerals. The mobile phone 11A according to the first embodiment illustrated in FIG. 71 or 72 employs the swing cladding tube C1 or the pivoting cladding tube C2 as a cable integrated tube in place of the swing cladding tube T1 or the pivoting cladding tube T2 illustrated in FIG. 23 or 32. The swing cladding tube C1 envelops a first wiring member 760A. The pivoting cladding tube C2 envelops the first wiring member 760A and the second wiring member 760B. That is, the mobile phone 11A according to the first embodiment illustrated in FIG. 71 or 72 has a configuration identical to that illustrated in FIG. 23 or 32 except that the swing cladding tube C1 enveloping the first wiring member 760A or the pivoting cladding tube C2 enveloping the first wiring member 760A and the second wiring member 760B is employed in place of the swing cladding tube T1 or the pivoting cladding tube T2 illustrated in FIG. 23 or 32. Accordingly, illustration of the components in FIG. 71 or 72 identical to those of FIG. 23 or 32 provided with the same reference numerals is therefore omitted.

In the mobile phone 11A according to the first embodiment illustrated in FIG. 71, the swing cladding tube C1 passes through the first shaft hole 106 of the swing connecting member 101. In the mobile phone 11A according to the first embodiment illustrated in FIG. 72, the swing cladding tube C1 passes through the guide slot 108 of the swing connecting member 101. When the swing cladding tube C1 passes through the guide slot 108 of the swing connecting member 101, the swing cladding tube C1 may be fixed by the fixing member 151 (see FIG. 34) as illustrated in the third insertion type above. When the swing cladding tube C1 passes through the swing connecting member 101, the swing cladding tube C1 may be passed through the dedicated hole 162 (e.g., see FIG. 40) of the swing connecting member 101 as illustrated in the fourth insertion type above. A similar insertion type of the swing cladding tube C1 inserted into the swing connecting member 101 in the mobile phone 11A according to the first embodiment may be applicable to the mobile phone 11B according to the second embodiment or the mobile phone 11C according to the third embodiment. In the mobile phone 11D according to the fourth embodiment, the swing cladding tube C1 passes through the dedicated pivoting shaft hole 506 of the swing connecting member 501 (e.g., see FIG. 56).

In the mobile phone 11A according to the first embodiment illustrated in FIG. 72, the pivoting cladding tube C2 passes through the second pivoting shaft SL. In the mobile phone 11A according to the first embodiment illustrated in FIG. 72, the pivoting cladding tube C2 passes through the second pivoting shaft SL. A similar insertion type of the pivoting cladding tube C2 inserted into the second pivoting shaft SL in the mobile phone 11A according to the first embodiment may be applicable to the mobile phone 11D according to the fourth embodiment.

Note that in a case where the only purpose is to provide waterproof properties to the third wiring opening 319, the third stopper 763BA or the third restoration part 765BA may be omitted (removed) from the third reinforcing part 762BA of the pivoting cladding tube B2. Note that in a case where the only purpose is to provide the waterproof properties to the fourth wiring opening 403, the fourth stopper 763BB or the fourth restoration part 765BB may be omitted (removed) from the fourth reinforcing part 762BB of the pivoting cladding tube C2.

Note that a modification associated with the electrical connection to the first wiring member E1 and the second wiring member E2 is similar to the modification associated with the electrical connection to the first wiring member E1 and the second wiring member E2 in the waterproof structure with the aforementioned first insertion type. Thus, illustration of such a modification of the waterproof structure associated with the electrical connection is omitted from the description.

### 10. Modification

The order of the embodiments will not indicate superiority or inferiority of the invention. Alterations may be made to the embodiments without departing from the scope of the invention.

### 10-1. Modification of Waterproof Structure Illustrated in FIGS. 19 and 22

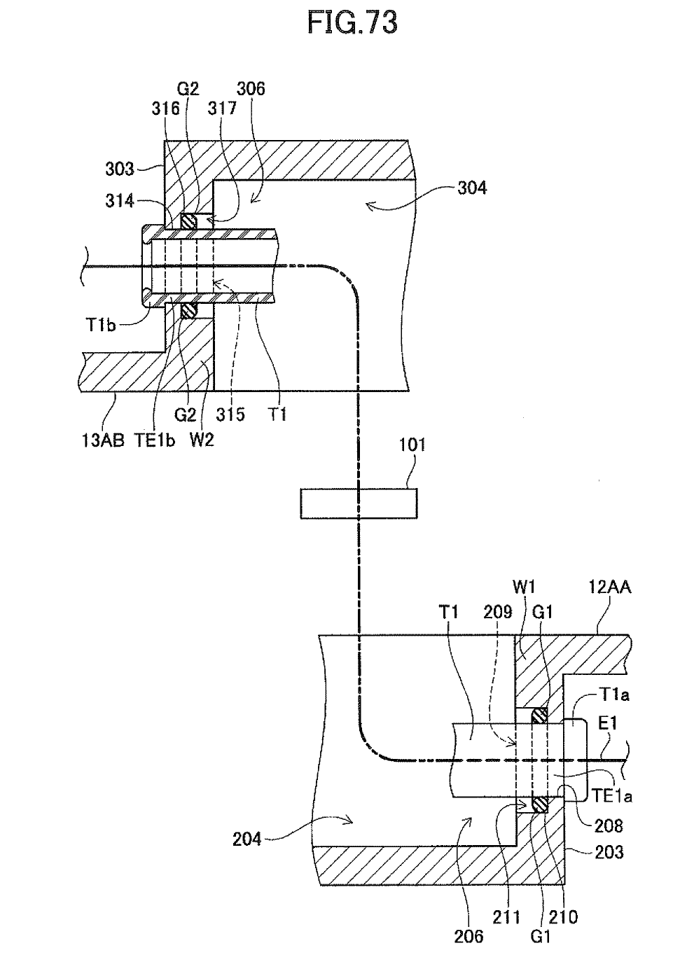

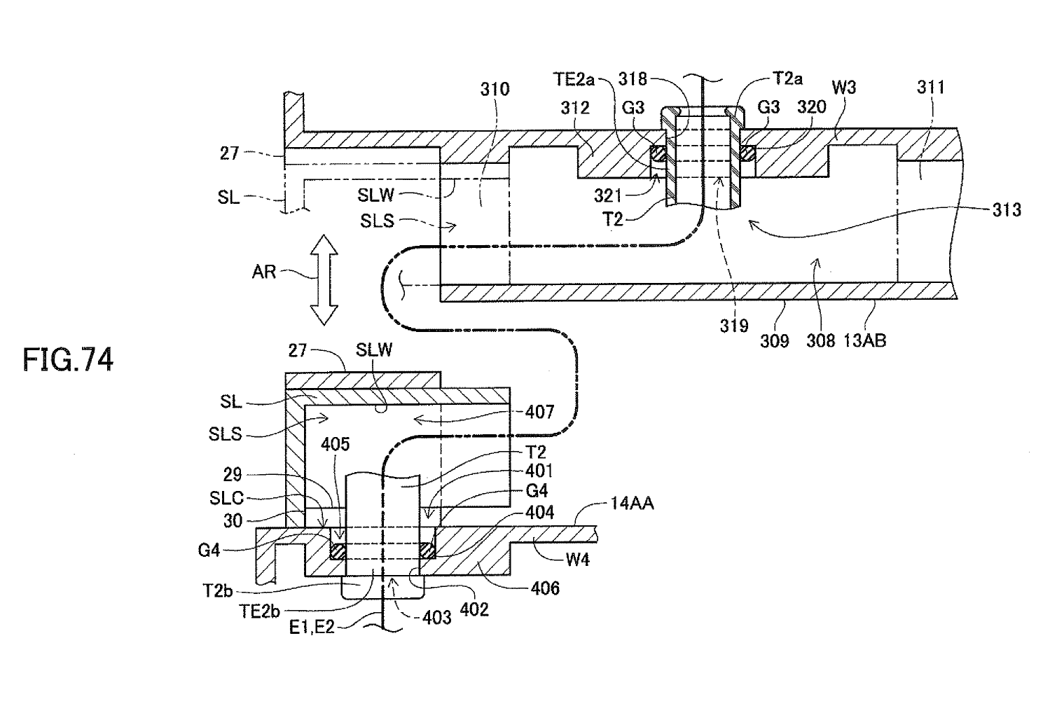

FIG. 73 is a view illustrating a modification of the waterproof structure of FIG. 19. In FIG. 73, components identical to those illustrated in FIG. 19 are provided with the same reference numerals. In the following description, illustration of the components in FIG. 73 identical to those of FIG. 19 provided with the same reference numerals is therefore omitted unless there is a difference between the two configurations. FIG. 74 is a view illustrating a modification of the waterproof structure of FIG. 22. In FIG. 74, components identical to those illustrated in FIG. 22 are provided with the same reference numerals. In the following description, illustration of the components in FIG. 74 identical to those of FIG. 22 provided with the same reference numerals is therefore omitted unless there is a difference between the two configurations.

Note that the waterproof structure illustrated in the lower part of FIG. 19 may be changed to a waterproof structure illustrated in a lower part of FIG. 73. In the waterproof structure illustrated in the lower part of FIG. 73, the first continuous groove wall 210 of the first wiring opening wall 208 is formed such that the first continuous groove wall 210 faces the first space 204. Consequently, the first continuous groove 211 of the first wiring opening wall 208 is formed such that the first continuous groove 211 faces the first space 204. The first wiring opening 209 has a counterbore shape. That is, the first fixing sealer G1 with being attached to the first fixing end TE1a of the swing cladding tube T1 may be attached to the first continuous groove 211 of the first wiring opening wall 208. This may facilitate inserting of the first fixing end TE1a of the swing cladding tube T1 into the first wiring opening 209 in addition to securing the waterproof properties given to the first wiring opening 209. Further, the first wiring opening 209 having the counterbore shape does not have a ring groove. Hence, even though the swing connecting side first housing 12AA is reduced in size or thinned, it may be easy to form the first wiring opening 209 in the swing connecting side first housing 12AA that has been reduced in size or thinned.

Note that the waterproof structure illustrated in the upper part of FIG. 19 may be changed to a waterproof structure illustrated in the upper part of FIG. 73. In the waterproof structure illustrated in the upper part of FIG. 73, the second continuous groove wall 316 of the second wiring opening wall 314 is formed such that the second continuous groove wall 316 faces the second space 304. Consequently, the second continuous groove 317 of the second wiring opening wall 314 is formed such that the second continuous groove 317 faces the second space 304. The second wiring opening 315 has a counterbore shape. That is, the second fixing sealer G1 with being attached to the second fixing end TE1b of the swing cladding tube T1 may be attached to the second continuous groove 317 of the second wiring opening wall 314. This may facilitate inserting of the second fixing end TE1b of the swing cladding tube T1 into the second wiring opening 315 in addition to securing the waterproof properties given to the second wiring opening 315. Further, the second wiring opening 315 having the counterbore shape does not have a ring groove. Hence, even though the swing connecting side second housing 13AB is reduced in size or thinned, it may be easy to form the second wiring opening 315 in the swing connecting side second housing 13AB that has been reduced in size or thinned.

Note that the waterproof structure illustrated in the upper part of FIG. 22 may be changed to a waterproof structure illustrated in the upper part of FIG. 74. In the waterproof structure illustrated in the upper part of FIG. 74, the third continuous groove wall 320 of the third wiring opening wall 318 is formed such that the third continuous groove wall 320 faces the third space 308. Consequently, the third continuous groove 321 of the third wiring opening wall 318 is formed such that the third continuous groove 321 faces the third space 308. The third wiring opening 319 has a counterbore shape. That is, the third sealer G3 with being attached to the third fixing end TE2a of the pivoting cladding tube T2 may be attached to the third continuous groove 321 of the third wiring opening wall 318. This may facilitate inserting of the third fixing end TE2a of the pivoting cladding tube T2 into the third wiring opening 319 in addition to securing the waterproof properties given to the third wiring opening 319. Further, the third wiring opening 319 having the counterbore shape does not have a ring groove. Hence, even though the swing connecting side second housing 13AB is reduced in size or thinned, it may be easy to form the second wiring opening 315 in the swing connecting side second housing 13AB that has been reduced in size or thinned.

Note that the waterproof structure illustrated in the lower part of FIG. 22 may be changed to a waterproof structure illustrated in a lower part of FIG. 74. In the waterproof structure illustrated in the lower part of FIG. 74, the fourth continuous groove wall 404 of the fourth wiring opening wall 402 is formed such that the fourth continuous groove wall 404 faces the fourth space 407. Consequently, the fourth continuous groove 405 of the fourth wiring opening wall 402 is formed such that the fourth continuous groove 405 faces the fourth space 407. The fourth wiring opening 403 has a counterbore shape. That is, the fourth sealer G4 with being attached to the fourth fixing end TE2b of the pivoting cladding tube T2 may be attached to the fourth continuous groove 405 of the fourth wiring opening wall 402. This may facilitate inserting of the fourth fixing end TE2b of the pivoting cladding tube T2 into the fourth wiring opening 403 in addition to securing the waterproof properties given to the fourth wiring opening 403. Further, the fourth wiring opening 403 having the counterbore shape does not have a ring groove. Hence, even though the pivoting connecting side third housing 14AA is reduced in size or thinned, it may be easy to form the fourth wiring opening 403 in the pivoting connecting side third housing 14AA that has been reduced in size or thinned.

### 10-2. Modification of Waterproof Structure Having Inserting Member

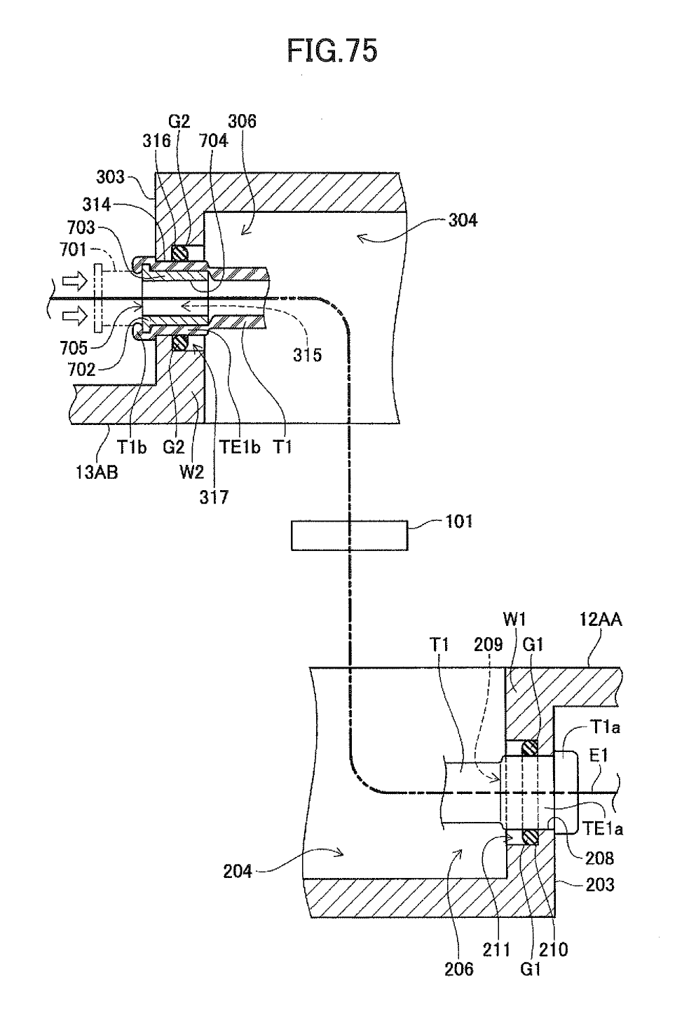

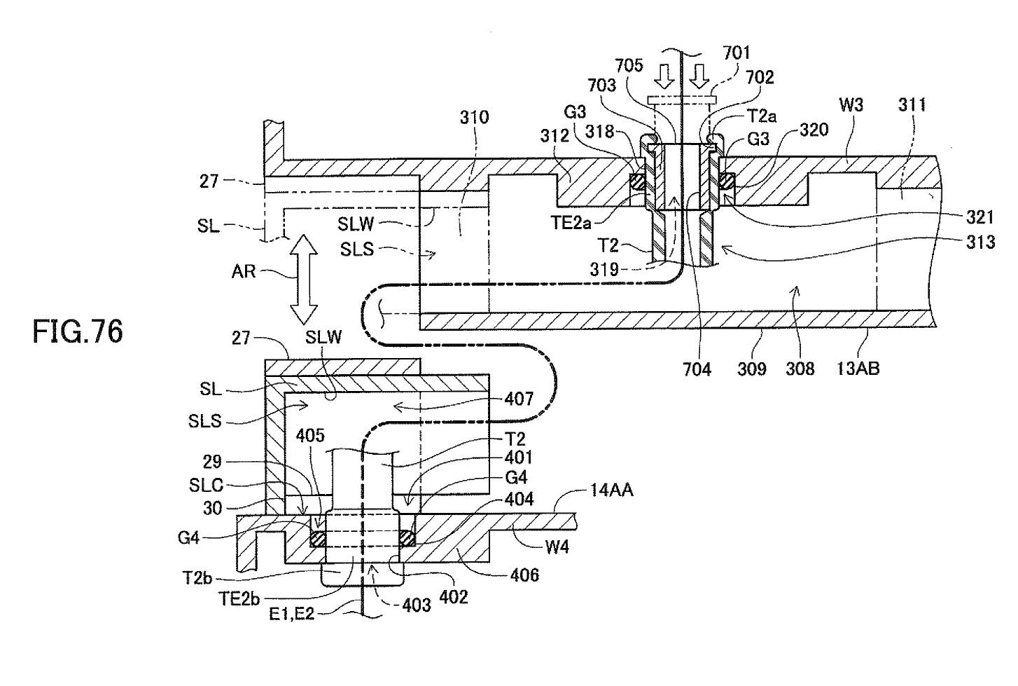

FIG. 75 is a view illustrating a modification of the waterproof structure of FIG. 59. In FIG. 75, components identical to those illustrated in FIG. 59 are provided with the same reference numerals. In the following description, illustration of the components in FIG. 75 identical to those of FIG. 59 provided with the same reference numerals is therefore omitted unless there is a difference between the two configurations. FIG. 76 is a view illustrating a modification of the waterproof structure of FIG. 60. In FIG. 76, components identical to those illustrated in FIG. 60 are provided with the same reference numerals. In the following description, illustration of the components in FIG. 76 identical to those of FIG. 70 provided with the same reference numerals is therefore omitted unless there is a difference between the two configurations.

Note that the waterproof structure illustrated in the lower part of FIG. 59 may be changed to a waterproof structure illustrated in a lower part of FIG. 75. Note that an altered part of the waterproof structure illustrated in the lower part of FIG. 75 is the same as that of a waterproof structure illustrated in the lower part of FIG. 73. This may facilitate inserting of the first fixing end TE1a of the swing cladding tube T1 into the first wiring opening 209 in the waterproof structure illustrated in the lower part of FIG. 75, in addition to securing the waterproof properties given to the first wiring opening 209. Further, the first wiring opening 209 having the counterbore shape does not have a ring groove. Hence, even though the swing connecting side first housing 12AA is reduced in size or thinned, it may be easy to form the first wiring opening 209 in the swing connecting side first housing 12AA that has been reduced in size or thinned.

Note that the waterproof structure illustrated in the upper part of FIG. 59 may be changed to a waterproof structure illustrated in the upper part of FIG. 75. Note that an altered part of the waterproof structure illustrated in the upper part of FIG. 75 is the same as that of a waterproof structure illustrated in the upper part of FIG. 73. This may facilitate inserting of the second fixing end TE1b of the swing cladding tube T1 into the second wiring opening 315 in the waterproof structure illustrated in the upper part of FIG. 75, in addition to securing the waterproof properties given to the second wiring opening 315. Further, the second wiring opening 315 having the counterbore shape does not have a ring groove. Hence, even though the swing connecting side second housing 13AB is reduced in size or thinned, it may be easy to form the second wiring opening 315 in the swing connecting side second housing 13AB that has been reduced in size or thinned.

Note that the waterproof structure illustrated in the upper part of FIG. 60 may be changed to a waterproof structure illustrated in the upper part of FIG. 76. Note that an altered part of the waterproof structure illustrated in the upper part of FIG. 76 is the same as that of a waterproof structure illustrated in the upper part of FIG. 74. This may facilitate inserting of the third fixing end TE2a of the pivoting cladding tube T2 into the third wiring opening 319 in the waterproof structure illustrated in the upper part of FIG. 76, in addition to securing the waterproof properties given to the third wiring opening 319. Further, the third wiring opening 319 having the counterbore shape does not have a ring groove. Hence, even though the swing connecting side second housing 13AB is reduced in size or thinned, it may be easy to form the second wiring opening 315 in the swing connecting side second housing 13AB that has been reduced in size or thinned.

Note that the waterproof structure illustrated in the lower part of FIG. 60 may be changed to a waterproof structure illustrated in a lower part of FIG. 76. Note that an altered part of the waterproof structure illustrated in the lower part of FIG. 76 is the same as that of a waterproof structure illustrated in the lower part of FIG. 74. This may facilitate inserting of the fourth fixing end TE2b of the pivoting cladding tube T2 into the fourth wiring opening 403 in the waterproof structure illustrated in the lower part of FIG. 76, in addition to securing the waterproof properties given to the fourth wiring opening 403. Further, the fourth wiring opening 403 having the counterbore shape does not have a ring groove. Hence, even though the pivoting connecting side third housing 14AA is reduced in size or thinned, it may be easy to form the fourth wiring opening 403 in the pivoting connecting side third housing 14AA that has been reduced in size or thinned.

### 10-3. First Modification of Waterproof Structure Having Cylindrical Member

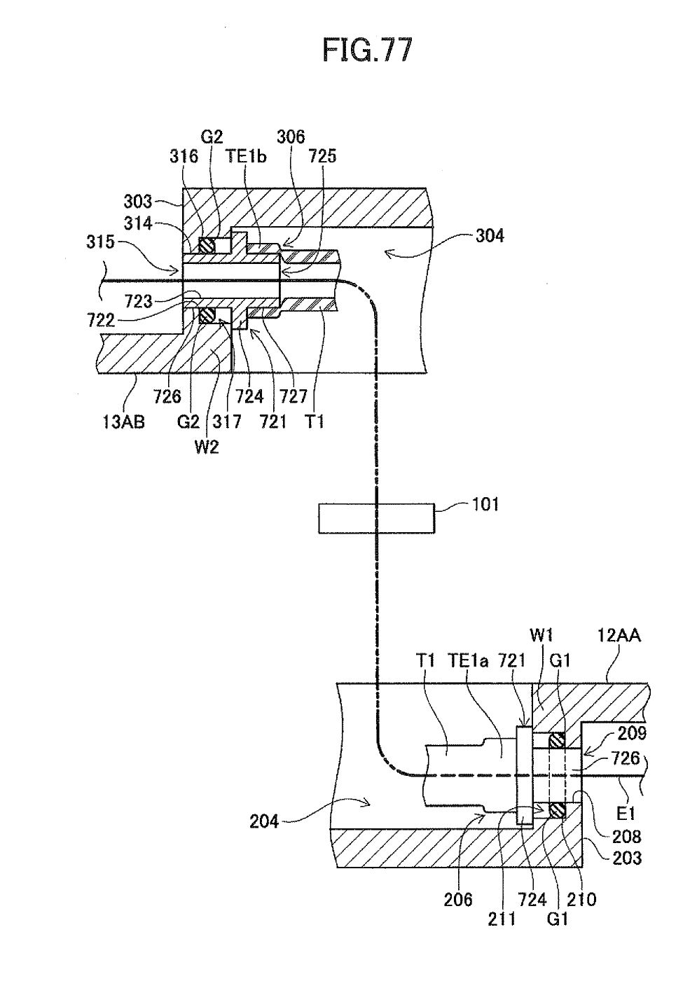

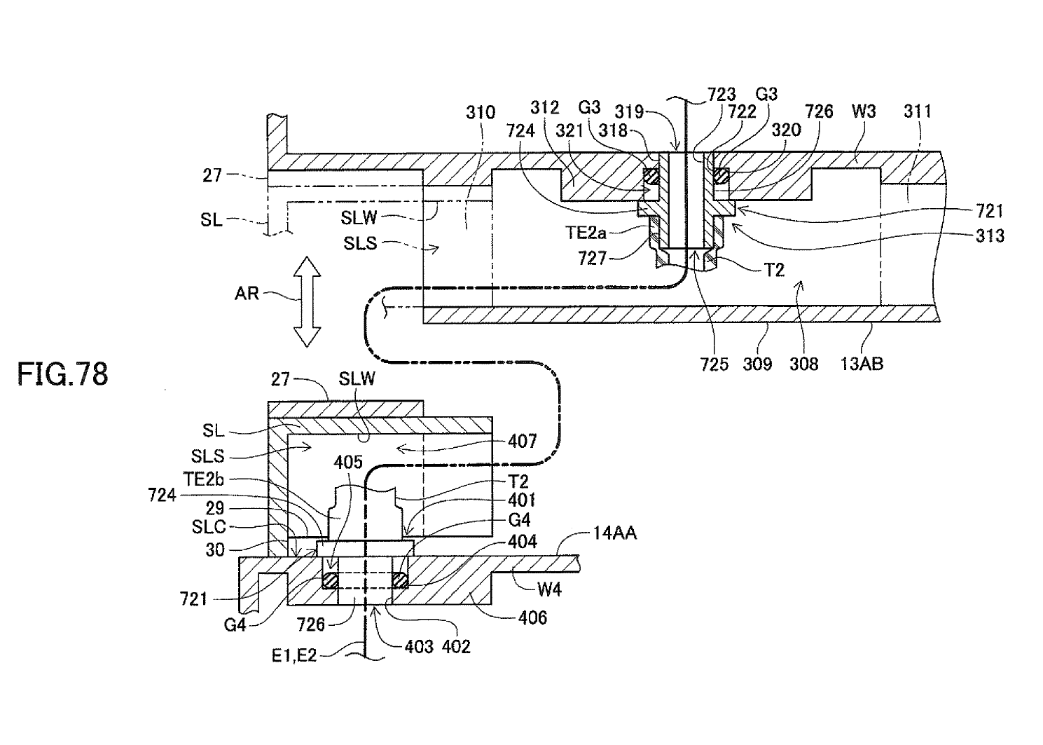

FIG. 77 is a view illustrating a first modification of the waterproof structure of FIG. 61. In FIG. 77, components identical to those illustrated in FIG. 61 are provided with the same reference numerals. In the following description, illustration of the components in FIG. 77 identical to those of FIG. 61 provided with the same reference numerals is therefore omitted unless there is a difference between the two configurations. FIG. 78 is a view illustrating a first modification of the waterproof structure of FIG. 62. In FIG. 78, components identical to those illustrated in FIG. 62 are provided with the same reference numerals. In the following description, illustration of the components in FIG. 78 identical to those of FIG. 62 provided with the same reference numerals is therefore omitted unless there is a difference between the two configurations.

Note that the waterproof structure illustrated in the lower part of FIG. 61 may be changed to a waterproof structure illustrated in a lower part of FIG. 77. In the waterproof structure illustrated in the lower part of FIG. 77, the first continuous groove wall 210 of the first wiring opening wall 208 is formed such that the first continuous groove wall 210 faces the first space 204. Consequently, the first continuous groove 211 of the first wiring opening wall 208 is formed such that the first continuous groove 211 faces the first space 204. The first wiring opening 209 has a counterbore shape. That is, the first fixing sealer G1 with being attached to a wiring opening side circumferential wall 726 of a cylindrical member 721 may be attached to the first continuous groove 211 of the first wiring opening wall 208. This may facilitate inserting of the first fixing end TE1a of the swing cladding tube T1 into the first wiring opening 209 via the cylindrical member 721 in addition to securing the waterproof properties given to the first wiring opening 209. Further, the first wiring opening 209 having the counterbore shape does not have a ring groove. Hence, even though the swing connecting side first housing 12AA is reduced in size or thinned, it may be easy to form the first wiring opening 209 in the swing connecting side first housing 12AA that has been reduced in size or thinned.

Note that the waterproof structure illustrated in the upper part of FIG. 61 may be changed to a waterproof structure illustrated in the upper part of FIG. 77. In the waterproof structure illustrated in the upper part of FIG. 77, the second continuous groove wall 316 of the second wiring opening wall 314 is formed such that the second continuous groove wall 316 faces the second space 304. Consequently, the second continuous groove 317 of the second wiring opening wall 314 is formed such that the second continuous groove 317 faces the second space 304. The second wiring opening 315 has a counterbore shape. That is, the second fixing sealer G2 with being attached to the wiring opening side circumferential wall 726 of the cylindrical member 721 may be attached to the second continuous groove 317 of the second wiring opening wall 314. This may facilitate inserting of the second fixing end TE1b of the swing cladding tube T1 into the second wiring opening 315 via the cylindrical member 721 in addition to securing the waterproof properties given to the second wiring opening 315. Further, the second wiring opening 315 having the counterbore shape does not have a ring groove. Hence, even though the swing connecting side second housing 13AB is reduced in size or thinned, it may be easy to form the second wiring opening 315 in the swing connecting side second housing 13AB that has been reduced in size or thinned.

Note that the waterproof structure illustrated in the upper part of FIG. 62 may be changed to a waterproof structure illustrated in the upper part of FIG. 78. In the waterproof structure illustrated in the upper part of FIG. 78, the third continuous groove wall 320 of the third wiring opening wall 318 is formed such that the third continuous groove wall 320 faces the third space 308. Consequently, the third continuous groove 321 of the third wiring opening wall 318 is formed such that the third continuous groove 321 faces the third space 308. The third wiring opening 319 has a counterbore shape. That is, the third sealer G3 with being attached to the wiring opening side circumferential wall 726 of the cylindrical member 721 may be attached to the third continuous groove 321 of the third wiring opening wall 318. This may facilitate inserting of the third fixing end TE2a of the pivoting cladding tube T2 into the third wiring opening 319 via the cylindrical member 721 in addition to securing the waterproof properties given to the third wiring opening 319. Further, the third wiring opening 319 having the counterbore shape does not have a ring groove. Hence, even though the swing connecting side second housing 13AB is reduced in size or thinned, it may be easy to form the third wiring opening 319 in the swing connecting side second housing 13AB that has been reduced in size or thinned.

Note that the waterproof structure illustrated in the lower part of FIG. 62 may be changed to a waterproof structure illustrated in a lower part of FIG. 78. In the waterproof structure illustrated in the lower part of FIG. 78, the fourth continuous groove wall 404 of the fourth wiring opening wall 402 is formed such that the fourth continuous groove wall 404 faces the fourth space 407. Consequently, the fourth continuous groove 405 of the fourth wiring opening wall 402 is formed such that the fourth continuous groove 405 faces the fourth space 407. The fourth wiring opening 403 has a counterbore shape. That is, the fourth sealer G4 with being attached to the wiring opening side circumferential wall 726 of the cylindrical member 721 is attached to the fourth continuous groove 405 of the fourth wiring opening wall 402. This may facilitate inserting of the fourth fixing end TE2b of the pivoting cladding tube T2 into the fourth wiring opening 403 via the cylindrical member 721 in addition to securing the waterproof properties given to the fourth wiring opening 403. Further, the fourth wiring opening 403 having the counterbore shape does not have a ring groove. Hence, even though the pivoting connecting side third housing 14AA is reduced in size or thinned, it may be easy to form the fourth wiring opening 403 in the pivoting connecting side third housing 14AA that has been reduced in size or thinned.

### 10-4. Second Modification of Waterproof Structure Having Cylindrical Member

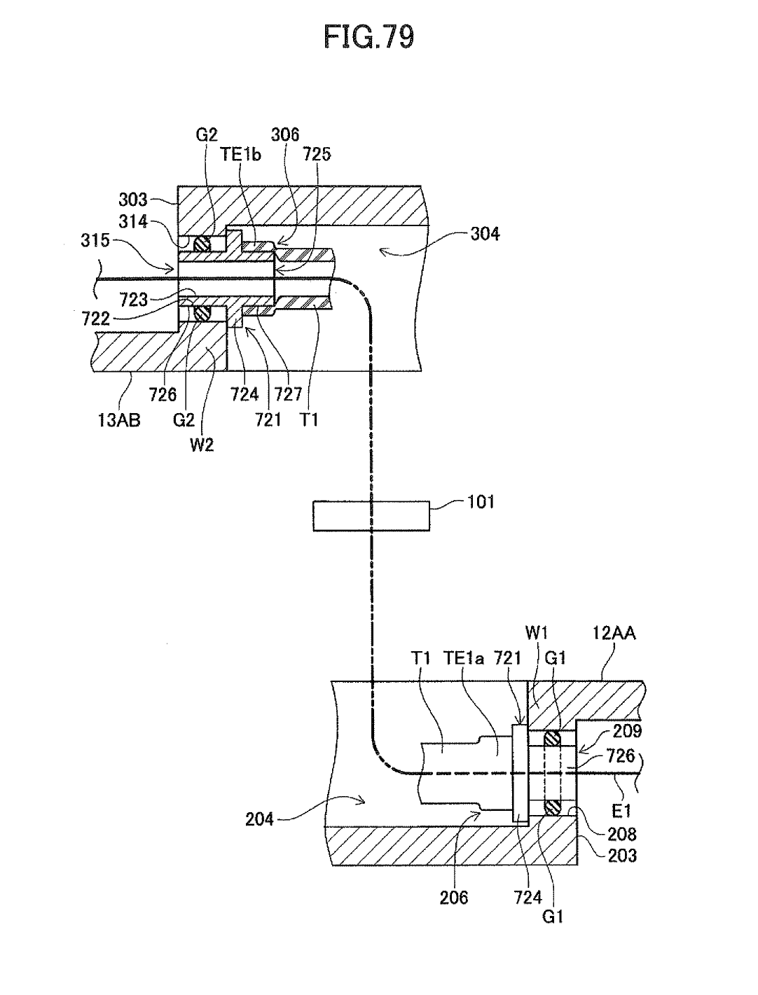

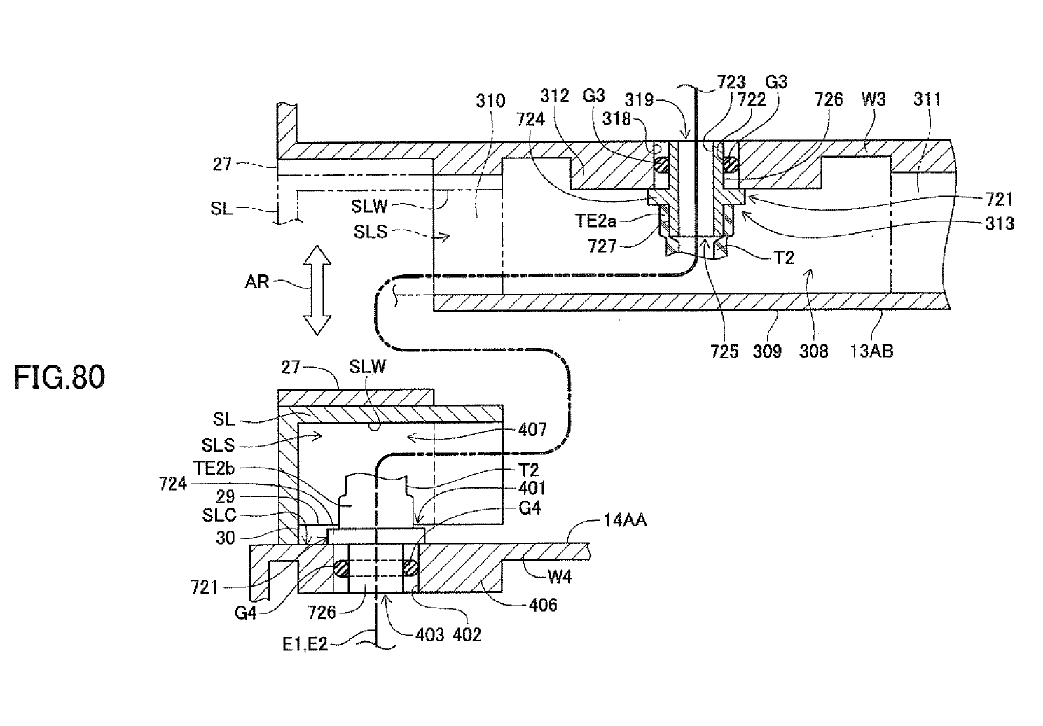

FIG. 79 is a view illustrating a second modification of the waterproof structure of FIG. 61. In FIG. 79, components identical to those illustrated in FIG. 61 are provided with the same reference numerals. In the following description, illustration of the components in FIG. 79 identical to those of FIG. 61 provided with the same reference numerals is therefore omitted unless there is a difference between the two configurations. FIG. 80 is a view illustrating a second modification of the waterproof structure of FIG. 62. In FIG. 80, components identical to those illustrated in FIG. 62 are provided with the same reference numerals. In the following description, illustration of the components in FIG. 80 identical to those of FIG. 62 provided with the same reference numerals is therefore omitted unless there is a difference between the two configurations.

Note that the waterproof structure illustrated in the lower part of FIG. 61 may be changed to a waterproof structure illustrated in a lower part of FIG. 79. The difference (i.e., a changed part) between the waterproof structure illustrated in the lower part of FIG. 61 and the waterproof structure illustrated in the lower part of FIG. 79 is that a wall part formed of the first continuous groove wall 210 penetrating the lateral wall W1 illustrated in the lower part of FIG. 61 is utilized as the first wiring opening wall 208. That is, the first continuous groove wall 210 and the first continuous groove 211 of the waterproof structure illustrated in the lower part of FIG. 61 are not present in the waterproof structure illustrated in the lower part of FIG. 79. The first wiring opening 209 has a simple hole shape. In the waterproof structure illustrated in the lower part of FIG. 79, the first fixing sealer G1 is compressed by the first wiring opening wall 208 and the wiring opening side circumferential wall 726 of the cylindrical member 721. That is, the first fixing sealer G1 with being attached to the wiring opening side circumferential wall 726 of the cylindrical member 721 is attached to the first wiring opening wall 208. This may facilitate inserting of the first fixing end TE1a of the swing cladding tube T1 into the first wiring opening 209 via the cylindrical member 721 in addition to securing the waterproof properties given to the first wiring opening 209. Further, the first wiring opening 209 having the simple hole shape does not have a ring groove. Hence, even though the swing connecting side first housing 12AA is reduced in size or thinned, it may be easy to form the first wiring opening 209 in the swing connecting side first housing 12AA that has been reduced in size or thinned.

Note that the waterproof structure illustrated in the upper part of FIG. 61 may be changed to a waterproof structure illustrated in the upper part of FIG. 79. The difference (i.e., a changed part) between the waterproof structure illustrated in the upper part of FIG. 61 and the waterproof structure illustrated in the upper part of FIG. 79 is that a wall part formed of the second continuous groove wall 316 penetrating the lateral wall W2 illustrated in the upper part of FIG. 61 is utilized as the second wiring opening wall 314. That is, the second continuous groove wall 316 and the second continuous groove 317 of the waterproof structure illustrated in the upper part of FIG. 61 are not present in the waterproof structure illustrated in the upper part of FIG. 79. The second wiring opening 315 has a simple hole shape. In the waterproof structure illustrated in the upper part of FIG. 79, the second fixing sealer G2 is compressed by the second wiring opening wall 314 and the wiring opening side circumferential wall 726 of the cylindrical member 721. That is, the second fixing sealer G2 with being attached to the wiring opening side circumferential wall 726 of the cylindrical member 721 is attached to the second wiring opening wall 314. This may facilitate inserting of the second fixing end TE1b of the swing cladding tube T1 into the second wiring opening 315 via the cylindrical member 721 in addition to securing the waterproof properties given to the second wiring opening 315. Further, the second wiring opening 315 having the simple hole shape does not have a ring groove. Hence, even though the swing connecting side second housing 13AB is reduced in size or thinned, it may be easy to form the second wiring opening 315 in the swing connecting side second housing 13AB that has been reduced in size or thinned.

Note that the waterproof structure illustrated in the upper part of FIG. 62 may be changed to a waterproof structure illustrated in the upper part of FIG. 80. The difference (i.e., a changed part) between the waterproof structure illustrated in the upper part of FIG. 62 and the waterproof structure illustrated in the upper part of FIG. 80 is that a wall part formed of the third continuous groove wall 320 penetrating the lateral wall W3 illustrated in the upper part of FIG. 62 is utilized as the third wiring opening wall 318. That is, the third continuous groove wall 320 and the third continuous groove 321 of the waterproof structure illustrated in the upper part of FIG. 62 are not present in the waterproof structure illustrated in the upper part of FIG. 80. The third wiring opening 319 has a simple hole shape. In the waterproof structure illustrated in the upper part of FIG. 80, the third sealer G3 is compressed by the third wiring opening wall 318 and the wiring opening side circumferential wall 726 of the cylindrical member 721. That is, the third sealer G3 with being attached to the wiring opening side circumferential wall 726 of the cylindrical member 721 is attached to the first wiring opening wall 318. This may facilitate inserting of the third fixing end TE2a of the pivoting cladding tube T2 into the third wiring opening 319 via the cylindrical member 721 in addition to securing the waterproof properties given to the third wiring opening 319. Further, the third wiring opening 319 having the simple hole shape does not have a ring groove. Hence, even though the swing connecting side second housing 13AB is reduced in size or thinned, it may be easy to form the third wiring opening 319 in the swing connecting side second housing 13AB that has been reduced in size or thinned.

Note that the waterproof structure illustrated in the lower part of FIG. 62 may be changed to a waterproof structure illustrated in a lower part of FIG. 80. The difference (i.e., a changed part) between the waterproof structure illustrated in the lower part of FIG. 62 and the waterproof structure illustrated in the lower part of FIG. 80 is that a wall part formed of the fourth continuous groove wall 404 penetrating the lateral wall W4 illustrated in the lower part of FIG. 62 is utilized as the fourth wiring opening wall 402. That is, the fourth continuous groove wall 404 and the fourth continuous groove 405 of the waterproof structure illustrated in the lower part of FIG. 62 are not present in the waterproof structure illustrated in the lower part of FIG. 80. The fourth wiring opening 403 has a simple hole shape. In the waterproof structure illustrated in the lower part of FIG. 80, the fourth sealer G4 is compressed by the fourth wiring opening wall 402 and the wiring opening side circumferential wall 726 of the cylindrical member 721. That is, the fourth sealer G4 with being attached to the wiring opening side circumferential wall 726 of the cylindrical member 721 is attached to the fourth wiring opening wall 402. This may facilitate inserting of the fourth fixing end TE2b of the pivoting cladding tube T2 into the fourth wiring opening 403 via the cylindrical member 721 in addition to securing the waterproof properties given to the fourth wiring opening 403. Further, the fourth wiring opening 403 having the simple hole shape does not have a ring groove. Hence, even though the pivoting connecting side third housing 14AA is reduced in size or thinned, it may be easy to form the fourth wiring opening 403 in the pivoting connecting side third housing 14AA that has been reduced in size or thinned.

### 10-5. Modification of Waterproof Structure Having Projection Tube

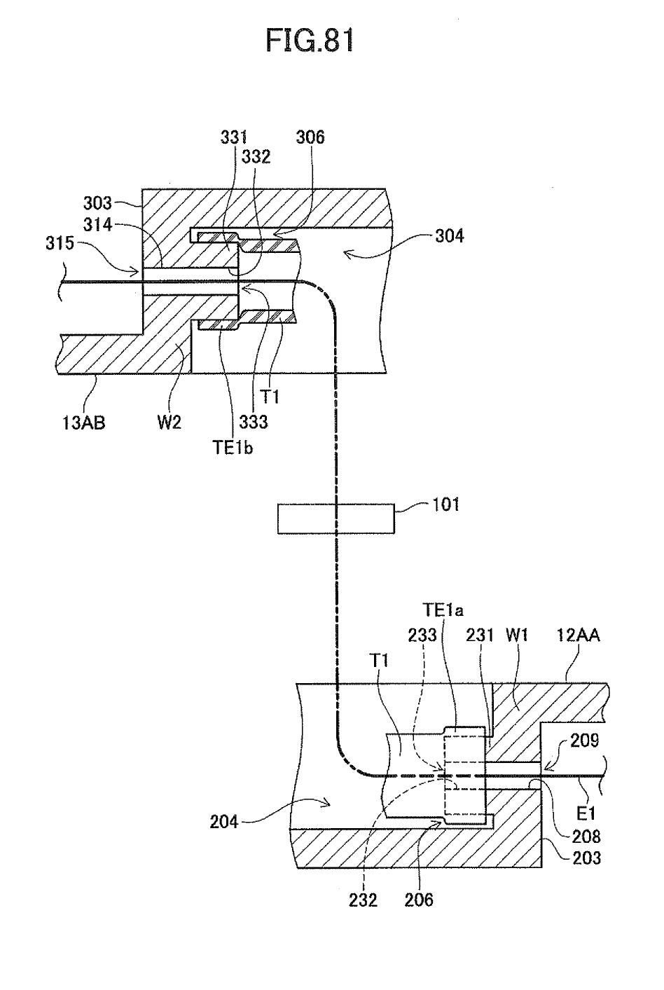

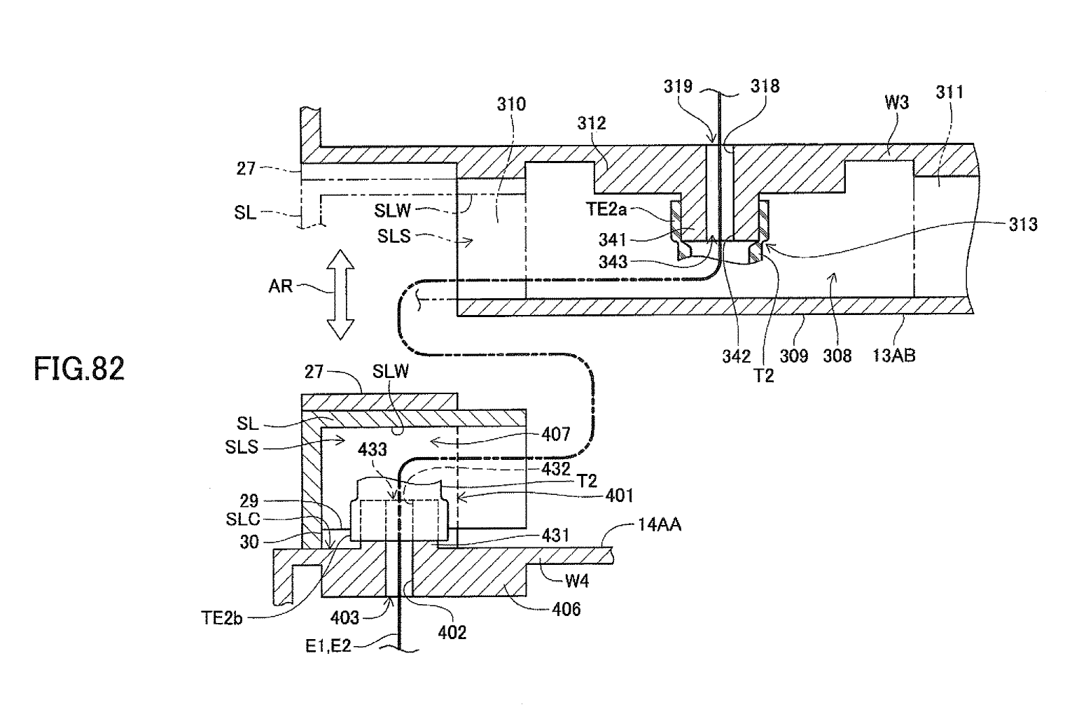

FIG. 81 is a view illustrating a modification of the waterproof structure of FIG. 63. In FIG. 81, components identical to those illustrated in FIG. 63 are provided with the same reference numerals. In the following description, illustration of the components in FIG. 81 identical to those of FIG. 63 provided with the same reference numerals is therefore omitted unless there is a difference between the two configurations. FIG. 82 is a view illustrating a modification of the waterproof structure of FIG. 64. In FIG. 82, components identical to those illustrated in FIG. 64 are provided with the same reference numerals. In the following description, illustration of the components in FIG. 82 identical to those of FIG. 64 provided with the same reference numerals is therefore omitted unless there is a difference between the two configurations.

Note that the waterproof structure illustrated in the lower part of FIG. 63 may be changed to a waterproof structure illustrated in a lower part of FIG. 81. The first continuous groove wall 210, the first continuous groove 211, and the first fixing sealer G1 of the waterproof structure illustrated in the lower part of FIG. 63 are not present in the waterproof structure illustrated in the lower part of FIG. 81. That is, in the waterproof structure illustrated in the lower part of FIG. 81, the first wiring opening 209 acquires waterproof properties owing to elasticity of the first fixing end TE1a of the swing cladding tube T1 inserted into the first projection tube 231. If waterproof properties provided by the elasticity of the first fixing end TE1a of the swing cladding tube T1 itself are sufficient, the first continuous groove wall 210, the first continuous groove 211, and the first fixing sealer G1 of the waterproof structure illustrated in the lower part of FIG. 63 may be omitted. Hence, even though the swing connecting side first housing 12AA is reduced in size or thinned, it may be easy to form the first projection tube 231 in the swing connecting side first housing 12AA that has been reduced in size or thinned.

Note that the waterproof structure illustrated in the upper part of FIG. 63 may be changed to a waterproof structure illustrated in the upper part of FIG. 81. The second continuous groove wall 316, the second continuous groove 317, and the second fixing sealer G2 of the waterproof structure illustrated in the upper part of FIG. 63 are not present in the waterproof structure illustrated in the upper part of FIG. 81. That is, in the waterproof structure illustrated in the upper part of FIG. 81, the second wiring opening 315 acquires waterproof properties owing to elasticity of the second fixing end TE1b of the swing cladding tube T1 inserted into the second projection tube 331. If waterproof properties provided by the elasticity of the second fixing end TE1b of the swing cladding tube T1 itself are sufficient, the second continuous groove wall 316, the second continuous groove 317, and the second fixing sealer G2 of the waterproof structure illustrated in the upper part of FIG. 63 may be omitted. Hence, even though the swing connecting side second housing 13AB is reduced in size or thinned, it may be easy to form the second projection tube 331 in the swing connecting side second housing 13AB that has been reduced in size or thinned.

Note that the waterproof structure illustrated in the upper part of FIG. 64 may be changed to a waterproof structure illustrated in the upper part of FIG. 82. The third continuous groove wall 320, the third continuous groove 321, and the third fixing sealer G3 of the waterproof structure illustrated in the upper part of FIG. 64 are not present in the waterproof structure illustrated in the upper part of FIG. 82. That is, in the waterproof structure illustrated in the upper part of FIG. 82, the third wiring opening 319 acquires waterproof properties owing to elasticity of the third fixing end TE2a of the pivoting cladding tube T2 inserted into the third projection tube 341. If waterproof properties provided by the elasticity of the third fixing end TE2a of the pivoting cladding tube T2 itself are sufficient, the third continuous groove wall 320, the third continuous groove 321, and the third fixing sealer G3 of the waterproof structure illustrated in the upper part of FIG. 64 may be omitted. Hence, even though the swing connecting side second housing 13AB is reduced in size or thinned, it may be easy to form the third projection tube 341 in the swing connecting side second housing 13AB that has been reduced in size or thinned.

Note that the waterproof structure illustrated in the lower part of FIG. 64 may be changed to a waterproof structure illustrated in a lower part of FIG. 82. The fourth continuous wall 404, the fourth continuous groove 405, and the fourth fixing sealer G4 of the waterproof structure illustrated in the lower part of FIG. 64 are not present in the waterproof structure illustrated in the lower part of FIG. 82. That is, in the waterproof structure illustrated in the lower part of FIG. 82, the fourth wiring opening 403 acquires waterproof properties owing to elasticity of the fourth fixing end TE2b of the pivoting cladding tube T2 inserted into the fourth projection tube 431. If waterproof properties provided by the elasticity of the fourth fixing end TE2b of the pivoting cladding tube T2 itself are sufficient, the fourth continuous groove wall 404, the fourth continuous groove 405, and the fourth fixing sealer G4 of the waterproof structure illustrated in the lower part of FIG. 64 may be omitted. Hence, even though the pivoting connecting side third housing 14AAis reduced in size or thinned, it may be easy to form the fourth projection tube 431 in the pivoting connecting side third housing 14AA that has been reduced in size or thinned.

### 10-6. Modification of Waterproof Structure Having Gasket Integrated Tube

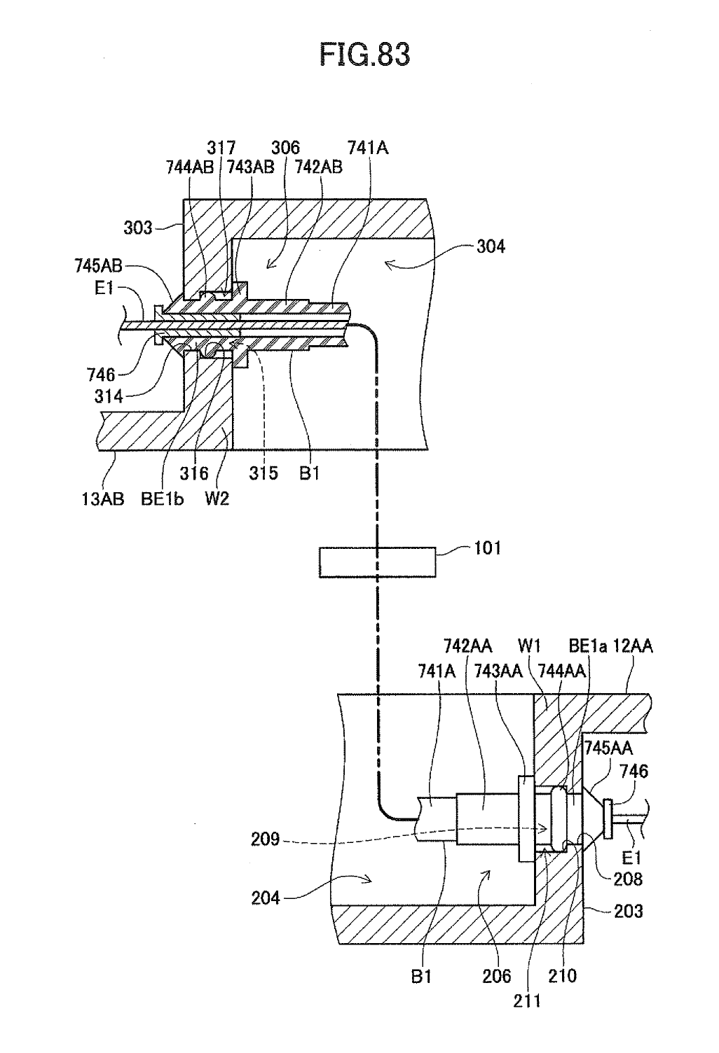

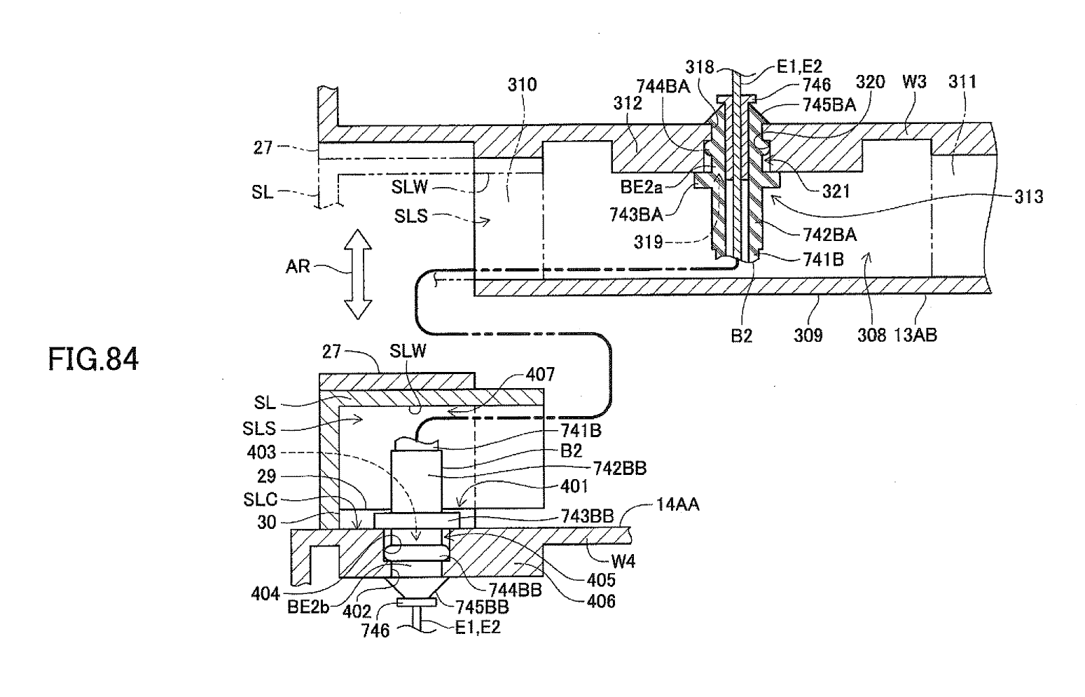

FIG. 83 is a view illustrating a modification of the waterproof structure of FIG. 65. In FIG. 83, components identical to those illustrated in FIG. 65 are provided with the same reference numerals. In the following description, illustration of the components in FIG. 83 identical to those of FIG. 65 provided with the same reference numerals is therefore omitted unless there is a difference between the two configurations. FIG. 84 is a view illustrating a modification of the waterproof structure of FIG. 66. In FIG. 84, components identical to those illustrated in FIG. 66 are provided with the same reference numerals. In the following description, illustration of the components in FIG. 84 identical to those of FIG. 66 provided with the same reference numerals is therefore omitted unless there is a difference between the two configurations.

Note that the waterproof structure illustrated in the lower part of FIG. 65 may be changed to a waterproof structure illustrated in a lower part of FIG. 83. In the waterproof structure illustrated in the lower part of FIG. 83, the first continuous groove wall 210 of the first wiring opening wall 208 is formed such that the first continuous groove wall 210 faces the first space 204. Consequently, the first continuous groove 211 of the first wiring opening wall 208 is formed such that the first continuous groove 211 faces the first space 204. The first wiring opening 209 has a counterbore shape. That is, in the waterproof structure illustrated in the lower part of FIG. 83, the first fixing sealer 744AA of the swing cladding tube B1 may be tightly attached to the first continuous groove wall 210 of the first wiring opening wall 208 after having been compressively deformed in an amount significantly less than that of the compressive deformation of the waterproof structure illustrated in the lower part of FIG. 65. This may facilitate inserting of the first fixing end BE1a of the swing cladding tube B1 into the first wiring opening 209 in addition to securing the waterproof properties given to the first wiring opening 209. Further, the first wiring opening 209 having the counterbore shape does not have a ring groove. Hence, even though the swing connecting side first housing 12AA is reduced in size or thinned, it may be easy to form the first wiring opening 209 in the swing connecting side first housing 12AA that has been reduced in size or thinned.

Note that the waterproof structure illustrated in the upper part of FIG. 65 may be changed to a waterproof structure illustrated in the upper part of FIG. 83. In the waterproof structure illustrated in the upper part of FIG. 83, the second continuous groove wall 316 of the second wiring opening wall 314 is formed such that the second continuous groove wall 316 faces the second space 304. Consequently, the second continuous groove 317 of the second wiring opening wall 314 is formed such that the second continuous groove 317 faces the second space 304. The second wiring opening 315 has a counterbore shape. That is, in the waterproof structure illustrated in the upper part of FIG. 83, the second fixing sealer 744AB of the swing cladding tube B1 may be tightly attached to the second continuous groove wall 316 of the second wiring opening wall 314 after having been compressively deformed in an amount significantly less than that of the compressive deformation of the waterproof structure illustrated in the upper part of FIG. 65. This may facilitate inserting of the second fixing end BE1b of the swing cladding tube B1 into the second wiring opening 315 in addition to securing the waterproof properties given to the second wiring opening 315. Further, the second wiring opening 315 having the counterbore shape does not have a ring groove. Hence, even though the swing connecting side second housing 13AB is reduced in size or thinned, it may be easy to form the second wiring opening 315 in the swing connecting side second housing 13AB that has been reduced in size or thinned.

Note that the waterproof structure illustrated in the upper part of FIG. 66 may be changed to a waterproof structure illustrated in the upper part of FIG. 84. In the waterproof structure illustrated in the upper part of FIG. 84, the third continuous groove wall 320 of the third wiring opening wall 318 is formed such that the third continuous groove wall 320 faces the third space 308. Consequently, the third continuous groove 321 of the third wiring opening wall 318 is formed such that the third continuous groove 321 faces the third space 308. The third wiring opening 319 has a counterbore shape. That is, in the waterproof structure illustrated in the upper part of FIG. 84, the third fixing sealer 744BA of the pivoting cladding tube B2 may be tightly attached to the third continuous groove wall 320 of the third wiring opening wall 318 after having been compressively deformed in an amount significantly less than that of the compressive deformation of the waterproof structure illustrated in the upper part of FIG. 66. This may facilitate inserting of the third fixing end BE2a of the pivoting cladding tube B2 into the third wiring opening 319 in addition to securing the waterproof properties given to the third wiring opening 319. Further, the third wiring opening 319 having the counterbore shape does not have a ring groove. Hence, even though the swing connecting side second housing 13AB is reduced in size or thinned, it may be easy to form the third wiring opening 319 in the swing connecting side second housing 13AB that has been reduced in size or thinned.

Note that the waterproof structure illustrated in the lower part of FIG. 66 may be changed to a waterproof structure illustrated in a lower part of FIG. 84. In the waterproof structure illustrated in the lower part of FIG. 84, the fourth continuous groove wall 404 of the fourth wiring opening wall 402 is formed such that the fourth continuous groove wall 404 faces the fourth space 407. Consequently, the fourth continuous groove 405 of the fourth wiring opening wall 402 is formed such that the fourth continuous groove 405 faces the fourth space 407. The fourth wiring opening 403 has a counterbore shape. That is, in the waterproof structure illustrated in the lower part of FIG. 84, the fourth fixing sealer 744BB of the pivoting cladding tube B2 may be tightly attached to the fourth continuous groove wall 404 of the fourth wiring opening wall 402 after having been compressively deformed in an amount significantly less than that of the compressive deformation of the waterproof structure illustrated in the lower part of FIG. 66. This may facilitate inserting of the fourth fixing end BE2b of the pivoting cladding tube B2 into the fourth wiring opening 403 in addition to securing the waterproof properties given to the fourth wiring opening 403. Further, the fourth wiring opening 403 having the counterbore shape does not have a ring groove. Hence, even though the pivoting connecting side third housing 14AA is reduced in size or thinned, it may be easy to form the fourth wiring opening 403 in the pivoting connecting side third housing 14AA that has been reduced in size or thinned.

### 10-7. Modification of Waterproof Structure Having Cable Integrated Tube

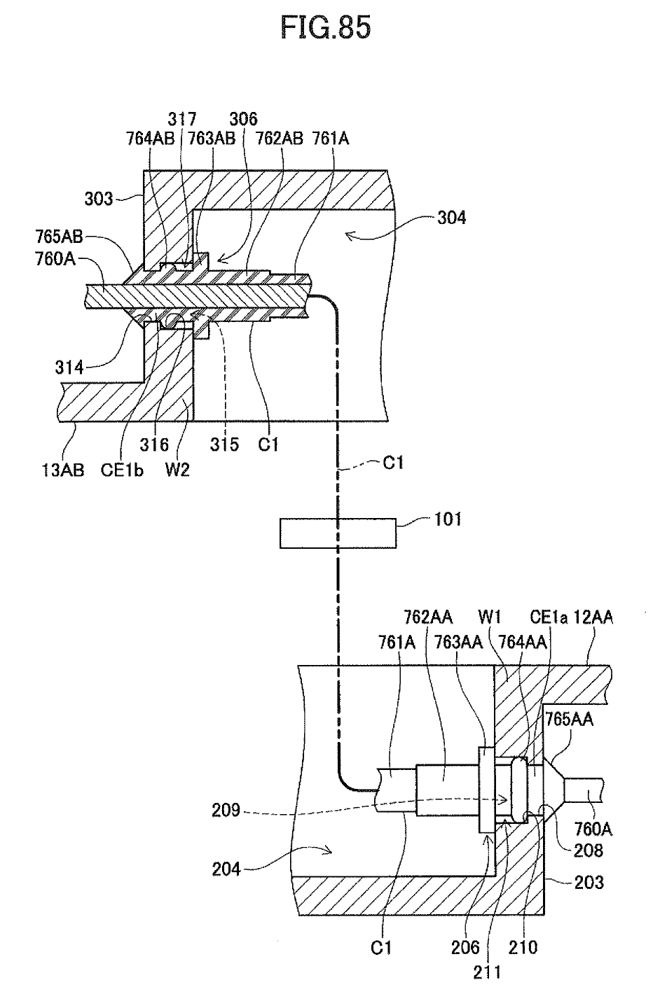

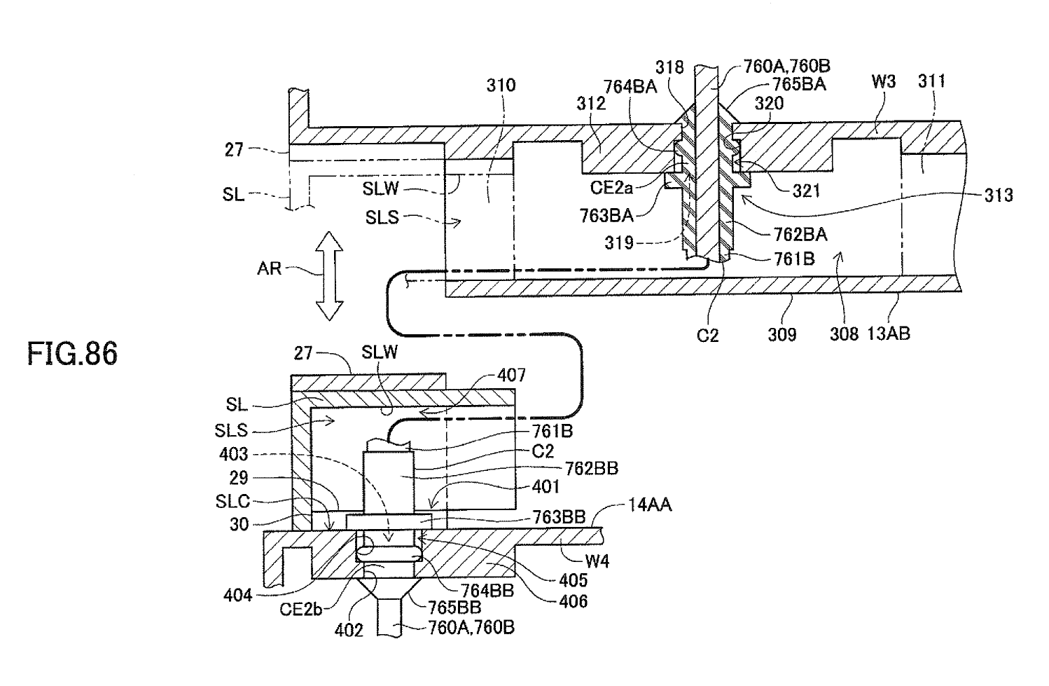

FIG. 85 is a view illustrating a modification of the waterproof structure of FIG. 69. In FIG. 85, components identical to those illustrated in FIG. 69 are provided with the same reference numerals. In the following description, illustration of the components in FIG. 85 identical to those of FIG. 69 provided with the same reference numerals is therefore omitted unless there is a difference between the two configurations. FIG. 86 is a view illustrating a modification of the waterproof structure of FIG. 70. In FIG. 86, components identical to those illustrated in FIG. 70 are provided with the same reference numerals. In the following description, illustration of the components in FIG. 86 identical to those of FIG. 70 provided with the same reference numerals is therefore omitted unless there is a difference between the two configurations.

Note that the waterproof structure illustrated in the lower part of FIG. 69 may be changed to a waterproof structure illustrated in a lower part of FIG. 85. Note that an altered part of the waterproof structure illustrated in the lower part of FIG. 85 is the same as that of a waterproof structure illustrated in the lower part of FIG. 83. This may facilitate inserting of the first fixing end CE1a of the swing cladding tube C1 into the first wiring opening 209 in the waterproof structure illustrated in the lower part of FIG. 85, in addition to securing the waterproof properties given to the first wiring opening 209. Further, the first wiring opening 209 having the counterbore shape does not have a ring groove. Hence, even though the swing connecting side first housing 12AA is reduced in size or thinned, it may be easy to form the first wiring opening 209 in the swing connecting side first housing 12AA that has been reduced in size or thinned.

Note that the waterproof structure illustrated in the upper part of FIG. 69 may be changed to a waterproof structure illustrated in the upper part of FIG. 85. Note that an altered part of the waterproof structure illustrated in the upper part of FIG. 85 is the same as that of a waterproof structure illustrated in the upper part of FIG. 83. This may facilitate inserting of the second fixing end CE1b of the swing cladding tube C1 into the second wiring opening 315 in the waterproof structure illustrated in the upper part of FIG. 85, in addition to securing the waterproof properties given to the second wiring opening 315. Further, the second wiring opening 315 having the counterbore shape does not have a ring groove. Hence, even though the swing connecting side second housing 13AB is reduced in size or thinned, it may be easy to form the second wiring opening 315 in the swing connecting side second housing 13AB that has been reduced in size or thinned.

Note that the waterproof structure illustrated in the upper part of FIG. 70 may be changed to a waterproof structure illustrated in the upper part of FIG. 86. Note that an altered part of the waterproof structure illustrated in the upper part of FIG. 86 is the same as that of a waterproof structure illustrated in the upper part of FIG. 84. This may facilitate inserting of the third fixing end CE2a of the pivoting cladding tube C2 into the third wiring opening 319 in the waterproof structure illustrated in the upper part of FIG. 86, in addition to securing the waterproof properties given to the third wiring opening 319. Further, the third wiring opening 319 having the counterbore shape does not have a ring groove. Hence, even though the swing connecting side second housing 13AB is reduced in size or thinned, it may be easy to form the third wiring opening 319 in the swing connecting side second housing 13AB that has been reduced in size or thinned.

Note that the waterproof structure illustrated in the lower part of FIG. 70 may be changed to a waterproof structure illustrated in a lower part of FIG. 86. Note that an altered part of the waterproof structure illustrated in the lower part of FIG. 86 is the same as that of a waterproof structure illustrated in the lower part of FIG. 84. This may facilitate inserting of the fourth fixing end CE2b of the pivoting cladding tube C2 into the fourth wiring opening 403 in the waterproof structure illustrated in the lower part of FIG. 86, in addition to securing the waterproof properties given to the fourth wiring opening 403. Further, the fourth wiring opening 403 having the counterbore shape does not have a ring groove. Hence, even though the pivoting connecting side third housing 14AA is reduced in size or thinned, it may be easy to form the fourth wiring opening 403 in the pivoting connecting side third housing 14AA that has been reduced in size or thinned.

### 10-8. Waterproof Structure Having Gasket Integrated FPCB

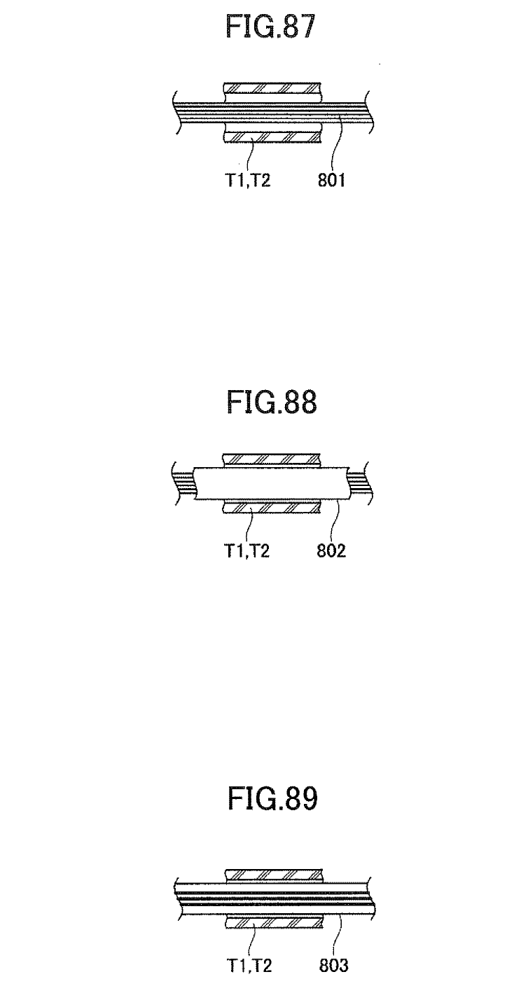

FIGS. 87 to 89 are views each illustrating an example of a wiring member passing through the swing cladding tube or the pivoting cladding tube. Specifically, FIGS. 87 to 89 each illustrate a cross section of the swing connecting cladding tube T1 or the pivoting cladding tube T2. FIG. 87 is a view illustrating an example of numerous insulating wires 801 passing through the swing cladding tube T1 or the pivoting cladding tube T2. In a case where the wiring member is composed of plural single core cables, the wiring member composed of the plural core cables may pass through the swing connecting cladding tube T1 or the pivoting cladding tube T2. FIG. 88 is a view illustrating an example of a multi-conductor cable 802 passing through the swing cladding tube T1 or the pivoting cladding tube T2. Ina case where the wiring member is a single core cable or a thin line coaxial cable, the wiring member formed of the core cable or the thin line coaxial cable may pass through the swing connecting cladding tube T1 or the pivoting cladding tube T2 as illustrated in FIG. 88. FIG. 89 is a view illustrating an example of a flexible flat cable (FFC) 803 passing through the swing cladding tube T1 or the pivoting cladding tube T2. In a case where the wiring member is the FFC or a flexible printing circuit board (FPCB), the wiring member formed of the FFC or FPCB may pass through the swing connecting cladding tube T1 or the pivoting cladding tube T2 as illustrated in FIG. 89.

In the above embodiments, the wiring member formed of the insulating wires 801, the multi-conductor cable 802, or the FFC is, as illustrated in FIGS. 87 to 89, enveloped by the swing cladding tube T1 or the pivoting cladding tube T2. In the swing cladding tube C1 serving as the cable integrated tube, a cable protection outer sheath (or simply called a “sheath”) enveloping a first wiring member 760A such as each of core wires of the multi-conductor may of course be utilized as a substitute for the swing cladding tube T1 as illustrated in FIG. 69. Similarly, in the pivoting cladding tube C2 illustrated in FIG. 70, the cable protection outer sheath (or simply called a “sheath”) may also be utilized as a substitute for the pivoting cladding tube T2.

In the following are examples of the swing cladding tube or the pivoting cladding tube as an insulating part of the FPCB employed as a substitute for an insulating part of the FPCB. The insulating part of the FPCB has waterproof properties. The insulating part of the FPCB, for which the swing cladding tube or the pivoting cladding tube is utilized as a substitute, integrates a gasket.

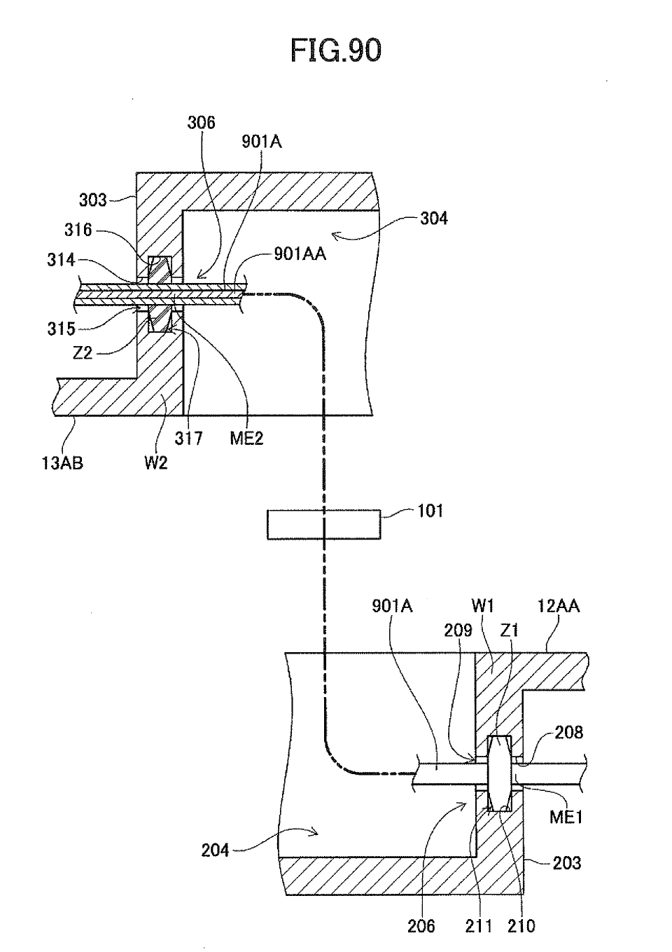

FIG. 90 is a view illustrating a waterproof structure having a swing cladding tube 901A formed of a gasket integrated FPCB. FIG. 90 depicts sectional views illustrating the first housing side water stop part 206 and the second housing side first water stop part 306 to both of which the swing cladding tube 901A is attached.

FIG. 90 is a simplified external view illustrating a swing connecting member 101. The external views of the swing cladding tube 901A and a first fixing sealer Z1 are illustrated in a lower part of FIG. 90. In FIG. 90, components identical to those illustrated above are provided with the same reference numerals. Note that FIG. 90 illustrates a waterproof structure applied to the mobile phone 11A according to the first embodiment.

As illustrated in the lower part of FIG. 90, the swing connecting side first housing 12AA includes the first housing side water stop part 206 on a lateral wall W1 of the first space wall 203 forming the first space 204. By contrast, as illustrated in an upper part of FIG. 90, the swing connecting side second housing 13AB includes the second housing side first water stop part 306 on a lateral wall W2 of the second space wall 303 forming the second space 304. Since the first housing side water stop part 206 and the second housing side first water stop part 306 illustrated in FIG. 90 include configurations identical to those illustrated in FIG. 18, illustration of the configurations of the first housing side water stop part 206 and the second housing side first water stop part 306 is omitted from the description.

The swing cladding tube 901A passing through the swing connecting member 101 is attached to the first housing side water stop part 206 and the second housing side first water stop part 306.

The swing cladding tube T1 serves as an insulating part of the FPCB. Accordingly, the swing cladding tube 901A has flexibility. The swing cladding tube 901A includes a conductor part 901AA of the FPCB. Accordingly, the conductor part 901AA of the FPCB is enveloped by the swing cladding tube 901A serving as the insulating part of the FPCB. The swing cladding tube 901A includes the first fixing sealer Z1 and a second fixing sealer Z2. The first fixing sealer Z1 and the second fixing sealer Z2 correspond to respective ring-shaped thick projection parts formed in a periphery of the swing cladding tube 901A. The first fixing sealer Z1 and the second fixing sealer Z2 are integrated with the swing cladding tube 901A. Such an integrating method may, for example, include an adhesion process method. The first fixing sealer Z1 and the second fixing sealer Z2 may preferably be formed of a material the same as the material forming an O ring. Examples of the material forming the O ring include a rubber material, and the like. Hence, the first fixing sealer Z1 and the second fixing sealer Z2 have elasticity.

As illustrated in an upper part of FIG. 90, when the swing cladding tube 901A is attached to the second housing side first water stop part 306, the second fixing sealer Z2 of the swing cladding tube 901A is pushed into the second wiring opening 315 via the second space 304 serving as a wiring space. Since the second fixing sealer Z2 has elasticity, the second fixing sealer Z2 is compressively deformed while the second fixing sealer Z2 is pushed into the second wiring opening 315. When the second fixing sealer Z2 resides in the second continuous groove 317, the second fixing sealer Z2 is restored from its compressively deformed shape. The second fixing sealer Z2 is attached to the second continuous groove 317 in a state where the second fixing sealer Z2 is restored from the compressively deformed shape.

When the swing cladding tube 901A is pulled toward the second space 304 in a state where the second fixing sealer Z2 is restored from its compressively deformed shape, the second fixing sealer Z2 is stuck to the second continuous groove 317. That is, even though the swing cladding tube 901A is pulled toward the second space 304, the second fixing sealer Z2 is stuck to the second continuous groove 317. Hence, the swing cladding tube 901A may be prevented from coming off the second wiring opening 315 to the second space 304.

The second fixing sealer Z2 of the swing cladding tube 901A is compressed by the second continuous groove wall 316 in a state where the second fixing sealer Z2 of the swing cladding tube B1 is attached to the second continuous groove 317. When the second fixing sealer Z2 of the swing cladding tube 901A is compressed by the second continuous groove wall 316, the second fixing sealer Z2 intervenes between the second continuous groove wall 316 and a second fixing end ME2 serving as an end part of the swing cladding tube 901A. When the second fixing sealer Z2 intervenes between the second continuous groove wall 316 and the second fixing end ME2 of the swing cladding tube 901A, the second fixing end ME2 of the swing cladding tube 901A is inserted into the second wiring opening 315.

That is, in a state where the second fixing end ME2 of the swing cladding tube 901A is inserted into the second wiring opening 315, the second fixing sealer Z2 integrated with the swing cladding tube 901A intervenes between the second continuous groove wall 316 and the second fixing end ME2 of the swing cladding tube 901A. When the second fixing sealer Z2 intervenes between the second continuous groove wall 316 and the second fixing end ME2 of the swing cladding tube 901A, a gap between the second wiring opening wall 314 and the second fixing end ME2 of the swing cladding tube 901A is sealed with the second sealer Z2. Accordingly, the second fixing end ME2 of the swing cladding tube 901A is cohesively or closely connected to the second wiring opening 315 via the second fixing sealer Z2. That is, the second wiring opening 315 acquires waterproof properties by causing the second fixing sealer Z2 to seal the gap between the second wiring opening wall 314 and the second fixing end ME2 of the swing cladding tube 901A. The second fixing sealer Z2 may be formed to have a compressible size according to the second continuous groove wall 316.

In the first housing side water stop part 206 illustrated in the lower part of FIG. 90, a first fixing end ME1 serving as an end part of the swing cladding tube 901A is inserted into the first wiring opening 209. The function and effect of the swing cladding tube 901A attached to the first housing side water stop part 206 illustrated in the lower part of FIG. 90 are similar to those of the swing cladding tube 901A attached to the second housing side first water stop part 306 illustrated in the upper part of FIG. 90. Hence, illustration of the function and effect of the swing cladding tube 901A attached to the first housing side water stop part 206 illustrated in the lower part of FIG. 90 is omitted from the description.

Note that the waterproof structure illustrated in FIG. 90 may also be applied to the mobile phone 11B according to the second embodiment, the mobile phone 11C according to the third embodiment, and the mobile phone 11D according to the fourth embodiment. In a case the waterproof structure illustrated in FIG. 90 is applied to the mobile phone 11D according to the fourth embodiment, the swing cladding tube 901A is of course passed through the swing connecting member 501 (e.g., see FIG. 56) in place of the swing connecting member 101.

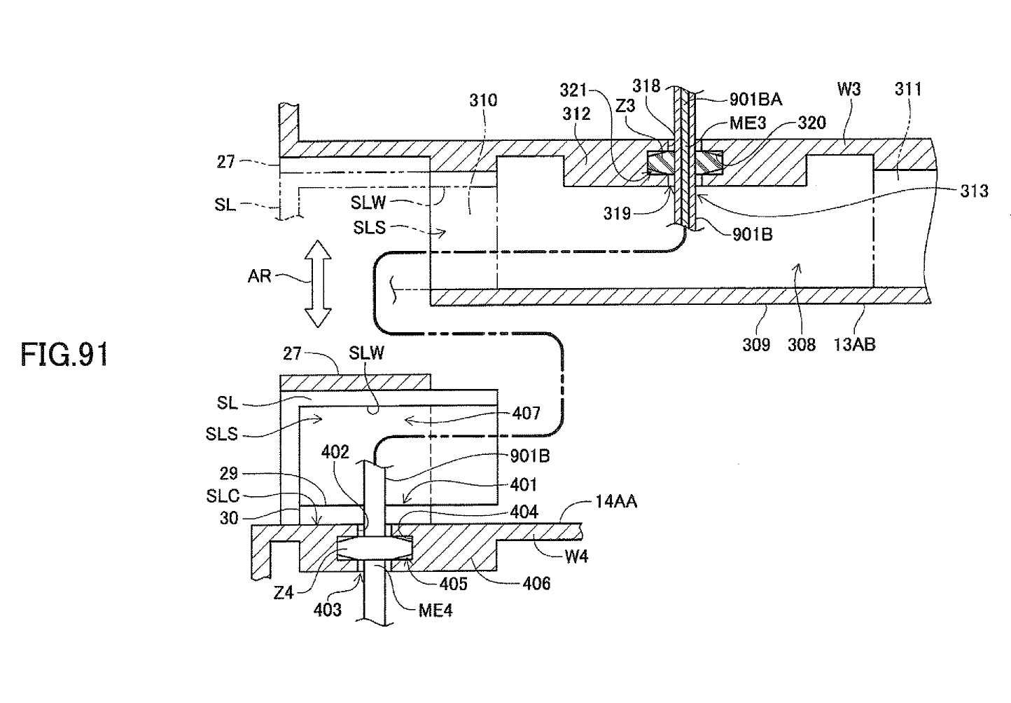

FIG. 91 is a view illustrating a waterproof structure utilizing a pivoting cladding tube 901B serving as a gasket integrated flexible printing circuit board (FPCB). FIG. 91 depicts sectional views illustrating the second housing side second water stop part 313 and the third housing side water stop part 401 to both of which the pivoting cladding tube 901B is attached.

The external views of the pivoting cladding tube 901B and a fourth fixing sealer Z4 are illustrated in a lower part of FIG. 91. In FIG. 91, components identical to those illustrated above are provided with the same reference numerals. Note that FIG. 91 illustrates a waterproof structure applied to the mobile phone 11A according to the first embodiment. Note that the waterproof structure illustrated in FIG. 91 may be applicable to the mobile phone 11D according to the fourth embodiment.

The pivoting cladding tube 901B passing through the second pivoting shaft SL is attached to the second housing side second water stop part 313 and the third housing side water stop part 401.

The pivoting cladding tube 901B serves as an insulating part of the FPCB. Accordingly, the pivoting cladding tube 901B has flexibility. The pivoting cladding tube 901B includes a conductor part 901BA of the FPCB. Accordingly, the conductor part 901BA of the FPCB is enveloped by the pivoting cladding tube 901B serving as the insulating part of the FPCB. The pivoting cladding tube 901B includes a third fixing sealer Z3 and the fourth fixing sealer Z4. The third fixing sealer Z3 and the fourth fixing sealer Z4 correspond to respective ring-shaped thick projection parts formed in a periphery of the pivoting cladding tube 901B. The third fixing sealer Z3 and the fourth fixing sealer Z4 are integrated with the pivoting cladding tube 901B. Such an integrating method may, for example, include an adhesion process method. The third fixing sealer Z3 and the fourth fixing sealer Z4 may preferably be formed of a material the same as the material forming an O ring. Examples of the material forming the O ring include a rubber material, and the like. Hence, the third fixing sealer Z3 and the fourth fixing sealer Z4 have elasticity.

As illustrated in the upper part of FIG. 91, when the pivoting cladding tube 901B is attached to the second housing side first water stop part 313, the pivoting cladding tube 901B is pushed into the third wiring opening 319 via the third space 308 serving as a wiring space. Since the third fixing sealer Z3 has elasticity, the third fixing sealer Z3 is compressively deformed while the third fixing sealer Z3 is pushed into the second wiring opening 319. When the third fixing sealer Z3 resides in the third continuous groove 321, the third fixing sealer Z3 is restored from its compressively deformed shape. The third fixing sealer Z3 is attached to the third continuous groove 321 in a state where the third fixing sealer Z3 is restored from the compressively deformed shape.

When the pivoting cladding tube 901B is pulled toward the third space 308 in a state where the third fixing sealer Z3 is restored from its compressively deformed shape, the third fixing sealer Z3 is stuck to the third continuous groove 321. That is, even though the pivoting cladding tube 901B is pulled toward the third space 308, the third fixing sealer Z3 is stuck to the third continuous groove 321. Hence, the pivoting cladding tube 901B may be prevented from coming off the third wiring opening 319 to the third space 308.

The third fixing sealer Z3 of the pivoting cladding tube 901B is compressed by the third continuous groove wall 320 in a state where the third fixing sealer Z3 of the pivoting cladding tube 901B is attached to the third continuous groove 321. When the third fixing sealer Z3 of the pivoting cladding tube 901B is compressed by the third continuous groove wall 320, the third fixing sealer Z3 intervenes between the third continuous groove wall 320 and the third fixing end ME3 serving as an end part of the pivoting cladding tube 901B. When the third fixing sealer Z3 intervenes between the third continuous groove wall 320 and the third fixing end ME3 of the pivoting cladding tube 901B, the third fixing end ME3 of the pivoting cladding tube 901B is inserted into the third wiring opening 319.

That is, in a state where the third fixing end ME3 of the pivoting cladding tube 901B is inserted into the third wiring opening 319, the third fixing sealer Z3 integrated with the pivoting cladding tube 901B intervenes between the third continuous groove wall 320 and the third fixing end ME3 of the pivoting cladding tube 901B. When the third fixing sealer Z3 intervenes between the third continuous groove wall 320 and the third fixing end ME3 of the pivoting cladding tube 901B, a gap between the third wiring opening wall 318 and the third fixing end ME3 of the pivoting cladding tube 901B is sealed with the third sealer Z3. Accordingly, the third fixing end ME3 of the pivoting cladding tube 901B is cohesively or closely connected to the third wiring opening 319 via the third fixing sealer Z3. That is, the third wiring opening 319 acquires waterproof properties by causing the third fixing sealer Z3 to seal the gap between the third wiring opening wall 318 and the third fixing end ME3 of the pivoting cladding tube 901B. The third fixing sealer Z3 may be formed to have a compressible size according to the third continuous groove wall 320.

In the third housing side water stop part 401 illustrated in the lower part of FIG. 91, a fourth fixing end ME4 of the pivoting cladding tube 901B is inserted into a fourth wiring opening 403 serving as an end part of the pivoting cladding tube 901B. The function and effect of the pivoting cladding tube 901B attached to the third housing side water stop part 401 illustrated in the lower part of FIG. 91 are similar to those of the pivoting cladding tube 901B attached to the second housing side second water stop part 313 illustrated in the upper part of FIG. 91. Hence, illustration of the function and effect of the pivoting cladding tube 901B attached to the third housing side water stop part 401 illustrated in the lower part of FIG. 91 is omitted from the description.

Note that the third wiring opening 319 may be shared between the non-swing connecting side second housing 13AA (see FIG. 16) and the swing connecting side second housing 13AB. Technically speaking, when the third wiring opening 319 is shared between the non-swing connecting side second housing 13AA and the swing connecting side second housing 13AB, the third wiring opening 319 is formed by placing the second non-swing connecting side second housing 13AA over the swing connecting side second housing 13AB. Note that the third continuous groove wall 321 is in communication with the circumferential groove 302a (see FIG. 17) formed in the flange rib 301 of the swing connecting side second housing 13AB (see FIG. 17). Further, the third fixing sealer Z3 is integrated with the gasket 302b (see FIG. 17) fitted in the circumferential groove 302a. That is, a three-dimensional gasket obtained by integrating the third fixing sealer G3 of the pivoting cladding tube 901B and the gasket 302b is used. The third fixing sealer Z3 and the gasket 302b may be integrated, for example, by bonding the third fixing sealer Z3 and the gasket 302b with adhesion (i.e., an adhesion process method).

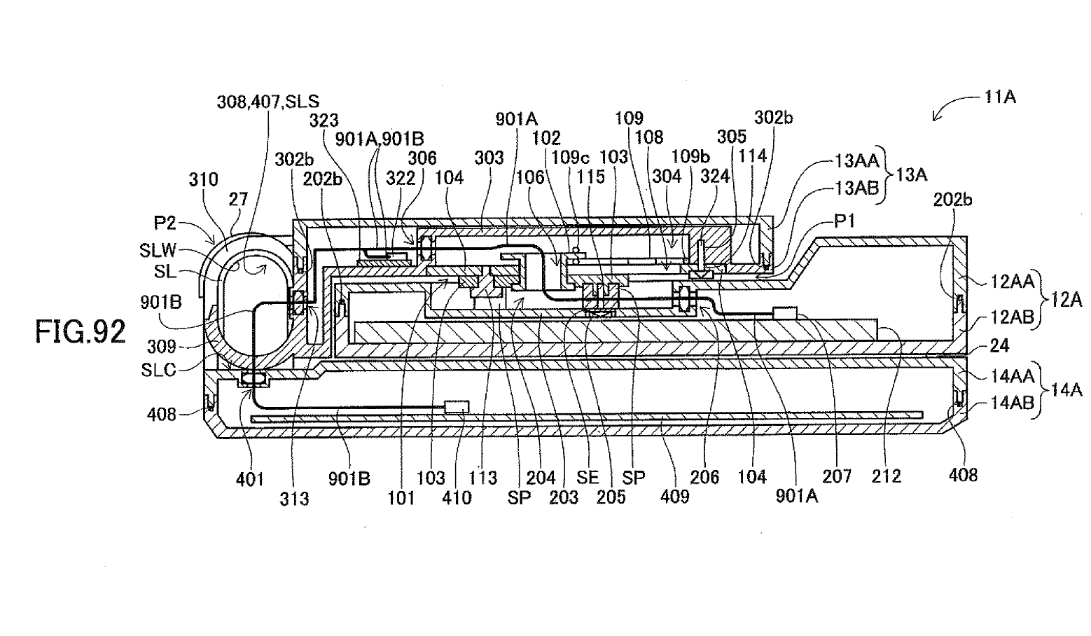

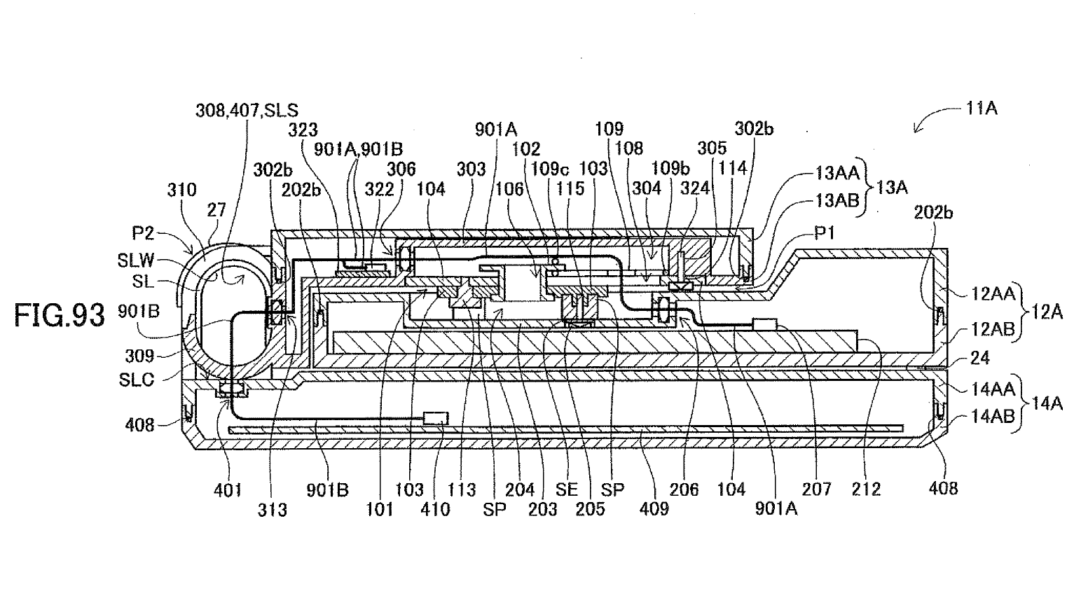

FIG. 92 or FIG. 93 is a sectional view illustrating the mobile phone 11A according to the first embodiment having a swing cladding tube 901A or a pivoting cladding tube 901B serving as a gasket integrated FPCB. The sectional view illustrated in FIG. 92 or 93 depicts a cross section of the mobile phone 11A according to the first embodiment viewing from a point D1 in FIG. 3 in a case where the mobile phone 11A according to the first embodiment in the folded state illustrated in FIG. 3 is cut along a dash-dot section line D. Note that illustration of the third space wall 31 (see FIG. 3) placed over the third space wall 309 is omitted from FIG. 92 or 93.

In FIGS. 92 to 93, components identical to those illustrated in FIG. 23 or 32 are provided with the same reference numerals. The mobile phone 11A according to the first embodiment illustrated in FIG. 92 or 93 employs the swing cladding tube 901A or the pivoting cladding tube 901B as a gasket integrated FPCB in place of the swing cladding tube T1 or the pivoting cladding tube T2 illustrated in FIG. 23 or 32. The swing cladding tube 901A serving as an insulating part of the FPCB envelops a conductor part 901AA of the FPCB. The pivoting cladding tube 901B serving as an insulating part of the FPCB envelops a conductor part 901BA of the FPCB. That is, the mobile phone 11A according to the first embodiment illustrated in FIG. 92 or 93 has a configuration identical to that illustrated in FIG. 23 or 32 except for the swing cladding tube 901A enveloping the conductor part 901AA of the swing cladding tube 901A or the pivoting cladding tube 901B enveloping the conductor part of the FPCB. Accordingly, illustration of the components in FIG. 92 or 93 identical to those of FIG. 23 or 32 provided with the same reference numerals is therefore omitted.

In the mobile phone 11A according to the first embodiment illustrated in FIG. 92, the swing cladding tube 901A passes through the first shaft hole 106 of the swing connecting member 101. In the mobile phone 11A according to the first embodiment illustrated in FIG. 93, the swing cladding tube 901A passes through the guide slot 108 of the swing connecting member 101. When the swing cladding tube 901A passes through the guide slot 108 of the swing connecting member 101, the swing cladding tube 901A is fixed by the fixing member 151 (see FIG. 34) as illustrated in the third insertion type above. When the swing cladding tube 901A passes through the swing connecting member 101, the swing cladding tube 901A may be passed through the dedicated hole 162 (e.g., see FIG. 40) of the swing connecting member 101 as illustrated in the fourth insertion type above. A similar insertion type of the swing cladding tube 901A inserted into the swing connecting member 101 in the mobile phone 11A according to the first embodiment may be applicable to the mobile phone 11B according to the second embodiment or the mobile phone 11C according to the third embodiment. In the mobile phone 11D according to the fourth embodiment, the swing cladding tube 901A passes through the dedicated pivoting shaft hole 506 of the swing connecting member 501 (e.g., see FIG. 56).

In the mobile phone 11A according to the first embodiment illustrated in FIG. 92, the pivoting cladding tube 901B passes through the second pivoting shaft SL. Likewise, in the mobile phone 11A according to the first embodiment illustrated in FIG. 93, the pivoting cladding tube 901B is also passed through the second pivoting shaft SL. A similar insertion type of the pivoting cladding tube 901B inserted into the second pivoting shaft SL in the mobile phone 11A according to the first embodiment may be applicable to the mobile phone 11D according to the fourth embodiment.

The swing cladding tube 901A or the pivoting cladding tube 901B is a substitute for the insulating part of the FPCB; however, they may be a substitute for an insulating part of the FFC. The insulating part of the FPCB has waterproof properties. When the swing cladding tube 901A or the pivoting cladding tube 901B is utilized as a substitute for the insulating part of the FFC, a gasket is integrated with the insulating part of the FFC for which the swing cladding tube or the pivoting cladding tube serves as the substitute.

In addition, since a modification of the waterproof structure (see FIG. 24) associated with the electrical connection to the first wiring member E1 and the second wiring member E2 is similar to the waterproof structure with the first insertion type, illustration of such a modification of the waterproof structure associated with the electrical connection is omitted from the description.

### 10-9. Modification of Waterproof Structure Having Gasket Integrated FPCB

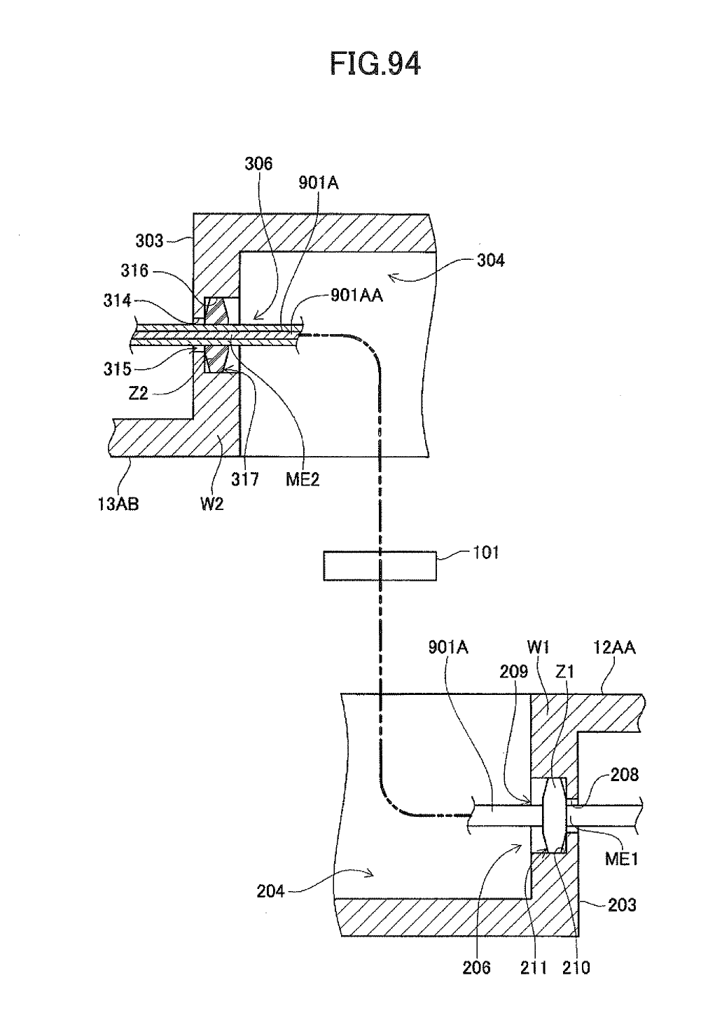

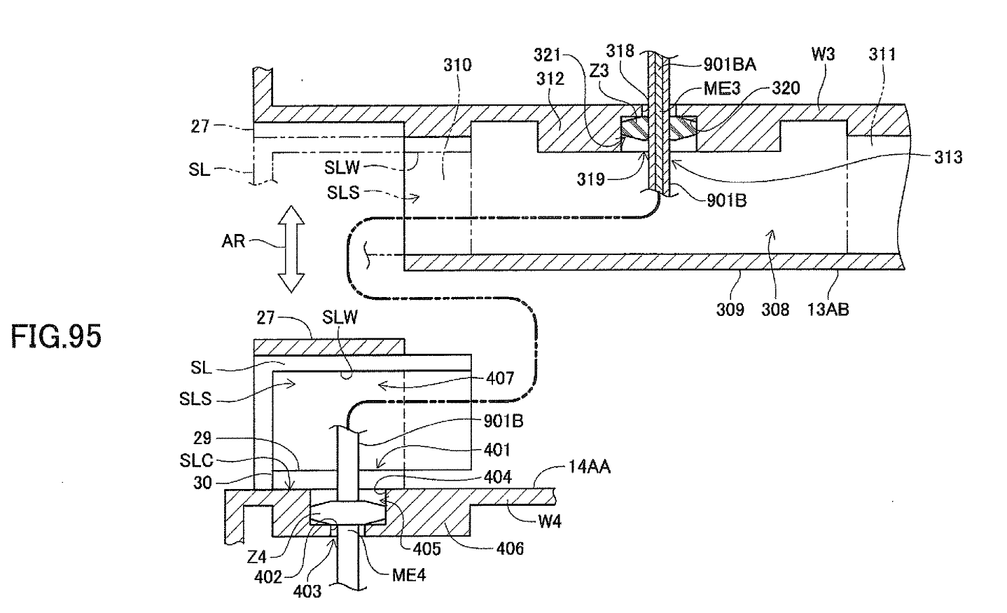

FIG. 94 is a view illustrating a modification of the waterproof structure of FIG. 90. In FIG. 94, components identical to those illustrated in FIG. 90 are provided with the same reference numerals. In the following description, illustration of the components in FIG. 94 identical to those of FIG. 90 provided with the same reference numerals is therefore omitted unless there is a difference between the two configurations. FIG. 95 is a view illustrating a modification of the waterproof structure of FIG. 91. In FIG. 95, components identical to those illustrated in FIG. 91 are provided with the same reference numerals. In the following description, illustration of the components in FIG. 95 identical to those of FIG. 91 provided with the same reference numerals is therefore omitted unless there is a difference between the two configurations.

Note that the waterproof structure illustrated in the lower part of FIG. 90 may be changed to a waterproof structure illustrated in a lower part of FIG. 94. In the waterproof structure illustrated in the lower part of FIG. 94, the first continuous groove wall 210 of the first wiring opening wall 208 is formed such that the first continuous groove wall 210 faces the first space 204. Consequently, the first continuous groove 211 of the first wiring opening wall 208 is formed such that the first continuous groove 211 faces the first space 204. The first wiring opening 209 has a counterbore shape. That is, in the waterproof structure illustrated in the lower part of FIG. 94, the first fixing sealer Z1 of the swing cladding tube 901A may be tightly attached to the first continuous groove wall 210 of the first wiring opening wall 208 after having been compressively deformed in an amount significantly less than that of the compressive deformation of the waterproof structure illustrated in the lower part of FIG. 90. This may facilitate inserting of the first fixing end ME1 of the swing cladding tube 901A into the first wiring opening 209 in addition to securing the waterproof properties given to the first wiring opening 209. Further, the first wiring opening 209 having the counterbore shape does not have a ring groove. Hence, even though the swing connecting side first housing 12AA is reduced in size or thinned, it may be easy to form the first wiring opening 209 in the swing connecting side first housing 12AA that has been reduced in size or thinned.

Note that the waterproof structure illustrated in the upper part of FIG. 90 may be changed to a waterproof structure illustrated in the upper part of FIG. 94. In the waterproof structure illustrated in the upper part of FIG. 94, the second continuous groove wall 316 of the second wiring opening wall 314 is formed such that the second continuous groove wall 316 faces the second space 304. Consequently, the second continuous groove 317 of the second wiring opening wall 314 is formed such that the second continuous groove 317 faces the second space 304. The second wiring opening 315 has a counterbore shape. That is, in the waterproof structure illustrated in the upper part of FIG. 94, the second fixing sealer Z2 of the swing cladding tube 901A may be tightly attached to the second continuous groove wall 316 of the second wiring opening wall 314 after having been compressively deformed in an amount significantly less than that of the compressive deformation of the waterproof structure illustrated in the upper part of FIG. 90. This may facilitate inserting of the second fixing end ME2 of the swing cladding tube 901A into the second wiring opening 315 in addition to securing the waterproof properties given to the second wiring opening 315. Further, the second wiring opening 315 having the counterbore shape does not have a ring groove. Hence, even though the swing connecting side second housing 13AB is reduced in size or thinned, it may be easy to form the second wiring opening 315 in the swing connecting side second housing 13AB that has been reduced in size or thinned.

Note that the waterproof structure illustrated in the upper part of FIG. 91 may be changed to a waterproof structure illustrated in the upper part of FIG. 95. In the waterproof structure illustrated in the upper part of FIG. 95, the third continuous groove wall 320 of the third wiring opening wall 318 is formed such that the third continuous groove wall 320 faces the third space 308. Consequently, the third continuous groove 321 of the third wiring opening wall 318 is formed such that the third continuous groove 321 faces the third space 308. The third wiring opening 319 has a counterbore shape. That is, in the waterproof structure illustrated in the upper part of FIG. 95, the third fixing sealer Z3 of the pivoting cladding tube 901B may be tightly attached to the third continuous groove wall 320 of the third wiring opening wall 318 after having been compressively deformed in an amount significantly less than that of the compressive deformation of the waterproof structure illustrated in the upper part of FIG. 91. This may facilitate inserting of the third fixing end ME3 of the pivoting cladding tube 901B into the third wiring opening 319 in addition to securing the waterproof properties given to the third wiring opening 319. Further, the third wiring opening 319 having the counterbore shape does not have a ring groove. Hence, even though the swing connecting side second housing 13AB is reduced in size or thinned, it may be easy to form the third wiring opening 319 in the swing connecting side second housing 13AB that has been reduced in size or thinned.

Note that the waterproof structure illustrated in the lower part of FIG. 91 may be changed to a waterproof structure illustrated in a lower part of FIG. 95. In the waterproof structure illustrated in the lower part of FIG. 95, the fourth continuous groove wall 404 of the fourth wiring opening wall 402 is formed such that the fourth continuous groove wall 404 faces the fourth space 407. Consequently, the fourth continuous groove 405 of the fourth wiring opening wall 402 is formed such that the fourth continuous groove 405 faces the fourth space 407. The fourth wiring opening 403 has a counterbore shape. That is, in the waterproof structure illustrated in the lower part of FIG. 95, the fourth fixing sealer Z4 of the pivoting cladding tube 901B may be tightly attached to the fourth continuous groove wall 404 of the fourth wiring opening wall 402 after having been compressively deformed in an amount significantly less than that of the compressive deformation of the waterproof structure illustrated in the lower part of FIG. 91. This may facilitate inserting of the fourth fixing end ME4 of the pivoting cladding tube 901B into the fourth wiring opening 403 in addition to securing the waterproof properties given to the fourth wiring opening 403. Further, the fourth wiring opening 403 having the counterbore shape does not have a ring groove. Hence, even though the pivoting connecting side third housing 14AA is reduced in size or thinned, it may be easy to form the fourth wiring opening 403 in the pivoting connecting side third housing 14AA that has been reduced in size or thinned.

### 10-10. Modification of Fixing Member

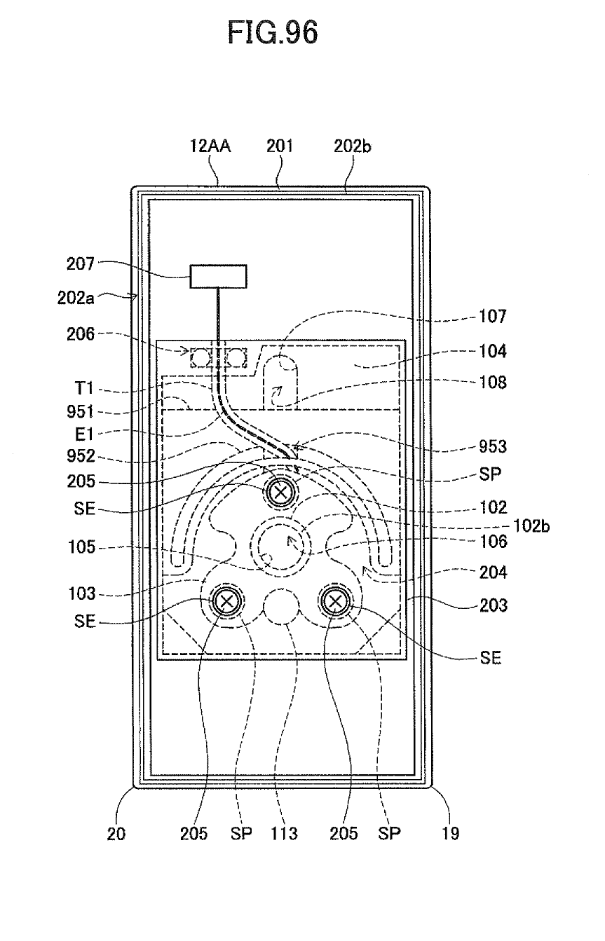

FIG. 34 is a view illustrating a fixing member 151 for fixing the swing cladding tube T1 passing through the guide slot 108 within the impenetrable region J. The modification illustrated in FIG. 96 may of course be capable of maintaining the swing cladding tube T1 passing through the guide slot 108 not to be compressed by the plate cam 103 or the guide slot wall 107. FIG. 96 is an internal view illustrating a modification of the swing connecting side first housing 12AA of the mobile phone 11A according to the first embodiment. In FIG. 96, components identical to those illustrated in FIG. 25 are provided with the same reference numerals. In the following description, illustration of the components in FIG. 96 identical to those of FIG. 25 provided with the same reference numerals is therefore omitted.

As illustrated in FIG. 96, an arc plate 951 includes an arc groove 952. The arc groove 952 is used for maintaining the swing cladding tube T1 passing through the guide slot 108 so as not to be compressed by the plate cam 103 or the guide slot wall 107. The arc plate 951 having the arc groove 952 is fixed to the first space wall 203 from an outer side of the swing connecting side first housing 12AA. When the arc plate 951 is fixed to the first space wall 203, an opening is formed in an overlapped part of the arc groove 952 of the arc plate 951 and the guide slot 108 of the clamping plate 104. The swing cladding tube T1 passes through the opening 953.

When the arc plate 951 is fixed to the first space wall 203, the center of the arc groove 952 of the arc plate 951 is located at an axis position of the first pivoting shaft 102 attached to the guide slot 108. Note that the position at which the arc plate 951 having the arc groove 952 corresponds to a position at which the guide slot 108 overlaps the arc groove 952 when the plate cam 103 is located at any positions over guide slot 108. Accordingly, the opening 953 is formed when the first housing 12A resides in any of positions illustrated in FIGS. 4 to 8.

The arc plate 951 and the plate cam 103 are both fixed to the swing connecting side first housing 12AA of the first housing 12A. Hence, when the position of the first housing 12A transitions to any of the positions illustrated in FIGS. 4 to 8 and the plate cam 103 moves over the guide slot 108 while pivoting, the arc groove 952 of the arc plate 951 also moves over the guide slot 108 while pivoting. Hence, when the position of the first housing 12A transitions to any of the positions illustrated in FIGS. 4 to 8, the swing cladding tube T1 passing through the opening 953 moves within the guide slot 108 so as to be guided by the pivoting arc groove 952. Note that grease is utilized for facilitating guiding the swing cladding tube T1 within the arc groove 952.

Note that the arc plate 951 and the plate cam 103 are both fixed to the swing connecting side first housing 12AA. Hence, when the position of the first housing 12A is any of the positions illustrated in FIGS. 4 to 8, a distance between the arc plate 951 and the plate cam 103 remains unchanged. That is, even when the position of the first housing 12A is in anyone of the positions illustrated in FIGS. 4 to 8, a distance between the opening 953 formed in the arc groove 952 of the arc plate and the plate cam 103 remain unchanged.

Accordingly, since the swing cladding tube T1 passing through the opening 953 is not compressed by the plate cam 103 or the guide slot wall 107, reciprocation of the plate cam 103 will not be disturbed by the swing cladding tube T1 moving within the guide slot 108. Hence, the flexibility of the swing operation of the swing connecting member 101 (e.g., see FIG. 9) may be maintained. Further, when the swing operation is performed by the swing connecting member 101, the swing cladding tube T1 will not be damaged by the plate cam 103 or the guide slot wall 107. Hence, the first wiring member E1 enveloped by the swing cladding tube T1 will be protected. Accordingly, even if the first pivoting shaft 102 repeatedly pivots and slides within the guide slot 108 due to the swing operation repeatedly performed by the swing connecting member 101, the first wiring member E1 exhibits prolonged durability.

Note that the modification of the waterproof structure illustrated in FIG. 96 may also be applied to the mobile phone 11B according to the second embodiment, the mobile phone 11C according to the third embodiment, and the mobile phone 11D according to the fourth embodiment.

The disclosed embodiments may be capable of implementing waterproof properties while exhibiting flexibility of the swing operation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. A mobile terminal comprising:
a first housing having a first space wall forming a first recess-shaped space, and a first wiring opening formed in the first space wall;
a second housing having a second space wall forming a second recess-shaped space, and a second wiring opening formed in the second space wall;
a swing connecting member disposed in a space formed between the first recess-shaped space and the second recess-shaped space facing each other, the swing connecting member having a through hole for allowing the first recess-shaped space and the second recess-shaped space to be in communication with each other and being configured to swingably move the first housing and the second housing; and
a first wiring member passing through the through hole, the first wiring member having a first fixing end closely connected to the first wiring opening and a second fixing end closely connected to the second wiring opening.

2. The mobile terminal as claimed in claim 1, wherein
the swing connecting member includes
a first pivoting shaft;
a plate cam attached to the first housing such that the plate cam is projected from the first pivoting shaft;
a clamping plate attached to the second housing;
a guide slot wall forming a guide slot in the clamping plate;
a resilient member having resilient force to slidably move the first pivoting shaft pivotally and slidably attached to the guide slot in a resilient force direction;
a pivoting contactor against which the plate cam is pressed by the resilient force of the resilient member; and
a first shaft hole wall forming a first shaft hole in the first pivoting shaft,
the first wiring member passing through the first shaft hole of the first pivoting shaft.

3. The mobile terminal as claimed in claim 1, wherein
the swing connecting member includes
a first pivoting shaft;
a plate cam attached to the first housing such that the plate cam is projected from the first pivoting shaft;
a clamping plate attached to the second housing;
a guide slot wall forming a guide slot in the clamping plate;
a resilient member having resilient force to slidably move the first pivoting shaft that is pivotally and slidably attached to the guide slot in a resilient force direction; and
a pivoting contactor against which the plate cam is pressed by the resilient force of the resilient member,
the first wiring member passing through the guide slot.

4. The mobile terminal as claimed in claim 1, wherein
the swing connecting member includes
a first pivoting shaft;
a plate cam attached to the first housing such that the plate cam is projected from the first pivoting shaft;
a clamping plate attached to the second housing;
a guide slot wall forming a guide slot in the clamping plate;
a resilient member having resilient force to slidably move the first pivoting shaft that is pivotally and slidably attached to the guide slot in a resilient force direction; and
a pivoting contactor against which the plate cam is pressed by the resilient force of the resilient member,
the through hole of the swing connecting member being formed in the clamping plate that resides within an impenetrable region outside a movable range within which the plate cam and the resilient member are allowed to move.

5. The mobile terminal as claimed in claim 1, wherein
the resilient member is a torsion spring having a first end locked on the clamping plate and a second end hooked on the first pivoting shaft.

6. The mobile terminal as claimed in claim 1, further comprising:
a third space wall forming a third space in the second housing;
a third wiring opening wall forming a third wiring opening in the third space wall;
a third housing;
a fourth space wall forming a fourth space in the third housing;
a fourth wiring opening wall forming a fourth wiring opening in the fourth space wall;
a second pivoting shaft having waterproof properties, the second pivoting shaft being attached to a connecting position at which a position of the third space of the second housing matches a position of the fourth space of the third housing to provide a flexible pivotal operability connecting relationship between the second housing and the third housing;
a second shaft hole wall forming a second shaft hole in the second pivoting shaft, the second shaft hole allowing the third space of the second housing and the fourth space of the third housing to be in communication with each other;
a pivoting cladding tube having flexibility and passing through the second shaft hole of the second pivoting shaft, the pivoting cladding tube having a third fixing end closely connected to the third wiring opening of the third space wall and a fourth fixing end closely connected to the fourth wiring opening of the fourth space wall; and
a second wiring member enveloped by the pivoting cladding tube, the second wiring member passing through the third wiring opening of the third space wall and the fourth wiring opening of the fourth space wall.

7. The mobile terminal as claimed in claim 2, further comprising:
a third space wall forming a third space in the second housing;
a third wiring opening wall forming a third wiring opening in the third space wall;
a third housing;
a fourth space wall forming a fourth space in the third housing;
a fourth wiring opening wall forming a fourth wiring opening in the fourth space wall;
a second pivoting shaft having waterproof properties, the second pivoting shaft being attached to a connecting position at which a position of the third space of the second housing matches a position of the fourth space of the third housing to provide a flexible pivotal operability connecting relationship between the second housing and the third housing;
a second shaft hole wall forming a second shaft hole in the second pivoting shaft, the second shaft hole allowing the third space of the second housing and the fourth space of the third housing to be in communication with each other;
a pivoting cladding tube having flexibility and passing through the second shaft hole of the second pivoting shaft, the pivoting cladding tube having a third fixing end closely connected to the third wiring opening of the third space wall and a fourth fixing end closely connected to the fourth wiring opening of the fourth space wall; and
a second wiring member enveloped by the pivoting cladding tube, the second wiring member passing through the third wiring opening of the third space wall and the fourth wiring opening of the fourth space wall.

8. The mobile terminal as claimed in claim 3, further comprising:
a third space wall forming a third space in the second housing;
a third wiring opening wall forming a third wiring opening in the third space wall;
a third housing;
a fourth space wall forming a fourth space in the third housing;
a fourth wiring opening wall forming a fourth wiring opening in the fourth space wall;
a second pivoting shaft having waterproof properties, the second pivoting shaft being attached to a connecting position at which a position of the third space of the second housing matches a position of the fourth space of the third housing to provide a flexible pivotal operability connecting relationship between the second housing and the third housing;
a second shaft hole wall forming a second shaft hole in the second pivoting shaft, the second shaft hole allowing the third space of the second housing and the fourth space of the third housing to be in communication with each other;
a pivoting cladding tube having flexibility and passing through the second shaft hole of the second pivoting shaft, the pivoting cladding tube having a third fixing end closely connected to the third wiring opening of the third space wall and a fourth fixing end closely connected to the fourth wiring opening of the fourth space wall; and
a second wiring member enveloped by the pivoting cladding tube, the second wiring member passing through the third wiring opening of the third space wall and the fourth wiring opening of the fourth space wall.

9. The mobile terminal as claimed in claim 4, further comprising:
a third space wall forming a third space in the second housing;
a third wiring opening wall forming a third wiring opening in the third space wall;
a third housing;
a fourth space wall forming a fourth space in the third housing;
a fourth wiring opening wall forming a fourth wiring opening in the fourth space wall;
a second pivoting shaft having waterproof properties, the second pivoting shaft being attached to a connecting position at which a position of the third space of the second housing matches a position of the fourth space of the third housing to provide a flexible pivotal operability connecting relationship between the second housing and the third housing;
a second shaft hole wall forming a second shaft hole in the second pivoting shaft, the second shaft hole allowing the third space of the second housing and the fourth space of the third housing to be in communication with each other;
a pivoting cladding tube having flexibility and passing through the second shaft hole of the second pivoting shaft, the pivoting cladding tube having a third fixing end closely connected to the third wiring opening of the third space wall and a fourth fixing end closely connected to the fourth wiring opening of the fourth space wall; and
a second wiring member enveloped by the pivoting cladding tube, the second wiring member passing through the third wiring opening of the third space wall and the fourth wiring opening of the fourth space wall.

10. The mobile terminal as claimed in claim 1, further comprising:
a first fixing sealer attached to the first wiring opening of the first space wall to seal an interval between the first wiring opening and the first fixing end of the first wiring member; and
a first continuous groove wall forming a first continuous groove in the first wiring opening, wherein
the first fixing sealer attached to the first wiring opening of the first space wall is closely attached to the first continuous groove wall to seal an interval between the first wiring opening and the first fixing end of the first wiring member such that the first fixing sealer is integrally formed on the first fixing end of the first wiring member.

11. The mobile terminal as claimed in claim 2, further comprising:
a first fixing sealer attached to the first wiring opening of the first space wall to seal an interval between the first wiring opening and the first fixing end of the first wiring member; and
a first continuous groove wall forming a first continuous groove in the first wiring opening, wherein
the first fixing sealer attached to the first wiring opening of the first space wall is closely attached to the first continuous groove wall to seal an interval between the first wiring opening and the first fixing end of the first wiring member such that the first fixing sealer is integrally formed on the first fixing end of the first wiring member.

12. The mobile terminal as claimed in claim 3, further comprising:
a first fixing sealer attached to the first wiring opening of the first space wall to seal an interval between the first wiring opening and the first fixing end of the first wiring member; and
a first continuous groove wall forming a first continuous groove in the first wiring opening, wherein
the first fixing sealer attached to the first wiring opening of the first space wall is closely attached to the first continuous groove wall to seal an interval between the first wiring opening and the first fixing end of the first wiring member such that the first fixing sealer is integrally formed on the first fixing end of the first wiring member.

13. The mobile terminal as claimed in claim 4, further comprising:
a first fixing sealer attached to the first wiring opening of the first space wall to seal an interval between the first wiring opening and the first fixing end of the first wiring member; and
a first continuous groove wall forming a first continuous groove in the first wiring opening, wherein
the first fixing sealer attached to the first wiring opening of the first space wall is closely attached to the first continuous groove wall to seal an interval between the first wiring opening and the first fixing end of the first wiring member such that the first fixing sealer is integrally formed on the first fixing end of the first wiring member.

14. The mobile terminal as claimed in claim 6, further comprising:
a first fixing sealer attached to the first wiring opening of the first space wall to seal an interval between the first wiring opening and the first fixing end of the first wiring member; and
a first continuous groove wall forming a first continuous groove in the first wiring opening, wherein
the first fixing sealer attached to the first wiring opening of the first space wall is closely attached to the first continuous groove wall to seal an interval between the first wiring opening and the first fixing end of the first wiring member such that the first fixing sealer is integrally formed on the first fixing end of the first wiring member.

15. The mobile terminal as claimed in claim 7, further comprising:
a first fixing sealer attached to the first wiring opening of the first space wall to seal an interval between the first wiring opening and the first fixing end of the first wiring member; and
a first continuous groove wall forming a first continuous groove in the first wiring opening, wherein
the first fixing sealer attached to the first wiring opening of the first space wall is closely attached to the first continuous groove wall to seal an interval between the first wiring opening and the first fixing end of the first wiring member such that the first fixing sealer is integrally formed on the first fixing end of the first wiring member.

16. The mobile terminal as claimed in claim 8, further comprising:
a first fixing sealer attached to the first wiring opening of the first space wall to seal an interval between the first wiring opening and the first fixing end of the first wiring member; and
a first continuous groove wall forming a first continuous groove in the first wiring opening, wherein
the first fixing sealer attached to the first wiring opening of the first space wall is closely attached to the first continuous groove wall to seal an interval between the first wiring opening and the first fixing end of the first wiring member such that the first fixing sealer is integrally formed on the first fixing end of the first wiring member.

17. The mobile terminal as claimed in claim 9, further comprising:
a first fixing sealer attached to the first wiring opening of the first space wall to seal an interval between the first wiring opening and the first fixing end of the first wiring member; and
a first continuous groove wall forming a first continuous groove in the first wiring opening, wherein
the first fixing sealer attached to the first wiring opening of the first space wall is closely attached to the first continuous groove wall to seal an interval between the first wiring opening and the first fixing end of the first wiring member such that the first fixing sealer is integrally formed on the first fixing end of the first wiring member.
